(19) United States
(12) Patent Application Publication
(10) Pub. No.: US 2026/0142170 A1
(43) Pub. Date: May 21, 2026

(54) POSITIVE ELECTRODE ACTIVE MATERIAL, SECONDARY BATTERY, AND VEHICLE

(71) Applicant: SEMICONDUCTOR ENERGY LABORATORY CO., LTD., ATSUGI-SHI (JP)

(72) Inventors: Mayumi MIKAMI, Atsugi (JP); Jo SAITO, Atsugi (JP); Kazuki TANEMURA, Isehara (JP); Tatsuyoshi TAKAHASHI, Atsugi (JP); Yohei MOMMA, Isehara (JP); Kazuya SHIMADA, Atsugi (JP); Kunihiro FUKUSHIMA, Isehara (JP)

(21) Appl. No.: 19/445,777

(22) Filed: Jan. 12, 2026

Related U.S. Application Data
(63) Continuation of application No. 17/734,744, filed on May 2, 2022.

(30) Foreign Application Priority Data
May 7, 2021 (JP) 2021-079264

(51) Int. Cl. H01M 4/525; H01M 4/02

(52) U.S. Cl. CPC H01M 4/525; H01M 2004/028

(57) ABSTRACT

A positive electrode active material in which a discharge capacity decrease due to charge and discharge cycles is suppressed and a secondary battery including the positive electrode active material are provided. A positive electrode active material in which a change in a crystal structure, e.g., a shift in CoO₂ layers is small between a discharged state and a high-voltage charged state is provided. For example, a positive electrode active material that has a layered rock-salt crystal structure belonging to the space group R-3m in a discharged state and a crystal structure belonging to the space group P2/m in a charged state where x in LiₓCoO₂ is greater than 0.1 and less than or equal to 0.24 is provided. When the positive electrode active material is analyzed by powder X-ray diffraction, a diffraction pattern has at least diffraction peaks at 2θ of 19.47±0.10° and 2θ of 45.62±0.05°.

### CROSS REFERENCE TO RELATED APPLICATIONS

This application is a continuation of U.S. application Ser. No. 17/734,744, filed May 2, 2022, now pending, which claims the benefit of a foreign priority application filed in Japan on May 7, 2021, as Application No. 2021-079264, both of which are incorporated by reference.

### BACKGROUND OF THE INVENTION

### 1. Field of the Invention

One embodiment of the present invention relates to an object, a method, or a manufacturing method. The present invention relates to a process, a machine, manufacture, or a composition of matter. One embodiment of the present invention relates to a power storage device including a secondary battery, a semiconductor device, a display device, a light-emitting device, a lighting device, an electronic device, or a manufacturing method thereof.

Note that electronic devices in this specification mean all devices including power storage devices, and electro-optical devices including power storage devices, information terminal devices including power storage devices, and the like are all electronic devices.

### 2. Description of the Related Art

In recent years, a variety of power storage devices such as lithium-ion secondary batteries, lithium-ion capacitors, air batteries, and all-solid-state batteries have been actively developed. In particular, demand for lithium-ion secondary batteries with high output and high capacity has rapidly grown with the development of the semiconductor industry. The lithium-ion secondary batteries are essential as rechargeable energy supply sources for today's information society.

In particular, secondary batteries for mobile electronic devices, for example, are highly demanded to have high discharge capacity per weight and excellent cycle performance. In order to meet such demands, positive electrode active materials in positive electrodes of secondary batteries have been actively improved (e.g., Patent Documents 1 to 3). Crystal structures of positive electrode active materials have also been studied (Non-Patent Documents 1 to 3).

X-ray diffraction (XRD) is one of methods used for analysis of a crystal structure of a positive electrode active material. With the use of the Inorganic Crystal Structure Database (ICSD) described in Non-Patent Document 4, XRD data can be analyzed. For Rietveld analysis, the analysis program RIETAN-FP (Non-Patent Document 5) can be used, for example.

### REFERENCES

### Patent Documents

[Patent Document 1] Japanese Published Patent Application No. 2019-179758
[Patent Document 2] PCT International publication No. 2020/026078
[Patent Document 3] Japanese Published Patent Application No. 2020-140954

### Non-Patent Documents

[Non-Patent Document 1] Toyoki Okumura et al., “Correlation of lithium ion distribution and X-ray absorption near-edge structure in O3- and O2-lithium cobalt oxides from first-principle calculation”, Journal of Materials Chemistry, 22, 2012, pp. 17340-17348.
[Non-Patent Document 2]T. Motohashi et al., “Electronic phase diagram of the layered cobalt oxide system LiₓCoO₂ (0.0≤x≤1.0)”, Physical Review B, 80 (16); 165114.
[Non-Patent Document 3] Zhaohui Chen et al., “Staging Phase Transitions in LiₓCoO₂”, Journal of The Electrochemical Society, 149 (12), 2002, A1604-A1609.
[Non-Patent Document 4]A. Belsky et al., “New developments in the Inorganic Crystal Structure Database (ICSD): accessibility in support of materials research and design”, Acta Cryst., B58, 2002, pp. 364-369.
[Non-Patent Document 5]F. Izumi and K. Momma, Solid State Phenom., 130, 2007, pp. 15-20
[Non-Patent Document 6]W. S. Rasband, ImageJ, U. S. National Institutes of Health, Bethesda, Maryland, USA, http://rsb.info.nih.gov/ij/, 1997-2012.
[Non-Patent Document 7]C. A. Schneider, W. S. Rasband, K. W. Eliceiri, “NIH Image to ImageJ: 25 years of image analysis”, Nature Methods, 9, 2012, pp. 671-675.
[Non-Patent Document 8]M. D. Abramoff, P. J. Magelhaes, S. J. Ram, “Image Processing with ImageJ”, Biophotonics International, volume 11, issue 7, 2004, pp. 36-42.

### SUMMARY OF THE INVENTION

Development of lithium-ion secondary batteries has room for improvement in terms of discharge capacity, cycle performance, reliability, safety, cost, and the like.

Therefore, positive electrode active materials that can improve discharge capacity, cycle performance, reliability, safety, cost, and the like when used in lithium-ion secondary batteries have been needed.

An object of one embodiment of the present invention is to provide a positive electrode active material or a composite oxide which can be used in a lithium-ion secondary battery and in which a discharge capacity decrease due to charge and discharge cycles is suppressed. Another object is to provide a positive electrode active material or a composite oxide having a crystal structure that is unlikely to be broken by repeated charge and discharge. Another object is to provide a positive electrode active material or a composite oxide with high discharge capacity. Another object is to provide a highly safe or highly reliable secondary battery.

Another object of one embodiment of the present invention is to provide a positive electrode active material, a composite oxide, a power storage device, or a manufacturing method thereof.

Note that the description of these objects does not preclude the existence of other objects. In one embodiment of the present invention, there is no need to achieve all these objects. Other objects can be derived from the description of the specification, the drawings, and the claims.

In order to achieve the above-described objects, one embodiment of the present invention is to provide a positive electrode active material or a composite oxide with a small change in a crystal structure even when high-voltage charge is performed with small x in LiₓCoO₂.

Alternatively, one embodiment of the present invention is to provide a positive electrode active material having a crystal structure in which a shift in CoO₂ layers is inhibited unlike in the H1-3 type structure, even when charge voltage is higher than or equal to 4.6 V and lower than or equal to 4.8 V or x in LiₓCoO₂ is greater than 0.1 and less than or equal to 0.24, typically greater than or equal to 0.15 and less than or equal to 0.17.

Specifically, one embodiment of the present invention is a positive electrode active material that has a layered rock-salt crystal structure belonging to a space group R-3m in a discharged state, and has a crystal structure belonging to a space group P2/m with lattice constants a=4.88±0.01 Å, b=2.82±0.01 Å, c=4.84±0.01 Å, α=90°, p=109.58±0.01°, and γ=90° in a charged state when x in LiₓCoO₂ is greater than 0.1 and less than or equal to 0.24.

In the above structure, coordinates of cobalt and oxygen in a unit cell are preferably Co1 (0.5, 0, 0.5), Co2 (0, 0.5, 0.5), O1 (0.232, 0, 0.645), and O2 (0.781, 0.5, 0.679) in the crystal structure in a charged state when x in LiₓCoO₂ is greater than 0.1 and less than or equal to 0.24.

Another embodiment of the present invention is a positive electrode active material having a layered rock-salt crystal structure belonging to the space group R-3m in a discharged state. When analysis by powder X-ray diffraction is performed on the positive electrode active material in a charged state with x in LiₓCoO₂ of greater than 0.1 and less than or equal to 0.24, a diffraction pattern has at least diffraction peaks at greater than or equal to 19.370 and less than or equal to 19.570 and greater than or equal to 45.570 and less than or equal to 45.67°.

Another embodiment of the present invention is a positive electrode active material having a layered rock-salt crystal structure belonging to the space group R-3m in a discharged state. When analysis by powder X-ray diffraction is performed on the positive electrode active material with x in LiₓCoO₂ of greater than 0.1 and less than or equal to 0.24, a diffraction pattern has at least diffraction peaks at greater than or equal to 19.130 and less than 19.37°, greater than or equal to 19.37° and less than or equal to 19.57°, greater than or equal to 45.370 and less than 45.57°, and greater than or equal to 45.570 and less than or equal to 45.67°.

Another embodiment of the present invention is a positive electrode active material containing lithium cobalt oxide. In the case where the positive electrode active material is used for a positive electrode and a lithium metal is used for a negative electrode to form a battery; the battery is subjected to CCCV charge at 4.7 V or higher a plurality of times; and the positive electrode of the battery is then analyzed by powder X-ray diffraction with CuKα₁ radiation in an argon atmosphere, an XRD pattern of the positive electrode active material has at least a diffraction peak at 2θ of 19.47±0.10° and a diffraction peak at 2θ of 45.62±0.05°.

Another embodiment of the present invention is a positive electrode active material containing lithium cobalt oxide. In the case where the positive electrode active material is used for a positive electrode, a lithium metal is used for a negative electrode, and 1 mol/L lithium hexafluorophosphate and a mixture containing ethylene carbonate (EC) and diethyl carbonate (DEC) at a volume ratio of 3:7 and vinylene carbonate (VC) at 2 wt % are used for an electrolyte solution to form a battery; the battery is subjected to constant current charge to 4.75 V at a current value of 10 mA/g in a 45-° C. environment; and the positive electrode of the battery is then analyzed by powder X-ray diffraction with CuKα₁ radiation in an argon atmosphere, an XRD pattern of the positive electrode active material has at least a diffraction peak at 2θ of 19.47±0.10° and a diffraction peak at 2θ of 45.62±0.05°.

Another embodiment of the present invention is a positive electrode active material containing lithium cobalt oxide. When the positive electrode active material is analyzed by Raman spectroscopy at a laser wavelength of 532 nm and an output of 2.5 mW and integrated intensities of a peak in the range from 580 cm⁻¹ to 600 cm⁻¹ and a peak in the range from 665 cm⁻¹ to 685 cm⁻¹ are represented by I2 and I3, respectively, I3/I2 is greater than or equal to 1% and less than or equal to 10%.

In any of the above structures, cobalt preferably accounts for 90 atomic % or more of a transition metal M of the positive electrode active material.

In any of the above structures, H1-3 and O1 type structures preferably account for less than or equal to 50% of the positive electrode active material.

In any of the above structures, the positive electrode active material preferably contains magnesium, nickel, and aluminum in a surface portion.

In any of the above structures, a peak of magnesium concentration and a peak of nickel concentration are preferably exhibited closer to the surface side of the positive electrode active material than a peak of aluminum concentration is in results of linear analysis by energy dispersive X-ray spectroscopy.

According to one embodiment of the present invention, a positive electrode active material or a composite oxide which can be used in a lithium-ion secondary battery and in which a discharge capacity decrease due to charge and discharge cycles is suppressed can be provided. A positive electrode active material or a composite oxide having a crystal structure that is unlikely to be broken by repeated charge and discharge can be provided. A positive electrode active material or a composite oxide with high discharge capacity can be provided. A highly safe or highly reliable secondary battery can be provided.

One embodiment of the present invention can provide a positive electrode active material, a composite oxide, a power storage device, or a manufacturing method thereof.

Note that the description of these effects does not preclude the existence of other effects. One embodiment of the present invention does not need to have all the effects. Other effects will be apparent from and can be derived from the description of the specification, the drawings, the claims, and the like.

### BRIEF DESCRIPTION OF THE DRAWINGS

FIG. 1A is a cross-sectional view of a positive electrode active material, and FIGS. 1B1 and 1B2 are cross-sectional views of part of the positive electrode active material;

FIG. 2 is an example of a TEM image showing crystal orientations substantially aligned with each other;

FIG. 3A is an example of a STEM image showing crystal orientations substantially aligned with each other, FIG. 3B shows an FFT pattern of a region of a rock-salt crystal RS, and FIG. 3C shows an FFT pattern of a region of a layered rock-salt crystal LRS;

FIG. 4 shows crystal structures of a positive electrode active material;

FIG. 5 shows crystal structures of a conventional positive electrode active material;

FIGS. 6A1 and 6A2 are cross-sectional views of part of a positive electrode active material and FIGS. 6B1, 6B2, 6B3, and 6C show results of calculating a crystal plane and magnesium distribution in lithium cobalt oxide;

FIGS. 7A and 7B are cross-sectional views of a positive electrode active material and FIGS. 7C1 and 7C2 are cross-sectional views of part of the positive electrode active material;

FIG. 8 shows XRD patterns calculated from crystal structures;

FIG. 9 shows XRD patterns calculated from crystal structures;

FIGS. 10A and 10B show XRD patterns calculated from crystal structures;

FIGS. 11A to 11C show lattice constants calculated using XRD;

FIGS. 12A to 12C show lattice constants calculated using XRD;

FIG. 13 is cross-sectional views of a positive electrode active material;

FIG. 14 is a cross-sectional view of a positive electrode active material;

FIGS. 15A to 15C illustrate methods for forming a positive electrode active material;

FIG. 16 illustrates a method for forming a positive electrode active material;

FIGS. 17A to 17C illustrate methods for forming a positive electrode active material;

FIGS. 18A and 18B are cross-sectional views of an active material layer containing graphene or a graphene compound as a conductive material;

FIGS. 19A and 19B illustrate examples of a secondary battery;

FIGS. 20A to 20C illustrate an example of a secondary battery;

FIGS. 21A and 21B illustrate an example of a secondary battery;

FIGS. 22A and 22B illustrate a coin-type secondary battery and FIG. 22C illustrates charge and discharge of the secondary battery;

FIGS. 23A to 23D illustrate a cylindrical secondary battery;

FIGS. 24A and 24B illustrate an example of a power storage device;

FIGS. 25A to 25D illustrate examples of a power storage device;

FIGS. 26A and 26B illustrate examples of a secondary battery;

FIG. 27 illustrates an example of a secondary battery;

FIGS. 28A to 28C illustrate a laminated secondary battery;

FIGS. 29A and 29B illustrate a laminated secondary battery;

FIG. 30 is an external view of a secondary battery;

FIG. 31 is an external view of a secondary battery;

FIGS. 32A to 32C illustrate a method for fabricating a secondary battery;

FIGS. 33A to 33H illustrate examples of electronic devices;

FIGS. 34A to 34C illustrate an example of an electronic device;

FIG. 35 illustrates examples of electronic devices;

FIGS. 36A to 36D illustrate examples of electronic devices;

FIGS. 37A to 37C illustrate examples of electronic devices;

FIGS. 38A to 38C illustrate examples of vehicles;

FIGS. 39A to 39F are surface SEM images of positive electrode active materials;

FIGS. 40A to 40H are surface SEM images of positive electrode active materials;

FIGS. 41A and 41B are HAADF-STEM images of a positive electrode active material;

FIGS. 42A and 42B are HAADF-STEM images of a positive electrode active material;

FIGS. 43A and 43B are HAADF-STEM images of a positive electrode active material;

FIGS. 44A and 44B are nanobeam electron diffraction patterns;

FIGS. 45A and 45B are nanobeam electron diffraction patterns;

FIGS. 46A and 46B are nanobeam electron diffraction patterns;

FIG. 47A is a HAADF-STEM image of a positive electrode active material, FIG. 47B is a cobalt mapping image, FIG. 47C is an oxygen mapping image, FIG. 47D is a magnesium mapping image, FIG. 47E is an aluminum mapping image, and FIG. 47F is a silicon mapping image;

FIG. 48A illustrates a scanning method in STEM-EDX linear analysis and FIG. 48B is a profile of the STEM-EDX linear analysis;

FIG. 49 is an enlarged view of a part in FIG. 48B;

FIGS. 50A and 50B are HAADF-STEM images of a positive electrode active material;

FIGS. 51A and 51B are nanobeam electron diffraction patterns;

FIGS. 52A and 52B are nanobeam electron diffraction patterns;

FIGS. 53A and 53B are nanobeam electron diffraction patterns;

FIG. 54A is a HAADF-STEM image of a positive electrode active material, FIG. 54B is a silicon mapping image, FIG. 54C is an oxygen mapping image, FIG. 54D is a magnesium mapping image, FIG. 54E is an aluminum mapping image, and FIG. 54F is a nickel mapping image;

FIG. 55A illustrates a scanning method in STEM-EDX linear analysis and FIG. 55B is a profile of the STEM-EDX linear analysis;

FIG. 56 is an enlarged view of a part in FIG. 55B;

FIGS. 57A and 57B are HAADF-STEM images of a positive electrode active material;

FIGS. 58A and 58B are measurement results of particle size distribution in a positive electrode active material;

FIGS. 59A to 59C are surface SEM images of positive electrode active materials;

FIGS. 60A to 60C are graphs showing distribution of grayscale values of positive electrode active materials;

FIGS. 61A to 61C are luminance histograms of positive electrode active materials;

FIGS. 62A to 62D are graphs showing cycle performance of secondary batteries;

FIGS. 63A to 63D are graphs showing cycle performance of secondary batteries;

FIGS. 64A to 64D are graphs showing cycle performance of secondary batteries;

FIGS. 65A to 65D are graphs showing cycle performance of secondary batteries;

FIGS. 66A and 66B are graphs showing cycle performance of secondary batteries;

FIG. 67A is a photograph of a pellet, and FIGS. 67B and 67C are surface SEM images of a positive electrode active material;

FIG. 68A is a surface SEM image of a positive electrode active material and FIG. 68B is a cross-sectional STEM image thereof, FIGS. 69A1 and 69B1 are cross-sectional HAADF-STEM images of a positive electrode active material, and FIGS. 69A2, 69A3, 69A4, 69B2, 69B3, and 69B4 are EDX mapping images;

FIG. 70 shows a dQ/dVvsV curve of a secondary battery;

FIG. 71 shows a dQ/dVvsV curve of a secondary battery;

FIG. 72 shows a dQ/dVvsV curve of a secondary battery;

FIG. 73 shows a dQ/dVvsV curve of a secondary battery;

FIG. 74 shows XRD patterns of a positive electrode;

FIGS. 75A and 75B show enlarged portions of XRD patterns of FIG. 74;

FIG. 76 shows XRD patterns of a positive electrode;

FIGS. 77A and 77B show enlarged portions of XRD patterns of FIG. 76;

FIG. 78 shows XRD patterns of a positive electrode;

FIGS. 79A and 79B show enlarged portions of XRD patterns of FIG. 78;

FIG. 80 shows XRD patterns of a positive electrode;

FIGS. 81A and 81B show enlarged portions of XRD patterns of FIG. 80;

FIG. 82 shows XRD patterns of a positive electrode;

FIGS. 83A and 83B show enlarged portions of XRD patterns of FIG. 82;

FIG. 84 shows XRD patterns of a positive electrode;

FIGS. 85A and 85B show enlarged portions of XRD patterns of FIG. 84;

FIG. 86 shows XRD patterns of a positive electrode;

FIGS. 87A and 87B show enlarged portions of XRD patterns of FIG. 86;

FIG. 88 shows XRD patterns of a positive electrode;

FIGS. 89A and 89B show enlarged portions of XRD patterns of FIG. 88;

FIG. 90 shows XRD patterns of a positive electrode;

FIGS. 91A and 91B show enlarged portions of XRD patterns of FIG. 90;

FIG. 92 shows diagrams relating to powder resistivity measurement;

FIG. 93 is a graph showing discharge curves obtained in measurement by a current-rest-method;

FIG. 94 illustrates an analysis method for measurement by a current-rest-method;

FIGS. 95A and 95B show analysis results of measurement by a current-rest-method;

FIG. 96 shows analysis results of measurement by a current-rest-method;

FIGS. 97A and 97B show Raman spectra of positive electrode active materials; and

FIG. 98A shows a Raman spectrum of a positive electrode active material and FIG. 98B shows a Raman spectra of a positive electrode.

### DETAILED DESCRIPTION OF THE INVENTION

Hereinafter, examples of embodiments of the present invention will be described with reference to the drawings and the like. Note that the present invention should not be construed as being limited to the examples of embodiments given below. Embodiments of the invention can be changed unless it deviates from the spirit of the present invention.

In this specification and the like, a space group is represented using the short symbol of the international notation (or the Hermann-Mauguin notation). In addition, the Miller index is used for the expression of crystal planes and crystal orientations. An individual plane that shows a crystal plane is denoted by “( )”. In the crystallography, a bar is placed over a number in the expression of space groups, crystal planes, and crystal orientations; in this specification and the like, because of format limitations, crystal planes, crystal orientations, and space groups are sometimes expressed by placing a minus sign (−) in front of a number instead of placing a bar over the number. Furthermore, an individual direction that shows an orientation in crystal is denoted by “[ ]”, a set direction that shows all of the equivalent orientations is denoted by “< >”, an individual plane that shows a crystal plane is denoted by “( )”, and a set plane having equivalent symmetry is denoted by “{ }”. Atrigonal system represented by the space group R-3m is generally represented by a composite hexagonal lattice for easy understanding of the structure and, in some cases, not only (hkl) but also (hkil) is used as the Miller index. Here, i=−(h+k) is satisfied.

In this specification and the like, particles are not necessarily spherical (with a circular cross section). Other examples of the cross-sectional shapes of particles include an ellipse, a rectangle, a trapezoid, a triangle, a quadrilateral with rounded corners, and an asymmetrical shape, and a particle may have an indefinite shape.

In this specification and the like, a theoretical capacity of a positive electrode active material refers to the amount of electricity obtained when all lithium that can be inserted into and extracted from the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

The remaining amount of lithium that can be inserted into and extracted from a positive electrode active material is represented by x in a compositional formula, e.g., LiₓCoO₂. In the case of a positive electrode active material in a secondary battery, x can be represented by (theoretical capacity−charge capacity)/theoretical capacity. For example, when a secondary battery using LiCoO₂ as a positive electrode active material is charged to 219.2 mAh/g, the positive electrode active material can be represented by Li_{0.2}CoO₂, i.e., x=0.2. Note that “x in LiₓCoO₂ is small” means, for example, 0.1<x≤0.24.

Lithium cobalt oxide to be used for a positive electrode, which has been appropriately synthesized and almost satisfies the stoichiometric proportion, is LiCoO₂ with x of 1. Even after discharge of a secondary battery ends, the lithium cobalt oxide can be called LiCoO₂ with x of 1. Here, “discharge ends” means that a voltage becomes 3.0 V or 2.5 V or lower at a current of 100 mAh or lower, for example.

Charge capacity and/or discharge capacity used for calculation of x in LiₓCoO₂ is preferably measured under the condition where there is no influence or small influence of a short circuit and/or decomposition of an electrolyte solution or the like. For example, data of a secondary battery that is measured while a sudden change in capacity that seems to be derived from a short circuit should not be used for calculation of x.

The space group of a crystal structure is identified by XRD, electron diffraction, neutron diffraction, or the like. Thus, in this specification and the like, belonging to a space group or being a space group can be rephrased as being identified as a space group.

A structure is referred to as a cubic close-packed structure when three layers of anions are shifted and stacked like “ABCABC” in the structure. Accordingly, anions do not necessarily form a cubic lattice structure. At the same time, actual crystals always have a defect and thus, analysis results are not necessarily consistent with the theory. For example, in an electron diffraction pattern or a fast Fourier transform (FFT) pattern of a TEM image or the like, a spot may appear in a position different from a theoretical position. For example, anions may be regarded as forming a cubic close-packed structure when a difference in orientation from a theoretical position is 5° or less or 2.5° or less.

Uniformity refers to a phenomenon in which, in a solid made of a plurality of elements (e.g., A, B, and C), a certain element (e.g., A) is distributed with similar nature in specific regions. Note that it is acceptable for the specific regions to have substantially the same concentration of the element. For example, a difference in the concentration of the element between the specific regions can be 10% or less. Examples of the specific regions include a surface portion, a surface, a projection, a depression, and an inner portion.

A positive electrode active material to which an additive element is added is referred to as a composite oxide, a positive electrode material, a positive electrode material for a secondary battery, or the like in some cases. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a complex.

In the case where the features of individual particles of a positive electrode active material are described in the following embodiment and the like, not all the particles necessarily have the features. When 50% or more, preferably 70% or more, further preferably 90% or more of three or more randomly selected particles of a positive electrode active material have the features, it can be said that an effect of improving the characteristics of the positive electrode active material and a secondary battery including the positive electrode active material is sufficiently obtained.

The voltage of a positive electrode generally increases with increasing charge voltage of a secondary battery. The positive electrode active material of one embodiment of the present invention has a stable crystal structure even at a high voltage. The stable crystal structure of the positive electrode active material in a charged state can suppress a charge and discharge capacity decrease due to repeated charge and discharge.

A short circuit of a secondary battery might cause not only a malfunction in charging operation and/or discharging operation of the secondary battery but also heat generation and firing. In order to obtain a safe secondary battery, a short-circuit current is preferably inhibited even at a high charge voltage. With the positive electrode active material of one embodiment of the present invention, a short-circuit current is inhibited even at a high charge voltage. Thus, a secondary battery with both high discharge capacity and high safety can be obtained.

Note that the description is made on the assumption that materials (such as a positive electrode active material, a negative electrode active material, an electrolyte, and a separator) of a secondary battery have not deteriorated unless otherwise specified. A decrease in discharge capacity due to aging treatment and burn-in treatment during the manufacturing process of a secondary battery is not regarded as deterioration. For example, a state where discharge capacity is higher than or equal to 97% of the rated capacity of a lithium-ion secondary battery cell and an assembled lithium-ion secondary battery (hereinafter, referred to as a lithium-ion secondary battery) can be regarded as a non-deteriorated state. The rated capacity conforms to Japanese Industrial Standards (JIS C 8711:2019) in the case of a lithium-ion secondary battery for a portable device. The rated capacities of other lithium-ion secondary batteries conform to not only JIS described above but also JIS, standards defined by the International Electrotechnical Commission (IEC), and the like for electric vehicle propulsion, industrial use, and the like.

Note that in this specification and the like, in some cases, materials included in a secondary battery that have not deteriorated are referred to as initial products or materials in an initial state, and materials that have deteriorated (have discharge capacity lower than 97% of the rated capacity of the secondary battery) are referred to as products in use, materials in a used state, products that are already used, or materials in an already-used state.

### Embodiment 1

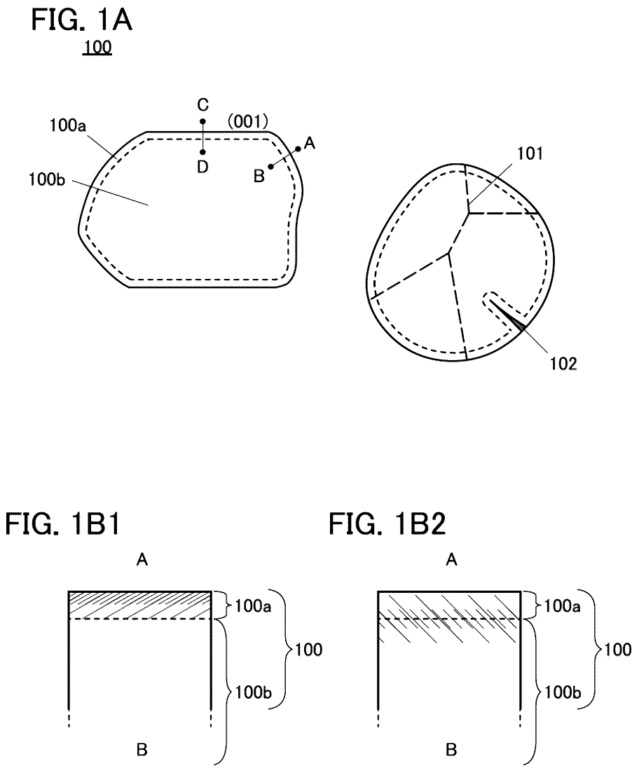

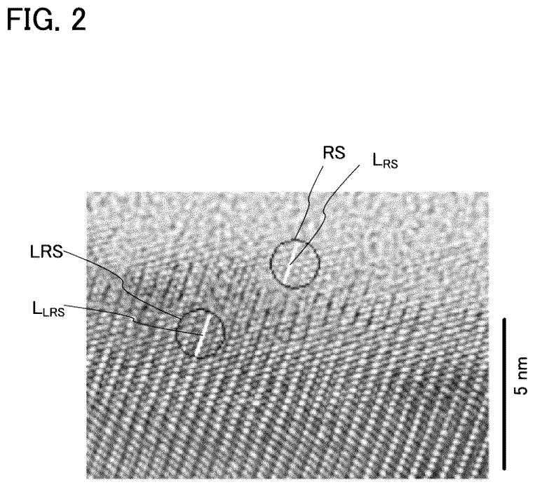

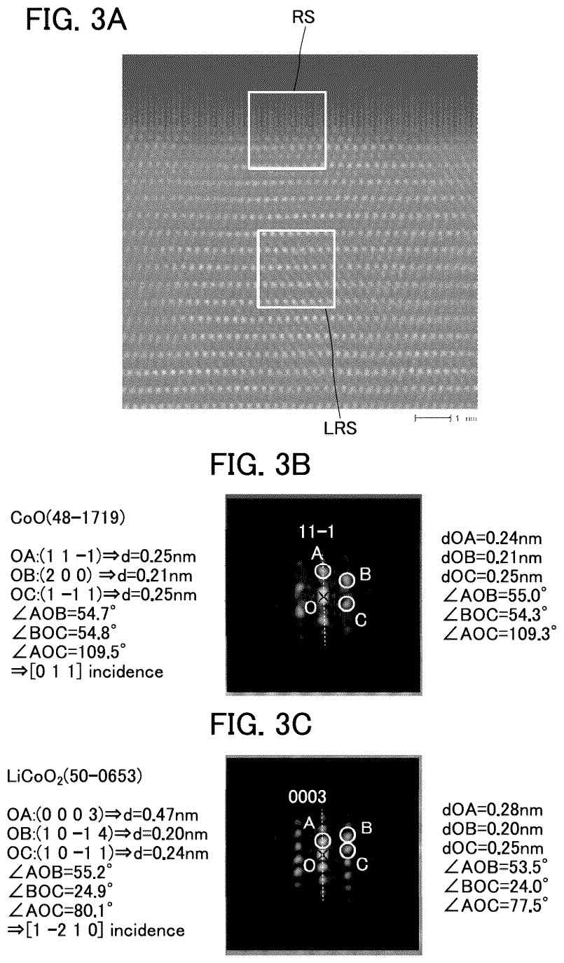

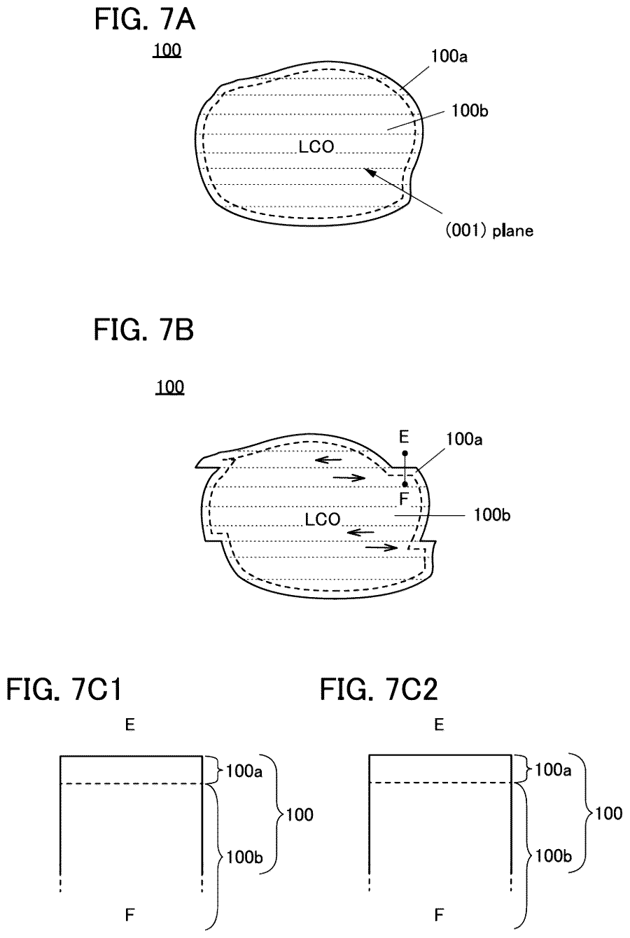

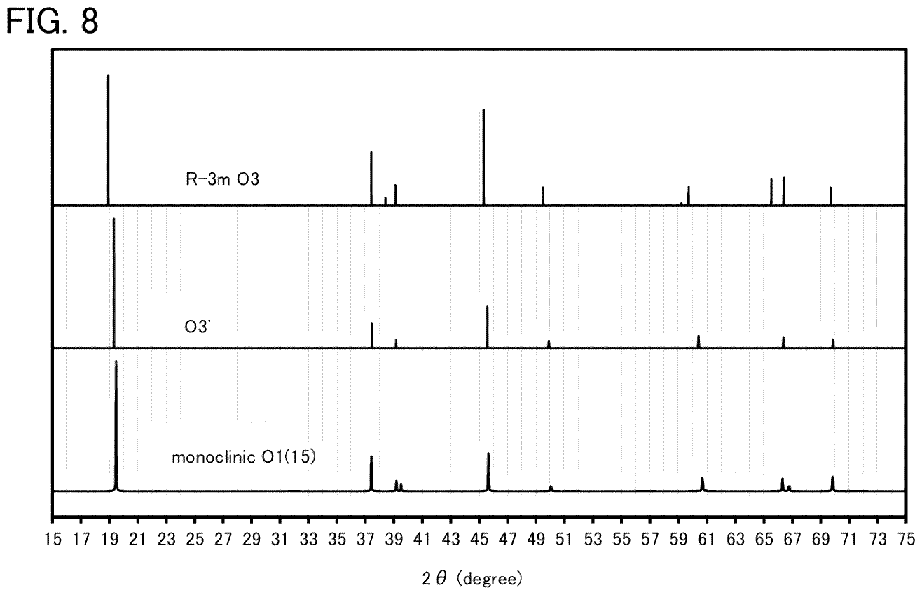

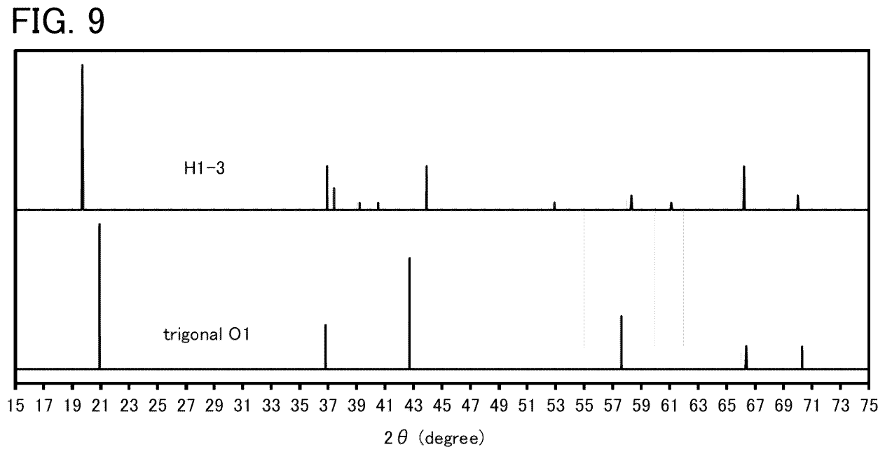

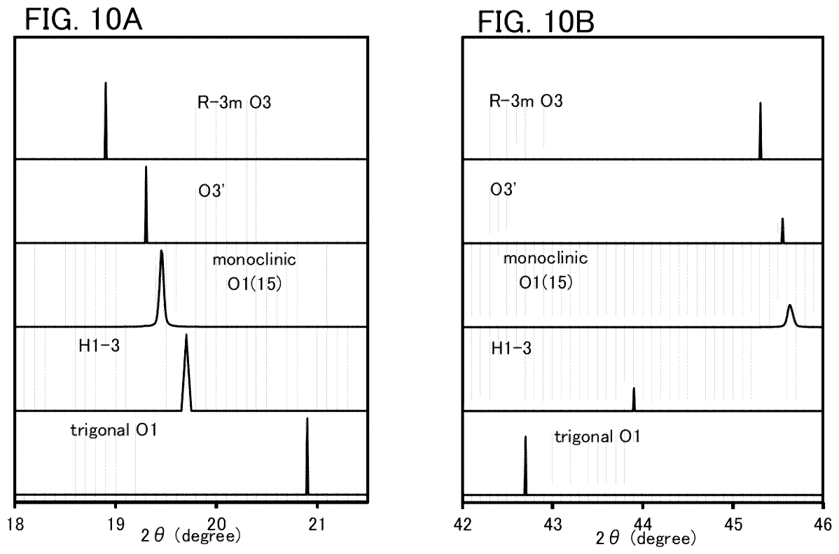

In this embodiment, a positive electrode active material 100 of one embodiment of the present invention will be described with reference to FIGS. 1A, 1B11, and 1B2, FIG. 2, FIGS. 3A to 3C, FIG. 4, FIG. 5, FIGS. 6A1, 6A2, 6B1, 6B2, 6B3, and 6C, FIGS. 7A, 7B, 7C1, and 7C2, FIG. 8, FIG. 9, FIGS. 10A and 10B, FIGS. 11A to 11C, FIGS. 12A to 12C, FIG. 13, and FIG. 14.

FIG. 1A is a cross-sectional view of the positive electrode active material 100 of one embodiment of the present invention. FIGS. 1B1 and 1B2 show enlarged views of a portion near the line A-B in FIG. 1A.

As illustrated in FIGS. 1A, 1B1, and 1B2, the positive electrode active material 100 includes a surface portion 100a and an inner portion 100b. In each drawing, the dashed line denotes a boundary between the surface portion 100a and the inner portion 100b. In FIG. 1A, the dashed-dotted line denotes part of a crystal grain boundary 101.

In this specification and the like, the surface portion 100a of the positive electrode active material 100 refers to a region that is 50 nm, preferably 35 nm, further preferably 20 nm in depth from the surface toward the inner portion, and most preferably 10 nm in depth in a perpendicular direction or a substantially perpendicular direction from the surface toward the inner portion. Note that “substantially perpendicular” refers to a state where an angle is greater than or equal to 80° and less than or equal to 100°. A plane generated by a crack can be considered as a surface. The surface portion 100a can be rephrased as the vicinity of a surface, a region in the vicinity of a surface, or a shell.

The inner portion 100b refers to a region deeper than the surface portion 100a of the positive electrode active material. The inner portion 100b can be rephrased as an inner region or a core.

A surface of the positive electrode active material 100 refers to a surface of a composite oxide including the surface portion 100a and the inner portion 100b. Thus, the positive electrode active material 100 does not contain a material to which metal oxide that does not contain a lithium site contributing to charge and discharge, such as aluminum oxide (Al₂O₃), is attached, or a carbonate, a hydroxy group, or the like which is chemically adsorbed after formation of the positive electrode active material 100. The attached metal oxide refers to, for example, metal oxide having a crystal structure different from that of the inner portion 100b.

Furthermore, an electrolyte, an organic solvent, a binder, a conductive material, and a compound originating from any of these that are attached to the positive electrode active material 100 are not contained either.

Since the positive electrode active material 100 is a compound containing oxygen and a transition metal into and from which lithium can be inserted and extracted, an interface between a region where oxygen and the transition metal M(Co, Ni, Mn, Fe, or the like) that is oxidized or reduced due to insertion and extraction of lithium exist and a region where oxygen and the transition metal Mdo not exist is considered as the surface of the positive electrode active material. A plane generated by slipping and/or a crack also can be considered as the surface of the positive electrode active material. When the positive electrode active material is analyzed, a protective film is attached on its surface in some cases; however, the protective film is not included in the positive electrode active material. As the protective film, a single-layer film or a multilayer film of carbon, a metal, an oxide, a resin, or the like is sometimes used.

Therefore, the surface of the positive electrode active material in, for example, linear analysis by energy dispersive X-ray spectroscopy with a scanning transmission electron microscope (STEM-EDX linear analysis) refers to a point where a value of the amount of the detected transition metal M is equal to 50% of the sum of the average value M_{AVE} of the amount of the detected transition metal M in the inner portion and the average value M_{BG} of the amount of the background transition metal M and a point where a value of the amount of the detected oxygen is equal to 50% of the sum of the average value O_{AVE} of the amount of detected oxygen in the inner portion and the average value O_{BG} of the amount of background oxygen. Note that in the case where the positions of the points are different between the transition metal M and oxygen, the difference is probably due to the influence of a carbonate, metal oxide containing oxygen, or the like, which is attached to the surface. Thus, the point where the value of the amount of the detected transition metal M is equal to 50% of the sum of the average value M_{AVE} of the amount of the detected transition metal M in the inner portion and the average value M_{BG} of the amount of the background transition metal M can be used. In the case of a positive electrode active material containing a plurality of transition metals M, its surface can be determined using M_{AVE} and M_{BG} of an element whose number is the largest in the inner portion 100b.

The average value M_{BG} of the amount of the background transition metal M can be calculated by averaging the amount in the range greater than or equal to 2 nm, preferably greater than or equal to 3 nm, which is outside a portion in the vicinity of the portion at which the amount of the detected transition metal M begins to increase, for example. The average value M_{AVE} of the amount of the detected transition metal M in the inner portion can be calculated by averaging the amount in the range greater than or equal to 2 nm, preferably greater than or equal to 3 nm in a region where the numbers of the transition metals Mand oxygen atoms are saturated and stabilized, e.g., a portion that is greater than or equal to 30 nm, preferably greater than 50 nm in depth from the portion where the amount the detected transition metal M begins to increase, for example. The average value O_{BG} of the amount of background oxygen and the average value O_{AVE} of the amount of detected oxygen in the inner portion can be calculated in a similar manner.

The surface of the positive electrode active material 100 in, for example, a cross-sectional STEM image is a boundary between a region where an image derived from the crystal structure of the positive electrode active material is observed and a region where the image is not observed. The surface of the positive electrode active material 100 is also determined as the outermost surface of a region where an atomic column derived from an atomic nucleus of, among metal elements which constitute the positive electrode active material, a metal element that has a larger atomic number than lithium is observed in the cross-sectional STEM image. Alternatively, the surface refers to an intersection of a tangent drawn at a luminance profile from the surface toward the bulk and an axis in the depth direction in a STEM image. The surface in a STEM image or the like may be judged employing also analysis with higher spatial resolution.

The spatial resolution of STEM-EDX is approximately 1 nm. Thus, the maximum value of an additive element profile may be shifted by approximately 1 nm. For example, even when the maximum value of the profile of an additive element such as magnesium exists outside the surface determined in the above-described manner, it can be said that a difference between the maximum value and the surface is within the margin of error when the difference is less than 1 nm.

A peak in STEM-EDX linear analysis refers to the detection intensity in each element profile or the maximum value of the characteristic X ray of each element. As a noise in STEM-EDX linear analysis, a measured value having a half width smaller than or equal to spatial resolution (R), for example, smaller than or equal to R/2 can be given.

The adverse effect of a noise can be reduced by scanning the same portion a plurality of times under the same conditions. For example, an integrated value obtained by performing scanning six times can be used as the profile of each element. The times of scanning is not limited to six and an average of measured values obtained by performing scanning seven or more times can be used as the profile of each element.

STEM-EDX linear analysis can be performed as follows. First, a protective film is deposited over a surface of a positive electrode active material. For example, carbon can be deposited with an ion sputtering apparatus (MC1000, produced by Hitachi High-Tech Corporation).

Next, the positive electrode active material is thinned to fabricate a cross-section sample to be subjected to STEM-EDX linear analysis. For example, the positive electrode active material can be thinned with an FIB-SEM apparatus (XVision 200TBS, produced by Hitachi High-Tech Corporation). Here, picking up can be performed by a micro probing system (MPS), and an accelerating voltage at final processing can be, for example, 10 kV.

The STEM-EDX linear analysis can be performed using HD-2700 produced by Hitachi High-Tech Corporation as a STEM apparatus and two Octane T Ultra W produced by EDAX Inc as EDX detectors. In the EDX linear analysis, the emission current of the STEM apparatus is set to be in the range of 6 μA to 10 μA, and a portion of the thinned sample, which is not positioned at a deep level and has little unevenness, is measured. The magnification is 150,000 times, for example. The EDX linear analysis can be performed under conditions where drift correction is performed, the line width is 42 nm, the pitch is 0.2 nm, and the number of frames is 6 or more.

The crystal grain boundary 101 refers to, for example, a portion where particles of the positive electrode active material 100 adhere to each other, or a portion where crystal orientation changes inside the positive electrode active material 100, i.e., a portion where repetition of bright lines and dark lines is discontinuous in a STEM image or the like, a portion including a large number of crystal defects, a portion with a disordered crystal structure, or the like. A crystal defect refers to a defect that can be observed in a cross-sectional image observed with a transmission electron microscope (TEM), a cross-sectional STEM image, or the like, i.e., a structure including another atom between lattices, a hollow, or the like. The crystal grain boundary 101 can be regarded as a plane defect. The vicinity of the crystal grain boundary 101 refers to a region positioned within 10 nm from the crystal grain boundary 101.

### <Contained Element>

The positive electrode active material 100 contains lithium, cobalt, oxygen, and an additive element. The positive electrode active material 100 can include lithium cobalt oxide (LiCoO₂) to which an additive element is added. Note that the positive electrode active material 100 of one embodiment of the present invention has a crystal structure described later, and thus the composition of the lithium cobalt oxide is not strictly limited to Li:Co:O=1:1:2.

In order to maintain a neutrally charged state even when lithium ions are inserted and extracted, a positive electrode active material of a lithium-ion secondary battery needs to contain a transition metal taking part in an oxidation-reduction reaction. It is preferable that the positive electrode active material 100 of one embodiment of the present invention mainly contain cobalt as a transition metal taking part in an oxidation-reduction reaction. In addition to cobalt, at least one or both of nickel and manganese may be contained. Using cobalt at greater than or equal to 75 atomic %, preferably greater than or equal to 90 atomic %, further preferably greater than or equal to 95 atomic % as the transition metal contained in the positive electrode active material 100 brings many advantages such as relatively easy synthesis, easy handling, and excellent cycle performance, which is preferable.

When cobalt is used as the transition metal contained in the positive electrode active material 100 at greater than or equal to 75 atomic %, preferably greater than or equal to 90 atomic %, further preferably greater than or equal to 95 atomic %, LiₓCoO₂ with small x is more stable than a composite oxide in which nickel accounts for the majority of the transition metal, such as lithium nickel oxide (LiNiO₂). This is probably because cobalt is less likely to be distorted due to the Jahn-Teller effect than nickel. It is known that the Jahn-Teller effect in a transition metal compound varies in degree according to the number of electrons in the d orbital of the transition metal. The influence of the Jahn-Teller effect is large in a composite oxide having a layered rock-salt structure, such as lithium nickel oxide, in which octahedral coordinated low-spin nickel(III) accounts for the majority of the transition metal, and a layer having an octahedral structure formed of nickel and oxygen is likely to be distorted. Thus, there is a concern that the crystal structure might break in charge and discharge cycles. The size of a nickel ion is larger than the size of a cobalt ion and close to that of a lithium ion. Thus, there is a problem in that cation mixing between nickel and lithium is likely to occur in a composite oxide having a layered rock-salt structure in which nickel accounts for the majority of the transition metal, such as lithium nickel oxide.

As the additive element contained in the positive electrode active material 100, one or more selected from magnesium, fluorine, nickel, aluminum, titanium, zirconium, vanadium, iron, manganese, chromium, niobium, arsenic, zinc, silicon, sulfur, phosphorus, boron, bromine, and beryllium are preferably used. The total percentage of the transition metal among the additive elements is preferably less than 25 atomic %, further preferably less than 10 atomic %, still further preferably less than 5 atomic %.

That is, the positive electrode active material 100 can contain lithium cobalt oxide to which magnesium and fluorine are added, lithium cobalt oxide to which magnesium, fluorine, and titanium are added, lithium cobalt oxide to which magnesium, fluorine, and aluminum are added, lithium cobalt oxide to which magnesium, fluorine, and nickel are added, lithium cobalt oxide to which magnesium, fluorine, nickel, and aluminum are added, or the like.

The additive element is preferably dissolved in the positive electrode active material 100. Thus, in STEM-EDX linear analysis, for example, a position where the amount of the detected additive element increases is preferably at a deeper level than a position where the amount of the detected transition metal M increases, i.e., on the inner portion side of the positive electrode active material 100.

In this specification and the like, the depth at which the amount of detected element increases in STEM-EDX linear analysis refers to the depth at which a measured value, which can be determined not to be a noise in terms of intensity, spatial resolution, and the like, is successively obtained.

Such additive elements further stabilize the crystal structure of the positive electrode active material 100 as described later. In this specification and the like, an additive element can be rephrased as part of a mixture or a raw material.

Note that as the additive element, magnesium, fluorine, nickel, aluminum, titanium, zirconium, vanadium, iron, manganese, chromium, niobium, arsenic, zinc, silicon, sulfur, phosphorus, boron, bromine, or beryllium is not necessarily contained.

When the positive electrode active material 100 is substantially free from manganese, for example, the above advantages, including relatively easy synthesis, easy handling, and excellent cycle performance, are enhanced. The weight of manganese contained in the positive electrode active material 100 is preferably less than or equal to 600 ppm, further preferably less than or equal to 100 ppm, for example.

### <Crystal Structure>

<x in LiₓCoO₂ is 1>>

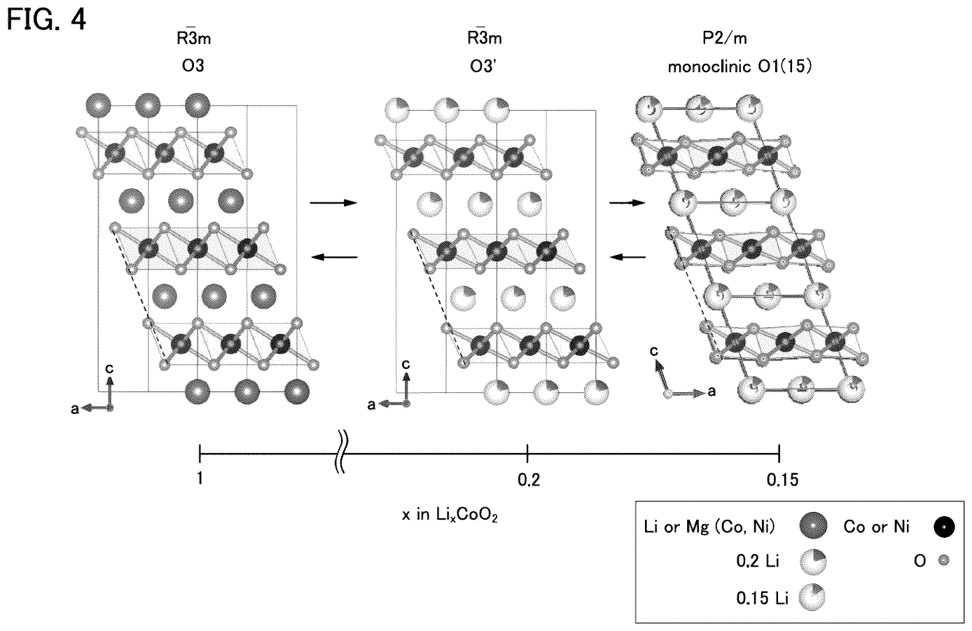

The positive electrode active material 100 of one embodiment of the present invention preferably has a layered rock-salt crystal structure belonging to the space group R-3m in a discharged state, i.e., a state where x in LiₓCoO₂ is 1. A composite oxide having a layered rock-salt structure is favorably used as a positive electrode active material of a secondary battery because it has high discharge capacity and a two-dimensional diffusion path for lithium ions and is thus suitable for an insertion/extraction reaction of lithium ions. For this reason, it is particularly preferable that the inner portion 100b, which accounts for the majority of the volume of the positive electrode active material 100, have a layered rock-salt crystal structure. In FIG. 4, the layered rock-salt crystal structure is denoted by R-3m O3.

Meanwhile, the surface portion 100a of the positive electrode active material 100 of one embodiment of the present invention preferably has a function of reinforcing the layered structure, which is formed of octahedrons of cobalt and oxygen, of the inner portion 100b so that the layered structure does not break even when lithium is extracted from the positive electrode active material 100 by charge. Alternatively, the surface portion 100a preferably functions as a barrier film of the positive electrode active material 100. Alternatively, the surface portion 100a, which is the outer portion of the positive electrode active material 100, preferably reinforces the positive electrode active material 100. Here, the term “reinforce” means inhibition of a change in the structures of the surface portion 100a and the inner portion 100b of the positive electrode active material 100 such as extraction of oxygen and/or inhibition of oxidative decomposition of an electrolyte on the surface of the positive electrode active material 100.

Accordingly, the surface portion 100a preferably has a crystal structure different from that of the inner portion 100b. The surface portion 100a preferably has a more stable composition and a more stable crystal structure than those of the inner portion 100b at room temperature (25° C.). For example, at least part of the surface portion 100a of the positive electrode active material 100 of one embodiment of the present invention preferably has a rock-salt crystal structure. Alternatively, the surface portion 100a preferably has both a layered rock-salt crystal structure and a rock-salt crystal structure. Alternatively, the surface portion 100a preferably has features of both a layered rock-salt crystal structure and a rock-salt crystal structure.

The surface portion 100a is a region from which lithium ions are extracted first in charge, and is more likely to have a low lithium concentration than the inner portion 100b. It can be said that bonds between atoms are partly cut on the surface of the particle of the positive electrode active material 100 included in the surface portion 100a. Therefore, the surface portion 100a is regarded as a region that is likely to be unstable and deterioration of its crystal structure is likely to begin. Meanwhile, if the surface portion 100a can have sufficient stability, the layered structure, which is formed of octahedrons of cobalt and oxygen, of the inner portion 100b is difficult to break even when x in LiₓCoO₂ is small, e.g., 0.24 or less. Furthermore, a shift in layers, which are formed of octahedrons of cobalt and oxygen, of the inner portion 100b can be inhibited.

To obtain a stable composition and a stable crystal structure of the surface portion 100a, the surface portion 100a preferably contains the additive element, further preferably a plurality of the additive elements. The surface portion 100a preferably has a higher concentration of one or more selected from the additive elements than the inner portion 100b. The one or more selected from the additive elements contained in the positive electrode active material 100 preferably have a concentration gradient. In addition, it is further preferable that the additive elements contained in the positive electrode active material 100 be differently distributed. For example, it is preferable that the additive elements exhibit concentration peaks at different depths from a surface. The concentration peak here refers to the local maximum value of the concentration in the surface portion 100a or the concentration in 50 nm or less in depth from the surface.

For example, some of the additive elements such as magnesium, fluorine, nickel, titanium, silicon, phosphorus, boron, and calcium preferably have a concentration gradient as shown in FIG. 1B1 by gradation, in which the concentration increases from the inner portion 100b toward the surface. An additive element which has such a concentration gradient is referred to as an additive element X.

Another additive element such as aluminum or manganese preferably has a concentration gradient as shown in FIG. 1B2 by hatching and exhibits a concentration peak in a deeper region than the additive element X. The concentration peak may be located in the surface portion 100a or located deeper than the surface portion 100a. For example, the concentration peak is preferably located in a region that is 5 nm to 30 nm in depth from the surface toward the inner portion. An additive element which has such a concentration gradient is referred to as an additive element Y.

### [Magnesium]

For example, magnesium, which is an example of the additive element X, is divalent, and a magnesium ion is more stable in lithium sites than in cobalt sites in a layered rock-salt crystal structure; thus, magnesium is likely to enter the lithium sites. An appropriate concentration of magnesium in the lithium sites of the surface portion 100a facilitates maintenance of the layered rock-salt crystal structure. This is probably because magnesium in the lithium sites serves as a column supporting the CoO₂ layers. Moreover, magnesium can inhibit extraction of oxygen therearound in a state where x in LiₓCoO₂ is, for example, 0.24 or less. Magnesium is also expected to increase the density of the positive electrode active material 100. In addition, a high magnesium concentration in the surface portion 100a probably increases the corrosion resistance to hydrofluoric acid generated by the decomposition of the electrolyte solution.

An appropriate magnesium concentration is preferable because an adverse effect on insertion and extraction of lithium in charge and discharge can be prevented and the above-described advantages can be obtained. However, excess magnesium might adversely affect insertion and extraction of lithium. Furthermore, the effect of stabilizing the crystal structure might be reduced. This is probably because magnesium enters the cobalt sites in addition to the lithium sites. Moreover, an undesired magnesium compound (e.g., an oxide or a fluoride) which does not enter the lithium site or the cobalt site might be unevenly distributed at the surface of the positive electrode active material or the like to serve as a resistance component of a secondary battery. As the magnesium concentration in the positive electrode active material increases, the discharge capacity of the positive electrode active material decreases in some cases. This is probably because excess magnesium enters the lithium sites and the amount of lithium contributing to charge and discharge decreases.

Thus, the entire positive electrode active material 100 preferably contains an appropriate amount of magnesium. The number of magnesium atoms is preferably 0.002 to 0.06 times, preferably larger than or equal to 0.005 times and less than or equal to 0.03 times, still further preferably approximately 0.01 times the number of cobalt atoms, for example. The amount of magnesium contained in the entire positive electrode active material 100 may be, for example, a value obtained by element analysis on the entire positive electrode active material 100 with glow discharge mass spectrometry (GD-MS), inductively coupled plasma mass spectrometry (ICP-MS), or the like or may be based on the proportion of a raw material in the formation process of the positive electrode active material 100.

### [Nickel]

Nickel, which is an example of the additive elements X, can exist in both the cobalt site and the lithium site. Nickel preferably exists in the cobalt site because a lower oxidation-reduction potential can be obtained as compared with the case where only cobalt exists in the cobalt site, leading to an increase in discharge capacity.

In addition, when nickel exists in the lithium site, a shift in the layers, which are formed of octahedrons of cobalt and oxygen, can be inhibited. Moreover, a change in the volume in charge and discharge is inhibited. Furthermore, an elastic modulus becomes large, i.e., hardness increases. This is probably because nickel in the lithium sites also serves as a column supporting the CoO₂ layers. Therefore, in particular, the crystal structure is expected to be more stable in a charged state at high temperatures, e.g., 45° C. or higher, which is preferable.

The distance between a cation and an anion of nickel oxide (NiO) is closer to the average of the distance between a cation and an anion of LiCoO₂ than those of MgO and CoO, and the orientations of NiO and LiCoO₂ are likely to be aligned with each other.

Ionization tendency is the lowest in nickel and higher in the order of cobalt, aluminum, and magnesium. Therefore, it is considered that in charge, nickel is less likely to be diffused into an electrolyte solution than the other elements described above. Accordingly, nickel is considered to have a high effect of stabilizing the crystal structure of the surface portion in a charged state.

Furthermore, in nickel, Ni²⁺ is more stable than Ni³⁺ and Ni⁴⁺, and nickel has a higher trivalent ionization energy than cobalt. Thus, it is known that a spinel crystal structure does not appear only with nickel and oxygen. Therefore, nickel is considered to have an effect of suppressing a change from a layered rock-salt crystal structure to a spinel crystal structure.

Meanwhile, excess nickel increases the influence of distortion due to the Jahn-Teller effect, which is not preferable. Moreover, excess nickel might adversely affect insertion and extraction of lithium.

Thus, the entire positive electrode active material 100 preferably contains an appropriate amount of nickel. For example, the number of nickel atoms in the positive electrode active material 100 of one embodiment of the present invention is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, the number of nickel atoms in the positive electrode active material 100 of one embodiment of the present invention is preferably greater than 0% and less than or equal to 4%, greater than 0% and less than or equal to 2%, greater than or equal to 0.05% and less than or equal to 7.5%, greater than or equal to 0.05% and less than or equal to 2%, greater than or equal to 0.1% and less than or equal to 7.5%, or greater than or equal to 0.1% and less than or equal to 4% of the number of cobalt atoms. The amount of nickel described here may be a value obtained by element analysis on the entire positive electrode active material with GD-MS, ICP-MS, or the like or may be based on the proportion of a raw material in the formation process of the positive electrode active material.

### [Aluminum]

Aluminum, which is an example of the additive element Y, can exist in a cobalt site in a layered rock-salt crystal structure. Since aluminum is a trivalent representative element and its valence does not change, lithium around aluminum is less likely to transfer even in charge and discharge. Thus, aluminum and lithium around aluminum serve as columns to inhibit a change in the crystal structure. Furthermore, aluminum has an effect of inhibiting elusion of cobalt around aluminum and improving continuous charge tolerance. Moreover, an Al—O bond is stronger than a Co—O bond and thus extraction of oxygen around aluminum can be inhibited. These effects improve thermal stability. Therefore, a secondary battery including the positive electrode active material 100 containing aluminum as the additive element can have high stability. In addition, the positive electrode active material 100 having a crystal structure that is unlikely to be broken by repeated charge and discharge can be provided.

Moreover, excess aluminum might adversely affect insertion and extraction of lithium.

Thus, the entire positive electrode active material 100 preferably contains an appropriate amount of aluminum. The number of aluminum atoms in the entire positive electrode active material 100 is, for example, preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, the number of aluminum atoms is preferably greater than or equal to 0.05% and less than or equal to 2% or greater than or equal to 0.1% and less than or equal to 4%. Here, the amount of aluminum contained in the entire positive electrode active material 100 may be a value obtained by element analysis on the entire positive electrode active material 100 with GD-MS, ICP-MS, or the like or may be based on the proportion of a raw material in the formation process of the positive electrode active material 100.

### [Fluorine]

When fluorine, which is an example of the additive element X, is substituted for part of oxygen in the surface portion 100a, the lithium extraction energy is lowered. This is because the oxidation-reduction potential of cobalt ions associated with lithium extraction differs depending on whether fluorine exists. That is, when fluorine is not included, cobalt ions change from a trivalent state to a tetravalent state owing to lithium extraction. Meanwhile, when fluorine is included, cobalt ions change from a divalent state to a trivalent state owing to lithium extraction. The oxidation-reduction potential of cobalt ions differs in these cases. It can thus be said that when fluorine is substituted for part of oxygen in the surface portion 100a of the positive electrode active material 100, lithium ions near fluorine are likely to be extracted and inserted smoothly. Thus, a secondary battery including such a positive electrode active material 100 can have improved charge and discharge characteristics, improved large current characteristics, or the like. When fluorine exists in the surface portion 100a, which has a surface in contact with the electrolyte solution, the corrosion resistance to hydrofluoric acid can be effectively increased. As will be described in detail in the following embodiment, a fluoride such as lithium fluoride that has a lower melting point than another additive element source can serve as a fusing agent (also referred to as a flux) for lowering the melting point of another additive element source.

An oxide of titanium, which is an example of the additive element X, is known to have superhydrophilicity. Accordingly, the positive electrode active material 100 including an oxide of titanium at the surface portion 100a presumably has good wettability with respect to a high-polarity solvent. Such a positive electrode active material 100 and a high-polarity electrolyte solution can have favorable contact at the interface therebetween and presumably inhibit an internal resistance increase when a secondary battery is formed using such a positive electrode active material 100.

When the surface portion 100a includes phosphorus, which is an example of the additive element X, a short circuit can be inhibited while a state with small x in LiₓCoO₂ is maintained, in some cases, which is preferable. For example, a compound containing phosphorus and oxygen preferably exists in the surface portion 100a.

When the positive electrode active material 100 contains phosphorus, phosphorus may react with hydrogen fluoride generated by the decomposition of the electrolyte solution or the electrolyte, which might decrease the hydrogen fluoride concentration in the electrolyte and is preferable.

In the case where the electrolyte contains LiPF₆, hydrogen fluoride might be generated by hydrolysis. In addition, hydrogen fluoride might be generated by the reaction of polyvinylidene fluoride (PVDF) used as a component of the positive electrode and alkali. The decrease in hydrogen fluoride concentration in the electrolyte may inhibit corrosion of a current collector and/or separation of a coating portion 104 or may inhibit a reduction in adhesion properties due to gelling and/or insolubilization of PVDF.

When containing phosphorus in addition to magnesium, the positive electrode active material 100 is extremely stable in a state with small x in LiₓCoO₂. When phosphorus is contained in the positive electrode active material 100, the number of phosphorus atoms is preferably greater than or equal to 1% and less than or equal to 20%, further preferably greater than or equal to 2% and less than or equal to 10%, still further preferably greater than or equal to 3% and less than or equal to 8% of the number of cobalt atoms. Alternatively, the number of phosphorus atoms is preferably greater than or equal to 1% and less than or equal to 10%, greater than or equal to 1% and less than or equal to 8%, greater than or equal to 2% and less than or equal to 20%, greater than or equal to 2% and less than or equal to 8%, greater than or equal to 3% and less than or equal to 20%, or greater than or equal to 3% and less than or equal to 10% of the number of cobalt atoms. In addition, the number of magnesium atoms is preferably greater than or equal to 0.1% and less than or equal to 10%, further preferably greater than or equal to 0.5% and less than or equal to 5%, still further preferably greater than or equal to 0.7% and less than or equal to 4% of the number of cobalt atoms. Alternatively, the number of magnesium atoms is preferably greater than or equal to 0.1% and less than or equal to 5%, greater than or equal to 0.1% and less than or equal to 4%, greater than or equal to 0.5% and less than or equal to 10%, greater than or equal to 0.5% and less than or equal to 4%, greater than or equal to 0.7% and less than or equal to 10%, or greater than or equal to 0.7% and less than or equal to 5% of the number of cobalt atoms. The phosphorus concentration and the magnesium concentration described here may each be a value obtained by element analysis on the entire positive electrode active material 100 using GC-MS, ICP-MS, or the like, or may be a value based on the ratio of the raw materials mixed in the process of forming the positive electrode active material 100, for example.

In the case where the positive electrode active material 100 has a crack, crack development is sometimes inhibited by phosphorus, more specifically, a compound containing phosphorus and oxygen or the like that exists in the inner portion of the positive electrode active material having the crack on its surface, e.g., the filling portion 102.

### [Synergistic Effect Between a Plurality of Elements]

When the surface portion 100a contains both magnesium and nickel, divalent nickel might be able to exist more stably in the vicinity of divalent magnesium. Thus, even when x in LiₓCoO₂ is small, elution of magnesium might be inhibited, which might contribute to stabilization of the surface portion 100a.

For a similar reason, when the additive element is added to lithium cobalt oxide in the formation process, magnesium is preferably added in a step before a step where nickel is added. Alternatively, magnesium and nickel are preferably added in the same step. The reason is as follows: magnesium has a large ion radius and thus is likely to remain at the surface portion of lithium cobalt oxide regardless of in which step magnesium is added, but nickel may be widely diffused to the inner portion of lithium cobalt oxide when magnesium does not exist. Thus, when nickel is added before magnesium is added, nickel might be diffused to the inner portion of lithium cobalt oxide and a preferable amount of nickel might not remain at the surface portion.

Additive elements that are differently distributed, such as the additive element X and the additive element Y, are preferably contained at a time, in which case the crystal structure of a wider region can be stabilized. For example, the crystal structure of a wider region can be stabilized in the case where the positive electrode active material 100 contains all of magnesium and nickel, which are examples of the additive element X, and aluminum, which is an example of the additive element Y, as compared with the case where only the additive element X or the additive element Y is contained. In the case where the positive electrode active material 100 contains both the additive element X and the additive element Y as described above, the surface can be sufficiently stabilized by the additive element X such as magnesium and nickel; thus, the additive element Y such as aluminum is not necessary for the surface. It is preferable that aluminum be widely distributed in a region deeper than the surface. For example, it is preferable that aluminum be continuously detected in a region that is 1 nm to 25 nm in depth from the surface. It is preferable that aluminum be widely distributed in a region that is 0 nm to 100 nm, preferably 0.5 nm to 50 nm in depth from the surface, in which case the crystal structure of a wider region can be stabilized.

When a plurality of the additive elements are contained as described above, the effects of the additive elements contribute synergistically to further stabilization of the surface portion 100a. In particular, magnesium, nickel, and aluminum are preferably contained because a high effect of stabilizing the composition and the crystal structure can be obtained.

Note that it is not preferable that the surface portion 100a be occupied by only a compound of an additive element and oxygen because it becomes difficult to insert and extract lithium. For example, it is not preferable that the surface portion 100a be occupied by only MgO, a structure in which MgO and NiO(II) form a solid solution, and/or a structure in which MgO and CoO(II) form a solid solution. Thus, the surface portion 100a should contain at least cobalt, and also contain lithium in a discharged state to have the path through which lithium is inserted and extracted.

To ensure the sufficient path through which lithium is inserted and extracted, the concentration of cobalt is preferably higher than that of magnesium in the surface portion 100a. For example, the atomic ratio of magnesium to cobalt (Mg/Co) is preferably less than or equal to 0.62. In addition, the concentration of cobalt is preferably higher than those of nickel, aluminum, and fluorine in the surface portion 100a.

Moreover, excess nickel might hinder diffusion of lithium; thus, the concentration of magnesium is preferably higher than that of nickel in the surface portion 100a. For example, the number of nickel atoms is preferably one sixth or less that of magnesium atoms.

It is preferable that some additive elements, in particular, magnesium, nickel, and aluminum have higher concentrations in the surface portion 100a than in the inner portion 100b and exist randomly also in the inner portion 100b to have low concentrations. When magnesium and aluminum exist in the lithium sites of the inner portion 100b at appropriate concentrations, an effect of facilitating maintenance of the layered rock-salt crystal structure can be obtained in a manner similar to the above. When nickel exists in the lithium sites of the inner portion 100b at an appropriate concentration, a shift in the layered structure formed of octahedrons of cobalt and oxygen can be inhibited in a manner similar to the above. Also in the case where both magnesium and nickel are contained, a synergistic effect of inhibiting elusion of magnesium can be expected in a manner similar to the above.

It is preferable that the crystal structure continuously change from the inner portion 100b toward the surface owing to the above-described concentration gradient of the additive element. Alternatively, it is preferable that the surface portion 100a and the inner portion 100b have substantially the same crystal orientation.

For example, a crystal structure is preferably changed continuously from the layered rock-salt inner portion 100b toward the surface and the surface portion 100a that have a rock-salt structure or have features of both a rock-salt structure and a layered rock-salt structure. Alternatively, the orientations of the surface portion 100a that has a rock-salt structure or has the features of both a rock-salt structure and a layered rock-salt structure and the layered rock-salt inner portion 100b are preferably substantially aligned with each other.

Note that in this specification and the like, a layered rock-salt crystal structure that belongs to the space group R-3m of a composite oxide containing lithium and a transition metal such as cobalt refers to a crystal structure in which a rock-salt ion arrangement where cations and anions are alternately arranged is included and lithium and the transition metal are regularly arranged to form a two-dimensional plane, so that lithium can diffuse two-dimensionally. Note that a defect such as a cation or anion vacancy may exist. In the layered rock-salt crystal structure, strictly, a lattice of a rock-salt crystal is distorted in some cases.

A rock-salt crystal structure refers to a structure in which a cubic crystal structure with the space group Fm-3m or the like is included and cations and anions are alternately arranged. Note that a cation or anion vacancy may exist.

Having features of both a layered rock-salt crystal structure and a rock-salt crystal structure can be judged by electron diffraction, a TEM image, a cross-sectional STEM image, and the like.

There is no distinction among cation sites in a rock-salt structure. Meanwhile, a layered rock-salt crystal structure has two types of cation sites: one type is mostly occupied by lithium, and the other is occupied by the transition metal. A stacked-layer structure where two-dimensional planes of cations and two-dimensional planes of anions are alternately arranged is the same in a rock-salt structure and a layered rock-salt structure. Given that the center spot (transmission spot) among bright spots in an electron diffraction pattern corresponding to crystal planes that form the two-dimensional planes is at the origin point 000, the bright spot nearest to the center spot is on the (111) plane in an ideal rock-salt structure, for instance, and on the (003) plane in a layered rock-salt structure, for instance. For example, when electron diffraction patterns of rock-salt MgO and layered rock-salt LiCoO₂ are compared to each other, the distance between the bright spots on the (003) plane of LiCoO₂ is observed at a distance approximately half the distance between the bright spots on the (111) plane of MgO. Thus, when two phases of rock-salt MgO and layered rock-salt LiCoO₂ are included in a region to be analyzed, a plane orientation in which bright spots with high luminance and bright spots with low luminance are alternately arranged exists in an electron diffraction pattern. A bright spot common between the rock-salt and layered rock-salt structures has high luminance, whereas a bright spot caused only in the layered rock-salt structure has low luminance.

When a layered rock-salt crystal structure is observed from a direction perpendicular to the c-axis in a cross-sectional STEM image and the like, layers observed with high luminance and layers observed with low luminance are alternately observed. Such a feature is not observed in a rock-salt structure because there is no distinction among cation sites. When a crystal structure having the features of both a rock-salt structure and a layered rock-salt structure is observed from a given crystal orientation, layers observed with high luminance and layers observed with low luminance are alternately observed in a cross-sectional STEM image and the like, and a metal that has a lager atomic number than lithium exists in part of the layers with low luminance, i.e., the lithium layers.

Anions of a layered rock-salt crystal and anions of a rock-salt crystal form a cubic close-packed structure (face-centered cubic lattice structure). Anions of an O3′ crystal and a monoclinic O1(15) crystal, which are described later, are presumed to form a cubic close-packed structure. Thus, when a layered rock-salt crystal and a rock-salt crystal are in contact with each other, there is a crystal plane at which orientations of cubic close-packed structures formed of anions are aligned with each other.

The description can also be made as follows. An anion on the {111}plane of a cubic crystal structure has a triangle lattice. A layered rock-salt structure, which belongs to the space group R-3m and is a rhombohedral structure, is generally represented by a composite hexagonal lattice for easy understanding of the structure, and the (0001) plane of the layered rock-salt structure has a hexagonal lattice. The triangle lattice on the {111}plane of the cubic crystal has atomic arrangement similar to that of the hexagonal lattice on the (0001) plane of the layered rock-salt structure. These lattices being consistent with each other can be expressed as “orientations of the cubic close-packed structures are aligned with each other”.

Note that a space group of the layered rock-salt crystal and the O3′ crystal is R-3m, which is different from the space group Fm-3m of a rock-salt crystal (the space group of a general rock-salt crystal); thus, the Miller index of the crystal plane satisfying the above conditions in the layered rock-salt crystal and the O3′ crystal is different from that in the rock-salt crystal. In this specification, in the layered rock-salt crystal, the O3′ crystal, and the rock-salt crystal, a state where the orientations of the cubic close-packed structures formed of anions are aligned with each other may be referred to as a state where crystal orientations are substantially aligned with each other. In addition, a state where three-dimensional structures have similarity, e.g., crystal orientations are substantially aligned with each other, or orientations are crystallographically the same is referred to as “topotaxy”.

The orientations of crystals in two regions being substantially aligned with each other can be judged, for example, from a TEM image, a STEM image, a high-angle annular dark field scanning TEM (HAADF-STEM) image, an annular bright-field scanning transmission electron microscope (ABF-STEM) image, an electron diffraction pattern, and an FFT pattern of a TEM image and a STEM image or the like. X-ray diffraction (XRD), electron diffraction, neutron diffraction, and the like can also be used for judging.

FIG. 2 shows an example of a TEM image in which orientations of a layered rock-salt crystal LRS and a rock-salt crystal RS are substantially aligned with each other. In a TEM image, a STEM image, a HAADF-STEM image, an ABF-STEM image, and the like, an image showing a crystal structure is obtained.

For example, in a high-resolution TEM image, a contrast derived from a crystal plane is obtained. When an electron beam is incident perpendicularly to the c-axis of a composite hexagonal lattice of a layered rock-salt structure, for example, a contrast derived from the (0003) plane is obtained as repetition of bright bands (bright strips) and dark bands (dark strips) because of diffraction and interference of the electron beam. Thus, when repetition of bright lines and dark lines is observed and the angle between the bright lines (e.g., L_{RS} and L_{LRS} in FIG. 2) is 5° or less or 2.5° or less in the TEM image, it can be judged that the crystal planes are substantially aligned with each other, that is, orientations of the crystals are substantially aligned with each other. Similarly, when the angle between the dark lines is 5° or less or 2.5° or less, it can be judged that orientations of the crystals are substantially aligned with each other.

In a HAADF-STEM image, a contrast corresponding to the atomic number is obtained, and an element having a larger atomic number is observed to be brighter. For example, in the case of lithium cobalt oxide that has a layered rock-salt structure belonging to the space group R-3m, cobalt (atomic number: 27) has the largest atomic number; hence, an electron beam is strongly scattered at the position of a cobalt atom, and arrangement of the cobalt atoms is observed as bright lines or arrangement of high-luminance dots. Thus, when the lithium cobalt oxide having a layered rock-salt crystal structure is observed perpendicularly to the c-axis, arrangement of the cobalt atoms is observed as bright lines or arrangement of high-luminance dots, and arrangement of lithium atoms and oxygen atoms is observed as dark lines or a low-luminance region in the direction perpendicular to the c-axis. The same applies to the case where fluorine (atomic number: 9) and magnesium (atomic number: 12) are included as the additive elements of the lithium cobalt oxide.

Consequently, in the case where repetition of bright lines and dark lines is observed in two regions having different crystal structures and the angle between the bright lines is 5° or less or 2.5° or less in a HAADF-STEM image, it can be judged that arrangements of the atoms are substantially aligned with each other, that is, orientations of the crystals are substantially aligned with each other. Similarly, when the angle between the dark lines is 5° or less or 2.5° or less, it can be judged that orientations of the crystals are substantially aligned with each other.

With an ABF-STEM, an element having a smaller atomic number is observed to be brighter, but a contrast corresponding to the atomic number is obtained as with a HAADF-STEM; hence, in an ABF-STEM image, crystal orientations can be judged as in a HAADF-STEM image.

FIG. 3A shows an example of a STEM image in which orientations of the layered rock-salt crystal LRS and the rock-salt crystal RS are substantially aligned with each other. FIG. 3B shows an FFT pattern of a region of the rock-salt crystal RS, and FIG. 3C shows an FFT pattern of a region of the layered rock-salt crystal LRS. In FIG. 3B and FIG. 3C, the composition, the JCPDS card number, and dvalues and angles to be calculated are shown on the left. The measured values are shown on the right. A spot denoted by O is zero-order diffraction.

A spot denoted by A in FIG. 3B is derived from 11-1 reflection of a cubic structure. A spot denoted by A in FIG. 3C is derived from 0003 reflection of a layered rock-salt structure. It is found from FIG. 3B and FIG. 3C that the direction of the 11-1 reflection of the cubic structure and the direction of the 0003 reflection of the layered rock-salt structure are substantially aligned with each other. That is, a straight line that passes through AO in FIG. 3B is substantially parallel to a straight line that passes through AO in FIG. 3C. Here, the terms “substantially aligned” and “substantially parallel” mean that the angle between the two is 5° or less or 2.5° or less.

When the orientations of the layered rock-salt crystal and the rock-salt crystal are substantially aligned with each other in the above manner in an FFT pattern and an electron diffraction pattern, the <0003> orientation of the layered rock-salt crystal and the <11-1> orientation of the rock-salt crystal may be substantially aligned with each other. In that case, it is preferred that these reciprocal lattice points be spot-shaped, that is, they be not connected to other reciprocal lattice points. The state where reciprocal lattice points are spot-shaped and not connected to other reciprocal lattice points means high crystallinity.

When the direction of the 11-1 reflection of the cubic structure and the direction of the 0003 reflection of the layered rock-salt structure are substantially aligned with each other as described above, a spot that is not derived from the 0003 reflection of the layered rock-salt structure may be observed, depending on the incident direction of the electron beam, on a reciprocal lattice space different from the direction of the 0003 reflection of the layered rock-salt structure. For example, a spot denoted by B in FIG. 3C is derived from 1014 reflection of the layered rock-salt structure. This is sometimes observed at a position where the difference in orientation from the reciprocal lattice point derived from the 0003 reflection of the layered rock-salt structure (A in FIG. 3C) is greater than or equal to 520 and less than or equal to 56° (i.e., ∠AOB is 52° to 56°) and dis greater than or equal to 0.19 nm and less than or equal to 0.21 nm. Note that these indices are just an example, and the spot does not necessarily correspond with them and may be, for example, a reciprocal lattice point equivalent to 0003 and 1014.

Similarly, a spot that is not derived from the 11-1 reflection of the cubic structure may be observed on a reciprocal lattice space different from the direction where the 11-1 reflection of the cubic structure is observed. For example, a spot denoted by B in FIG. 3B is derived from 200 reflection of the cubic structure. A diffraction spot is sometimes observed at a position where the difference in orientation from the reciprocal lattice point derived from the 11-1 reflection of the cubic structure (A in FIG. 3B) is greater than or equal to 540 and less than or equal to 560 (i.e., ∠AOB is 54° to 56°). Note that these indices are just an example, and the spot does not necessarily correspond with them and may be, for example, a reciprocal lattice point equivalent to 11-1 and 200.

It is known that in a layered rock-salt positive electrode active material, such as lithium cobalt oxide, the (0003) plane and a plane equivalent thereto and the (10-14) plane and a plane equivalent thereto are likely to be crystal planes. Thus, a sample to be observed can be processed to be thin using a focused ion beam (FIB) or the like such that an electron beam of a TEM, for example, enters in [12-10], in order to easily observe the (0003) plane in careful observation of the shape of the positive electrode active material with a SEM or the like. To judge alignment of crystal orientations, a sample is preferably processed to be thin so that the (0003) plane of the layered rock-salt structure is easily observed.

<x in LiₓCoO₂ is Small>>

The crystal structure in a state where x in LiₓCoO₂ is small of the positive electrode active material 100 of one embodiment of the present invention is different from that of a conventional positive electrode active material because the positive electrode active material 100 has the above-described additive element distribution and/or crystal structure in a discharged state. Here, “x is small” means 0.1<x≤0.24.

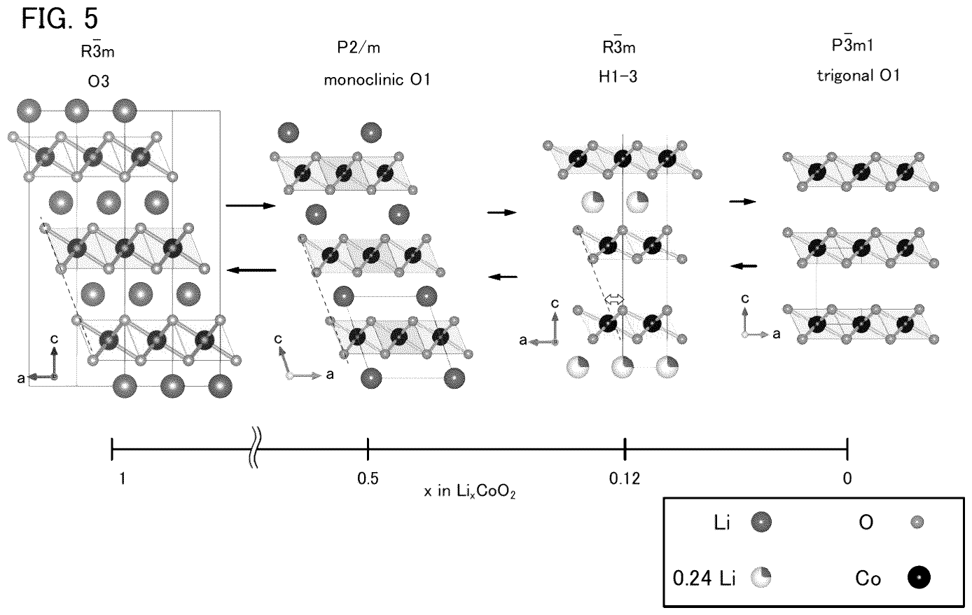

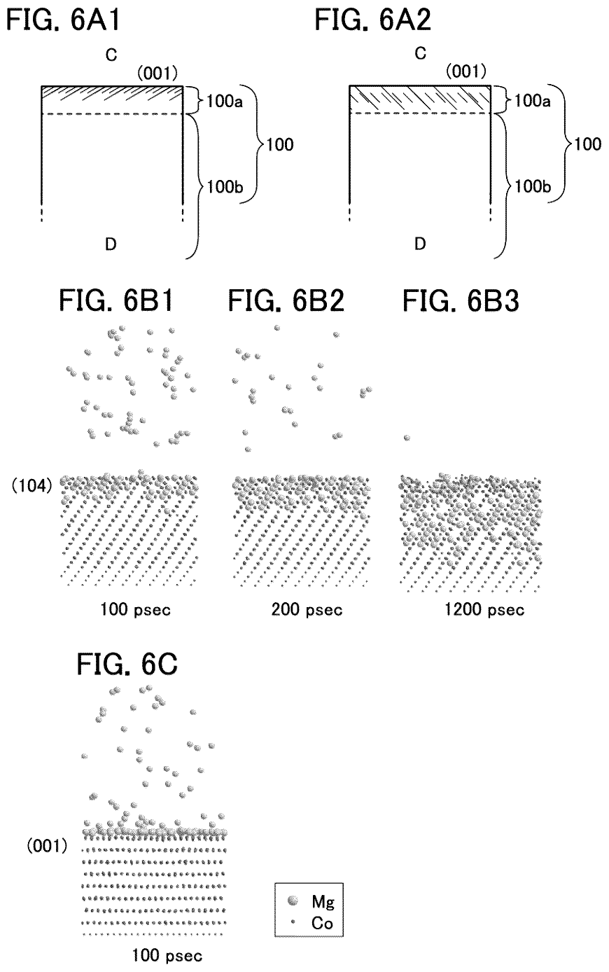

A conventional positive electrode active material and the positive electrode active material 100 of one embodiment of the present invention are compared, and changes in the crystal structures owing to a change in x in LiₓCoO₂ will be described with reference to FIG. 4, FIG. 5, FIGS. 6A1, 6A2, 6B1, 6B2, 6B3, and 6C, FIGS. 7A, 7B, 7C1, and 7C2, and FIG. 8.

A change in the crystal structure of the conventional positive electrode active material is shown in FIG. 5. The conventional positive electrode active material shown in FIG. 5 is lithium cobalt oxide (LiCoO₂) containing no additive element. A change in the crystal structure of lithium cobalt oxide containing no additive element is described in Non-Patent Documents 1 to 3 and the like.

In FIG. 5, the crystal structure of lithium cobalt oxide with x in LiₓCoO₂ of 1 is denoted by R-3m O3. In this crystal structure, lithium occupies octahedral sites and a unit cell includes three COO₂ layers. Thus, this crystal structure is referred to as an O3 type structure in some cases. Note that the COO₂ layer has a structure in which an octahedral structure with cobalt coordinated to six oxygen atoms continues on a plane in an edge-shared state. Such a layer is sometimes referred to as a layer formed of octahedrons of cobalt and oxygen.

Conventional lithium cobalt oxide with x of approximately 0.5 is known to have an improved symmetry of lithium and have a monoclinic crystal structure belonging to the space group P2/m. This structure includes one COO₂ layer in a unit cell. Thus, this crystal structure is referred to as an O1 type structure or a monoclinic O1 type structure in some cases.

A positive electrode active material with x of 0 has the trigonal crystal structure belonging to the space group P-3m1 and includes one COO₂ layer in a unit cell. Hence, this crystal structure is referred to as an O1 type structure or a trigonal O1 type structure in some cases. Moreover, in some cases, this crystal structure is referred to as a hexagonal O1 type structure when a trigonal crystal system is converted into a composite hexagonal lattice.

Conventional lithium cobalt oxide with x of approximately 0.12 has the crystal structure belonging to the space group R-3m. This structure can also be regarded as a structure in which CoO₂ structures such as a trigonal O1 type structure and LiCoO₂ structures such as a structure belonging to R-3m O3 are alternately stacked. Thus, this crystal structure is referred to as an H1-3 type structure in some cases. Note that since insertion and extraction of lithium do not necessarily uniformly occur in the positive electrode active material in reality, the lithium concentrations can vary in the positive electrode active material. Thus, the H1-3 type structure is started to be observed when x is approximately 0.25 in practice. The number of cobalt atoms per unit cell in the actual H1-3 type structure is twice that in other structures. However, in this specification including FIG. 5, the c-axis of the H1-3 type structure is half that of the unit cell for easy comparison with the other crystal structures.

For the H1-3 type structure, as disclosed in Non-Patent Document 3, the coordinates of cobalt and oxygen in the unit cell can be expressed as follows, for example: Co (0, 0, 0.42150±0.00016), O₁ (0, 0, 0.27671±0.00045), and O₂ (0, 0, 0.11535±0.00045). Note that O₁ and O₂ are each an oxygen atom. A preferred unit cell for representing a crystal structure in a positive electrode active material can be selected by Rietveld analysis of XRD patterns, for example. In this case, a unit cell is selected such that the value of goodness of fit (GOF) is small.

When charge and discharge are repeated so that x in LiₓCoO₂ becomes 0.24 or less, the crystal structure of conventional lithium cobalt oxide repeatedly changes between the H1-3 type structure and the R-3m O3 structure in a discharged state (i.e., an unbalanced phase change).

However, there is a large shift in the CoO₂ layers between these two crystal structures. As denoted by the dotted lines and the arrow in FIG. 5, the CoO₂ layer in the H1-3 type structure largely shifts from that in the structure belonging to R-3m O3 in a discharged state. Such a dynamic structural change can adversely affect the stability of the crystal structure.

A difference in volume between the two crystal structures is also large. When the H1-3 type structure and the R-3m O3 type structure in a discharged state contain the same number of cobalt atoms, these structures have a difference in volume of greater than 3.5%, typically greater than or equal to 3.9%.

In addition, a structure in which CoO₂ layers are arranged continuously, such as the structure belonging to trigonal O1, included in the H1-3 type structure is highly likely to be unstable.

Accordingly, the repeated charge and discharge that make x be 0.24 or less gradually break the crystal structure of conventional lithium cobalt oxide. The broken crystal structure triggers deterioration of the cycle performance. This is because the broken crystal structure has a smaller number of sites where lithium can exist stably and makes it difficult to insert and extract lithium.

Meanwhile, in the positive electrode active material 100 of one embodiment of the present invention shown in FIG. 4, a change in the crystal structure between a discharged state with x in LiₓCoO₂ of 1 and a state with x of 0.24 or less is smaller than that in a conventional positive electrode active material. Specifically, a shift in the CoO₂ layers between the state with x of 1 and the state with x of 0.24 or less can be small. Furthermore, a change in the volume can be small in the case where the positive electrode active materials have the same number of cobalt atoms. Thus, the positive electrode active material 100 of one embodiment of the present invention can have a crystal structure that is difficult to break even when charge and discharge are repeated so that x becomes 0.24 or less, and obtain excellent cycle performance. In addition, the positive electrode active material 100 of one embodiment of the present invention with x in LiₓCoO₂ of 0.24 or less can have a more stable crystal structure than a conventional positive electrode active material. Thus, in the positive electrode active material 100 of one embodiment of the present invention, a short circuit is less likely to occur in a state where x in LiₓCoO₂ is kept at 0.24 or less. This is preferable because the safety of a secondary battery is further improved.

FIG. 4 shows crystal structures of the inner portion 100b of the positive electrode active material 100 in a state where x in LiₓCoO₂ is 1, approximately 0.2, and approximately 0.15. The inner portion 100b, accounting for the majority of the volume of the positive electrode active material 100, largely contributes to charge and discharge and is accordingly a portion where a shift in CoO₂ layers and a volume change matter most.

The positive electrode active material 100 with x of 1 has the R-3m O3 type structure, which is the same as that of conventional lithium cobalt oxide.

However, the positive electrode active material 100 has a crystal structure different from the H1-3 type structure in a state where x is 0.24 or less, e.g., approximately 0.2 or approximately 0.15, with which conventional lithium cobalt oxide has the H1-3 type structure.

The positive electrode active material 100 of one embodiment of the present invention with x of approximately 0.2 has a trigonal crystal structure belonging to the space group R-3m. The symmetry of the CoO₂ layers of this structure is the same as that of the O3 type structure. Thus, this crystal structure is called an O3′ type structure. In FIG. 4, this crystal structure is denoted by R-3m O3′.

Note that in the unit cell of the O3′ type structure, the coordinates of cobalt and oxygen can be represented by Co (0, 0, 0.5) and O (0, 0, x) within the range of 0.20≤x≤0.25. In the unit cell, the lattice constant of the a-axis is preferably 2.797≤a≤2.837 (Å), further preferably 2.807≤a≤2.827 (Å), typically a=2.817 (Å). The lattice constant of the c-axis is preferably 13.681≤c≤13.881 (Å), further preferably 13.751≤c≤13.811 (Å), typically, c=13.781 (Å).

When x is approximately 0.15, the positive electrode active material 100 of one embodiment of the present invention has a monoclinic crystal structure belonging to the space group P2/m. In this structure, a unit cell includes one CoO₂ layer. Here, lithium in the positive electrode active material 100 is approximately 15 atomic % of that in a discharged state. Thus, this crystal structure is called a monoclinic O1(15) type structure. In FIG. 4, this crystal structure is denoted by P2/m monoclinic O1(15).

Note that in the unit cell of the monoclinic O1(15) type structure, the coordinates of cobalt and oxygen can be represented by Co1 (0.5, 0, 0.5), Co2 (0, 0.5, 0.5), O1 (X_{O1}, 0, Z_{O1}) within the range of 0.23≤X_{O1} 0.24 and 0.61≤Z_{O1}≤0.65, and O2 (X_{O2}, 0.5, Z_{O2}) within the range of 0.75≤X_{O2}≤0.78 and 0.68≤Z_{O2}≤0.71. The unit cell has lattice constants a=4.880±0.05 Å, b=2.817±0.05 Å, c=4.839±0.05 Å, α=90°, β=109.6±0.10, and γ=90°.

Note that this crystal structure can have the lattice constants even when belonging to the space group R-3m if a certain error is allowed. In this case, the coordinates of cobalt and oxygen in the unit cell can be represented by Co (0, 0, 0.5) and O (0, 0, Z_{O}) within the range of 0.21≤Z_{O}≤0.23. The unit cell has lattice constants a=2.817±0.02 Å and c=13.68±0.1 Å.

In both the O3′ type structure and the monoclinic O1(15) type structure, an ion of cobalt, nickel, magnesium, or the like occupies a site coordinated to six oxygen atoms. Note that a light element such as lithium and magnesium sometimes occupies a site coordinated to four oxygen atoms.

As denoted by the dotted lines in FIG. 4, the CoO₂ layers hardly shift between the R-3m O3 structure, the O3′ type structure, and the monoclinic O1(15) type structure in a discharged state.

The R-3m O3 type structure and the O3′ type structure in a discharged state that contain the same number of cobalt atoms have a difference in volume of 2.5% or less, specifically 2.2% or less, typically 1.8%.

The R-3m O3 type structure and the monoclinic O1(15) type structure in a discharged state that contain the same number of cobalt atoms have a difference in volume of 3.3% or less, specifically 3.0% or less, typically 2.5%.

Table 1 shows a difference in volume of one cobalt atom between the R-3m O3 type structure, the O3′ type structure, the monoclinic O1(15) type structure, the H1-3 type structure, and the trigonal O1 type structure in a discharged state. For the lattice constants of the crystal structures used for calculating the values in Table 1, the values in the documents (ICSD coll. code. 172909 and 88721) can be referred to. For the H1-3 type structure, Non-Patent Document 3 can be referred to. The values of the O3′ type structure and the monoclinic O1(15) type structure can be calculated from the experimental values of XRD.

TABLE 1

| | | | | | | | volume |
|---|---|---|---|---|---|---|---|
| | lattice constant | | | | volume of | volume per | change rate |
| crystal structure | a (Å) | b (Å) | c (Å) | β (°) | unit cell (Å³) | Col (Å³) | (%) |
| R-3m O3 | 2.8156 | 2.8156 | 14.0542 | 90 | 96.49 | 32.16 | — |
| (LiCoO₂) | | | | | | | |
| O3′ | 2.818 | 2.818 | 13.78 | 90 | 94.76 | 31.59 | 1.8 |
| monoclinic O1(15 | 4.881 | 2.817 | 4.839 | 109.6 | 62.69 | 31.35 | 2.5 |
| H1-3 | 2.82 | 2.82 | 26.92 | 90 | 185.4 | 30.90 | 3.9 |
| trigonal O1 | 2.8048 | 2.8048 | 4.2509 | 90 | 28.96 | 28.96 | 10.0 |
| (CoO_{1.92}) | | | | | | | |

As described above, in the positive electrode active material 100 of one embodiment of the present invention, a change in the crystal structure caused when x in LiₓCoO₂ is small, i.e., when a large amount of lithium is extracted, is smaller than that in a conventional positive electrode active material. In addition, a change in the volume in the case where the positive electrode active materials having the same number of cobalt atoms are compared is inhibited. Thus, the crystal structure of the positive electrode active material 100 is less likely to break even when charge and discharge are repeated so that x becomes 0.24 or less. Therefore, a decrease in charge and discharge capacity of the positive electrode active material 100 in charge and discharge cycles is inhibited. Furthermore, the positive electrode active material 100 can stably use a large amount of lithium than a conventional positive electrode active material and thus has large discharge capacity per weight and per volume. Thus, with the use of the positive electrode active material 100, a secondary battery with large discharge capacity per weight and per volume can be fabricated.

Note that the positive electrode active material 100 actually has the O3′ type structure in some cases when x in LiₓCoO₂ is greater than or equal to 0.15 and less than or equal to 0.24, and is assumed to have the O3′ type structure even when x is greater than 0.24 and less than or equal to 0.27. In addition, the positive electrode active material 100 actually has the monoclinic O1(15) type structure in some cases when x in LiₓCoO₂ is greater than 0.1 and less than or equal to 0.2, typically greater than or equal to 0.15 and less than or equal to 0.17. However, the crystal structure is influenced by not only x in LiₓCoO₂ but also the number of charge and discharge cycles, a charge current and a discharge current, temperature, an electrolyte, and the like, so that the range of x is not limited to the above.

Thus, when x in LiₓCoO₂ is greater than 0.1 and less than or equal to 0.24, the positive electrode active material 100 may have the O3′ type structure and/or the monoclinic O1(15) type structure. Not all the particles contained in the inner portion 100b of the positive electrode active material 100 necessarily have the O3′ type structure and/or the monoclinic O1(15) type structure. Some of the particles may have another crystal structure or be amorphous.

In order to make x in LiₓCoO₂ small, charge at a high charge voltage is necessary in general. Therefore, the state where x in LiₓCoO₂ is small can be rephrased as a state where charge at a high charge voltage has been performed. For example, when CC/CV charge is performed at 25° C. and 4.6 V or higher using the potential of a lithium metal as a reference, the H1-3 type structure appears in a conventional positive electrode active material. Therefore, a charge voltage of 4.6 V or higher can be regarded as a high charge voltage with reference to the potential of a lithium metal. In this specification and the like, unless otherwise specified, charge voltage is shown with reference to the potential of a lithium metal.

That is, the positive electrode active material 100 of one embodiment of the present invention is preferable because the R-3m O3 structure having symmetry can be maintained even when charge at a high charge voltage, e.g., 4.6 V or higher is performed at 25° C. Moreover, the positive electrode active material 100 of one embodiment of the present invention is preferable because the O3′ type structure can be obtained when charge at a higher charge voltage, e.g., a voltage higher than or equal to 4.65 V and lower than or equal to 4.7 V is performed at 25° C. Furthermore, the positive electrode active material 100 of one embodiment of the present invention is preferable because the monoclinic O1(15) type structure can be obtained when charge at a much higher charge voltage, e.g., a voltage higher than 4.7 V and lower than or equal to 4.8 V is performed at 25° C.

At a far higher charge voltage, the H1-3 type structure is eventually observed in the positive electrode active material 100 in some cases. As described above, the crystal structure is influenced by the number of charge and discharge cycles, a charge current and a discharge current, temperature, an electrolyte, and the like, so that the positive electrode active material 100 of one embodiment of the present invention sometimes has the O3′ type structure even at a lower charge voltage, e.g., a charge voltage of higher than or equal to 4.5 V and lower than 4.6 V at 25° C. Similarly, the positive electrode active material 100 sometimes has the monoclinic O1(15) type structure at a charge voltage of higher than or equal to 4.65 V and lower than or equal to 4.7 V at 25° C.

Note that in the case where graphite is used as a negative electrode active material in a secondary battery, the voltage of the secondary battery is lower than the above-mentioned voltages by the potential of graphite. The potential of graphite is approximately 0.05 V to 0.2 V with reference to the potential of a lithium metal. Therefore, in the case of a secondary battery using graphite as a negative electrode active material, a similar crystal structure is obtained at a voltage corresponding to a difference between the above-described voltage and the potential of the graphite.

Although a chance of the existence of lithium in all lithium sites is the same in the O3′ type structure and the monoclinic O1(15) type structure in FIG. 4, the present invention is not limited thereto. Lithium may exist unevenly in only some of the lithium sites. For example, lithium may symmetrically exist as in the monoclinic O1 type structure (Li_{0.5}CoO₂) in FIG. 5. Distribution of lithium can be analyzed by neutron diffraction, for example.

Each of the O3′ type structure and the monoclinic O1(15) type structure can be regarded as a crystal structure that contains lithium between layers randomly and is similar to a CdCl₂ crystal structure. The crystal structure similar to the CdCl₂ crystal structure is close to a crystal structure of lithium nickel oxide that is charged to be Li_{0.06}NiO₂; however, pure lithium cobalt oxide or a layered rock-salt positive electrode active material containing a large amount of cobalt is known not to have the CdCl₂ crystal structure generally.

The additive-element concentration gradient is preferably similar in a plurality of portions of the surface portion 100a of the positive electrode active material 100. In other words, it is preferable that the reinforcement derived from the additive element uniformly occurs in the surface portion 100a. When the surface portion 100a partly has reinforcement, stress might be concentrated on parts that do not have reinforcement. The concentration of stress on part of the positive electrode active material 100 might cause defects such as cracks from that part, leading to cracking of the positive electrode active material and a decrease in discharge capacity.

Note that the additive elements do not necessarily have similar concentration gradients throughout the surface portion 100a of the positive electrode active material 100. FIGS. 6A1 and 6A2 show enlarged views of a portion near the line C-D in FIG. 1A. FIG. 6A1 shows an example of distribution of the additive element Xin the portion near the line C-D in FIG. 1A and FIG. 6A2 shows an example of distribution of the additive element Yin the portion near the line C-D.

Here, the portion near the line C-D has a layered rock-salt crystal structure belonging to R-3m and the surface of the portion has a (001) orientation. The distribution of the additive element at the surface having a (001) orientation may be different from that at other surfaces. For example, concentration peaks of one or more selected from the additive element X and the additive element Y may be distributed shallower from the surface having a (001) orientation and the surface portion 100a thereof than from a surface having an orientation other than a (001) orientation. Alternatively, the surface having a (001) orientation and the surface portion 100a thereof may have a lower concentration of one or more selected from the additive element X and the additive element Y than a surface having an orientation other than a (001) orientation. Further alternatively, at the surface having a (001) orientation and the surface portion 100a thereof, the concentration of one or more selected from the additive element X and the additive element Y may be below the lower detection limit.

In a layered rock-salt crystal structure belonging to R-3m, cations are arranged parallel to a (001) plane. In other words, a CoO₂ layer and a lithium layer are alternately stacked parallel to a (001) plane. Accordingly, a diffusion path of lithium ions also exists parallel to a (001) plane.

The CoO₂ layer is relatively stable and thus, the surface of the positive electrode active material 100 is more stable when having a (001) orientation. A main diffusion path of lithium ions in charge and discharge is not exposed at a (001) plane.

By contrast, a diffusion path of lithium ions is exposed at a surface having an orientation other than a (001) orientation. Thus, the surface having an orientation other than a (001) orientation and the surface portion 100a thereof easily lose stability because they are regions where extraction of lithium ions starts as well as important regions for maintaining a diffusion path of lithium ions. It is thus extremely important to reinforce the surface having an orientation other than a (001) orientation and the surface portion 100a thereof so that the crystal structure of the whole positive electrode active material 100 is maintained.

Accordingly, in the positive electrode active material 100 of another embodiment of the present invention, it is important to distribute the additive element at the surface having an orientation other than a (001) orientation and the surface portion 100a thereof as shown in FIG. 1B1 or 1B2. In particular, among the additive elements, nickel is preferably detected at the surface having an orientation other than a (001) orientation and the surface portion 100a thereof. By contrast, in the surface having a (001) orientation and the surface portion 100a thereof, the concentration of the additive element may be low as described above or the additive element may be absent.

For example, the half width of distribution of magnesium at the surface having a (001) orientation and the surface portion 100a thereof is preferably greater than or equal to 10 nm and less than or equal to 200 nm, further preferably greater than or equal to 50 nm and less than or equal to 150 nm, still further preferably greater than or equal to 80 nm and less than or equal to 120 nm. The half width of distribution of magnesium at the surface not having a (001) orientation and the surface portion 100a thereof is preferably greater than 200 nm and less than or equal to 500 nm, further preferably greater than 200 nm and less than or equal to 300 nm, still further preferably greater than or equal to 230 nm and less than or equal to 270 nm.

The half width of distribution of nickel at the surface not having a (001) orientation and the surface portion 100a thereof is preferably greater than or equal to 30 nm and less than or equal to 150 nm, further preferably greater than or equal to 50 nm and less than or equal to 130 nm, still further preferably greater than or equal to 70 nm and less than or equal to 110 nm.

In the formation method as described in the following embodiment, in which high-purity LiCoO₂ is formed, the additive element is mixed afterwards, and heating is performed, the additive element spreads mainly via a diffusion path of lithium ions. Thus, distribution of the additive element at the surface having an orientation other than a (001) orientation and the surface portion 100a thereof can easily fall within a preferred range.

Calculation results of distribution of the additive element in the case where high-purity LiCoO₂ is formed, the additive element is mixed, and heating is performed are described with reference to FIGS. 6B1, 6B2, 6B3, and 6C.

FIG. 6B1 shows calculation results for a surface having a (104) orientation and the surface portion 100a thereof. The classical molecular dynamics method was used for the calculation. LiCoO₂ (LCO) was put in the lower portion of the system, whereas LiF and MgF₂ were put in the upper portion of the system as a magnesium source, a lithium source, and a fluorine source. The ensemble was NVT, the density of the initial structure was 1.8 g/cm³, the temperature of the system was 2000 K, the elapsed time was 100 psec, the potential was optimized with an LCO crystal structure, combination with the universal force field (UFF) was used for other atoms, the number of atoms in the system was approximately 10000, and electric charges in the system were neutral. To simplify the drawing, only Co atoms and Mg atoms are shown.

Similarly, FIG. 6B2 shows results of calculation in which the elapsed time was 200 psec, and FIG. 6B3 shows results of calculation in which the elapsed time was 1200 psec.

From the above-described calculation, magnesium is probably diffused in the following process.
(1) Lithium is extracted from LCO owing to heat.
(2) Magnesium enters the lithium layer of LCO and is diffused into the inner portion.
(3) Lithium originating from LiF enters the lithium layer of LCO and compensates for the extraction of lithium in (1).

FIG. 6B1, in which 100 psec elapsed, clearly shows diffusion of magnesium atoms into LCO. Magnesium atoms are diffused along the arranged cobalt atoms, and in FIG. 6B3 in which 1200 psec elapsed, almost all the magnesium atoms provided in the upper portion of the system are taken into LCO.

FIG. 6C shows results of calculation which is the same as the calculation in FIG. 6B1 except that a (001) orientation was employed. In FIG. 6C, magnesium atoms stay at the surface of LCO. Note that FIG. 6C shows the calculation results of the case where 100 psec elapsed. The positive electrode active material 100 is actually formed through heating for longer than or equal to 2 hours, so that magnesium atoms may be slowly diffused into the inner portion of LCO.

As described above, by the formation method in which high-purity LiCoO₂ is formed, the additive element is then mixed, and heating is performed, the distribution of the additive element can be preferable at a surface having an orientation other than a (001) orientation and the surface portion 100a thereof as compared to the distribution of the additive element in a (001) plane.

Moreover, in the formation method involving initial heating, which is described later, lithium in the surface portion 100a is expected to be extracted from LiCoO₂ owing to the initial heating and thus, the additive element such as magnesium can be distributed easily in the surface portion at a high concentration.

The positive electrode active material 100 preferably has a smooth surface with little unevenness; however, it is not necessary that the whole surface of the positive electrode active material 100 be in such a state. In a composite oxide with a layered rock-salt crystal structure belonging to R-3m, slipping easily occurs at a plane parallel to a (001) plane, e.g., a plane where lithium atoms are arranged. In the case where a (001) plane exists as shown in FIG. 7A, for example, a pressing step or other steps sometimes causes slipping in a direction parallel to the (001) plane as denoted by arrows in FIG. 7B, resulting in deformation.

In this case, at a surface newly formed as a result of slipping and the surface portion 100a thereof, the additive element does not exist or the concentration of the additive element is below the lower detection limit in some cases. The line E-F in FIG. 7B denotes sections of examples of the surface newly formed as a result of slipping and its surface portion 100a. FIGS. 7C1 and 7C2 show enlarged views of the vicinity of the line E-F. In FIGS. 7C1 and 7C2, unlike in FIGS. 1B11, and 1B2, there is neither distribution of the additive element Xnor that of the additive element Y.

However, because slipping easily occurs parallel to a (001) plane, the newly formed surface and the surface portion 100a thereof easily have a (001) orientation. In this case, since a diffusion path of lithium ions is not exposed and the surface having a (001) plane is relatively stable, substantially no problem is caused even when the additive element does not exist or the concentration of the additive element is below the lower detection limit in the surface having a (001) plane.

Note that as described above, in a composite oxide whose composition is LiCoO₂ and which has a layered rock-salt crystal structure belonging to R-3m, cobalt atoms are arranged parallel to a (001) plane. In a HAADF-STEM image, the luminance of cobalt, which has the largest atom number in LiCoO₂, is the highest. Thus, in a HAADF-STEM image, arrangement of atoms with a high luminance may be regarded as arrangement of cobalt atoms. Repetition of such arrangement with a high luminance can be rephrased as crystal fringes or lattice fringes.

### <<Crystal Grain Boundary>>

It is further preferable that the additive element contained in the positive electrode active material 100 of one embodiment of the present invention have the above-described distribution and be at least partly unevenly distributed at the crystal grain boundary 101 and the vicinity thereof.

In this specification and the like, uneven distribution refers to a state where a concentration of a certain element in a certain region is different from that in other regions, and may be rephrased as segregation, precipitation, unevenness, deviation, a mixture of a high-concentration portion and a low-concentration portion, or the like.

For example, the magnesium concentration at the crystal grain boundary 101 and the vicinity thereof in the positive electrode active material 100 is preferably higher than that in the other regions in the inner portion 100b. In addition, the fluorine concentration at the crystal grain boundary 101 and the vicinity thereof is preferably higher than that in the other regions in the inner portion 100b. In addition, the nickel concentration at the crystal grain boundary 101 and the vicinity thereof is preferably higher than that in the other regions in the inner portion 100b. In addition, the aluminum concentration at the crystal grain boundary 101 and the vicinity thereof is preferably higher than that in the other regions in the inner portion 100b.

The crystal grain boundary 101 is a plane defect, and thus tends to be unstable and suffer a change in the crystal structure like the surface of the particle. Thus, the higher the concentration of the additive element at the crystal grain boundary 101 and the vicinity thereof is, the more effectively the change in the crystal structure can be reduced.

When the magnesium concentration and the fluorine concentration are high at the crystal grain boundary 101 and the vicinity thereof, the magnesium concentration and the fluorine concentration in the vicinity of a surface generated by a crack are also high even when the crack is generated along the crystal grain boundary 101 of the positive electrode active material 100 of one embodiment of the present invention. Thus, the positive electrode active material including a crack can also have an increased corrosion resistance to hydrofluoric acid.

### <Particle Diameter>

When the particle diameter of the positive electrode active material 100 of one embodiment of the present invention is too large, there are problems such as difficulty in lithium diffusion and large surface roughness of an active material layer at the time when the material is applied to a current collector. By contrast, too small a particle diameter causes problems such as difficulty in loading of the active material layer at the time when the material is applied to the current collector and overreaction with the electrolyte solution. Therefore, the median diameter (D50) is preferably greater than or equal to 1 μm and less than or equal to 100 μm, further preferably greater than or equal to 2 μm and less than or equal to 40 μm, still further preferably greater than or equal to 5 μm and less than or equal to 30 μm. Alternatively, the median diameter (D50) is preferably greater than or equal to 1 μm and less than or equal to 40 μm, greater than or equal to 1 μm and less than or equal to 30 μm, greater than or equal to 2 μm and less than or equal to 100 μm, greater than or equal to 2 μm and less than or equal to 30 μm, greater than or equal to 5 μm and less than or equal to 100 μm, or greater than or equal to 5 μm and less than or equal to 40 μm.

### <Analysis Method>

Whether or not a given positive electrode active material is the positive electrode active material 100 of one embodiment of the present invention, which has the O3′ type structure and/or the monoclinic O1(15) type structure when x in LiₓCoO₂ is small, can be judged by analyzing a positive electrode including the positive electrode active material with small x in LiₓCoO₂ by XRD, electron diffraction, neutron diffraction, electron spin resonance (ESR), nuclear magnetic resonance (NMR), or the like.

XRD is particularly preferable because the symmetry of a transition metal such as cobalt in the positive electrode active material can be analyzed with high resolution, comparison of the degree of crystallinity and comparison of the crystal orientation can be performed, distortion of lattice arrangement and the crystallite size can be analyzed, and a positive electrode obtained only by disassembling a secondary battery can be measured with sufficient accuracy, for example. The peaks appearing in the powder XRD patterns reflect the crystal structure of the inner portion 100b of the positive electrode active material 100, which accounts for the majority of the volume of the positive electrode active material 100.

In the case where the crystallite size is measured by powder XRD, the measurement is preferably performed while the influence of orientation due to pressure or the like is preferably removed. For example, it is preferable that the positive electrode active material be taken out from a positive electrode obtained from a disassembled secondary battery, the positive electrode active material be made into a powder sample, and then the measurement be performed.

As described above, the feature of the positive electrode active material 100 of one embodiment of the present invention is a small change in the crystal structure between a state with x in LiₓCoO₂ of 1 and a state with x of 0.24 or less. A material in which 50% or more of the crystal structure largely changes in a high-voltage charged state is not preferable because the material cannot withstand high-voltage charge and discharge.

It should be noted that the O3′ type structure or the monoclinic O1(15) type structure is not obtained in some cases only by addition of the additive element. For example, in a state with x in LiₓCoO₂ of 0.24 or less, lithium cobalt oxide containing magnesium and fluorine has the O3′ type structure and/or the monoclinic O1(15) type structure at 60% or more in some cases, and has the H1-3 type structure at 50% or more in other cases, depending on the concentration and distribution of the additive element.

In addition, in a state where x in LiₓCoO₂ is too small, e.g., 0.1 or less, or charge voltage is higher than 4.9 V, the positive electrode active material 100 sometimes has the H1-3 structure or the trigonal O1 structure. Thus, to determine whether or not a positive electrode active material is the positive electrode active material 100 of one embodiment of the present invention, analysis of the crystal structure by XRD and other methods and data such as charge capacity or charge voltage are needed.

However, the crystal structure of a positive electrode active material in a state with small x may be changed with exposure to the air. For example, the O3′ type structure and the monoclinic O1(15) type structure change into the H1-3 type structure in some cases. For that reason, all samples subjected to analysis of the crystal structure are preferably handled in an inert atmosphere such as an argon atmosphere.

Whether the additive element contained in a positive electrode active material has the above-described distribution can be judged by analysis using X-ray photoelectron spectroscopy (XPS), EDX, electron probe microanalysis (EPMA), or the like.

The crystal structure of the surface portion 100a, the crystal grain boundary 101, or the like can be analyzed by electron diffraction of a cross section of the positive electrode active material 100, for example.

### <<Charging Method>>

Charge for determining whether or not a composite oxide is the positive electrode active material 100 of one embodiment of the present invention can be performed on a CR2032 coin cell (with a diameter of 20 mm and a height of 3.2 mm) with a lithium counter electrode, for example.

More specifically, a positive electrode can be formed by application of a slurry in which the positive electrode active material, a conductive material, and a binder are mixed to a positive electrode current collector made of aluminum foil.

A lithium metal can be used for a counter electrode. Note that when the counter electrode is formed using a material other than the lithium metal, the potential of a secondary battery differs from the potential of the positive electrode. Unless otherwise specified, the voltage and the potential in this specification and the like refer to the potential of a positive electrode.

As an electrolyte contained in an electrolyte solution, 1 mol/L lithium hexafluorophosphate (LiPF₆) can be used. As the electrolyte solution, a solution in which ethylene carbonate (EC) and diethyl carbonate (DEC) at a volume ratio of 3:7 and vinylene carbonate (VC) at 2 wt % are mixed can be used.

As a separator, a 25-μm-thick polypropylene porous film can be used.

Stainless steel (SUS) can be used for a positive electrode can and a negative electrode can.

The coin cell fabricated with the above conditions is subjected to charge to a freely selected voltage (e.g., 4.5 V, 4.55 V, 4.6 V, 4.65 V, 4.7 V, 4.75 V, or 4.8 V). The charge conditions are not particularly limited as long as charge can be performed for enough time to a freely selected voltage. In the case of CCCV charge, for example, CC charge can be performed with a current higher than or equal to 20 mA/g and lower than or equal to 100 mA/g, and CV charge can be ended with a current higher than or equal to 2 mA/g and lower than or equal to 10 mA/g. To observe a phase change of the positive electrode active material, charge with such a small current value is preferably performed. The temperature is set to 25° C. or 45° C. After the charge is performed in this manner, the coin cell is disassembled in a glove box with an argon atmosphere to take out the positive electrode, whereby the positive electrode active material with predetermined charge capacity can be obtained. In order to inhibit a reaction with components in the external environment, the taken positive electrode is preferably enclosed in an argon atmosphere in performing various analyses later. For example, XRD can be performed on the positive electrode enclosed in an airtight container with an argon atmosphere. After charge is completed, the positive electrode is preferably taken out immediately and subjected to the analysis. Specifically, the positive electrode is preferably subjected to the analysis within 1 hour after the completion of charge, further preferably 30 minutes after the completion of charge.

In the case where the crystal structure in a charged state after charge and discharge are performed multiple times is analyzed, the conditions of the charge and discharge which are performed multiple times may be different from the above-described charge conditions. For example, the charge can be performed in the following manner: constant current charge to a freely selected voltage (e.g., 4.6 V, 4.65 V, 4.7 V, 4.75 V, or 4.8 V) at a current value of higher than or equal to 20 mA/g and lower than or equal to 100 mA/g is performed and then, constant voltage charge is performed until the current value becomes higher than or equal to 2 mA/g and lower than or equal to 10 mA/g. As the discharge, constant current discharge can be performed at higher than or equal to 20 mA/g and lower than or equal to 100 mA/g until the discharge voltage reaches 2.5 V.

Also in the case where the crystal structure in a discharged state after charge and discharge are performed multiple times is analyzed, constant current discharge can be performed at a current value of higher than or equal to 20 mA/g and lower than or equal to 100 mA/g until the discharge voltage reaches 2.5 V, for example.

### <<XRD>>

The apparatus and conditions adopted in the XRD measurement are not particularly limited. The measurement can be performed with the apparatus and conditions as described below, for example.
XRD apparatus: D8 ADVANCE produced by Bruker AXS
X-ray source: CuKα₁ radiation
Output: 40 kV, 40 mA
Angle of divergence: Div. Slit, 0.5°
Detector: LynxEye
Scanning method: 2θ/θ continuous scanning
Measurement range (2θ): from 15° to 90°
Step width (2θ): 0.01°
Counting time: 1 second/step
Rotation of sample stage: 15 rpm

In the case where the measurement sample is a powder, the sample can be set by, for example, being put in a glass sample holder or being sprinkled on a reflection-free silicon plate to which grease is applied. In the case where the measurement sample is a positive electrode, the sample can be set in such a manner that the positive electrode is attached to a substrate with a double-sided adhesive tape so that the position of the positive electrode active material layer can be adjusted to the measurement plane required by the apparatus.

FIG. 8, FIG. 9, and FIGS. 10A and 10B show ideal powder XRD patterns with CuKα₁ radiation that are calculated from models of the O3′ type structure, the monoclinic O1(15) type structure, and the H1-3 type structure. For comparison, ideal XRD patterns calculated from the crystal structure of LiCoO₂ (O3) with x in LiₓCoO₂ of 1 and the trigonal O1 structure with x of 0 are also shown. FIGS. 10A and 10B each show both the XRD pattern of the O3′ type structure, that of the monoclinic O1(15) type structure, and that of the H1-3 type structure; FIG. 10A is an enlarged diagram showing a range of 2θ of greater than or equal to 18° and less than or equal to 21° and FIG. 10B is an enlarged diagram showing a range of 2θ of greater than or equal to 42° and less than or equal to 46°. Note that the patterns of LiCoO₂ (O3) and CoO₂ (O1) were made from crystal structure data obtained from the Inorganic Crystal Structure Database (ICSD) (see Non-Patent Document 4) with Reflex Powder Diffraction, which is a module of Materials Studio (BIOVIA). The range of 20 was from 15° to 75°, the step size was 0.01, the wavelength λ1 was 1.540562×10⁻¹⁰ m, the wavelength λ2 was not set, and a single monochromator was used. The pattern of the H1-3 type structure was similarly made from the crystal structure data disclosed in Non-Patent Document 3. The O3′ type structure and the monoclinic O1(15) type structure were estimated from the XRD pattern of the positive electrode active material of one embodiment of the present invention, the crystal structures were fitted with TOPAS Version 3 (crystal structure analysis software produced by Bruker Corporation), and the XRD patterns of the O3′ type structure and the monoclinic O1(15) type structure were made in a similar manner to other structures.

As shown in FIG. 8 and FIGS. 10A and 10B, the O3′ type structure exhibits diffraction peaks at 2θ of 19.25±0.12° (greater than or equal to 19.13° and less than 19.37°) and 2θ of 45.47±0.10° (greater than or equal to 45.370 and less than 45.57°).

The monoclinic O1(15) type structure exhibits diffraction peaks at 2θ of 19.47±0.100 (greater than or equal to 19.370 and less than or equal to 19.57°) and 2θ of 45.62±0.05° (greater than or equal to 45.570 and less than or equal to 45.67°).

However, as shown in FIG. 9 and FIGS. 10A and 10B, the H1-3 type structure and the trigonal O1 type structure do not exhibit peaks at these positions. Thus, the peak at greater than or equal to 19.130 and less than 19.370 and/or greater than or equal to 19.370 and less than or equal to 19.570 and the peak at greater than or equal to 45.370 and less than 45.570 and/or greater than or equal to 45.570 and less than or equal to 45.670 in a state with small x in LiₓCoO₂ can be the features of the positive electrode active material 100 of one embodiment of the present invention.

It can be said that the positions of the XRD diffraction peaks exhibited by the crystal structure with x of 1 and the crystal structure with x of 0.24 or less are close to each other. More specifically, it can be said that a difference in 20 between the main diffraction peak exhibited by the crystal structure with x of 1 and the main diffraction peak exhibited by the crystal structure with x of 0.24 or less, which are exhibited at 2θ of greater than or equal to 420 and less than or equal to 46°, is 0.7 or less, preferably 0.5 or less.

Although the positive electrode active material 100 of one embodiment of the present invention has the O3′ type structure and/or the monoclinic O1(15) type structure when x in LiₓCoO₂ is small, not all the particles necessarily have the O3′ type structure and/or the monoclinic O1(15) type structure. Some of the particles may have another crystal structure or be amorphous. Note that when the XRD patterns are subjected to the Rietveld analysis, the O3′ type structure and/or the monoclinic O1(15) type structure preferably account for greater than or equal to 50%, further preferably greater than or equal to 60%, still further preferably greater than or equal to 66% of the positive electrode active material. The positive electrode active material in which the O3′ type structure and/or the monoclinic O1(15) type structure account for greater than or equal to 50%, preferably greater than or equal to 60%, further preferably greater than or equal to 66% can have sufficiently good cycle performance.

Furthermore, even after 100 or more cycles of charge and discharge after the measurement starts, the O3′ type structure and/or the monoclinic O1(15) type structure preferably account for greater than or equal to 35%, further preferably greater than or equal to 40%, still further preferably greater than or equal to 43%, in the Rietveld analysis.

In addition, the H1-3 type structure and the O1 type structure preferably account for less than or equal to 50% in the Rietveld analysis performed in a similar manner.

Sharpness of a diffraction peak in an XRD pattern indicates the degree of crystallinity. It is thus preferable that the diffraction peaks after charge be sharp or in other words, have a small half width, e.g., a small full width at half maximum. Even peaks that are derived from the same crystal phase have different half widths depending on the XRD measurement conditions and/or the 2θ value. In the case of the above-described measurement conditions, the peak observed at 2θ of greater than or equal to 43° and less than or equal to 46° preferably has a small full width at half maximum of less than or equal to 0.2°, further preferably less than or equal to 0.15°, still further preferably less than or equal to 0.12°. Note that not all peaks need to fulfill the requirement. A crystal phase can be regarded as having high crystallinity when one or more peaks derived from the crystal phase fulfill the requirement. Such high crystallinity efficiently contributes to stability of the crystal structure after charge.

The crystallite size of the O3′ type structure and the monoclinic O1(15) type structure of the positive electrode active material 100 is decreased to approximately one-twentieth that of LiCoO₂ (O3) in a discharged state. Thus, the peak of the O3′ type structure and/or the monoclinic O1(15) type structure can be clearly observed when x in LiₓCoO₂ is small even under the same XRD measurement conditions as those of a positive electrode before charge and discharge. By contrast, conventional LiCoO₂ has a small crystallite size and exhibits a broad and small peak although it can partly have a structure similar to the O3′ type structure and/or the monoclinic O1(15) type structure. The crystallite size can be calculated from the half width of the XRD peak.

As described above, the influence of the Jahn-Teller effect is preferably small in the positive electrode active material 100 of one embodiment of the present invention. The positive electrode active material 100 of one embodiment of the present invention may contain a transition metal such as nickel or manganese as the additive element in addition to cobalt as long as the influence of the Jahn-Teller effect is small.

The proportions of nickel and manganese and the range of the lattice constants with which the influence of the Jahn-Teller effect is presumed to be small in the positive electrode active material is examined by XRD analysis.

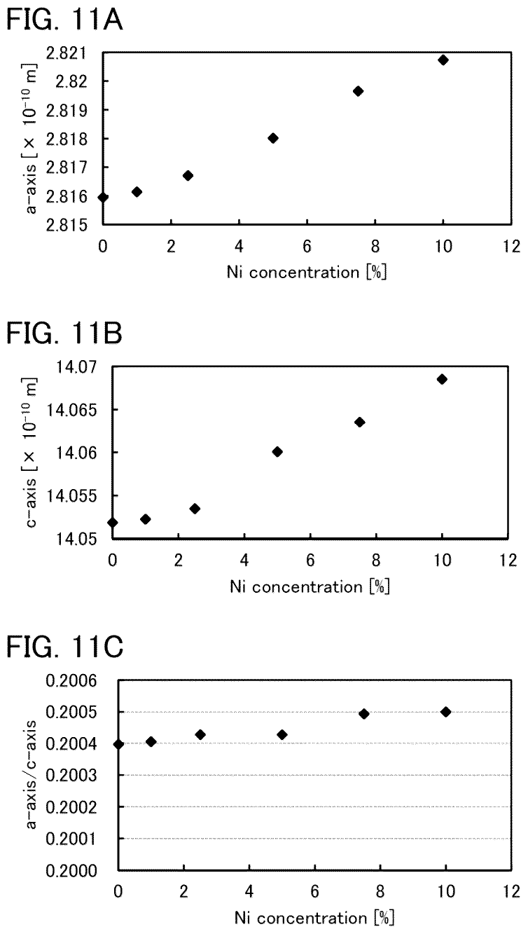

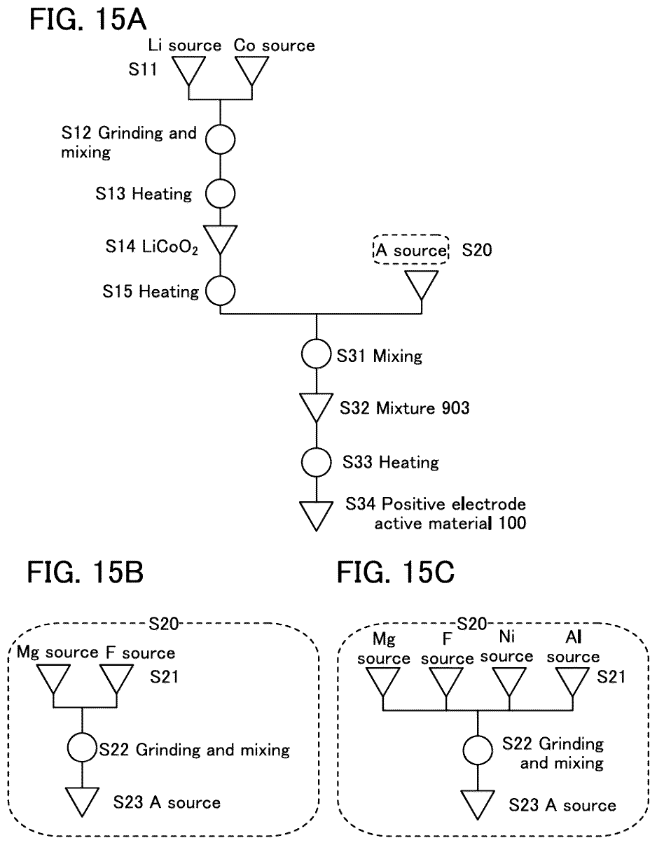

FIGS. 11A to 11C show the calculation results of the lattice constants of the a-axis and the c-axis by XRD in the case where the positive electrode active material 100 of one embodiment of the present invention has a layered rock-salt crystal structure and contains cobalt and nickel. FIG. 11A shows the results of the a-axis, and FIG. 11B shows the results of the c-axis. Note that the XRD patterns of a powder after the synthesis of the positive electrode active material before incorporation into a positive electrode were used for the calculation. The nickel concentration on the horizontal axis represents a nickel concentration with the sum of cobalt atoms and nickel atoms regarded as 100%. The positive electrode active material was formed in accordance with the formation method in FIGS. 15A to 15C except that the aluminum source was not used.

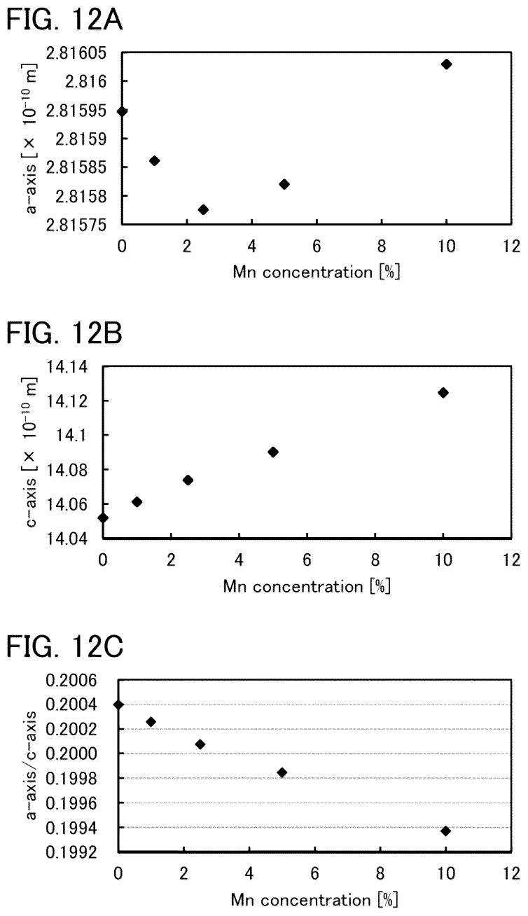

FIGS. 12A to 12C show the estimation results of the lattice constants of the a-axis and the c-axis by XRD in the case where the positive electrode active material 100 of one embodiment of the present invention has a layered rock-salt crystal structure and contains cobalt and manganese. FIG. 12A shows the results of the a-axis, and FIG. 12B shows the results of the c-axis. Note that the lattice constants shown in FIGS. 12A to 12C were obtained by XRD measurement of a powder after the synthesis of the positive electrode active material before incorporation into a positive electrode. The manganese concentration on the horizontal axis represents a manganese concentration with the sum of cobalt atoms and manganese atoms regarded as 100%. The positive electrode active material was formed in accordance with the formation method shown in FIG. 15 except that a manganese source was used instead of the nickel source and the aluminum source was not used.

FIG. 11C shows values obtained by dividing the lattice constants of the a-axis by the lattice constants of the c-axis (a-axis/c-axis) in the positive electrode active material, whose results of the lattice constants are shown in FIGS. 11A and 11B. FIG. 12C shows values obtained by dividing the lattice constants of the a-axis by the lattice constants of the c-axis (a-axis/c-axis) in the positive electrode active material, whose results of the lattice constants are shown in FIGS. 12A and 12B.

As shown in FIG. 11C, the value of a-axis/c-axis tends to significantly change between nickel concentrations of 5% and 7.5%, and the distortion of the a-axis becomes large at a nickel concentration of 7.5%. This distortion may be derived from the Jahn-Teller distortion of trivalent nickel. It is suggested that an excellent positive electrode active material with small Jahn-Teller distortion can be obtained at a nickel concentration of lower than 7.5%.

FIG. 12A indicates that the lattice constant changes differently at manganese concentrations of 5% or higher and does not follow the Vegard's law. This suggests that the crystal structure changes at manganese concentrations of 5% or higher. Thus, the manganese concentration is preferably 4% or lower, for example.

Note that the nickel concentration and the manganese concentration in the surface portion 100a are not limited to the above ranges. In other words, the nickel concentration and the manganese concentration in the surface portion 100a may be higher than the above concentrations.

Preferable ranges of the lattice constants of the positive electrode active material of one embodiment of the present invention are examined above. In the layered rock-salt crystal structure of the positive electrode active material 100 in a discharged state or a state where charge and discharge are not performed, which can be estimated from the XRD patterns, the lattice constant of the a-axis is preferably greater than 2.814×10⁻¹⁰ m and less than 2.817×10⁻¹⁰ m, and the lattice constant of the c-axis is preferably greater than 14.05×10⁻¹⁰ m and less than 14.07×10⁻¹⁰ m. The state where charge and discharge are not performed may be the state of a powder before the formation of a positive electrode of a secondary battery.

Alternatively, in the layered rock-salt crystal structure of the positive electrode active material 100 in a discharged state or the state where charge and discharge are not performed, the value obtained by dividing the lattice constant of the a-axis by the lattice constant of the c-axis (a-axis/c-axis) is preferably greater than 0.20000 and less than 0.20049.

Alternatively, when the layered rock-salt crystal structure of the positive electrode active material 100 in a discharged state or the state where charge and discharge are not performed is subjected to XRD analysis, a first peak is observed at 2θ of greater than or equal to 18.50° and less than or equal to 19.30°, and a second peak is observed at 2θ of greater than or equal to 38.00° and less than or equal to 38.80°, in some cases.

### <<XPS>>

In an inorganic oxide, a region that is approximately 2 nm to 8 nm (normally, less than or equal to 5 nm) in depth from a surface can be analyzed by XPS using monochromatic aluminum Kα radiation as an X-ray source; thus, the concentrations of elements in approximately half the depth of the surface portion 100a can be quantitatively analyzed. The bonding states of the elements can be analyzed by narrow scanning. Note that the quantitative accuracy of XPS is approximately ±1 atomic % in many cases. The lower detection limit is approximately 1 atomic % but depends on the element.

In the positive electrode active material 100 of one embodiment of the present invention, the concentration of one or more selected from the additive elements is preferably higher in the surface portion 100a than in the inner portion 100b. This means that the concentration of one or more selected from the additive elements in the surface portion 100a is preferably higher than the average concentration of the selected element(s) in the entire positive electrode active material 100. For this reason, for example, it is preferable that the concentration of one or more additive elements selected from the surface portion 100a, which is measured by XPS or the like, be higher than the average concentration of the additive element(s) in the entire positive electrode active material 100, which is measured by ICP-MS, GD-MS, or the like. For example, the concentration of magnesium of at least part of the surface portion 100a, which is measured by XPS or the like, is preferably higher than the concentration of magnesium of the entire positive electrode active material 100. In addition, the concentrations of nickel, aluminum, and fluorine of at least part of the surface portion 100a are preferably higher than the concentrations of nickel, aluminum, and fluorine of the entire positive electrode active material 100, respectively.

Note that the surface and the surface portion 100a of the positive electrode active material 100 of one embodiment of the present invention do not contain a carbonate, a hydroxy group, or the like which is chemically adsorbed after formation of the positive electrode active material 100. Furthermore, an electrolyte solution, a binder, a conductive material, and a compound originating from any of these that are attached to the surface of the positive electrode active material 100 are not contained either. Thus, in quantitative analysis of the elements contained in the positive electrode active material, correction may be performed to exclude carbon, hydrogen, excess oxygen, excess fluorine, and the like that might be detected in surface analysis such as XPS. For example, in XPS, the kinds of bonds can be identified by analysis, and a C—F bond originating from a binder may be excluded by correction.

Furthermore, before any of various kinds of analyses is performed, a sample such as a positive electrode active material and a positive electrode active material layer may be washed, for example, to eliminate an electrolyte solution, a binder, a conductive material, and a compound originating from any of these that are attached to the surface of the positive electrode active material. Although lithium might be eluted to a solvent or the like used in the washing at this time, the additive element is not easily eluted even in that case; thus, the atomic ratio of the additive element is not affected.

The concentration of the additive element may be compared using the ratio of the additive element to cobalt. The use of the ratio of the additive element to cobalt enables comparison while inhibiting the influence of a carbonate or the like which is chemically adsorbed after formation of the positive electrode active material. For example, in the XPS analysis, the atomic ratio of magnesium to cobalt (Mg/Co) is preferably greater than or equal to 0.4 and less than or equal to 1.5. In the ICP-MS analysis, Mg/Co is preferably greater than or equal to 0.001 and less than or equal to 0.06.

Similarly, to ensure the sufficient path through which lithium is inserted and extracted, the concentrations of lithium and cobalt are preferably higher than those of the additive elements in the surface portion 100a of the positive electrode active material 100. This means that the concentrations of lithium and cobalt in the surface portion 100a are preferably higher than that of one or more selected from the additive elements contained in the surface portion 100a, which is measured by XPS or the like. For example, the concentrations of cobalt and lithium in at least part of the surface portion 100a, which are measured by XPS or the like, are preferably higher than those of magnesium, nickel, aluminum, and fluorine in at least part of the surface portion 100a, which are measured by XPS or the like.

It is further preferable that the additive element Y such as aluminum be preferably widely distributed in a region that is 5 nm to 50 nm in depth from the surface, for example. Therefore, the additive element Y such as aluminum is detected by analysis on the entire positive electrode active material 100 by ICP-MS, GD-MS, or the like, but the concentration of the additive element Y such as aluminum is preferably lower than or equal to the lower detection limit in XPS or the like.

Moreover, when XPS analysis is performed on the positive electrode active material 100 of one embodiment of the present invention, the number of magnesium atoms is preferably 0.4 times or more and 1.2 times or less, further preferably 0.65 times or more and 1.0 times or less the number of cobalt atoms. The number of nickel atoms is preferably 0.15 times or less, further preferably 0.03 times or more and 0.13 times or less the number of cobalt atoms. The number of aluminum atoms is preferably 0.12 times or less, further preferably 0.09 times or less the number of cobalt atoms. The number of fluorine atoms is preferably 0.3 times or more and 0.9 times or less, further preferably 0.1 times or more and 1.1 times or less the number of cobalt atoms. When the atomic ratio is within the above range, it can be said that the additive element is not attached to the surface of the positive electrode active material 100 in a narrow range but widely distributed at a preferable concentration in the surface portion 100a of the positive electrode active material 100.

In the XPS analysis, monochromatic aluminum Kα radiation can be used as an X-ray source, for example. An extraction angle is, for example, 45°. For example, the measurement can be performed using the following apparatus and conditions.
Measurement device: Quantera II produced by PHI, Inc.
X-ray source: monochromatic Al Kα (1486.6 eV)
Detection area: 100 μm φ
Detection depth: approximately 4 nm to 5 nm (extraction angle 45°)
Measurement spectrum: wide scanning, narrow scanning of each detected element

In addition, when the positive electrode active material 100 of one embodiment of the present invention is analyzed by XPS, a peak indicating the bonding energy of fluorine with another element is preferably at greater than or equal to 682 eV and less than 685 eV, further preferably approximately 684.3 eV. This bonding energy is different from that of lithium fluoride (685 eV) and that of magnesium fluoride (686 eV). That is, the positive electrode active material 100 of one embodiment of the present invention containing fluorine is preferably in the bonding state other than lithium fluoride and magnesium fluoride.

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably approximately 1303 eV. This bonding energy is different from that of magnesium fluoride (1305 eV) and is close to that of magnesium oxide. That is, the positive electrode active material 100 of one embodiment of the present invention containing magnesium is preferably in the bonding state other than magnesium fluoride.

### <<EDX>>

One or more selected from the additive elements contained in the positive electrode active material 100 preferably have a concentration gradient. For example, it is further preferable that the additive elements contained in the positive electrode active material 100 exhibit concentration peaks at different depths from a surface. The concentration gradient of the additive element can be evaluated by exposing a cross section of the positive electrode active material 100 using an FIB and analyzing the cross section using EDX, EPMA, or the like.

In the EDX measurement, the measurement in which a region is measured while scanning the region and evaluated two-dimensionally is referred to as EDX surface analysis. The measurement by line scan, which is performed to evaluate the atomic concentration distribution in a positive electrode active material, is referred to as linear analysis. Furthermore, extracting data of a linear region from EDX surface analysis is referred to as linear analysis in some cases. The measurement of a region without scanning is referred to as point analysis.

By EDX surface analysis (e.g., element mapping), the concentrations of the additive element in the surface portion 100a, the inner portion 100b, the vicinity of the crystal grain boundary 101, and the like of the positive electrode active material 100 can be quantitatively analyzed. By EDX linear analysis, the concentration distribution and the highest concentration of the additive element can be analyzed. An analysis method in which a sample is sliced, such as STEM-EDX, is preferred because the method makes it possible to analyze the concentration distribution in the depth direction from the surface toward the center in a specific region of the positive electrode active material regardless of the distribution in the front-back direction.

EDX surface analysis or EDX point analysis of the positive electrode active material 100 of one embodiment of the present invention preferably reveals that the concentration of each additive element, in particular, the additive element Xin the surface portion 100a is higher than that in the inner portion 100b.

For example, EDX surface analysis or EDX point analysis of the positive electrode active material 100 containing magnesium as the additive element preferably reveals that the magnesium concentration in the surface portion 100a is higher than that in the inner portion 100b. In the EDX linear analysis, a peak of the magnesium concentration in the surface portion 100a is preferably exhibited by a region that is 3 nm in depth, further preferably 1 nm in depth, still further preferably 0.5 nm in depth from the surface toward the center of the positive electrode active material 100. In addition, the magnesium concentration preferably attenuates, at a depth of 1 nm from the point where the concentration reaches the peak, to less than or equal to 60% of the peak concentration. In addition, the magnesium concentration preferably attenuates, at a depth of 2 nm from the point where the concentration reaches the peak, to less than or equal to 30% of the peak concentration. Here, “a peak of concentration” refers to the local maximum value of concentration.

When the positive electrode active material 100 contains magnesium and fluorine as the additive elements, the distribution of fluorine preferably overlaps with the distribution of magnesium. For example, a difference in the depth direction between a peak of the fluorine concentration and a peak of the magnesium concentration is preferably within 10 nm, further preferably within 3 nm, still further preferably within 1 nm.

In the EDX linear analysis, a peak of the fluorine concentration in the surface portion 100a is preferably exhibited by a region that is 3 nm in depth, further preferably 1 nm in depth, still further preferably 0.5 nm in depth from the surface toward the center of the positive electrode active material 100. It is further preferable that a peak of the fluorine concentration be exhibited slightly closer to the surface side than a peak of the magnesium concentration is, which increases resistance to hydrofluoric acid. For example, it is preferable that a peak of the fluorine concentration be exhibited slightly closer to the surface side than a peak of the magnesium concentration is by 0.5 nm or more, further preferably 1.5 nm or more.

In the positive electrode active material 100 containing nickel as the additive element, a peak of the nickel concentration in the surface portion 100a is preferably exhibited by a region that is 3 nm in depth, further preferably 1 nm in depth, still further preferably 0.5 nm in depth from the surface toward the center of the positive electrode active material 100. When the positive electrode active material 100 contains magnesium and nickel, the distribution of nickel preferably overlaps with the distribution of magnesium. For example, a difference in the depth direction between a peak of the nickel concentration and a peak of the magnesium concentration is preferably within 10 nm, further preferably within 3 nm, still further preferably within 1 nm.

In the case where the positive electrode active material 100 contains aluminum as the additive element, in the EDX linear analysis, the peak of the magnesium concentration, the nickel concentration, or the fluorine concentration is preferably closer to the surface than the peak of the aluminum concentration is in the surface portion 100a. For example, the peak of the aluminum concentration is preferably exhibited by a region that is greater than or equal to 0.5 nm and less than or equal to 50 nm in depth, further preferably greater than or equal to 5 nm and less than or equal to 50 nm in depth from the surface toward the center of the positive electrode active material 100.

EDX linear, surface, or point analysis of the positive electrode active material 100 preferably reveals that the atomic ratio of magnesium to cobalt (Mg/Co) at a peak of the magnesium concentration is preferably greater than or equal to 0.05 and less than or equal to 0.6, further preferably greater than or equal to 0.1 and less than or equal to 0.4. The atomic ratio of aluminum to cobalt (Al/Co) at a peak of the aluminum concentration is preferably greater than or equal to 0.05 and less than or equal to 0.6, further preferably greater than or equal to 0.1 and less than or equal to 0.45. The atomic ratio of nickel to cobalt (Ni/Co) at a peak of the nickel concentration is preferably greater than or equal to 0 and less than or equal to 0.2, further preferably greater than or equal to 0.01 and less than or equal to 0.1. The atomic ratio of fluorine to cobalt (F/Co) at a peak of the fluorine concentration is preferably greater than or equal to 0 and less than or equal to 1.6, further preferably greater than or equal to 0.1 and less than or equal to 1.4.

According to results of the EDX linear analysis, where a surface of the positive electrode active material 100 is can be estimated as follows. A point where the detected amount of an element which uniformly exists in the inner portion 100b of the positive electrode active material 100, e.g., oxygen or cobalt, is ½ of the detected amount thereof in the inner portion 100b is assumed as the surface.

Since the positive electrode active material 100 is a composite oxide, the detected amount of oxygen can be used to estimate where the surface is. Specifically, an average value Oₐᵥₑ of the oxygen concentration of a region of the inner portion 100b where the detected amount of oxygen is stable is calculated first. At this time, in the case where oxygen O_{bg} which is probably led from chemical adsorption or the background is detected in a region that is obviously outside the surface, O_{bg} is subtracted from the measurement value to obtain the average value Oₐᵥₑ of the oxygen concentration. The measurement point where the measurement value which is closest to ½ of the average value Oₐᵥₑ, or ½Oₐᵥₑ, is obtained can be estimated to be the surface of the positive electrode active material.

The detected amount of cobalt can also be used to estimate where the surface is as in the above description. Alternatively, the sum of the detected amounts of the transition metals can be used for the estimation in a similar manner. The detected amount of the transition metal such as cobalt is unlikely to be affected by chemical adsorption and is thus suitable for the estimation of where the surface is.

When the positive electrode active material 100 is subjected to linear analysis or surface analysis, the atomic ratio of an additive element A to cobalt (A/Co) in the vicinity of the crystal grain boundary 101 is preferably greater than or equal to 0.020 and less than or equal to 0.50, further preferably greater than or equal to 0.025 and less than or equal to 0.30, still further preferably greater than or equal to 0.030 and less than or equal to 0.20. Alternatively, the atomic ratio is preferably greater than or equal to 0.020 and less than or equal to 0.30, greater than or equal to 0.020 and less than or equal to 0.20, greater than or equal to 0.025 and less than or equal to 0.50, greater than or equal to 0.025 and less than or equal to 0.20, greater than or equal to 0.030 and less than or equal to 0.50, or greater than or equal to 0.030 and less than or equal to 0.30.

In the case where the additive element is magnesium, for example, when the positive electrode active material 100 is subjected to linear analysis or surface analysis, the atomic ratio of magnesium to cobalt (Mg/Co) in the vicinity of the crystal grain boundary 101 is preferably greater than or equal to 0.020 and less than or equal to 0.50, further preferably greater than or equal to 0.025 and less than or equal to 0.30, still further preferably greater than or equal to 0.030 and less than or equal to 0.20. Alternatively, the atomic ratio is preferably greater than or equal to 0.020 and less than or equal to 0.30, greater than or equal to 0.020 and less than or equal to 0.20, greater than or equal to 0.025 and less than or equal to 0.50, greater than or equal to 0.025 and less than or equal to 0.20, greater than or equal to 0.030 and less than or equal to 0.50, or greater than or equal to 0.030 and less than or equal to 0.30. When the atomic ratio is within the above range in a plurality of portions, e.g., three or more portions of the positive electrode active material 100, it can be said that the additive element is not attached to the surface of the positive electrode active material 100 in a narrow range but widely distributed at a preferable concentration in the surface portion 100a of the positive electrode active material 100.

### <<EPMA>>

Quantitative analysis of elements can be conducted by EPMA. In surface analysis, distribution of each element can be analyzed.

EPMA surface analysis of a cross section of the positive electrode active material 100 of one embodiment of the present invention preferably reveals that one or two selected from the additive elements have a concentration gradient, as in the EDX analysis. It is further preferable that the additive elements exhibit concentration peaks at different depths from the surface. The preferred range of the concentration peaks of the additive elements are the same as those in EDX.

In EPMA, a region from a surface to a depth of approximately 1 μm is analyzed. Thus, the quantitative value of each element is sometimes different from measurement results obtained by other analysis methods. For example, when EPMA surface analysis is performed on the positive electrode active material 100, the concentration of the additive element existing in the surface portion 100a might be lower than the concentration obtained in XPS.

<<Charge Curve and dQ/dVvsV Curve>>

The positive electrode active material 100 of one embodiment of the present invention sometimes shows a characteristic voltage change along with charge. A voltage change can be read from a dQ/dVvsV curve, which can be obtained by differentiating capacitance (Q) in a charge curve with voltage (V) (dQ/dV). For example, there should be an unbalanced phase change and a significant change in the crystal structure between before and after a peak in a dQ/dVvsV curve. Note that in this specification and the like, an unbalanced phase change refers to a phenomenon that causes a nonlinear change in physical quantity.

The positive electrode active material 100 of one embodiment of the present invention sometimes shows a broad peak at around 4.55 V in a dQ/dVvsV curve. The peak at around 4.55 V reflects a change in voltage at the time of the phase change from the O3 type structure to the O3′ type structure. This means that when this peak is broad, a change in the energy necessary for extraction of lithium is smaller or in other words, a change in the crystal structure is smaller, than when the peak is sharp. These changes are preferably small, in which case the influence of a shift in CoO₂ layers and that of a change in volume are little.

Specifically, when the maximum value appearing at greater than or equal to 4.5 V and less than or equal to 4.6 V in a dQ/dVvsV curve of a charge curve is a first peak, the first peak preferably has a full width at half maximum of greater than or equal to 0.10 V to be sufficiently broad. In this specification and the like, the full width at half maximum of the first peak refers to the difference between HWHM₁ and HWHM₂, where HWHM₁ is an average value of the first peak and a first minimum value (the minimum dQ/dV value appearing at greater than or equal to 4.3 V and less than or equal to 4.5 V) and HWHM₂ is an average value of the first peak and a second minimum value (the minimum dQ/dV value appearing at greater than or equal to 4.6 V and less than or equal to 4.8 V).

The charge at the time of obtaining a dQ/dVvsV curve can be, for example, constant current charge to 4.9 V at 10 mA/g. In obtaining a dQ/dV value of the initial charge, the above charge is preferably started after discharge to 2.5 V at higher than or equal to 20 mA/g and lower than or equal to 100 mA/g before measurement.

Data acquisition at the time of charge can be performed in the following manner, for example: a voltage and a current are acquired at intervals of 1 second or at every 1-mV voltage change. The value obtained by adding the current value and time is charge capacity.

The difference between the n-th data and the n+1-th data of the above charge capacity is the n-th value of a capacity change dQ. Similarly, the difference between the n-th data and the n+1-th data of the above voltage is the n-th value of a voltage change dV.

Note that minute noise has considerable influence when the above data is used; thus, the dQ/dV value may be calculated from the moving average for a certain number of class intervals of the differences in the voltage and the moving average for a certain number of class intervals of the differences in the charge capacity. The number of class intervals can be 500, for example.

Specifically, the average value of the n-th to n+500-th dQ values is calculated and in a similar manner, the average value of the n-th to n+500-th dV values is calculated. The dQ/dV value can be dQ (the average of 500 dQ values)/dV (the average of 500 dV values). In a similar manner, the moving average value for 500 class intervals can be used for the voltage on the horizontal axis of a dQ/dVvsV graph. In the case where the above-described moving average value for 500 class intervals is used, the 501^{st} data from the last to the last data are largely influenced by noise and thus are not preferably used for the dQ/dVvsV graph.

In the case where a dQ/dVvsV curve after charge and discharge are performed multiple times is analyzed, the conditions of the charge and discharge performed multiple times may be different from the above-described charge conditions. For example, the charge can be performed in the following manner: constant current charge is performed at a freely selected voltage (e.g., 4.6 V, 4.65 V, 4.7 V, 4.75 V, or 4.8 V) and higher than or equal to 20 mA/g and lower than or equal to 100 mA/g and then, constant voltage charge is performed until the current value becomes higher than or equal to 2 mA/g and lower than or equal to 10 mA/g. As the discharge, constant current discharge can be performed at higher than or equal to 20 mA/g and lower than or equal to 100 mA/g until the discharge voltage reaches 2.5 V.

Note that the O3 type structure at the time of the phase change from the O3 type structure to the O3′ type structure at around 4.55 V has x in LiₓCoO₂ of approximately 0.3. The O3 type structure with x in LiₓCoO₂ of approximately 0.3 has the same symmetry as the O3 type structure with x of 1 illustrated in FIG. 5 but is slightly different from the O3 type structure with x of 1 in the distance between the CoO₂ layers. In this specification and the like, when O3 type structures with different x are distinguished from each other, the O3 type structure with x of 1 is referred to as O3 (2θ=18.85) and the O3 type structure with x of approximately 0.3 is referred to as O3 (2θ=18.57). This is because the position of the peak appearing at 2θ of approximately 19° in XRD measurement corresponds to the distance between the CoO₂ layers.

<<Discharge Curve and dQ/dVvsV Curve>>

When the positive electrode active material 100 of one embodiment of the present invention is discharged at a low current such as 40 mA/g or less after high-voltage charge, a characteristic voltage change appears just before the end of discharge, in some cases. This change can be clearly observed when a dQ/dVvsV curve calculated from the discharge curve has at least one peak within the range of 3.5 V to a voltage lower than approximately 3.9 V at which a peak appears.

### <<ESR>>

The positive electrode active material 100 of one embodiment of the present invention preferably contains cobalt, and nickel and magnesium as the additive elements. It is preferable that Ni³⁺ be substituted for part of CO³⁺ and Mg²⁺ be substituted for part of Li⁺ accordingly. Accompanying the substitution of Mg²⁺ for Li⁺, the Ni³⁺ might be reduced to be Ni²⁺. Accompanying the substitution of Mg²⁺ for part of Li⁺, CO³⁺ in the vicinity of Mg²⁺ might be reduced to be Co²⁺. Accompanying the substitution of Mg²⁺ for part of Co³⁺, Co³⁺ in the vicinity of Mg²⁺ might be oxidized to be Co⁴⁺.

Thus, the positive electrode active material 100 preferably contains one or more of Ni²⁺, Ni³⁺, CO²⁺, and Co⁴⁺. Moreover, the spin density attributed to one or more of Ni²⁺, Ni³⁺, Co2+, and Co⁴⁺ per weight of the positive electrode active material 100 is preferably greater than or equal to 2.0×10¹⁷ spins/g and less than or equal to 1.0×10²¹ spins/g. The positive electrode active material 100 preferably has the above spin density, in which case the crystal structure can be stable particularly in a charged state. Note that too high a magnesium concentration might reduce the spin density attributed to one or more of Ni²⁺, Ni³⁺, Co²⁺, and Co⁴⁺.

The spin density of a positive electrode active material can be analyzed by ESR, for example.

### <<Surface Roughness and Specific Surface Area>>

The positive electrode active material 100 of one embodiment of the present invention preferably has a smooth surface with little unevenness. A smooth surface with little unevenness indicates that a fusing agent described later adequately functions and the surfaces of the additive element source and lithium cobalt oxide melt. Thus, a smooth surface with little unevenness indicates favorable distribution of the additive element in the surface portion 100a.

A smooth surface with little unevenness can be recognized from, for example, a cross-sectional SEM image or a cross-sectional TEM image of the positive electrode active material 100 or the specific surface area of the positive electrode active material 100.

The level of the surface smoothness of the positive electrode active material 100 can be quantified from its cross-sectional SEM image, as described below, for example.

First, the positive electrode active material 100 is processed with an FIB or the like such that its cross section is exposed. At this time, the positive electrode active material 100 is preferably covered with a protective film, a protective agent, or the like. Next, a SEM image of the interface between the positive electrode active material 100 and the protective film or the like is taken. The SEM image is subjected to noise processing using image processing software. For example, the Gaussian Blur (σ=2) is performed, followed by binarization. In addition, interface extraction is performed using image processing software. Moreover, an interface line between the positive electrode active material 100 and the protective film or the like is selected with an automatic selection tool or the like, and data is extracted to spreadsheet software or the like. With the use of the function of the spreadsheet software or the like, correction is performed using regression curves (quadratic regression), parameters for calculating roughness are obtained from data subjected to slope correction, and root-mean-square (RMS) surface roughness is obtained by calculating standard deviation. This surface roughness refers to the surface roughness of part of the particle periphery (at least 400 nm) of the positive electrode active material.

On the surface of the particle of the positive electrode active material 100 of this embodiment, root-mean-square (RMS) surface roughness, which is an index of roughness, is preferably less than 3 nm, further preferably less than 1 nm, still further preferably less than 0.5 nm.

Note that the image processing software used for the noise processing, the interface extraction, or the like is not particularly limited, and for example, “ImageJ” described in Non-Patent Documents 6 to 8 can be used. In addition, the spreadsheet software or the like is not particularly limited, and Microsoft Office Excel can be used, for example.

For example, the level of surface smoothness of the positive electrode active material 100 can also be quantified from the ratio of an actual specific surface area S_{R} measured by a constant-volume gas adsorption method to an ideal specific surface area Sᵢ.

The ideal specific surface area Sᵢ is calculated on the assumption that all the particles have the same diameter as D50, have the same weight, and have ideal spherical shapes.

The median diameter D50 can be measured with a particle size analyzer or the like using a laser diffraction and scattering method. The specific surface area can be measured with a specific surface area analyzer or the like by a constant-volume gas adsorption method, for example.

In the positive electrode active material 100 of one embodiment of the present invention, the ratio of the actual specific surface area S_{R} to the ideal specific surface area Sᵢ obtained from the median diameter D50 (S_{R}/Sᵢ) is preferably less than or equal to 2.1.

Alternatively, the level of the surface smoothness of the positive electrode active material 100 can be quantified from its cross-sectional SEM image by a method as described below.

First, a surface SEM image of the positive electrode active material 100 is taken. At this time, conductive coating maybe performed as pretreatment for observation. The surface to be observed is preferably vertical to an electron beam. In the case of comparing a plurality of samples, the same measurement conditions and the same observation area are adopted.

Then, the above SEM image is converted into an 8-bit image (which is referred to as a grayscale image) with the use of image processing software (e.g., ImageJ). The grayscale image includes luminance (brightness information). For example, in an 8-bit grayscale image, luminance can be represented by 2⁸=256 gradation levels. A dark portion has a low gradation level and a bright portion has a high gradation level. A variation in luminance can be quantified in relation to the number of gradation levels. The value obtained by the quantification is referred to as a grayscale value. By obtaining such a grayscale value, the unevenness of the positive electrode active material can be evaluated quantitatively.

In addition, a variation in luminance in a target region can also be represented with a histogram. A histogram three-dimensionally shows distribution of gradation levels in a target region and is also referred to as a luminance histogram. A luminance histogram enables visually easy-to-understand evaluation of unevenness of the positive electrode active material.

In the positive electrode active material 100 of one embodiment of the present invention, the difference between the maximum grayscale value and the minimum grayscale value is preferably less than or equal to 120, further preferably less than or equal to 115, still further preferably greater than or equal to 70 and less than or equal to 115. The standard deviation of the grayscale value is preferably less than or equal to 11, further preferably less than or equal to 8, still further preferably greater than or equal to 4 and less than or equal to 8.

### <<Current-Rest-Method>>

The distribution of the additive element included in the surface portion of the positive electrode active material 100 of one embodiment of the present invention, such as magnesium, sometimes slightly changes during repeated charge and discharge. For example, in some cases, the distribution of the additive element becomes more favorable, so that the electronic conduction resistance decreases. Thus, in some cases, the electric resistance, i.e., a resistance component R(0.1 s) with a high response speed measured by a current-rest-method, decreases at the initial stage of the charge and discharge cycles.

For example, when the n-th (n is a natural number larger than 1) charge and the n+1-th charge are compared, the resistance component R(0.1 s) with a high response speed measured by a current-rest-method is lower in the n+1-th charge than in the n-th charge. Accordingly, the n+1-th discharge capacity is higher than the n-th discharge capacity in some cases. Also in the case of a positive electrode active material that does not contain any additive element, the second charge capacity can be higher than the initial charge capacity (i.e., n=1); thus, n is preferably greater than or equal to 2 and less than or equal to 10, for example. However, n is not limited to the above for the initial stage of the charge and discharge cycles. The stage where the charge and discharge capacity is substantially the same as the rated capacity or is greater than or equal to 97% of the rated capacity can be regarded as the initial stage of the charge and discharge cycles.

### <<Raman Spectroscopy>>

As described above, at least part of the surface portion 100a of the positive electrode active material 100 of one embodiment of the present invention preferably has a rock-salt crystal structure. Thus, when the positive electrode active material 100 and a positive electrode including the positive electrode active material 100 are analyzed by Raman spectroscopy, a cubic crystal structure such as a rock-salt crystal structure is preferably observed in addition to a layered rock-salt crystal structure. In a STEM image and a nanobeam electron diffraction pattern described later, when cobalt that substitutes for a lithium site, cobalt that exists at a tetracoordinated oxygen site, or the like does not appear with a certain frequency in the depth direction in observation, a bright spot cannot be detected in a STEM image and nanobeam electron diffraction. Meanwhile, Raman spectroscopy observes a vibration mode of a bond such as a Co—O bond, so that even when the number of Co—O bonds is small, a peak of a wave number of a vibration mode corresponding to cobalt can be observed in some cases. Furthermore, since Raman spectroscopy can measure a range with a several square micrometers and a depth of approximately 1 μm of a surface portion, a Co—O bond that exists only at the surface of a particle can be observed with high sensitivity.

When a laser wavelength is 532 nm, for example, peaks (vibration mode: E_{g}, Ai_{g}) of LiCoO₂ having a layered rock-salt structure are observed in a range from 470 cm⁻¹ to 490 cm⁻¹ and in a range from 580 cm⁻¹ to 600 cm⁻¹. Meanwhile, a peak (vibration mode: A_{1g}) of cubic CoOₓ (0<x<1) (Co_{1-y}O having a rock-salt structure (0<y<1) or CO₃O₄ having a spinel structure) is observed in a range from 665 cm⁻¹ to 685 cm⁻¹.

Thus, in the case where the integrated intensities of the peak in the range from 470 cm⁻¹ to 490 cm⁻¹, the peak in the range from 580 cm⁻¹ to 600 cm⁻¹, and the peak in the range from 665 cm⁻¹ to 685 cm⁻¹ are represented by I1, I2, and I3, respectively, I3/I2 is preferably greater than or equal to 1% and less than or equal to 10%, further preferably greater than or equal to 3% and less than or equal to 9%.

In the case where a cubic crystal structure such as a rock-salt structure is observed in the above-described range, it can be said that an appropriate range of the surface portion 100a of the positive electrode active material 100 has a rock-salt crystal structure.

### <<Nanobeam Electron Diffraction Pattern>>

As in Raman spectroscopy, features of both a layered rock-salt crystal structure and a rock-salt crystal structure are preferably observed in a nanobeam electron diffraction pattern. Note that in consideration of the above-described difference in sensitivity, in a STEM image and a nanobeam electron diffraction pattern, it is preferable that the features of a rock-salt crystal structure not be too significant at the surface portion 100a, in particular, the outermost surface (e.g., a portion that is 1 nm in depth from the surface). This is because a diffusion path of lithium can be ensured and a function of stabilizing a crystal structure can be increased in the case where the additive element such as magnesium exists in the lithium layer while the outermost surface has a layered rock-salt crystal structure as compared with the case where the outermost surface is covered with a rock-salt crystal structure.

Therefore, for example, when a nanobeam electron diffraction pattern of a region that is 1 nm or less in depth from the surface and a nanobeam electron diffraction pattern of a region that is 3 nm to 10 nm in depth from the surface are obtained, a difference between lattice constants calculated from the patterns is preferably small.

For example, a difference between lattice constants calculated from a measured portion that is 1 nm or less in depth from the surface and a measured portion that is 3 nm to 10 nm in depth from the surface is preferably less than or equal to 0.1 Å (a-axis) and less than or equal to 1.0 Å (c-axis). The difference is further preferably less than or equal to 0.05 Å (a-axis) and less than or equal to 0.6 Å (c-axis), still further preferably less than or equal to 0.04 Å (a-axis) and less than or equal to 0.3 Å (c-axis).

### <Additional Features>

The positive electrode active material 100 has a depression, a crack, a concave, a V-shaped cross section, or the like in some cases. These are examples of defects, and when charge and discharge are repeated, elution of cobalt, breakage of a crystal structure, cracking of the positive electrode active material 100, extraction of oxygen, or the like might be derived from these defects. However, when there is a filling portion 102 in FIG. 1A that fills such defects, elution of cobalt or the like can be inhibited. Thus, the positive electrode active material 100 can have high reliability and excellent cycle performance.

As described above, an excessive amount of the additive element in the positive electrode active material 100 might adversely affect insertion and extraction of lithium. The use of such a positive electrode active material 100 for a secondary battery might cause an internal resistance increase, a charge and discharge capacity decrease, and the like. Meanwhile, when the amount of the additive element is insufficient, the additive element is not distributed throughout the surface portion 100a, which might diminish the effect of inhibiting degradation of a crystal structure. The additive element is required to be contained in the positive electrode active material 100 at an appropriate concentration; however, the adjustment of the concentration is not easy.

For this reason, in the positive electrode active material 100, when the region where the additive element is unevenly distributed is included, some excess atoms of the additive element are removed from the inner portion 100b, so that the additive element concentration can be appropriate in the inner portion 100b. This can inhibit an internal resistance increase, a charge and discharge capacity decrease, and the like when the positive electrode active material 100 is used for a secondary battery. A feature of inhibiting an internal resistance increase in a secondary battery is extremely preferable especially in charge and discharge with a large amount of current such as charge and discharge at 400 mA/g or more.

In the positive electrode active material 100 including the region where the additive element is unevenly distributed, addition of excess additive elements to some extent in the formation process is acceptable. This is preferable because the margin of production can be increased.

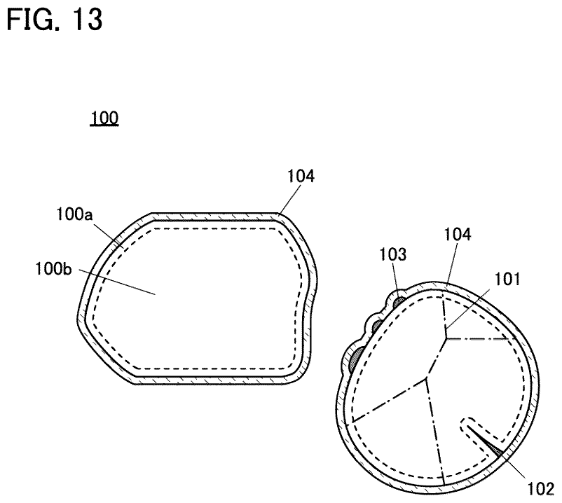

A coating portion may be attached to at least part of the surface of the positive electrode active material 100. FIG. 13 shows an example of the positive electrode active material 100 to which the coating portion 104 is attached.

The coating portion 104 is preferably formed by deposition of a decomposition product of an electrolyte and an organic electrolyte solution due to charge and discharge, for example. A coating portion originating from an electrolyte solution, which is formed on the surface of the positive electrode active material 100, is expected to improve charge and discharge cycle performance particularly when charge is repeated so that x in LiₓCoO₂ becomes 0.24 or less. This is because an increase in impedance of the surface of the positive electrode active material is inhibited or elution of cobalt is inhibited, for example. The coating portion 104 preferably contains carbon, oxygen, and fluorine, for example. The coating portion can have high quality easily when the electrolyte solution includes LiBOB and/or suberonitrile (SUN), for example. Accordingly, the coating portion 104 preferably contains one or more selected from boron, nitrogen, sulfur, and fluorine to possibly have high quality. The coating portion 104 does not necessarily cover the positive electrode active material 100 entirely. For example, the coating portion 104 covers greater than or equal to 50%, preferably greater than or equal to 70%, further preferably greater than or equal to 90% of the surface of the positive electrode active material 100.

When a positive electrode active material undergoes charge and discharge under conditions, including charge at 4.5 V or more, or at a high temperature, e.g., 45° C. or higher, a progressive defect that progresses deeply from the surface toward the inner portion might be generated. Progress of a defect in a positive electrode active material to form a hole can be referred to as pitting corrosion, and the hole generated by this phenomenon is also referred to as a pit in this specification.

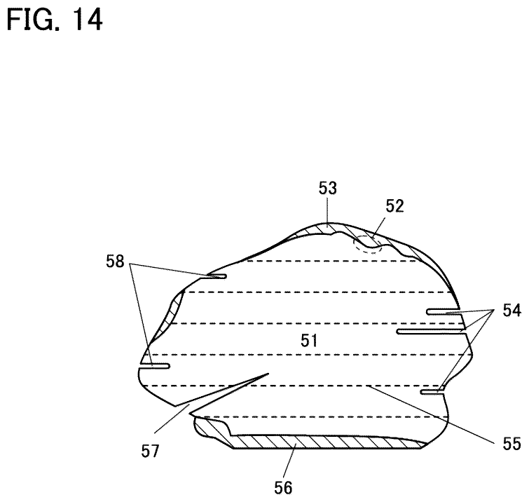

FIG. 14 is a schematic cross-sectional view of a positive electrode active material 51 including pits. A crystal plane 55 parallel to the arrangement of cations is also illustrated. Although a pit 54 and a pit 58 are illustrated as holes since FIG. 14 is a cross-sectional view, their opening shape is not circular but a wide groove-like shape. Unlike a depression 52, the pit 54 and the pit 58 are likely to be generated parallel to the arrangement of lithium ions as illustrated in the drawing.

In the positive electrode active material 51, surface portions where the additive elements exist are denoted by reference numerals 53 and 56. A surface portion where the pit is generated contains a smaller amount of the additive element than the surface portions 53 and 56 or contains the additive element whose concentration is below the lower detection limit, and thus probably has a poor function of a barrier film. Presumably, the crystal structure of lithium cobalt oxide in the vicinity of a portion where a pit is formed is broken and differs from a layered rock-salt crystal structure. The breakage of the crystal structure inhibits diffusion and release of lithium ions that are carrier ions; thus, a pit is probably a cause of degradation of cycle performance.

A source of a pit can be a point defect. It is considered that a pit is generated when a point defect included in a positive electrode active material changes due to repetitive charge and discharge, and the positive electrode active material undergoes chemical or electrochemical erosion or degradation due to the electrolyte or the like surrounding the positive electrode active material. This degradation does not occur uniformly in the surface of the positive electrode active material but occurs locally in a concentrated manner.

In addition, as illustrated in FIG. 14 as a crack 57, a defect such as a crack (also referred to as a crevice) might be generated by expansion and contraction of the positive electrode active material due to charge and discharge. In this specification, a crack and a pit are different from each other. Immediately after formation of a positive electrode active material, a crack can exist but a pit does not exist. A pit can also be regarded as a hole formed by extraction of some layers of cobalt and oxygen due to charge and discharge under high-voltage conditions at, e.g., 4.5 V or more or at a high temperature (45° C. or higher), i.e., a portion from which cobalt has been eluted. A crack refers to a surface newly generated by application of physical pressure or a crevice generated owing to the crystal grain boundary 101, for example. A crack might be caused by expansion and contraction of a positive electrode active material due to charge and discharge. A pit might be generated from a void inside a positive electrode active material and/or a crack.

This embodiment can be implemented in combination with any of the other embodiments.

### Embodiment 2

In this embodiment, an example of a method for forming the positive electrode active material 100 which is one embodiment of the present invention is described.

A way of adding an additive element is important in forming the positive electrode active material 100 having a distribution of the additive element, a composition, and/or a crystal structure that were/was described in the above embodiment. Favorable crystallinity of the inner portion 100b is also important.

Thus, in the formation process of the positive electrode active material 100, it is preferred that lithium cobalt oxide be synthesized first, and then an additive element source be mixed and heat treatment be performed.

In a method of synthesizing lithium cobalt oxide containing an additive element by mixing an additive element source concurrently with a cobalt source and a lithium source, it is sometimes difficult to increase the concentration of the additive element in the surface portion 100a. In addition, after lithium cobalt oxide is synthesized, only mixing an additive element source without performing heating causes the additive element to be just attached to, not dissolved in, the lithium cobalt oxide. It is difficult to distribute the additive element favorably without sufficient heating. Therefore, it is preferable that lithium cobalt oxide be synthesized, and then an additive element source be mixed and heat treatment be performed. The heat treatment after mixing of the additive element source may be referred to as annealing.

However, annealing at an excessively high temperature may cause cation mixing, which increases the possibility of entry of the additive element such as magnesium into the cobalt sites. Magnesium that exists in the cobalt sites does not have an effect of maintaining a layered rock-salt crystal structure belonging to R-3m when x in LiₓCoO₂ is small. Furthermore, heat treatment at an excessively high temperature might have an adverse effect; for example, cobalt might be reduced to have a valence of two or lithium might be evaporated.

In view of the above, a material functioning as a fusing agent is preferably mixed together with the additive element source. A material having a lower melting point than lithium cobalt oxide can be regarded as a material functioning as a fusing agent. For example, a fluorine compound such as lithium fluoride is preferably used. Addition of a fusing agent lowers the melting points of the additive element source and lithium cobalt oxide. Lowering the melting points makes it easier to distribute the additive element favorably at a temperature at which cation mixing is less likely to occur.

### [Initial Heating]

It is further preferable that heat treatment be performed between the synthesis of the lithium cobalt oxide and the mixing of the additive element. This heating is referred to as initial heating in some cases.

Since lithium is extracted from part of the surface portion 100a of the lithium cobalt oxide by the initial heating, the distribution of the additive element becomes more favorable.

Specifically, the distributions of the additive elements can be easily made different from each other by the initial heating in the following mechanism. First, lithium is extracted from part of the surface portion 100a by the initial heating. Next, additive element sources such as a nickel source, an aluminum source, and a magnesium source and lithium cobalt oxide including the surface portion 100a that is deficient in lithium are mixed and heated. Among the additive elements, magnesium is a divalent representative element, and nickel is a transition metal but is likely to be a divalent ion. Therefore, in part of the surface portion 100a, a rock-salt phase containing Co²⁺, which is reduced due to lithium deficiency, Mg²⁺, and Ni²⁺ is formed. Note that this phase is formed in part of the surface portion 100a, and thus is sometimes not clearly observed in an image obtained with an electron microscope, such as a STEM image, and an electron diffraction pattern.

Among the additive elements, nickel is likely to be dissolved and is diffused to the inner portion 100b in the case where the surface portion 100a of lithium cobalt oxide has a layered rock-salt structure, but is likely to remain in the surface portion 100a in the case where part of the surface portion 100a has a rock-salt structure. Thus, the initial heating can make it easy for a divalent additive element such as nickel to remain in the surface portion 100a. The effect of this initial heating is large particularly at the surface having an orientation other than a (001) orientation of the positive electrode active material 100 and the surface portion 100a thereof.

Furthermore, in such a rock-salt structure, the bond distance between a metal Me and oxygen (Me-O distance) tends to be longer than that in a layered rock-salt structure.

For example, Me-O distance is 2.09 Å and 2.11 Å in Ni_{0.5}Mg_{0.5}O having a rock-salt structure and MgO having a rock-salt structure, respectively. Even when a spinel phase is formed in part of the surface portion 100a, Me-O distance is 2.0125 Å and 2.02 Å in NiAl₂O₄ having a spinel structure and MgAl₂O₄ having a spinel structure, respectively. In each case, Me-O distance is longer than 2 Å. Note that 1 Å=10⁻¹⁰ m.

Meanwhile, in a layered rock-salt structure, the bond distance between oxygen and a metal other than lithium is shorter than the above-described distance. For example, Al—O distance is 1.905 Å (Li—O distance is 2.11 Å) in LiAlO₂ having a layered rock-salt structure. In addition, Co—O distance is 1.9224 Å (Li—O distance is 2.0916 Å) in LiCoO₂ having a layered rock-salt structure.

According to Shannon et al., Acta A 32 (1976) 751., the ion radius of hexacoordinated aluminum and the ion radius of hexacoordinated oxygen are 0.535 Å and 1.4 Å, respectively, and the sum of those values is 1.935 Å.

From the above, aluminum is considered to exist in a site other than a lithium site more stably in a layered rock-salt structure than in a rock-salt structure. Thus, in the surface portion 100a, aluminum is more likely to be distributed in, than in a region having a rock-salt phase that is close to the surface, a region having a layered rock-salt phase at a position deeper than the region and/or the inner portion 100b.

Moreover, the initial heating is expected to increase the crystallinity of the layered rock-salt crystal structure of the inner portion 100b.

For this reason, the initial heating is preferably performed in order to form the positive electrode active material 100 that has the monoclinic O1(15) type structure when x in LiₓCoO₂ is, for example, greater than or equal to 0.15 and less than or equal to 0.17.

However, the initial heating is not necessarily performed. In some cases, by controlling atmosphere, temperature, time, or the like in another heating step, e.g., annealing, the positive electrode active material 100 that has the O3′ type structure and/or the monoclinic O1(15) type structure when x in LiₓCoO₂ is small can be formed.

### <<Formation Method 1 of Positive Electrode Active Material>>

A formation method 1 of the positive electrode active material 100, in which annealing and initial heating are performed, is described with reference to FIGS. 15A to 15C.

### <Step S11>

In Step S11 shown in FIG. 15A, a lithium source (Li source) and a cobalt source (Co source) are prepared as materials for lithium and a transition metal which are starting materials.

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity of higher than or equal to 99.99%, for example.

As the cobalt source, a cobalt-containing compound is preferably used and for example, cobalt oxide, cobalt hydroxide, or the like can be used.

The cobalt source preferably has a high purity and is preferably a material having a purity of higher than or equal to 3N (99.9%), further preferably higher than or equal to 4N (99.99%), still further preferably higher than or equal to 4N5 (99.995%), yet still further preferably higher than or equal to 5N (99.999%), for example. Impurities of the positive electrode active material can be controlled by using such a high-purity material. As a result, a secondary battery with an increased capacity and/or increased reliability can be obtained.

Furthermore, the cobalt source preferably has high crystallinity and for example, the cobalt source preferably includes single crystal particles. The crystallinity of the cobalt source can be evaluated with a transmission electron microscope (TEM) image, a scanning transmission electron microscope (STEM) image, a high-angle annular dark-field scanning transmission electron microscope (HAADF-STEM) image, or an annular bright-field scanning transmission electron microscope (ABF-STEM) image or by X-ray diffraction (XRD), electron diffraction, neutron diffraction, or the like. Note that the above methods for evaluating crystallinity can also be employed to evaluate the crystallinity of materials other than the cobalt source.

### <Step S12>

Next, in Step S12 shown in FIG. 15A, the lithium source and the cobalt source are ground and mixed to form a mixed material. The grinding and mixing can be performed by a dry method or a wet method. A wet method is preferred because it can crush a material into a smaller size. When the grinding and mixing are performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent, which is unlikely to react with lithium, is preferably used. In this embodiment, dehydrated acetone with a purity of higher than or equal to 99.5% is used. It is preferable that the lithium source and the cobalt source be mixed into dehydrated acetone whose moisture content is less than or equal to 10 ppm and which has a purity of higher than or equal to 99.5% in the grinding and mixing. With the use of dehydrated acetone with the above-described purity, impurities that might be mixed can be reduced.

A ball mill, a bead mill, or the like can be used for the grinding and mixing. When a ball mill is used, aluminum oxide balls or zirconium oxide balls are preferably used as a grinding medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium. In this embodiment, the grinding and mixing are performed at a peripheral speed of 838 mm/s (the number of rotations: 400 rpm, the ball mill diameter: 40 mm).

### <Step S13>

Next, in Step S13 shown in FIG. 15A, the above mixed material is heated. The heating is preferably performed at higher than or equal to 800° C. and lower than or equal to 1100° C., further preferably at higher than or equal to 900° C. and lower than or equal to 1000° C., still further preferably at approximately 950° C. An excessively low temperature might lead to insufficient decomposition and melting of the lithium source and the cobalt source. An excessively high temperature might lead to a defect due to evaporation of lithium from the lithium source and/or excessive reduction of cobalt, for example. An oxygen defect which could be induced by a change of trivalent cobalt into divalent cobalt due to excessive reduction, for example.

When the heating time is too short, lithium cobalt oxide is not synthesized, but when the heating time is too long, the productivity is lowered. For example, the heating time is preferably longer than or equal to 1 hour and shorter than or equal to 100 hours, further preferably longer than or equal to 2 hours and shorter than or equal to 20 hours.

A temperature raising rate is preferably higher than or equal to 80° C./h and lower than or equal to 250° C./h, although depending on the end-point temperature of the heating. For example, in the case of heating at 1000° C. for 10 hours, the temperature raising rate is preferably 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 parts per billion (ppb).

The heating atmosphere is preferably an oxygen-containing atmosphere. In a method, a dry air is continuously introduced into a reaction chamber. The flow rate of a dry air in this case is preferably 10 L/min. Continuously introducing oxygen into a reaction chamber to make oxygen flow therein is referred to as “flowing”.

In the case where the heating atmosphere is an oxygen-containing atmosphere, flowing is not necessarily performed. For example, a method may be employed in which the pressure in the reaction chamber is reduced, the reaction chamber is filled (or “purged”) with oxygen, and the exit and entry of the oxygen are prevented. For example, the pressure in the reaction chamber may be reduced to −970 hPa and then, the reaction chamber may be filled with oxygen until the pressure becomes 50 hPa.

Cooling after the heating can be performed by letting the mixed material stand to cool, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

A crucible used at the time of the heating is preferably made of aluminum oxide. An aluminum oxide crucible is made of a material that hardly releases impurities. In this embodiment, a crucible made of aluminum oxide with a purity of 99.9% is used. The heating is preferably performed with the crucible covered with a lid, in which case volatilization of a material can be prevented.

A used crucible is preferable to a new crucible. In this specification and the like, a new crucible refers to a crucible that is subjected to heating two or less times while a material containing lithium, the transition metal M, and/or the additive element is contained therein. A used crucible refers to a crucible that is subjected to heating three or more times while a material containing lithium, the transition metal M, and/or the additive element is contained therein. In the case where a new crucible is used, some materials such as lithium fluoride might be absorbed by, diffused in, transferred to, and/or attached to a sagger. Lost of some materials due to such phenomena increases a concern that an element is not distributed in a preferred range particularly at the surface portion of a positive electrode active material. In contrast, such a risk is low in the case of a used crucible.

The heated material is ground as needed and may be made to pass through a sieve. Before collection of the heated material, the material may be moved from the crucible to a mortar. As the mortar, an aluminum oxide mortar can be suitably used. An aluminum oxide mortar is made of a material that hardly releases impurities. Specifically, a mortar made of aluminum oxide with a purity of higher than or equal to 90%, preferably higher than or equal to 99% is used. Note that heating conditions equivalent to those in Step S13 can be employed in a later-described heating step other than Step S13.

### <Step S14>

Through the above steps, lithium cobalt oxide (LiCoO₂) can be synthesized as Step S14 in FIG. 15A.

Although the example is described in which the composite oxide is formed by a solid phase method as in Steps S11 to S14, the composite oxide may be formed by a coprecipitation method. Alternatively, the composite oxide may be formed by a hydrothermal method.

### <Step S15>

Next, as Step S15 shown in FIG. 15A, the lithium cobalt oxide is heated. The heating in Step S15 is the first heating performed on the lithium cobalt oxide and thus, this heating is sometimes referred to as the initial heating. The heating is performed before Step S20 described below and thus is sometimes referred to as preheating or pretreatment.

By the initial heating, lithium is extracted from part of the surface portion 100a of the lithium cobalt oxide as described above. In addition, an effect of increasing the crystallinity of the inner portion 100b can be expected. The lithium source and/or cobalt source prepared in Step S11 and the like might contain impurities. The initial heating can reduce impurities in the lithium cobalt oxide obtained in Step S14.

Furthermore, through the initial heating, the surface of the lithium cobalt oxide becomes smooth. Having a smooth surface refers to a state where the composite oxide has little unevenness and is rounded as a whole and its corner portion is rounded. A smooth surface also refers to a surface to which few foreign matters are attached. Foreign matters are deemed to cause unevenness and are preferably not attached to a surface.

For the initial heating, a lithium compound source is not needed. Alternatively, an additive element source is not needed. Alternatively, a material functioning as a fusing agent is not needed.

When the heating time in this step is too short, an efficient effect is not obtained, but when the heating time in this step is too long, the productivity is lowered. For example, any of the heating conditions described for Step S13 can be selected. Additionally, the heating temperature in this step is preferably lower than that in Step S13 so that the crystal structure of the composite oxide is maintained. The heating time in this step is preferably shorter than that in Step S13 so that the crystal structure of the composite oxide is maintained. For example, the heating is preferably performed at a temperature of higher than or equal to 700° C. and lower than or equal to 1000° C. for longer than or equal to 2 hours and shorter than or equal to 20 hours.

The effect of increasing the crystallinity of the internal portion 100b is, for example, an effect of reducing distortion, a shift, or the like derived from differential shrinkage or the like of the lithium cobalt oxide formed in Step S13.

The heating in Step S13 might cause a temperature difference between the surface and the inner portion of the lithium cobalt oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the lithium cobalt oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the lithium cobalt oxide is relieved. Accordingly, the surface of the lithium cobalt oxide may become smooth, or “surface improvement is achieved”. In other words, it is deemed that Step S15 reduces the differential shrinkage caused in the lithium cobalt oxide to make the surface of the composite oxide smooth.

Such differential shrinkage might cause a micro shift in the lithium cobalt oxide such as a shift in a crystal. To reduce the shift, this step is preferably performed. Performing this step can distribute a shift uniformly in the composite oxide. When the shift is distributed uniformly, the surface of the composite oxide might become smooth, or “crystal grains might be aligned”. In other words, it is deemed that Step S15 reduces the shift in a crystal or the like which is caused in the composite oxide to make the surface of the composite oxide smooth.

In a secondary battery including lithium cobalt oxide with a smooth surface as a positive electrode active material, degradation by charge and discharge is suppressed and a crack in the positive electrode active material can be prevented.

Note that pre-synthesized lithium cobalt oxide may be used in Step S14. In this case, Steps S11 to S13 can be skipped. When Step S15 is performed on the pre-synthesized lithium cobalt oxide, lithium cobalt oxide with a smooth surface can be obtained.

### <Step S20>

Next, as shown in Step S20, the additive element A is preferably added to the lithium cobalt oxide that has been subjected to the initial heating. When the additive elementA is added to the lithium cobalt oxide that has been subjected to the initial heating, the additive element A can be uniformly added. It is thus preferable that the initial heating precede the addition of the additive element A. The step of adding the additive elementA is described with reference to FIGS. 15B and 15C.

### <Step S21>

In Step S21 shown in FIG. 15B, an additive element A source (A source) to be added to the lithium cobalt oxide is prepared. A lithium source may be prepared in addition to the additive element A source.

As the additive element A, the additive element described in the above embodiment, for example, either the additive element X or the additive element Y can be used. Specifically, one or more selected from magnesium, fluorine, nickel, aluminum, titanium, zirconium, vanadium, iron, manganese, chromium, niobium, arsenic, zinc, silicon, sulfur, phosphorus, and boron can be used. Furthermore, one or both of bromine and beryllium can be used.

When magnesium is selected as the additive element, the additive element source can be referred to as a magnesium source. As the magnesium source, magnesium fluoride, magnesium oxide, magnesium hydroxide, magnesium carbonate, or the like can be used. Two or more of these magnesium sources may be used.

When fluorine is selected as the additive element, the additive element source can be referred to as a fluorine source. As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), sodium aluminum hexafluoride (Na₃AlF₆), or the like can be used. In particular, lithium fluoride is preferable because it is easily melted in a heating process described later owing to its relatively low melting point of 848° C.

Magnesium fluoride can be used as both the fluorine source and the magnesium source. Lithium fluoride can be used also as a lithium source. Another example of the lithium source that can be used in Step S21 is lithium carbonate.

The fluorine source may be a gas; for example, fluorine (F₂), carbon fluoride, sulfur fluoride, oxygen fluoride (e.g., OF₂, O₂F₂, O₃F₂, O₄F₂, O₅F₂, O₆F₂, and O₂F), or the like may be used and mixed in the atmosphere in a heating step described later. Two or more of these fluorine sources may be used.

In this embodiment, lithium fluoride (LiF) is prepared as the fluorine source, and magnesium fluoride (MgF₂) is prepared as the fluorine source and the magnesium source. When lithium fluoride (LiF) and magnesium fluoride (MgF₂) are mixed at a molar ratio of approximately 65:35, the effect of lowering the melting point is maximized. Meanwhile, when the proportion of lithium fluoride increases, the cycle performance might deteriorate because of an excessive amount of lithium. Therefore, the molar ratio of lithium fluoride to magnesium fluoride (LiF:MgF₂) is preferably x:1 (0≤x≤1.9), further preferably x:1 (0.1≤x≤0.5), still further preferably x:1 (x=0.33 or an approximate value thereof). Note that in this specification and the like, the expression “an approximate value of a given value” means greater than 0.9 times and smaller than 1.1 times the given value.

### <Step S22>

Next, in Step S22 shown in FIG. 15B, the magnesium source and the fluorine source are ground and mixed. Any of the conditions for the grinding and mixing that are described for Step S12 can be selected to perform Step S22.

### <Step S23>

Next, in Step S23 shown in FIG. 15B, the materials ground and mixed in the above step are collected to give the additive element A source (A source). Note that the additive element A source in Step S23 contains a plurality of starting materials and can be referred to as a mixture.

As for the particle diameter of the mixture, its D50 (median diameter) is preferably greater than or equal to 600 nm and less than or equal to 10 μm, further preferably greater than or equal to 1 μm and less than or equal to 5 μm. Also when one kind of material is used as the additive element source, the D50 (median diameter) is preferably greater than or equal to 600 nm and less than or equal to 10 μm, further preferably greater than or equal to 1 μm and less than or equal to 5 μm.

Such a pulverized mixture (which may contain only one kind of the additive element) is easily attached to the surface of a lithium cobalt oxide particle uniformly in a later step of mixing with the lithium cobalt oxide. The mixture is preferably attached uniformly to the surface of the lithium cobalt oxide particle, in which case an additive element is easily distributed or dispersed uniformly in the surface portion 100a of the composite oxide after heating.

### <Step S21>

A process different from that in FIG. 15B is described with reference to FIG. 15C. In Step S21 shown in FIG. 15C, four kinds of additive element sources to be added to the lithium cobalt oxide are prepared. In other words, FIG. 15C is different from FIG. 15B in the kinds of the additive element sources. A lithium source may be prepared together with the additive element sources.

As the four kinds of additive element sources, a magnesium source (Mg source), a fluorine source (F source), a nickel source (Ni source), and an aluminum source (Al source) are prepared. Note that the magnesium source and the fluorine source can be selected from the compounds and the like described with reference to FIG. 15B. As the nickel source, nickel oxide, nickel hydroxide, or the like can be used. As the aluminum source, aluminum oxide, aluminum hydroxide, or the like can be used.

### <Steps S22 and S23>

Step S22 and Step S23 shown in FIG. 15C are similar to the steps described with reference to FIG. 15B.

### <Step S31>

Next, in Step S31 shown in FIG. 15A, the lithium cobalt oxide and the additive element A source (A source) are mixed. The atomic ratio of cobalt Co in the lithium cobalt oxide containing lithium to magnesium Mg in the additive element A source (Co:Mg) is preferably 100:y (0.1≤y≤6), further preferably 100:y (0.3≤y≤3).

The mixing in Step S31 is preferably performed under milder conditions than the mixing in Step S12, in order not to damage the shapes of the lithium cobalt oxide particles. For example, a condition with a smaller number of rotations or a shorter time than that for the mixing in Step S12 is preferable. Moreover, a dry method is regarded as a milder condition than a wet method. For example, a ball mill or a bead mill can be used for the mixing. When a ball mill is used, zirconium oxide balls are preferably used as a medium, for example.

In this embodiment, the mixing is performed with a ball mill using zirconium oxide balls with a diameter of 1 mm by a dry method at 150 rpm for 1 hour. The mixing is performed in a dry room the dew point of which is higher than or equal to −100° C. and lower than or equal to −10° C.

### <Step S32>

Next, in Step S32 in FIG. 15A, the materials mixed in the above step are collected, whereby a mixture 903 is obtained. At the time of the collection, the materials may be crushed as needed and made to pass through a sieve.

Note that although FIGS. 15A to 15C show the formation method in which addition of the additive element is performed only after the initial heating, the present invention is not limited to the above-described method. Addition of the additive element may be performed at another timing or may be performed a plurality of times. The elements may be added at timings different from each other.

For example, the additive element may be added to the lithium source and the cobalt source in Step S11, i.e., at the stage of the starting materials of the composite oxide. Then, lithium cobalt oxide containing the additive element can be obtained in Step S13. In that case, there is no need to separately perform Steps S11 to S14 and Steps S21 to S23, so that the method is simplified and enables increased productivity.

Alternatively, lithium cobalt oxide that contains some of the additive elements in advance may be used. When lithium cobalt oxide to which magnesium and fluorine are added is used, for example, part of the processes in Steps S11 to S14 and Step S20 can be skipped, so that the method is simplified and enables increased productivity.

Alternatively, after the heating in Step S15, to lithium cobalt oxide to which magnesium and fluorine are added in advance, a magnesium source and a fluorine source, or a magnesium source, a fluorine source, a nickel source, and an aluminum source may be added as in Step S20.

### <Step S33>

Then, in Step S33 shown in FIG. 15A, the mixture 903 is heated. Any of the heating conditions described for Step S13 can be selected. The heating time is preferably longer than or equal to 2 hours.

Here, a supplementary explanation of the heating temperature is provided. The lower limit of the heating temperature in Step S33 needs to be higher than or equal to the temperature at which a reaction between the lithium cobalt oxide and the additive element source proceeds. The temperature at which the reaction proceeds is the temperature at which interdiffusion of the elements included in the lithium cobalt oxide and the additive element source occurs, and may be lower than the melting temperatures of these materials. It is known that in the case of an oxide as an example, solid phase diffusion occurs at the Tamman temperature T_{d} (0.757 times the melting temperature Tₘ). Accordingly, it is only required that the heating temperature in Step S33 be higher than or equal to 650° C.

Needless to say, the reaction more easily proceeds at a temperature higher than or equal to the temperature at which one or more selected from the materials contained in the mixture 903 are melted. For example, in the case where LiF and MgF₂ are included in the additive element source, the lower limit of the heating temperature in Step S33 is preferably higher than or equal to 742° C. because the eutectic point of LiF and MgF₂ is around 742° C.

The mixture 903 obtained by mixing such that LiCoO₂:LiF:MgF₂=100:0.33:1 (molar ratio) exhibits an endothermic peak at around 830° C. in differential scanning calorimetry (DSC) measurement. Therefore, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of the lithium cobalt oxide (1130° C.). At around the decomposition temperature, a slight amount of the lithium cobalt oxide might be decomposed. Thus, the upper limit of the heating temperature is preferably lower than or equal to 1000° C., further preferably lower than or equal to 950° C., still further preferably lower than or equal to 900° C.

In view of the above, the heating temperature in Step S33 is preferably higher than or equal to 650° C. and lower than or equal to 1130° C., further preferably higher than or equal to 650° C. and lower than or equal to 1000° C., still further preferably higher than or equal to 650° C. and lower than or equal to 950° C., yet still further preferably higher than or equal to 650° C. and lower than or equal to 900° C. Furthermore, the heating temperature in Step S33 is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature in Step S33 is preferably higher than or equal to 800° C. and lower than or equal to 1100° C., further preferably higher than or equal to 830° C. and lower than or equal to 1130° C., still further preferably higher than or equal to 830° C. and lower than or equal to 1000° C., yet still further preferably higher than or equal to 830° C. and lower than or equal to 950° C., yet still further preferably higher than or equal to 830° C. and lower than or equal to 900° C. Note that the heating temperature in Step S33 is preferably higher than that in Step S13.

In addition, at the time of heating the mixture 903, the partial pressure of fluorine or a fluoride originating from the fluorine source or the like is preferably controlled to be within an appropriate range.

In the formation method described in this embodiment, some of the materials, e.g., LiF as the fluorine source, function as a fusing agent in some cases. Owing to the material functioning as a fusing agent, the heating temperature can be lower than the decomposition temperature of the lithium cobalt oxide, e.g., higher than or equal to 742° C. and lower than or equal to 950° C., which allows distribution of the additive element such as magnesium in the surface portion and formation of a positive electrode active material having favorable characteristics.

However, since LiF in a gas phase has a specific gravity less than that of oxygen, heating might volatilize LiF and in that case, LiF in the mixture 903 decreases. As a result, the function of a fusing agent deteriorates. Therefore, heating needs to be performed while volatilization of LiF is inhibited. Note that even when LiF is not used as the fluorine source or the like, Li at the surface of LiCoO₂ and F of the fluorine source might react to produce LiF, which might be volatilized. Therefore, such inhibition of volatilization is needed also when a fluoride having a higher melting point than LiF is used.

In view of this, the mixture 903 is preferably heated in an atmosphere containing LiF, i.e., the mixture 903 is preferably heated in a state where the partial pressure of LiF in a heating furnace is high. Such heating can inhibit volatilization of LiF in the mixture 903.

The heating in this step is preferably performed such that the particles of the mixture 903 are not adhered to each other. Adhesion of the particles of the mixture 903 during the heating might decrease the area of contact with oxygen in the atmosphere and inhibit a path of diffusion of the additive element (e.g., fluorine), thereby hindering distribution of the additive element (e.g., magnesium and fluorine) in the surface portion.

It is considered that uniform distribution of the additive element (e.g., fluorine) in the surface portion leads to a smooth positive electrode active material with little unevenness. Thus, it is preferable that the particles of the mixture 903 not be adhered to each other in order to allow the smooth surface obtained through the heating in Step S15 to be maintained or to be smoother in this step.

In the case of using a rotary kiln for the heating, the flow rate of an oxygen-containing atmosphere in the kiln is preferably controlled during the heating. For example, the flow rate of an oxygen-containing atmosphere is preferably set low, or no flowing of an atmosphere is preferably performed after an atmosphere is purged first and an oxygen atmosphere is introduced into the kiln. Flowing of oxygen is not preferable because it might cause evaporation of the fluorine source, which prevents maintaining the smoothness of the surface.

In the case of using a roller hearth kiln for the heating, the mixture 903 can be heated in an atmosphere containing LiF with the container in which the mixture 903 is put covered with a lid.

A supplementary explanation of the heating time is provided. The heating time depends on conditions such as the heating temperature and the particle size and composition of the lithium cobalt oxide in Step S14. The heating may be preferably performed at a lower temperature or for a shorter time in the case where the particle size of the lithium cobalt oxide is small than in the case where the particle size is large.

In the case where the lithium cobalt oxide in Step S14 in FIG. 15A has a median diameter (D50) of approximately 12 μm, the heating temperature is preferably higher than or equal to 650° C. and lower than or equal to 950° C., for example. The heating time is preferably longer than or equal to 3 hours and shorter than or equal to 60 hours, further preferably longer than or equal to 10 hours and shorter than or equal to 30 hours, still further preferably approximately 20 hours, for example. Note that the time for lowering the temperature after the heating is preferably longer than or equal to 10 hours and shorter than or equal to 50 hours, for example.

In the case where the lithium cobalt oxide in Step S14 has a median diameter (D50) of approximately 5 μm, the heating temperature is preferably higher than or equal to 650° C. and lower than or equal to 950° C., for example. The heating time is preferably longer than or equal to 1 hour and shorter than or equal to 10 hours, further preferably approximately 5 hours, for example. Note that the time for lowering the temperature after the heating is preferably longer than or equal to 10 hours and shorter than or equal to 50 hours, for example.

### <Step S34>

Next, the heated material is collected in Step S34 shown in FIG. 15A, in which crushing is performed as needed; thus, the positive electrode active material 100 is obtained. Here, the collected particles are preferably made to pass through a sieve. Through the above process, the positive electrode active material 100 of one embodiment of the present invention can be formed. The positive electrode active material of one embodiment of the present invention has a smooth surface.

### <<Formation Method 2 of Positive Electrode Active Material>>

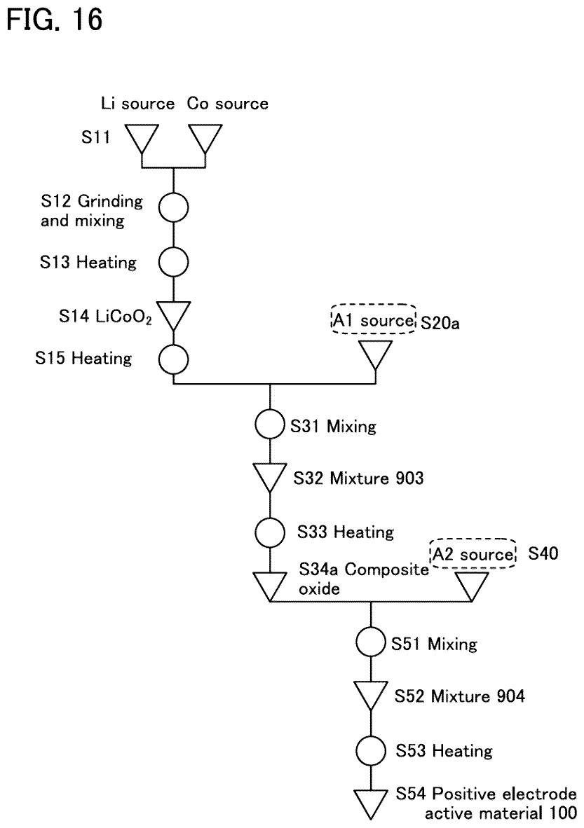

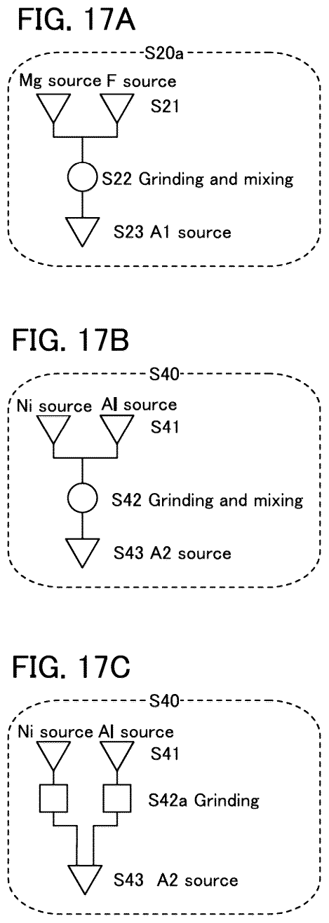

Next, as one embodiment of the present invention, a formation method 2 of a positive electrode active material, which is different from the formation method 1 of a positive electrode active material, is described with reference to FIG. 16 and FIGS. 17A to 17C. The formation method 2 of a positive electrode active material is different from the formation method 1 mainly in the number of times of adding the additive element and a mixing method. For the description except for the above, the description of the formation method 1 of a positive electrode active material can be referred to.

Steps S11 to S15 in FIG. 16 are performed as in FIG. 15A to prepare lithium cobalt oxide that has been subjected to the initial heating.

### <Step S20a>

Next, as shown in Step S20a, an additive element A1 is preferably added to the lithium cobalt oxide that has been subjected to the initial heating.

### <Step S21>

In Step S21 shown in FIG. 17A, a first additive element source is prepared. For the first additive element source, any of the examples of the additive element A described for Step S21 with reference to FIG. 15B can be used. For example, one or more elements selected from magnesium, fluorine, and calcium can be suitably used as the additive element A1. FIG. 17A shows an example ofusing a magnesium source (Mg source) and a fluorine source (F source) as the first additive element source.

Steps S21 to S23 shown in FIG. 17A can be performed under conditions similar to those of Steps S21 to S23 shown in FIG. 15B, whereby an additive element source (A1 source) can be obtained in Step S23.

Steps S31 to S33 shown in FIG. 16 can be performed in a manner similar to that of Steps S31 to S33 shown in FIG. 15A.

### <Step S34a>

Next, the material heated in Step S33 is collected to give lithium cobalt oxide containing the additive element A1. This composite oxide is called a second composite oxide to be distinguished from the composite oxide in Step S14.

### <Step S40>

In Step S40 shown in FIG. 16, an additive element A2 is added. FIGS. 17B and 17C are referred to in the following description.

### <Step S41>

In Step S41 shown in FIG. 17B, a second additive element source is prepared. For the second additive element source, any of the examples of the additive element A described for Step S21 with reference to FIG. 15B can be used. For example, one or more elements selected from nickel, titanium, boron, zirconium, and aluminum can be suitably used as the additive element A2. FIG. 17B shows an example of using a nickel source (Ni source) and an aluminum source (A1 source) as the second additive element source.

Steps S41 to S43 shown in FIG. 17B can be performed under conditions similar to those of Steps S21 to S23 shown in FIG. 15B, whereby an additive element source (A2 source) can be obtained in Step S43.

FIG. 17C shows a modification example of the steps which are described with reference to FIG. 17B. A nickel source (Ni source) and an aluminum source (A1 source) are prepared in Step S41 shown in FIG. 17C and are separately ground in Step S42a. Accordingly, a plurality of second additive element sources (A2 sources) are prepared in Step S43. FIG. 17C is different from FIG. 17B in separately grinding the additive elements in Step S42a.

### <Steps S51 to S53>

Next, Steps S51 to S53 shown in FIG. 16 can be performed under conditions similar to those of Steps S31 to S34 shown in FIG. 15A. The heating in Step S53 can be performed at a lower temperature and for a shorter time than the heating in Step S33. Through the above process, the positive electrode active material 100 of one embodiment of the present invention can be formed in Step S54. The positive electrode active material of one embodiment of the present invention has a smooth surface.

As shown in FIG. 16 and FIGS. 17A to 17C, in the formation method 2, introduction of the additive element to the lithium cobalt oxide is separated into introduction of the additive element A1 and that of the additive element A2. When the elements are separately introduced, the additive elements can have different profiles in the depth direction. For example, the additive element A1 can have a profile such that the concentration is higher in the surface portion than in the inner portion, and the additive element A2 can have a profile such that the concentration is higher in the inner portion than in the surface portion.

The initial heating described in this embodiment makes it possible to obtain a positive electrode active material having a smooth surface.

The initial heating described in this embodiment is performed on lithium cobalt oxide. Thus, the initial heating is preferably performed at a temperature lower than the heating temperature for forming the lithium cobalt oxide and for a time shorter than the heating time for forming the lithium cobalt oxide. The additive element is preferably added to the lithium cobalt oxide after the initial heating. The adding step may be separated into two or more steps. Such an order of steps is preferred in order to maintain the smoothness of the surface achieved by the initial heating.

This embodiment can be implemented in combination with any of the other embodiments.

### Embodiment 3

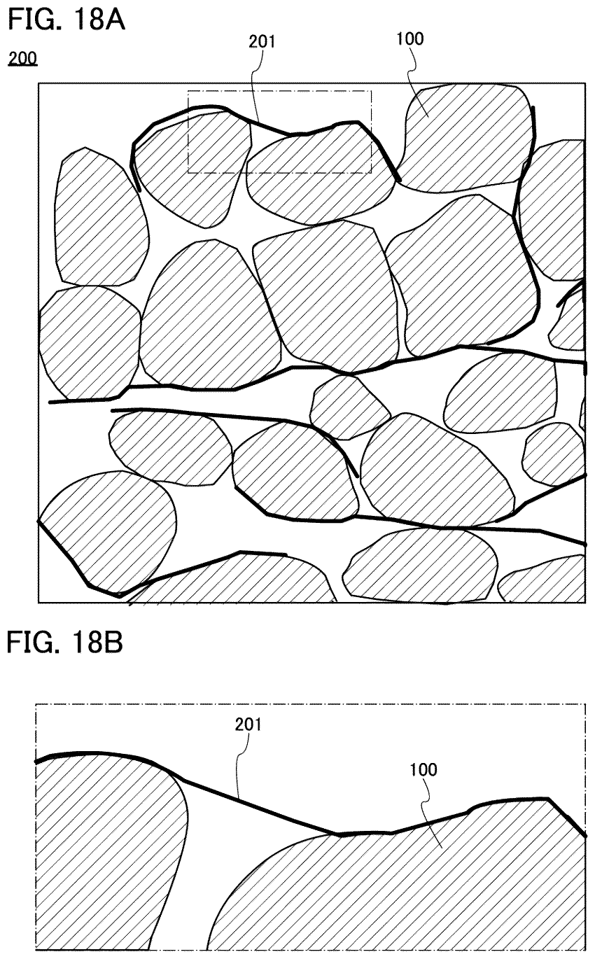

In this embodiment, examples of a secondary battery of one embodiment of the present invention are described with reference to FIGS. 18A and 18B, FIGS. 19A and 19B, FIGS. 20A to 20C, and FIGS. 21A and 21B.

### Structure Example 1 of Secondary Battery

Hereinafter, a secondary battery in which a positive electrode, a negative electrode, and an electrolyte solution are wrapped in an exterior body is described as an example.

### [Positive Electrode]

The positive electrode includes a positive electrode active material layer and a positive electrode current collector. The positive electrode active material layer includes a positive electrode active material, and may include a conductive material (which can be rephrased as a conductive additive) and a binder. As the positive electrode active material, the positive electrode active material formed by the formation method described in the above embodiments is used.

The positive electrode active material described in the above embodiments and another positive electrode active material may be mixed to be used.

Other examples of the positive electrode active material include a composite oxide with an olivine crystal structure, a composite oxide with a layered rock-salt crystal structure, and a composite oxide with a spinel crystal structure. For example, a compound such as LiFePO₄, LiFeO₂, LiNiO₂, LiMn₂O₄, V₂O₅, Cr₂O₅, or MnO₂ can be used.

As another positive electrode active material, it is preferable to add lithium nickel oxide (LiNiO₂ or LiNi₁₋ₓMₓO₂ (0<x<1) (M=Co, Al, or the like)) to a lithium-containing material with a spinel crystal structure which contains manganese, such as LiMn₂O₄, because the characteristics of the secondary battery including such a material can be improved.

Another example of the positive electrode active material is a lithium-manganese composite oxide that can be represented by a composition formula LiₐMn_{b}M_{c}O_{d}. Here, the element M is preferably silicon, phosphorus, or a metal element other than lithium and manganese, further preferably nickel. In the case where the whole particles of a lithium-manganese composite oxide is measured, it is preferable to satisfy the following at the time of discharge: 0<a/(b+c)<2; c>0; and 0.26≤(b+c)/d<0.5. Note that the proportions of metals, silicon, phosphorus, and other elements in the whole particles of a lithium-manganese composite oxide can be measured with, for example, an inductively coupled plasma mass spectrometer (ICP-MS). The proportion of oxygen in the whole particles of a lithium-manganese composite oxide can be measured by, for example, energy dispersive X-ray spectroscopy (EDX). Alternatively, the proportion of oxygen can be measured by ICP-MS combined with fusion gas analysis and valence evaluation of X-ray absorption fine structure (XAFS) analysis. Note that the lithium-manganese composite oxide is an oxide containing at least lithium and manganese, and may contain one or more elements selected from chromium, cobalt, aluminum, nickel, iron, magnesium, molybdenum, zinc, indium, gallium, copper, titanium, niobium, silicon, phosphorus, and the like.

A cross-sectional structure example of an active material layer 200 containing graphene or a graphene compound as a conductive material is described below.

FIG. 18A is a longitudinal cross-sectional view of the active material layer 200. The active material layer 200 includes particles of the positive electrode active material 100, graphene or a graphene compound 201 serving as the conductive material, and a binder (not illustrated).

The graphene compound 201 in this specification and the like refers to multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound is preferably bent. The graphene compound may be rounded like a carbon nanofiber.

In this specification and the like, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of a six-membered ring composed of carbon atoms. The reduced graphene oxide functions by itself and may have a stacked-layer structure. The reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide can function as a conductive material with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive material with high conductivity even with a small amount.

A graphene compound sometimes has excellent electrical characteristics of high conductivity and excellent physical properties of high flexibility and high mechanical strength. A graphene compound has a sheet-like shape. A graphene compound has a curved surface in some cases, thereby enabling low-resistant surface contact. Furthermore, a graphene compound sometimes has extremely high conductivity even with a small thickness, and thus a small amount of a graphene compound efficiently allows a conductive path to be formed in an active material layer. Hence, a graphene compound is preferably used as the conductive material, in which case the area where the active material and the conductive material are in contact with each other can be increased. The graphene compound preferably covers 80% or more of the area of the active material. Note that a graphene compound preferably clings to at least part of an active material particle. Alternatively, a graphene compound preferably overlays at least part of an active material particle. Alternatively, the shape of a graphene compound preferably conforms to at least part of the shape of an active material particle. The shape of an active material particle means, for example, an uneven surface of a single active material particle or an uneven surface formed by a plurality of active material particles. A graphene compound preferably surrounds at least part of an active material particle. A graphene compound may have a hole.

In the case where active material particles with a small diameter (e.g., 1 μm or less) are used, the specific surface area of the active material particles is large and thus more conductive paths for the active material particles are needed. In such a case, it is particularly preferred that a graphene compound that can efficiently form a conductive path even with a small amount be used.

It is particularly effective to use a graphene compound, which has the above-described properties, as a conductive material of a secondary battery that needs to be rapidly charged and discharged. For example, a secondary battery for a two- or four-wheeled vehicle, a secondary battery for a drone, or the like is required to have fast charge and discharge characteristics in some cases. In addition, a mobile electronic device or the like is required to have fast charge characteristics in some cases. Fast charge and discharge are referred to as charge and discharge at, for example, 200 mA/g, 400 mA/g, or 1000 mA/g or more.

The longitudinal cross section of the active material layer 200 in FIG. 18B shows substantially uniform dispersion of the sheet-like graphene or the graphene compound 201 in the active material layer 200. The graphene or the graphene compound 201 is schematically shown by the thick line in FIG. 18B but is actually a thin film having a thickness corresponding to the thickness of a single layer or a multi-layer of carbon molecules. A plurality of sheets of graphene or the plurality of graphene compounds 201 are formed to partly coat or adhere to the surfaces of the plurality of particles of the positive electrode active material 100, so that the plurality of sheets of graphene or the plurality of graphene compounds 201 make surface contact with the particles of the positive electrode active material 100.

Here, the plurality of sheets of graphene or the plurality of graphene compounds can be bonded to each other to form a net-like graphene compound sheet (hereinafter, referred to as a graphene compound net or a graphene net). A graphene net that covers the active material can function as a binder for bonding the active material particles. Accordingly, the amount of the binder can be reduced, or the binder does not have to be used. This can increase the proportion of the active material in the electrode volume and weight. That is to say, the discharge capacity of the secondary battery can be increased.

Here, it is preferable to perform reduction after a layer to be the active material layer 200 is formed in such a manner that graphene oxide is used as the graphene or the graphene compound 201 and mixed with an active material. That is, the formed active material layer preferably contains reduced graphene oxide. When graphene oxide with extremely high dispersibility in a polar solvent is used for the formation of the graphene or the graphene compound 201, the graphene or the graphene compound 201 can be substantially uniformly dispersed in the active material layer 200. The solvent is removed by volatilization from a dispersion medium in which graphene oxide is uniformly dispersed, and the graphene oxide is reduced; hence, the sheets of graphene or the graphene compounds 201 remaining in the active material layer 200 partly overlap with each other and are dispersed such that surface contact is made, thereby forming a three-dimensional conduction path. Note that graphene oxide can be reduced by heat treatment or with the use of a reducing agent, for example.

Unlike a conductive material in the form of particles, such as acetylene black, which makes point contact with an active material, the graphene and the graphene compound 201 are capable of making low-resistance surface contact; accordingly, the electrical conduction between the particles of the positive electrode active material 100 and the graphene or the graphene compound 201 can be improved with a small amount of the graphene or the graphene compound 201 compared with a normal conductive material. Thus, the proportion of the positive electrode active material 100 in the active material layer 200 can be increased, resulting in increased discharge capacity of the secondary battery.

It is possible to form, with a spray dry apparatus, a graphene compound serving as a conductive material as a coating portion to cover the entire surface of the active material in advance and to form a conductive path between the active materials using the graphene compound.

A material used in formation of the graphene compound may be mixed with the graphene compound to be used for the active material layer 200. For example, particles used as a catalyst in formation of the graphene compound may be mixed with the graphene compound. As an example of the catalyst in formation of the graphene compound, particles containing any of silicon oxide (SiO₂ or SiOₓ (x<2)), aluminum oxide, iron, nickel, ruthenium, iridium, platinum, copper, germanium, and the like can be given. The median diameter (D50) of the particles is preferably less than or equal to 1 μm, further preferably less than or equal to 100 nm.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Alternatively, fluororubber can be used as the binder.

As the binder, for example, water-soluble polymers are preferably used. As the water-soluble polymers, a polysaccharide can be used, for example. As the polysaccharide, one or more of starch, cellulose derivatives such as carboxymethyl cellulose (CMC), methyl cellulose, ethyl cellulose, hydroxypropyl cellulose, diacetyl cellulose, and regenerated cellulose, and the like can be used. It is further preferable that such water-soluble polymers be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

At least two of the above materials may be used in combination for the binder.

For example, a material having a significant viscosity modifying effect and another material maybe used in combination. For example, a rubber material or the like has high adhesion and/or high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. An example of a water-soluble polymer having a significant viscosity modifying effect is the above-mentioned polysaccharide; for instance, a cellulose derivative such as carboxymethyl cellulose (CMC), methyl cellulose, ethyl cellulose, hydroxypropyl cellulose, diacetyl cellulose, or regenerated cellulose, starch, or the like can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material and other components in the formation of a slurry for an electrode. In this specification, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, a passivation film refers to a film without electric conductivity or a film with extremely low electric conductivity, and can inhibit the decomposition of an electrolyte solution at a potential at which a battery reaction occurs when the passivation film is formed on the active material surface, for example. It is preferred that the passivation film can conduct lithium ions while suppressing electrical conduction.

### [Current Collector]

The current collector can be formed using a material that has high conductivity, such as a metal like stainless steel, gold, platinum, aluminum, or titanium, or an alloy thereof. It is preferred that a material used for the positive electrode current collector not be eluted at the potential of the positive electrode. It is also possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### [Negative Electrode]

The negative electrode includes a negative electrode active material layer and a negative electrode current collector. The negative electrode active material layer may contain a conductive material and a binder.

### [Negative Electrode Active Material]

As a negative electrode active material, for example, an alloy-based material and/or a carbon-based material can be used.

For the negative electrode active material, an element that enables charge and discharge reactions by an alloying reaction and a dealloying reaction with lithium can be used. For example, a material containing one or more selected from silicon, tin, gallium, aluminum, germanium, lead, antimony, bismuth, silver, zinc, cadmium, indium, and the like can be used. Such elements have higher charge and discharge capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Sᵢ, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by an alloying reaction and a dealloying reaction with lithium, a compound containing the element, and the like may be referred to as an alloy-based material.

In this specification and the like, SiO refers, for example, to silicon monoxide. Note that SiO can alternatively be expressed as SiOₓ. Here, x preferably has an approximate value of 1. For example, x is preferably greater than or equal to 0.2 and less than or equal to 1.5, further preferably greater than or equal to 0.3 and less than or equal to 1.2. Alternatively, x is preferably greater than or equal to 0.2 and less than or equal to 1.2. Still alternatively, x is preferably greater than or equal to 0.3 and less than or equal to 1.5.

As the carbon-based material, graphite, graphitizing carbon (soft carbon), non-graphitizing carbon (hard carbon), carbon nanotube, graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (greater than or equal to 0.05 V and less than or equal to 0.3 V vs. Li/Li⁺) when lithium ions are inserted into graphite (while a lithium-graphite intercalation compound is formed). For this reason, a lithium-ion secondary battery can have a high operating voltage. In addition, graphite is preferred because of its advantages such as a relatively high charge and discharge capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC), niobium pentoxide (Nb₂O₅), tungsten oxide (WO₂), or molybdenum oxide (MoO₂) can be used.

Alternatively, as the negative electrode active material, Li₃-xMₓN (Mis Co, Ni, or Cu) with a Li₃N structure, which is a nitride containing lithium and a transition metal, can be used. For example, Li_{2.6}Co_{0.4}N₃ is preferable because of high charge and discharge capacity (900 mAh/g and 1890 mAh/cm³).

A nitride containing lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. Note that in the case of using a material containing lithium ions as a positive electrode active material, the nitride containing lithium and a transition metal can be used as the negative electrode active material by extracting the lithium ions contained in the positive electrode active material in advance.

Alternatively, a material that causes a conversion reaction can be used for the negative electrode active material; for example, a transition metal oxide that does not form an alloy with lithium, such as cobalt oxide (CoO), nickel oxide (NiO), or iron oxide (FeO), may be used. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive material and the binder that can be included in the negative electrode active material layer, materials similar to those of the conductive material and the binder that can be included in the positive electrode active material layer can be used.

### [Negative Electrode Current Collector]

For the negative electrode current collector, a material similar to that of the positive electrode current collector can be used. Note that a material that is not alloyed with carrier ions of lithium or the like is preferably used for the negative electrode current collector.

### [Electrolyte Solution]

The electrolyte solution contains a solvent and an electrolyte. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination at an appropriate ratio.

Alternatively, the use of one or more ionic liquids (room temperature molten salts) that are unlikely to burn and volatize as the solvent of the electrolyte solution can prevent a secondary battery from exploding and/or catching fire even when the secondary battery internally shorts out or the internal temperature increases owing to overcharge or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), and LiN(C₂F₅SO₂)₂ can be used, or two or more of these lithium salts can be used in an appropriate combination at an appropriate ratio.

The electrolyte solution used for a secondary battery is preferably highly purified and contains a small number of dust particles or elements other than the constituent elements of the electrolyte solution (hereinafter, also simply referred to as impurities). Specifically, the weight ratio of impurities to the electrolyte solution is preferably less than or equal to 1%, further preferably less than or equal to 0.1%, still further preferably less than or equal to 0.01%.

Furthermore, an additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of the material to be added in the whole solvent is, for example, higher than or equal to 0.1 wt % and lower than or equal to 5 wt %. VC and LiBOB are particularly preferable because they facilitate formation of a favorable coating portion.

Alternatively, a polymer gel electrolyte obtained in such a manner that a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP) can be used. The formed polymer may be porous.

Instead of the electrolyte solution, a solid electrolyte including an inorganic material such as a sulfide-based or oxide-based inorganic material, a solid electrolyte including a polymer material such as a polyethylene oxide (PEO)-based polymer material, or the like may alternatively be used. When the solid electrolyte is used, a separator and/or a spacer is/are not necessary. Furthermore, the battery can be entirely solidified; therefore, there is no possibility of liquid leakage and thus the safety of the battery is dramatically improved.

### [Separator]

The secondary battery preferably includes a separator. The separator can be formed using, for example, paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably formed to have an envelope-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charge and discharge at a high voltage can be suppressed and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the discharge capacity per volume of the secondary battery can be increased because the safety of the secondary battery can be maintained even when the total thickness of the separator is small.

### [Exterior Body]

For an exterior body included in the secondary battery, a metal material such as aluminum and/or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

### Structure Example 2 of Secondary Battery

A structure of a secondary battery including a solid electrolyte layer is described below as another structure example of a secondary battery.

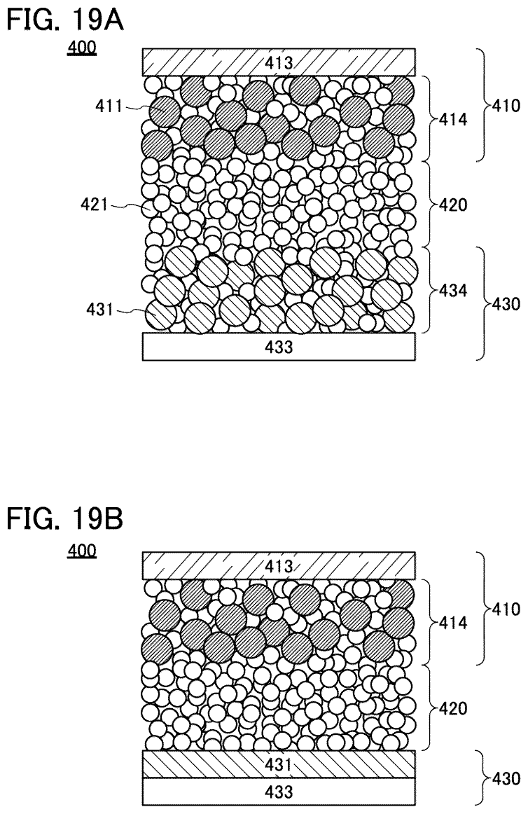

As illustrated in FIG. 19A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. As the positive electrode active material 411, the positive electrode active material formed by the formation method described in the above embodiments is used. The positive electrode active material layer 414 may also include a conductive material and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may also include a conductive material and a binder. Note that when metal lithium is used for the negative electrode 430, it is possible that the negative electrode 430 does not include the solid electrolyte 421 as illustrated in FIG. 19B. The use of metal lithium for the negative electrode 430 is preferable because the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

Examples of the sulfide-based solid electrolyte include a thio-LISICON-based material (e.g., Li₁₀GeP₂S₁₂ and Li_{3.25}Ge_{0.25}P_{0.75}S₄), sulfide glass (e.g., 70Li₂S·30P₂S₅, 30Li₂S·26B₂S₃·44LiI, 63Li₂S·36SiS₂·1Li₃PO₄, 57Li₂S·38SiS₂·5Li₄SiO₄, and 50Li₂S·50GeS₂), and sulfide-based crystallized glass (e.g., Li₇P₃S₁₁ and Li_{3.25}P_{0.95}S₄). The sulfide-based solid electrolyte has advantages such as high conductivity of some materials, low-temperature synthesis, and ease of maintaining a path for electrical conduction after charge and discharge because of its relative softness.

Examples of the oxide-based solid electrolyte include a material with a perovskite crystal structure (e.g., La_{2/3-x}Li₃ₓTiO₃), a material with a NASICON crystal structure (e.g., Li₁₋ₓAlₓTi₂₋ₓ(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO₄·50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide and/or porous silica are filled with such a halide-based solid electrolyte can be used as the solid electrolyte.

Alternatively, different solid electrolytes may be mixed and used.

In particular, Li₁₊ₓAlₓTi₂₋ₓ(PO₄)₃(0<x<1) having a NASICON crystal structure (hereinafter, LATP) is preferable because LATP contains aluminum and titanium, each of which is the element the positive electrode active material used in the secondary battery 400 of one embodiment of the present invention is allowed to contain, and thus a synergistic effect of improving the cycle performance is expected. Moreover, higher productivity due to the reduction in the number of steps is expected. Note that in this specification and the like, a material having a NASICON crystal structure refers to a compound that is represented by M₂(XO₄)₃ (M:transition metal; X: S, P, As, Mo, W, or the like) and has a structure in which MO₆ octahedrons and XO₄ tetrahedrons that share common corners are arranged three-dimensionally.

### [Exterior Body and Shape of Secondary Battery]

An exterior body of the secondary battery 400 of one embodiment of the present invention can be formed using a variety of materials and have a variety of shapes, and preferably has a function of applying pressure to the positive electrode, the solid electrolyte layer, and the negative electrode.

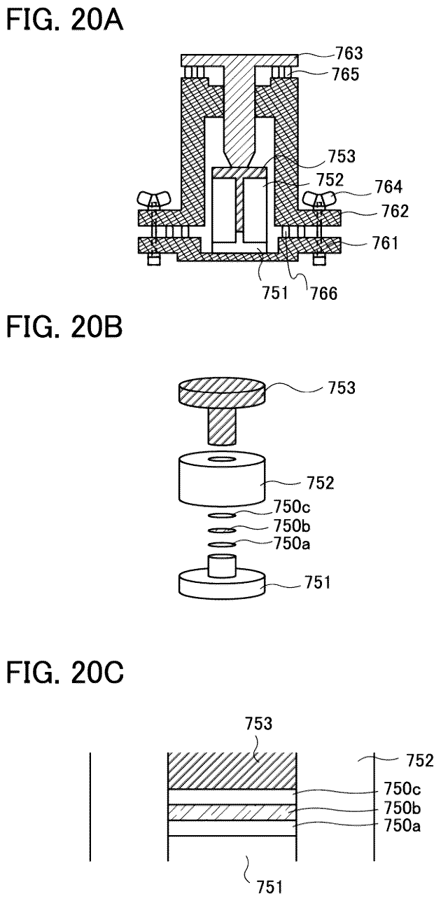

FIGS. 20A to 20C show an example of a cell for evaluating materials of an all-solid-state battery.

FIG. 20A is a schematic cross-sectional view of the evaluation cell. The evaluation cell includes a lower component 761, an upper component 762, and a fixation screw or a butterfly nut 764 for fixing these components. By rotating a pressure screw 763, an electrode plate 753 is pressed to fix an evaluation material. An insulator 766 is provided between the lower component 761 and the upper component 762 that are made of a stainless steel material. An O ring 765 for hermetic sealing is provided between the upper component 762 and the pressure screw 763.

The evaluation material is placed on an electrode plate 751, surrounded by an insulating tube 752, and pressed from above by the electrode plate 753. FIG. 20B is an enlarged perspective view of the evaluation material and its vicinity.

A stack of a positive electrode 750a, a solid electrolyte layer 750b, and a negative electrode 750c is shown here as an example of the evaluation material, and its cross section is shown in FIG. 20C. Note that the same portions in FIGS. 20A to 20C are denoted by the same reference numerals.

The electrode plate 751 and the lower component 761 that are electrically connected to the positive electrode 750a correspond to a positive electrode terminal. The electrode plate 753 and the upper component 762 that are electrically connected to the negative electrode 750c correspond to a negative electrode terminal. The electric resistance or the like can be measured while pressure is applied to the evaluation material through the electrode plate 751 and the electrode plate 753.

The exterior body of the secondary battery of one embodiment of the present invention is preferably a package having excellent airtightness. For example, a ceramic package and/or a resin package can be used. The exterior body is sealed preferably in a closed atmosphere where the outside air is blocked, for example, in a glove box.

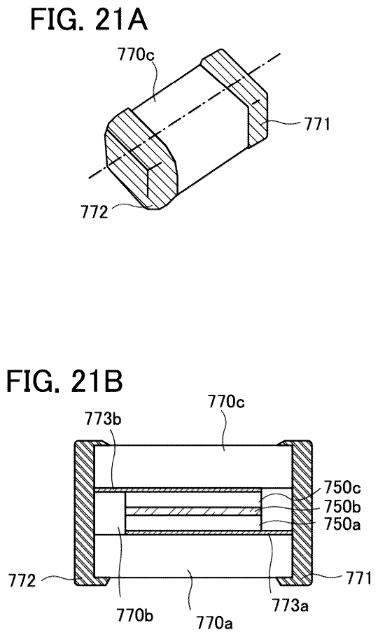

FIG. 21A is a perspective view of a secondary battery of one embodiment of the present invention that has an exterior body and a shape different from those in FIGS. 20A to 20C. The secondary battery in FIG. 21A includes external electrodes 771 and 772 and is sealed with an exterior body including a plurality of package components.

FIG. 21B illustrates an example of a cross section along the dashed-dotted line in FIG. 21A. A stack including the positive electrode 750a, the solid electrolyte layer 750b, and the negative electrode 750c is surrounded and sealed by a package component 770a including an electrode layer 773a on a flat plate, a frame-like package component 770b, and a package component 770c including an electrode layer 773b on a flat plate. For the package components 770a, 770b, and 770c, an insulating material, e.g., a resin material and/or ceramic, can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

This embodiment can be implemented in appropriate combination with any of the other embodiments.

### Embodiment 4

In this embodiment, examples of the shape of a secondary battery including the positive electrode described in the above embodiment are described. For the materials used for the secondary battery described in this embodiment, refer to the description of the above embodiment.

### <Coin-Type Secondary Battery>

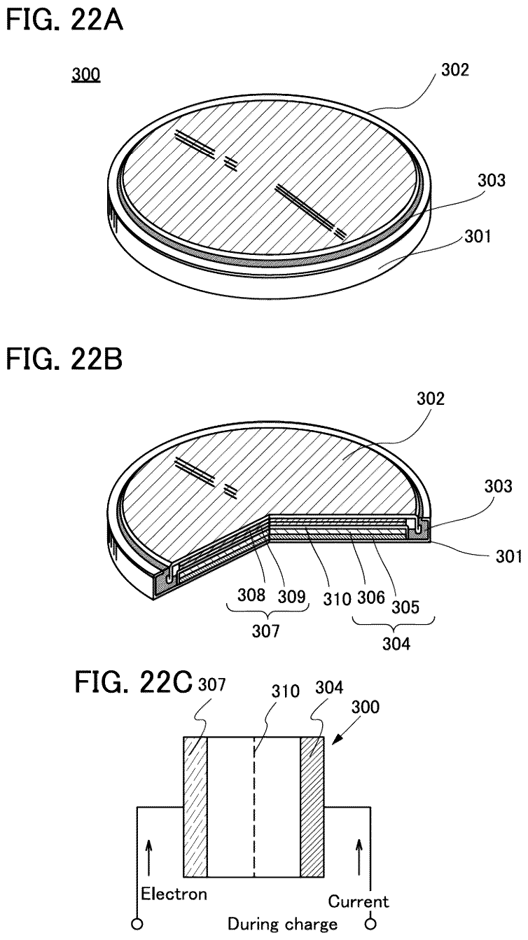

First, an example of a coin-type secondary battery is described. FIG. 22A is an external view of a coin-type (single-layer flat-type) secondary battery, and FIG. 22B is a cross-sectional view thereof. Coin-type secondary batteries are mainly used in small electronic devices. In this specification and the like, coin-type batteries include button-type batteries.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, and/or an alloy of such a metal and another metal (e.g., stainless steel) can be used. The positive electrode can 301 and the negative electrode can 302 are preferably covered with nickel and/or aluminum, for example, in order to prevent corrosion due to the electrolyte solution. The positive electrode can 301 and the negative electrode can 302 are electrically connected to the positive electrode 304 and the negative electrode 307, respectively.

The negative electrode 307, the positive electrode 304, and a separator 310 are immersed in the electrolyte solution. Then, as illustrated in FIG. 22B, the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 located therebetween. In this manner, the coin-type secondary battery 300 is fabricated.

When the positive electrode active material described in the above embodiment is used in the positive electrode 304, the coin-type secondary battery 300 can have high discharge capacity and excellent cycle performance.

Here, a current flow in charging a secondary battery is described with reference to FIG. 22C. When a secondary battery including lithium is regarded as a closed circuit, lithium ions transfer and a current flows in the same direction. Note that in the secondary battery including lithium, an anode and a cathode change places in charge and discharge, and an oxidation reaction and a reduction reaction occur on the corresponding sides; hence, an electrode with a high reaction potential is called a positive electrode and an electrode with a low reaction potential is called a negative electrode. For this reason, in this specification, the positive electrode is referred to as a “positive electrode” or a “plus electrode” and the negative electrode is referred to as a “negative electrode” or a “minus electrode” in all the cases where charge is performed, discharge is performed, a reverse pulse current is supplied, and a charge current is supplied. The use of the terms “anode” and “cathode”, which are related to an oxidation reaction and a reduction reaction, might cause confusion because the anode and the cathode change places at the time of charge and discharge. Therefore, the terms “anode” and “cathode” are not used in this specification. If the term “anode” or “cathode” is used, whether it is at the time of charge and discharge is noted, as well as whether the term corresponds to a positive (plus) electrode or a negative (minus) electrode.

A charger is connected to the two terminals in FIG. 22C, and the secondary battery 300 is charged. As the charge of the secondary battery 300 proceeds, a potential difference between the electrodes increases.

### <Cylindrical Secondary Battery>

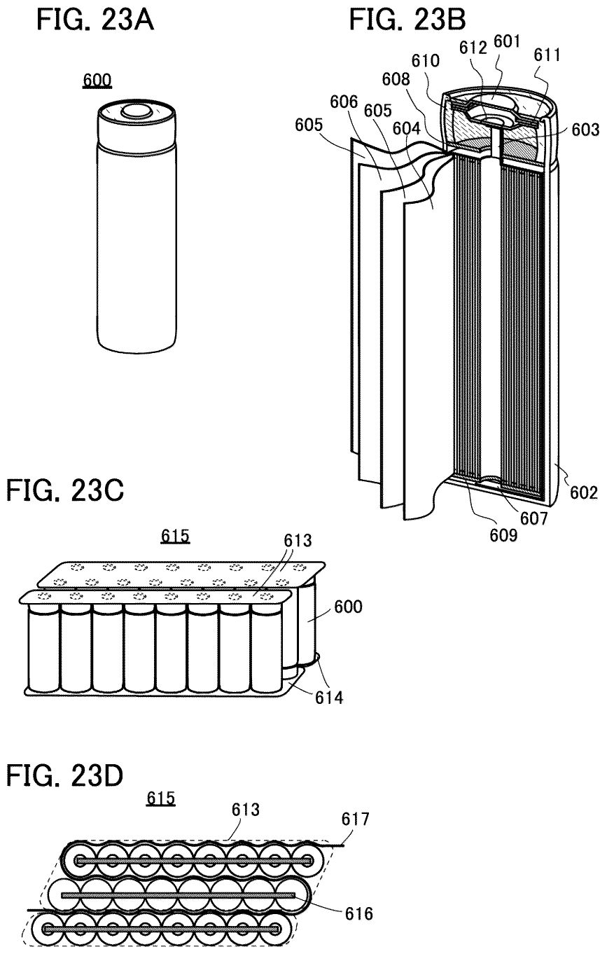

Next, an example of a cylindrical secondary battery is described with reference to FIGS. 23A to 23D. FIG. 23A is an external view of a cylindrical secondary battery 600. FIG. 23B is a schematic cross-sectional view of the cylindrical secondary battery 600. As illustrated in FIG. 23B, the cylindrical secondary battery 600 includes a positive electrode cap (battery lid) 601 on the top surface and a battery can (outer can) 602 on the side and bottom surfaces. The positive electrode cap 601 and the battery can (outer can) 602 are insulated from each other by a gasket (insulating gasket) 610.

Inside the battery can 602 having a hollow cylindrical shape, a battery element in which a strip-like positive electrode 604 and a strip-like negative electrode 606 are wound with a strip-like separator 605 located therebetween is provided. Although not illustrated, the battery element is wound around a center pin. One end of the battery can 602 is close and the other end thereof is open. For the battery can 602, a metal having corrosion resistance to an electrolyte solution, such as nickel, aluminum, or titanium, an alloy of such a metal, and/or an alloy of such a metal and another metal (e.g., stainless steel) can be used. The battery can 602 is preferably covered with nickel and/or aluminum, for example, in order to prevent corrosion due to the electrolyte solution. Inside the battery can 602, the battery element in which the positive electrode, the negative electrode, and the separator are wound is provided between a pair of insulating plates 608 and 609 that face each other. Furthermore, the inside of the battery can 602 provided with the battery element is filled with a nonaqueous electrolyte solution (not illustrated). As the nonaqueous electrolyte solution, an electrolyte solution similar to that for the coin-type secondary battery can be used.

Since the positive electrode and the negative electrode of the cylindrical storage battery are wound, active materials are preferably formed on both sides of the current collectors. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a positive temperature coefficient (PTC) element 611. The safety valve mechanism 612 cuts off electrical connection between the positive electrode cap 601 and the positive electrode 604 when the internal pressure of the battery exceeds a predetermined threshold value. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

As illustrated in FIG. 23C, a plurality of secondary batteries 600 may be sandwiched between a conductive plate 613 and a conductive plate 614 to form a module 615. The plurality of secondary batteries 600 may be connected in parallel, connected in series, or connected in series after being connected in parallel. With the module 615 including the plurality of secondary batteries 600, large electric power can be extracted.

FIG. 23D is a top view of the module 615. The conductive plate 613 is shown by the dotted line for clarity of the drawing. As illustrated in FIG. 23D, the module 615 may include a conductive wire 616 that electrically connects the plurality of secondary batteries 600 to each other. The conductive plate can be provided over the conductive wire 616 to overlap each other. In addition, a temperature control device 617 may be provided between the plurality of secondary batteries 600. The secondary batteries 600 can be cooled with the temperature control device 617 when overheated, whereas the secondary batteries 600 can be heated with the temperature control device 617 when cooled too much. Thus, the performance of the module 615 is unlikely to be influenced by the outside temperature. A heating medium included in the temperature control device 617 preferably has an insulating property and incombustibility.

When the positive electrode active material described in the above embodiment is used in the positive electrode 604, the cylindrical secondary battery 600 can have high discharge capacity and excellent cycle performance.

### <Structure Example of Power Storage Device Including Secondary Battery>

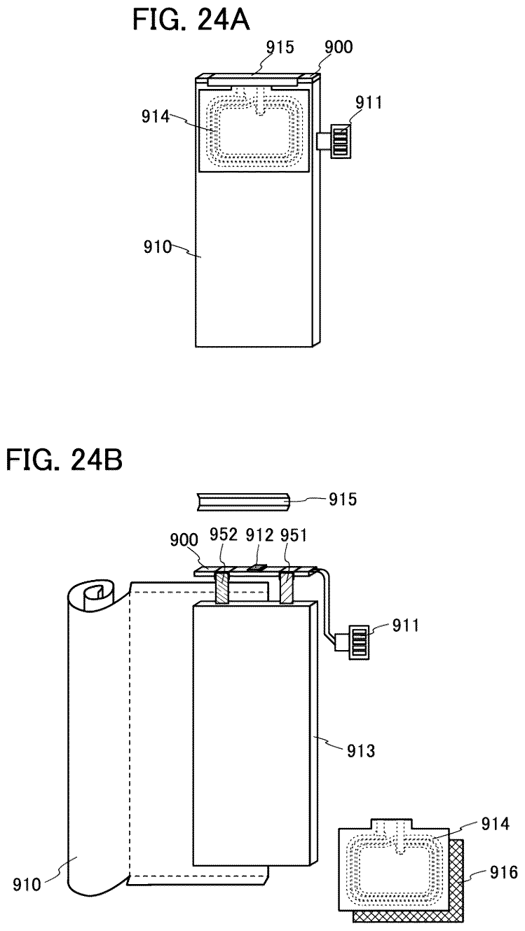

Other structure examples of a power storage device including a secondary battery are described with reference to FIGS. 24A and 24B, FIGS. 25A to 25D, FIGS. 26A and 26B, FIG. 27, and FIGS. 28A to 28C.

FIGS. 24A and 24B are external views of a battery pack. The battery pack includes a secondary battery 913 and a circuit board 900. The secondary battery 913 is connected to an antenna 914 through the circuit board 900. A label 910 is attached to the secondary battery 913. In addition, as illustrated in FIG. 24B, the secondary battery 913 is connected to a terminal 951 and a terminal 952. The circuit board 900 is fixed by a sealant 915.

The circuit board 900 includes a terminal 911 and a circuit 912. The terminal 911 is connected to the terminals 951 and 952, the antenna 914, and the circuit 912. Note that a plurality of terminals 911 may be provided to serve separately as a control signal input terminal, a power supply terminal, and the like.

The circuit 912 may be provided on the rear surface of the circuit board 900. Note that the shape of the antenna 914 is not limited to a coil shape and may be a linear shape or a plate shape. Furthermore, a planar antenna, an aperture antenna, a traveling-wave antenna, an EH antenna, a magnetic-field antenna, a dielectric antenna, or the like may be used. Alternatively, the antenna 914 may be a flat-plate conductor. The flat-plate conductor can serve as one of conductors for electric field coupling. That is, the antenna 914 can serve as one of two conductors of a capacitor. Thus, electric power can be transmitted and received not only by an electromagnetic field or a magnetic field but also by an electric field.

The battery pack includes a layer 916 between the secondary battery 913 and the antenna 914. The layer 916 has a function of blocking an electromagnetic field from the secondary battery 913, for example. As the layer 916, for example, a magnetic body can be used.

Note that the structure of the battery pack is not limited to that shown in FIGS. 24A and 24B.

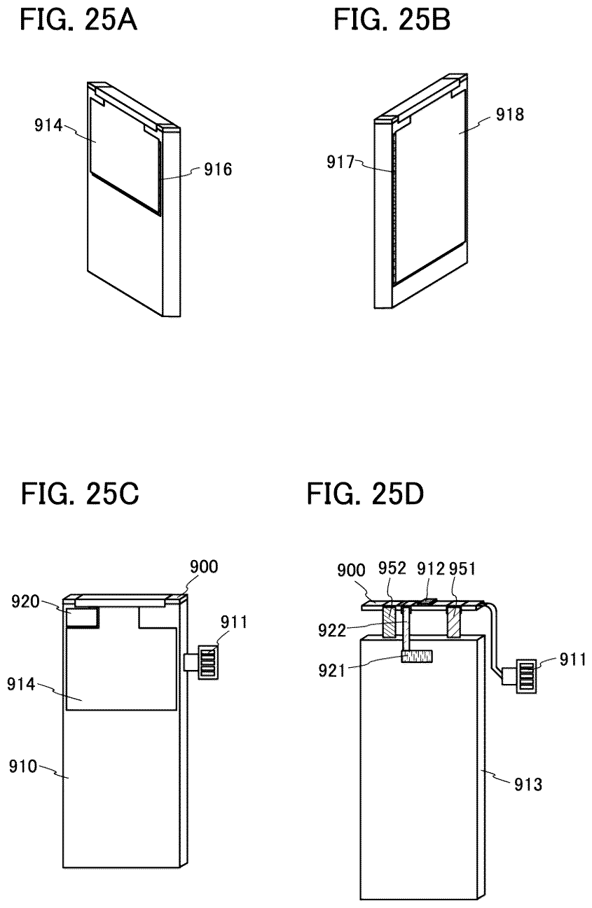

For example, as shown in FIGS. 25A and 25B, two opposite surfaces of the secondary battery 913 in FIGS. 24A and 24B may be provided with respective antennas. FIG. 25A is an external view illustrating one of the two surfaces, and FIG. 25B is an external view illustrating the other of the two surfaces. For portions identical to those in FIGS. 24A and 24B, refer to the description of the secondary battery illustrated in FIGS. 24A and 24B as appropriate.

As illustrated in FIG. 25A, the antenna 914 is provided on one of the opposite surfaces of the secondary battery 913 with the layer 916 located therebetween. As illustrated in FIG. 25B, an antenna 918 is provided on the other of the opposite surfaces of the secondary battery 913 with a layer 917 located therebetween. The layer 917 has a function of blocking an electromagnetic field from the secondary battery 913, for example. As the layer 917, for example, a magnetic body can be used.

With the above structure, both of the antennas 914 and 918 can be increased in size. The antenna 918 has a function of communicating data with an external device, for example. An antenna with a shape that can be used for the antenna 914, for example, can be used as the antenna 918. As a system for communication using the antenna 918 between the secondary battery and another device, a response method that can be used between the secondary battery and another device, such as near field communication (NFC), can be employed.

Alternatively, as illustrated in FIG. 25C, the secondary battery 913 in FIGS. 24A and 24B may be provided with a display device 920. The display device 920 is electrically connected to the terminal 911. Note that the label 910 is not necessarily provided in a portion where the display device 920 is provided. For portions identical to those in FIGS. 24A and 24B, refer to the description of the secondary battery illustrated in FIGS. 24A and 24B as appropriate.

The display device 920 can display, for example, an image showing whether charge is being carried out, an image showing the amount of stored power, or the like. As the display device 920, electronic paper, a liquid crystal display device, or an electroluminescent (EL) display device can be used, for instance. For example, the use of electronic paper can reduce power consumption of the display device 920.

Alternatively, as illustrated in FIG. 25D, the secondary battery 913 in FIGS. 24A and 24B may be provided with a sensor 921. The sensor 921 is electrically connected to the terminal 911 via a terminal 922. For portions identical to those in FIGS. 24A and 24B, refer to the description of the secondary battery illustrated in FIGS. 24A and 24B as appropriate.

The sensor 921 has a function of measuring, for example, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays. With the sensor 921, for example, data on an environment where the secondary battery is placed (e.g., temperature) can be acquired and stored in a memory inside the circuit 912.

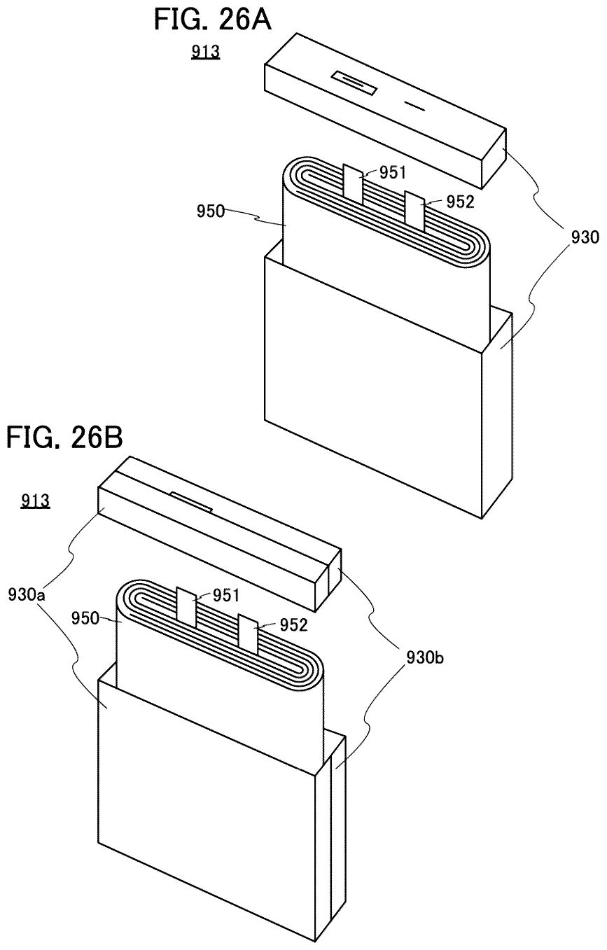

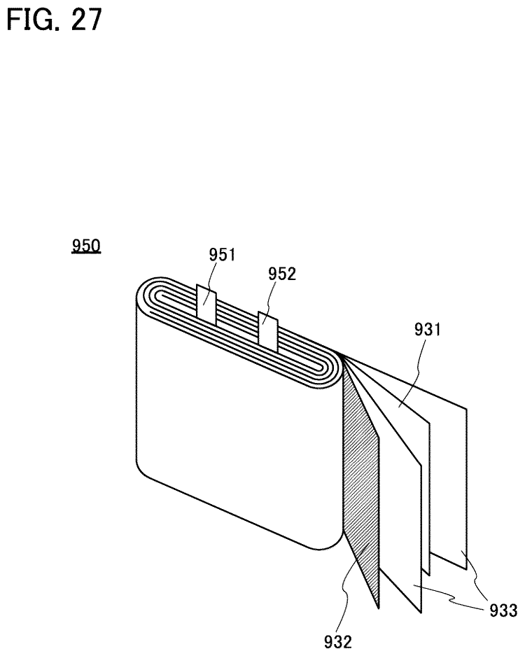

Another structure example of the secondary battery 913 is described with reference to FIGS. 26A and 26B and FIG. 27.

The secondary battery 913 illustrated in FIG. 26A includes a wound body 950 provided with the terminals 951 and 952 inside a housing 930. The wound body 950 is immersed in an electrolyte solution inside the housing 930. The terminal 952 is in contact with the housing 930. An insulator or the like prevents contact between the terminal 951 and the housing 930. Note that in FIG. 26A, the housing 930 divided into two pieces is illustrated for convenience; however, in the actual structure, the wound body 950 is covered with the housing 930 and the terminals 951 and 952 extend to the outside of the housing 930. For the housing 930, a metal material (e.g., aluminum) or a resin material can be used.

Note that as illustrated in FIG. 26B, the housing 930 in FIG. 26A may be formed using a plurality of materials. For example, in the secondary battery 913 in FIG. 26B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna such as the antenna 914 may be provided inside the housing 930a. For the housing 930b, a metal material can be used, for example.

FIG. 27 illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with the separator 933 therebetween. Note that a plurality of stacks each including the negative electrode 931, the positive electrode 932, and the separators 933 may be overlaid.

The negative electrode 931 is connected to the terminal 911 in FIGS. 24A and 24B via one of the terminals 951 and 952. The positive electrode 932 is connected to the terminal 911 in FIGS. 24A and 24B via the other of the terminals 951 and 952.

When the positive electrode active material described in the above embodiment is used in the positive electrode 932, the secondary battery 913 can have high discharge capacity and excellent cycle performance.

### <Laminated Secondary Battery>

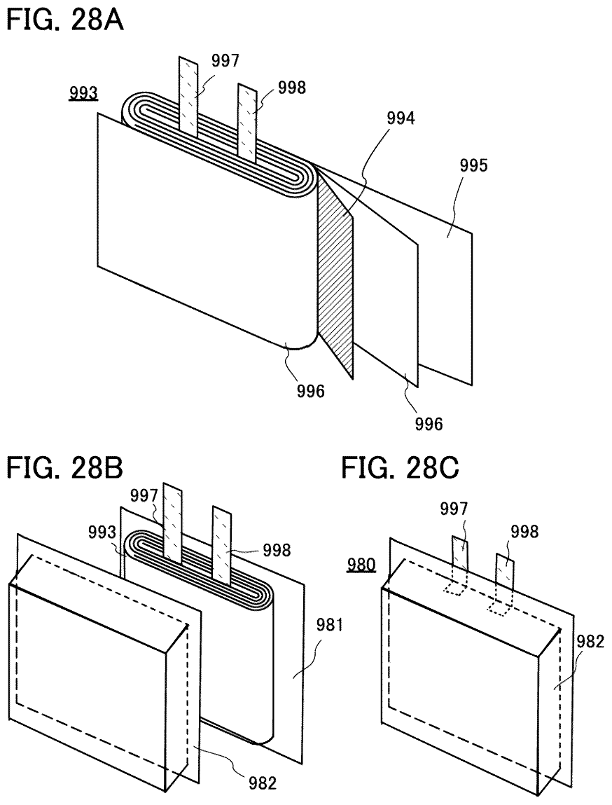

Next, examples of a laminated secondary battery are described with reference to FIGS. 28A to 28C, FIGS. 29A and 29B, FIG. 30, FIG. 31, and FIG. 32A. When a laminated secondary battery has flexibility and is used in an electronic device at least part of which is flexible, the secondary battery can be bent accordingly as the electronic device is bent.

A laminated secondary battery 980 is described with reference to FIGS. 28A to 28C. The laminated secondary battery 980 includes a wound body 993 illustrated in FIG. 28A. The wound body 993 includes a negative electrode 994, a positive electrode 995, and separators 996. The wound body 993 is, like the wound body 950 illustrated in FIG. 27, obtained by winding a sheet of a stack in which the negative electrode 994 and the positive electrode 995 overlap with the separator 996 therebetween.

Note that the number of stacks each including the negative electrode 994, the positive electrode 995, and the separator 996 can be determined as appropriate depending on required charge and discharge capacity and element volume. The negative electrode 994 is connected to a negative electrode current collector (not illustrated) via one of a lead electrode 997 and a lead electrode 998. The positive electrode 995 is connected to a positive electrode current collector (not illustrated) via the other of the lead electrode 997 and the lead electrode 998.

As illustrated in FIG. 28B, the wound body 993 is placed in a space formed by bonding a film 981 and a film 982 having a depression by thermocompression bonding or the like, whereby the secondary battery 980 can be formed as illustrated in FIG. 28C. Note that the film 981 and the film 982 serve as an exterior body. The wound body 993 includes the lead electrode 997 and the lead electrode 998, and is immersed in an electrolyte solution inside a space surrounded by the film 981 and the film 982 having a depression.

For the film 981 and the film 982 having a depression, a metal material such as aluminum and/or a resin material can be used, for example. With the use of a resin material for the film 981 and the film 982 having a depression, the film 981 and the film 982 having a depression can be changed in their forms when external force is applied; thus, a flexible storage battery can be fabricated.

Although FIGS. 28B and 28C illustrate an example in which a space is formed by the two films, the wound body 993 may be placed in a space formed by bending one film.

When the positive electrode active material described in the above embodiment is used in the positive electrode 995, the secondary battery 980 can have high discharge capacity and excellent cycle performance.

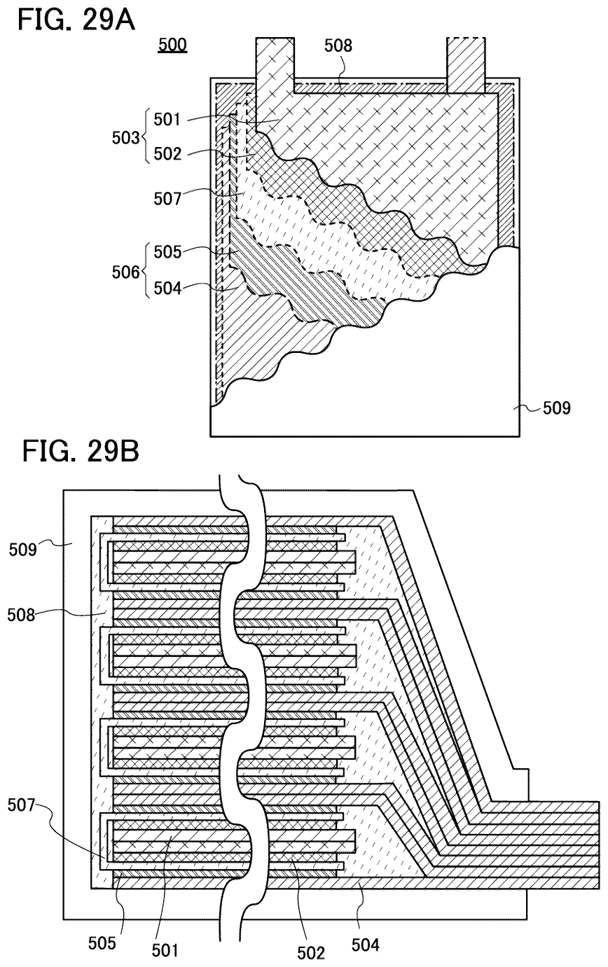

FIGS. 28A to 28C illustrate an example of the secondary battery 980 including a wound body in a space formed by films serving as an exterior body; alternatively, as illustrated in FIGS. 29A and 29B, a secondary battery may include a plurality of strip-shaped positive electrodes, a plurality of strip-shaped separators, and a plurality of strip-shaped negative electrodes in a space formed by films serving as an exterior body, for example.

A laminated secondary battery 500 illustrated in FIG. 29A includes a positive electrode 503 including a positive electrode current collector 501 and a positive electrode active material layer 502, a negative electrode 506 including a negative electrode current collector 504 and a negative electrode active material layer 505, a separator 507, an electrolyte solution 508, and an exterior body 509. The separator 507 is provided between the positive electrode 503 and the negative electrode 506 in the exterior body 509. The inside of the exterior body 509 is filled with the electrolyte solution 508. The electrolyte solution described in Embodiment 3 can be used as the electrolyte solution 508.

In the laminated secondary battery 500 illustrated in FIG. 29A, the positive electrode current collector 501 and the negative electrode current collector 504 also serve as terminals for obtaining electrical contact with the outside. For this reason, the positive electrode current collector 501 and the negative electrode current collector 504 may be arranged to be partly exposed to the outside of the exterior body 509. Alternatively, a lead electrode and the positive electrode current collector 501 or the negative electrode current collector 504 may be bonded to each other by ultrasonic welding, and instead of the positive electrode current collector 501 and the negative electrode current collector 504, the lead electrode may be exposed to the outside of the exterior body 509.

As the exterior body 509 in the laminated secondary battery 500, a laminate film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body can be used, for example.

FIG. 29B illustrates an example of a cross-sectional structure of the laminated secondary battery 500. Although FIG. 29A illustrates an example in which two current collectors are included for simplicity, an actual battery includes a plurality of electrode layers as illustrated in FIG. 29B.

In FIG. 29B, the number of electrode layers is 16, for example. The laminated secondary battery 500 has flexibility even though including 16 electrode layers. FIG. 29B illustrates a structure including eight layers of negative electrode current collectors 504 and eight layers of positive electrode current collectors 501, i.e., 16 layers in total. Note that FIG. 29B illustrates a cross section of the lead portion of the negative electrode, and the eight negative electrode current collectors 504 are bonded to each other by ultrasonic welding. It is needless to say that the number of electrode layers is not limited to 16 and maybe greater than 16 or less than 16. With a large number of electrode layers, the secondary battery can have high discharge capacity. By contrast, with a small number of electrode layers, the secondary battery can have a small thickness and high flexibility.

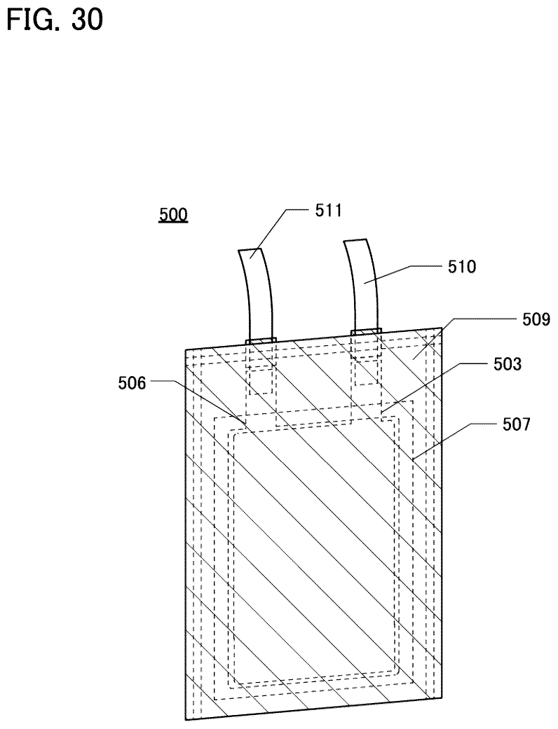

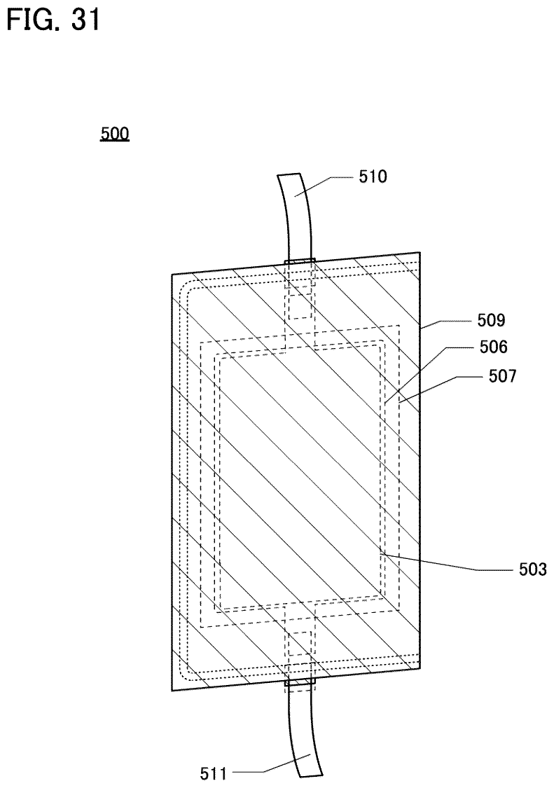

FIG. 30 and FIG. 31 illustrate examples of an external view of the laminated secondary battery 500. FIG. 30 and FIG. 31 illustrate the positive electrode 503, the negative electrode 506, the separator 507, the exterior body 509, a positive electrode lead electrode 510, and a negative electrode lead electrode 511.

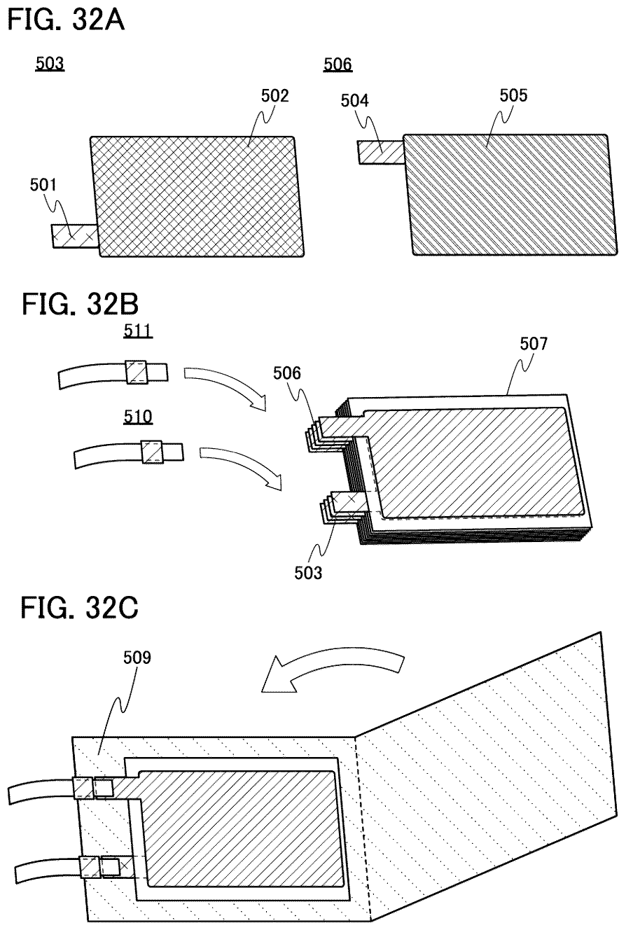

FIG. 32A illustrates external views of the positive electrode 503 and the negative electrode 506. The positive electrode 503 includes the positive electrode current collector 501, and the positive electrode active material layer 502 is formed on a surface of the positive electrode current collector 501. The positive electrode 503 also includes a region where the positive electrode current collector 501 is partly exposed (hereinafter, referred to as a tab region). The negative electrode 506 includes the negative electrode current collector 504, and the negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to those in the example illustrated in FIG. 32A.

### <Method for Fabricating Laminated Secondary Battery>

Here, an example of a method for fabricating the laminated secondary battery whose external view is illustrated in FIG. 30 is described with reference to FIGS. 32B and 32C.

First, the negative electrode 506, the separator 507, and the positive electrode 503 are stacked. FIG. 32B illustrates the stacked negative electrodes 506, separators 507, and positive electrodes 503. The secondary battery described here as an example includes five negative electrodes and four positive electrodes. Next, the tab regions of the positive electrodes 503 are bonded to each other, and the tab region of the positive electrode on the outermost surface and the positive electrode lead electrode 510 are bonded to each other. The bonding can be performed by ultrasonic welding, for example. In a similar manner, the tab regions of the negative electrodes 506 are bonded to each other, and the tab region of the negative electrode on the outermost surface and the negative electrode lead electrode 511 are bonded to each other.

Then, the negative electrodes 506, the separators 507, and the positive electrodes 503 are placed over the exterior body 509.

Subsequently, the exterior body 509 is folded along the dashed line as illustrated in FIG. 32C. Then, the outer edges of the exterior body 509 are bonded to each other. The bonding can be performed by thermocompression, for example. At this time, a part (or one side) of the exterior body 509 is left unbonded (to provide an inlet) so that the electrolyte solution 508 can be introduced later.

Next, the electrolyte solution 508 (not illustrated) is introduced into the exterior body 509 from the inlet of the exterior body 509. The electrolyte solution 508 is preferably introduced in a reduced pressure atmosphere or in an inert atmosphere. Lastly, the inlet is sealed by bonding. In this manner, the laminated secondary battery 500 can be fabricated.

When the positive electrode active material described in the above embodiment is used in the positive electrode 503, the secondary battery 500 can have high discharge capacity and excellent cycle performance.

In an all-solid-state battery, the contact state of the inside interface can be kept favorable by applying a predetermined pressure in the direction of stacking positive electrodes and negative electrodes. By applying a predetermined pressure in the direction of stacking the positive electrodes and the negative electrodes, the amount of expansion of the all-solid-state battery in the stacking direction due to charge and discharge can be suppressed, and the reliability of the all-solid-state battery can be improved.

This embodiment can be implemented in appropriate combination with any of the other embodiments.

### Embodiment 5

In this embodiment, examples of electronic devices each including the secondary battery of one embodiment of the present invention are described.

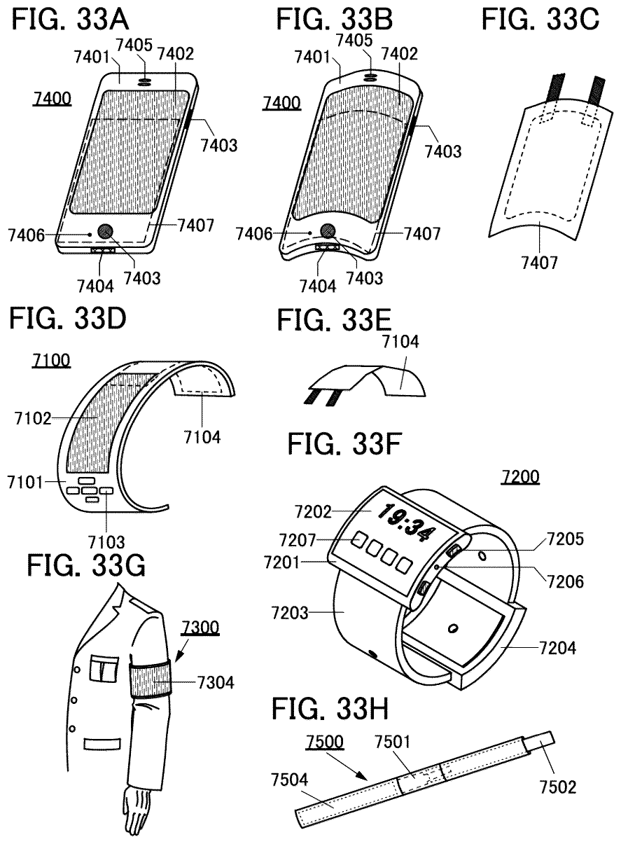

FIGS. 33A to 33G show examples of electronic devices including the bendable secondary battery described in the above embodiment. Examples of electronic devices including a bendable secondary battery include television sets (also referred to as televisions or television receivers), monitors of computers and the like, digital cameras, digital video cameras, digital photo frames, mobile phones (also referred to as cellular phones or mobile phone devices), portable game machines, portable information terminals, audio reproducing devices, and large game machines such as pachinko machines.

A flexible secondary battery can also be incorporated along a curved inside/outside wall surface of a house, a building, or the like or a curved interior/exterior surface of an automobile.

FIG. 33A illustrates an example of a mobile phone. A mobile phone 7400 is provided with a display portion 7402 incorporated in a housing 7401, operation buttons 7403, an external connection port 7404, a speaker 7405, a microphone 7406, and the like. The mobile phone 7400 includes a secondary battery 7407. By using the secondary battery of one embodiment of the present invention as the secondary battery 7407, a lightweight long-life mobile phone can be provided.

FIG. 33B illustrates the mobile phone 7400 in a state of being bent. When the whole mobile phone 7400 is bent by the external force, the secondary battery 7407 included in the mobile phone 7400 is also bent. FIG. 33C illustrates the secondary battery 7407 that is being bent at that time. The secondary battery 7407 is a thin storage battery. The secondary battery 7407 is fixed in a state of being bent. The secondary battery 7407 includes a lead electrode electrically connected to a current collector. The current collector is, for example, copper foil and is partly alloyed with gallium; thus, adhesion between the current collector and an active material layer in contact with the current collector is improved and the secondary battery 7407 can have high reliability even in a state of being bent.

FIG. 33D illustrates an example of a bangle-type display device. A portable display device 7100 includes a housing 7101, a display portion 7102, operation buttons 7103, and a secondary battery 7104. FIG. 33E illustrates the secondary battery 7104 that is being bent. When the display device is worn on a user's arm while the secondary battery 7104 is bent, the housing changes its shape and the curvature of part or the whole of the secondary battery 7104 is changed. Note that the radius of curvature of a curve at a point refers to the radius of the circular arc that best approximates the curve at that point. The reciprocal of the radius of curvature is curvature. Specifically, part or the whole of the housing or the main surface of the secondary battery 7104 is changed with a radius of curvature in the range of 40 mm to 150 mm. When the radius of curvature of the main surface of the secondary battery 7104 ranges from 40 mm to 150 mm, the reliability can be kept high. By using the secondary battery of one embodiment of the present invention as the secondary battery 7104, a lightweight long-life portable display device can be provided.

FIG. 33F illustrates an example of a watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, an application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by the operating system incorporated in the portable information terminal 7200.

The portable information terminal 7200 can employ near field communication based on an existing communication standard. For example, mutual communication between the portable information terminal 7200 and a headset capable of wireless communication can be performed, and thus hands-free calling is possible.

Moreover, the portable information terminal 7200 includes the input/output terminal 7206, and data can be directly transmitted to and received from another information terminal via a connector. In addition, charge via the input/output terminal 7206 is possible. Note that the charging operation may be performed by wireless power feeding without using the input/output terminal 7206.

The display portion 7202 of the portable information terminal 7200 includes the secondary battery of one embodiment of the present invention. With the use of the secondary battery of one embodiment of the present invention, a lightweight long-life portable information terminal can be provided. For example, the secondary battery 7104 in FIG. 33E that is in the state of being curved can be provided in the housing 7201. Alternatively, the secondary battery 7104 in FIG. 33E can be provided in the band 7203 such that it can be curved.

The portable information terminal 7200 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 33G illustrates an example of an armband display device. A display device 7300 includes a display portion 7304 and the secondary battery of one embodiment of the present invention. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication based on an existing communication standard.

The display device 7300 includes an input/output terminal, and data can be directly transmitted to and received from another information terminal via a connector. In addition, charge via the input/output terminal is possible. Note that the charging operation may be performed by wireless power feeding without using the input/output terminal.

By using the secondary battery of one embodiment of the present invention as the secondary battery included in the display device 7300, a lightweight long-life display device can be provided.

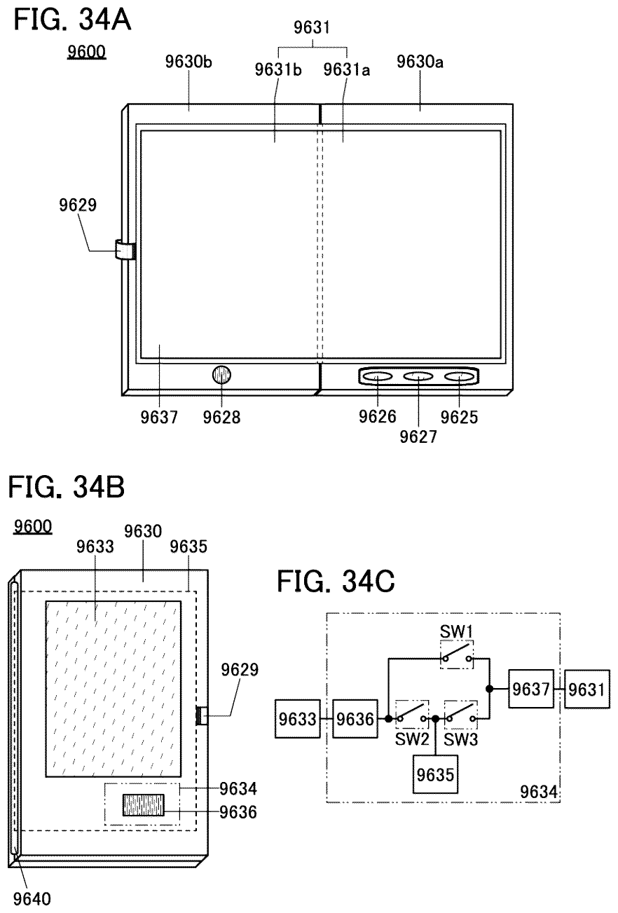

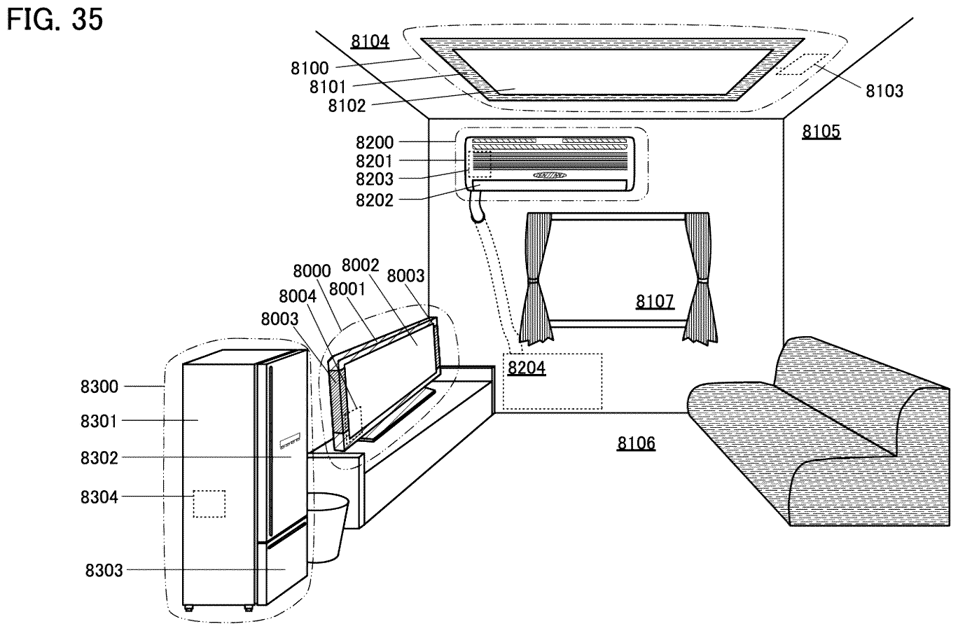

Examples of electronic devices each including the secondary battery with excellent cycle performance described in the above embodiment are described with reference to FIG. 33H, FIGS. 34A to 34C, and FIG. 35.

By using the secondary battery of one embodiment of the present invention as a secondary battery of a daily electronic device, a lightweight long-life product can be provided. Examples of daily electronic devices include an electric toothbrush, an electric shaver, and electric beauty equipment. As secondary batteries for these products, small and lightweight stick-type secondary batteries with high discharge capacity are desired in consideration of handling ease for users.

FIG. 33H is a perspective view of a device called a vaporizer (electronic cigarette). In FIG. 33H, an electronic cigarette 7500 includes an atomizer 7501 including a heating element, a secondary battery 7504 that supplies power to the atomizer, and a cartridge 7502 including a liquid supply bottle, a sensor, and the like. To improve safety, a protection circuit that prevents overcharge and/or overdischarge of the secondary battery 7504 may be electrically connected to the secondary battery 7504. The secondary battery 7504 in FIG. 33H includes an external terminal for connection to a charger. When the electronic cigarette 7500 is held by a user, the secondary battery 7504 is at the tip of the device; thus, it is preferred that the secondary battery 7504 have a short total length and be lightweight. With the secondary battery of one embodiment of the present invention, which has high discharge capacity and excellent cycle performance, the small and lightweight electronic cigarette 7500 that can be used for a long time over a long period can be provided.

Next, FIGS. 34A and 34B illustrate an example of a tablet terminal that can be folded in half A tablet terminal 9600 illustrated in FIGS. 34A and 34B includes a housing 9630a, a housing 9630b, a movable portion 9640 connecting the housings 9630a and 9630b, a display portion 9631 including a display portion 9631a and a display portion 9631b, switches 9625 to 9627, a fastener 9629, and an operation switch 9628. The use of a flexible panel for the display portion 9631 achieves a tablet terminal with a larger display portion. FIG. 34A illustrates the tablet terminal 9600 that is opened, and FIG. 34B illustrates the tablet terminal 9600 that is closed.

The tablet terminal 9600 includes a power storage unit 9635 inside the housings 9630a and 9630b. The power storage unit 9635 is provided across the housings 9630a and 9630b, passing through the movable portion 9640.

Part of or the entire display portion 9631 can be a touch panel region, and data can be input by touching text, an input form, an image including an icon, and the like displayed on the region. For example, it is possible that keyboard buttons are displayed on the entire display portion 9631a on the housing 9630a side, and data such as text and an image is displayed on the display portion 9631b on the housing 9630b side.

It is also possible that a keyboard is displayed on the display portion 9631b on the housing 9630b side, and data such as text or an image is displayed on the display portion 9631a on the housing 9630a side. Furthermore, a switching button for showing/hiding a keyboard on a touch panel may be displayed on the display portion 9631 so that the keyboard is displayed on the display portion 9631 by touching the button with a finger, a stylus, or the like.

In addition, touch input can be performed concurrently in a touch panel region in the display portion 9631a on the housing 9630a side and a touch panel region in the display portion 9631b on the housing 9630b side.

The switches 9625 to 9627 may function not only as an interface for operating the tablet terminal 9600 but also as an interface that can switch various functions. For example, one or more selected from the switches 9625 to 9627 may have a function of switching on/off of the tablet terminal 9600. For another example, one or more selected from the switches 9625 to 9627 may have a function of switching display between a portrait mode and a landscape mode and a function of switching display between monochrome display and color display. For another example, one or more selected from the switches 9625 to 9627 may have a function of adjusting the luminance of the display portion 9631. The luminance of the display portion 9631 can be optimized in accordance with the amount of external light in use of the tablet terminal 9600, which is detected by an optical sensor incorporated in the tablet terminal 9600. Note that in addition to the optical sensor, the tablet terminal may incorporate another sensing device such as a sensor for measuring inclination, like a gyroscope sensor or an acceleration sensor.

The display portion 9631a on the housing 9630a side and the display portion 9631b on the housing 9630b side have substantially the same display area in FIG. 34A; however, there is no particular limitation on the display areas of the display portions 9631a and 9631b, and the display portions may have different areas or different display quality. For example, one of the display portions 9631a and 9631b may display higher-definition images than the other.

The tablet terminal 9600 is folded in half in FIG. 34B. The tablet terminal 9600 includes a housing 9630, a solar cell 9633, and a charge/discharge control circuit 9634 including a DC-DC converter 9636. The power storage unit of one embodiment of the present invention is used as the power storage unit 9635.

As described above, the tablet terminal 9600 can be folded in half such that the housings 9630a and 9630b overlap with each other when not in use. Accordingly, the display portion 9631 can be protected, which increases the durability of the tablet terminal 9600. With the power storage unit 9635 including the secondary battery of one embodiment of the present invention, which has high discharge capacity and excellent cycle performance, the tablet terminal 9600 capable of being used for a long time over a long period can be provided.

The tablet terminal 9600 illustrated in FIGS. 34A and 34B can also have a function of displaying various kinds of data (e.g., a still image, a moving image, and a text image), a function of displaying a calendar, a date, the time, or the like on the display portion, a touch input function of operating or editing data displayed on the display portion by touch input, a function of controlling processing by various kinds of software (programs), and the like.

The solar cell 9633, which is attached on the surface of the tablet terminal 9600, supplies electric power to the touch panel, the display portion, a video signal processing portion, and the like. Note that the solar cell 9633 can be provided on one or both surfaces of the housing 9630, and the power storage unit 9635 can be charged efficiently. The use of a lithium-ion battery as the power storage unit 9635 brings an advantage such as a reduction in size.

The structure and operation of the charge/discharge control circuit 9634 illustrated in FIG. 34B are described with reference to a block diagram in FIG. 34C. FIG. 34C illustrates the solar cell 9633, the power storage unit 9635, the DC-DC converter 9636, a converter 9637, switches SW1 to SW3, and the display portion 9631. The power storage unit 9635, the DC-DC converter 9636, the converter 9637, and the switches SW1 to SW3 correspond to the charge/discharge control circuit 9634 in FIG. 34B.

First, an operation example in which electric power is generated by the solar cell 9633 using external light is described. The voltage of electric power generated by the solar cell is raised or lowered by the DC-DC converter 9636 to a voltage for charging the power storage unit 9635. When the display portion 9631 operates with the electric power from the solar cell 9633, the switch SW1 is turned on and the voltage of the electric power is raised or lowered by the converter 9637 to a voltage needed for the display portion 9631. When display on the display portion 9631 is not performed, the switch SW1 is turned off and the switch SW2 is turned on, so that the power storage unit 9635 can be charged.

Note that the solar cell 9633 is described as an example of a power generation unit; however, one embodiment of the present invention is not limited to this example. The power storage unit 9635 may be charged using another power generation unit such as a piezoelectric element or a thermoelectric conversion element (Peltier element). For example, the power storage unit 9635 may be charged with a non-contact power transmission module that transmits and receives electric power wirelessly (without contact), or with a combination of such a module with another charging unit.

FIG. 35 illustrates other examples of electronic devices. In FIG. 35, a display device 8000 is an example of an electronic device including a secondary battery 8004 of one embodiment of the present invention. Specifically, the display device 8000 corresponds to a display device for TV broadcast reception and includes a housing 8001, a display portion 8002, speaker portions 8003, the secondary battery 8004, and the like. The secondary battery 8004 of one embodiment of the present invention is provided in the housing 8001. The display device 8000 can receive electric power from a commercial power supply. Alternatively, the display device 8000 can use electric power stored in the secondary battery 8004. Thus, the display device 8000 can operate with the use of the secondary battery 8004 of one embodiment of the present invention as an uninterruptible power supply even when electric power cannot be supplied from a commercial power supply due to power failure or the like.

A semiconductor display device such as a liquid crystal display device, a light-emitting device in which a light-emitting element such as an organic EL element is provided in each pixel, an electrophoresis display device, a digital micromirror device (DMD), a plasma display panel (PDP), or a field emission display (FED) can be used for the display portion 8002.

Note that the display device includes, in its category, all of information display devices for personal computers, advertisement displays, and the like besides TV broadcast reception.

In FIG. 35, an installation lighting device 8100 is an example of an electronic device including a secondary battery 8103 of one embodiment of the present invention. Specifically, the lighting device 8100 includes a housing 8101, a light source 8102, the secondary battery 8103, and the like. Although FIG. 35 illustrates the case where the secondary battery 8103 is provided in a ceiling 8104 on which the housing 8101 and the light source 8102 are installed, the secondary battery 8103 may be provided in the housing 8101. The lighting device 8100 can receive electric power from a commercial power supply. Alternatively, the lighting device 8100 can use electric power stored in the secondary battery 8103. Thus, the lighting device 8100 can operate with the use of the secondary battery 8103 of one embodiment of the present invention as an uninterruptible power supply even when electric power cannot be supplied from a commercial power supply due to power failure or the like.

Note that although the installation lighting device 8100 provided in the ceiling 8104 is illustrated as an example in FIG. 35, the secondary battery of one embodiment of the present invention can be used in an installation lighting device provided in, for example, a wall 8105, a floor 8106, a window 8107, or the like other than the ceiling 8104. Alternatively, the secondary battery can be used in a tabletop lighting device or the like.

As the light source 8102, an artificial light source that emits light artificially by using electric power can be used. Specific examples of the artificial light source include an incandescent lamp, a discharge lamp such as a fluorescent lamp, and light-emitting elements such as an LED and an organic EL element.

In FIG. 35, an air conditioner including an indoor unit 8200 and an outdoor unit 8204 is an example of an electronic device including a secondary battery 8203 of one embodiment of the present invention. Specifically, the indoor unit 8200 includes a housing 8201, an air outlet 8202, the secondary battery 8203, and the like. Although FIG. 35 illustrates the case where the secondary battery 8203 is provided in the indoor unit 8200, the secondary battery 8203 may be provided in the outdoor unit 8204. Alternatively, the secondary batteries 8203 may be provided in both the indoor unit 8200 and the outdoor unit 8204. The air conditioner can receive electric power from a commercial power supply. Alternatively, the air conditioner can use electric power stored in the secondary battery 8203. Particularly in the case where the secondary batteries 8203 are provided in both the indoor unit 8200 and the outdoor unit 8204, the air conditioner can operate with the use of the secondary batteries 8203 of one embodiment of the present invention as uninterruptible power supplies even when electric power cannot be supplied from a commercial power supply due to power failure or the like.

Note that although the split-type air conditioner including the indoor unit and the outdoor unit is illustrated as an example in FIG. 35, the secondary battery of one embodiment of the present invention can also be used in an air conditioner in which the functions of an indoor unit and an outdoor unit are integrated in one housing.

In FIG. 35, an electric refrigerator-freezer 8300 is an example of an electronic device including a secondary battery 8304 of one embodiment of the present invention. Specifically, the electric refrigerator-freezer 8300 includes a housing 8301, a refrigerator door 8302, a freezer door 8303, the secondary battery 8304, and the like. The secondary battery 8304 is provided inside the housing 8301 in FIG. 35. The electric refrigerator-freezer 8300 can receive electric power from a commercial power supply. Alternatively, the electric refrigerator-freezer 8300 can use electric power stored in the secondary battery 8304. Thus, the electric refrigerator-freezer 8300 can operate with the use of the secondary battery 8304 of one embodiment of the present invention as an uninterruptible power supply even when electric power cannot be supplied from a commercial power supply due to power failure or the like.

Note that among the electronic devices described above, a high-frequency heating apparatus such as a microwave oven and an electronic device such as an electric rice cooker require high power in a short time. The tripping of a breaker of a commercial power supply in use of such an electronic device can be prevented by using the secondary battery of one embodiment of the present invention as an auxiliary power supply for supplying electric power which cannot be supplied enough by a commercial power supply.

In addition, by storing electric power in the secondary battery in a time period during which electronic devices are not used, particularly a time period during which the proportion of the amount of electric power that is actually used to the total amount of electric power that can be supplied from a commercial power supply (such a proportion is referred to as an electricity usage rate) is low, the electricity usage rate can be reduced in a time period other than the above. For example, in the case of the electric refrigerator-freezer 8300, electric power is stored in the secondary battery 8304 in night time when the temperature is low and the refrigerator door 8302 and the freezer door 8303 are not often opened or closed. On the other hand, in daytime when the temperature is high and the refrigerator door 8302 and the freezer door 8303 are frequently opened and closed, the secondary battery 8304 is used as an auxiliary power supply; thus, the electricity usage rate in daytime can be reduced.

According to one embodiment of the present invention, the secondary battery can have excellent cycle performance and improved reliability. Moreover, according to one embodiment of the present invention, a secondary battery with high discharge capacity can be obtained; hence, the secondary battery itself can be made more compact and lightweight as a result of improved characteristics of the secondary battery. Thus, the use of the secondary battery of one embodiment of the present invention enables the electronic device described in this embodiment to be more lightweight and have a longer lifetime.

This embodiment can be implemented in appropriate combination with any of the other embodiments.

### Embodiment 6

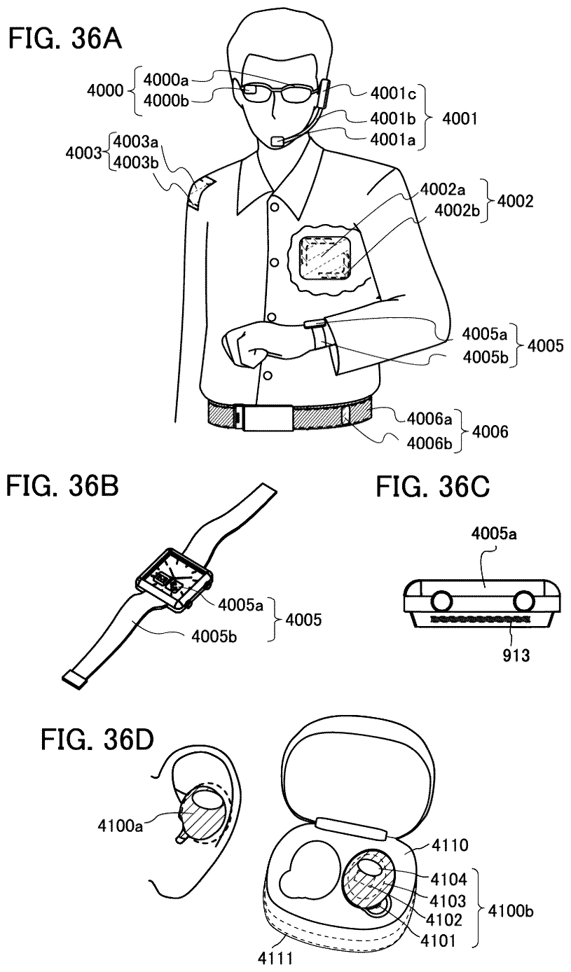

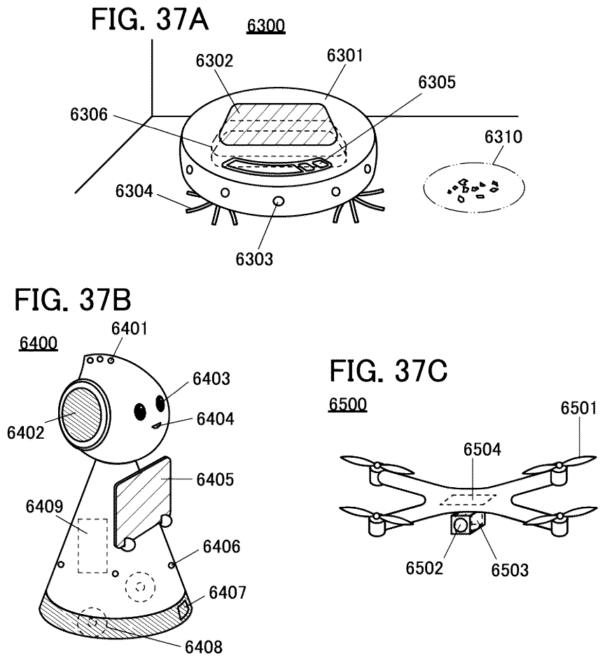

In this embodiment, examples of electronic devices each including the secondary battery described in the above embodiment are described with reference to FIGS. 36A to 36D and FIGS. 37A to 37C.

FIG. 36A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 36A. The glasses-type device 4000 includes a frame 4000a and a display part 4000b. The secondary battery is provided in a temple of the frame 4000a having a curved shape, whereby the glasses-type device 4000 can be lightweight, can have a well-balanced weight, and can be used continuously for a long time. With the use of the secondary battery of one embodiment of the present invention, space saving required with downsizing of a housing can be achieved.

The secondary battery of one embodiment of the present invention can be provided in a headset-type device 4001. The headset-type device 4001 includes at least a microphone part 4001a, a flexible pipe 4001b, and an earphone portion 4001c. The secondary battery can be provided in the flexible pipe 4001b and/or the earphone portion 4001c. With the use of the secondary battery of one embodiment of the present invention, space saving required with downsizing of a housing can be achieved.

The secondary battery of one embodiment of the present invention can be provided in a device 4002 that can be attached directly to a body. A secondary battery 4002b can be provided in a thin housing 4002a of the device 4002. With the use of the secondary battery of one embodiment of the present invention, space saving required with downsizing of a housing can be achieved.

The secondary battery of one embodiment of the present invention can be provided in a device 4003 that can be attached to clothes. A secondary battery 4003b can be provided in a thin housing 4003a of the device 4003. With the use of the secondary battery of one embodiment of the present invention, space saving required with downsizing of a housing can be achieved.

The secondary battery of one embodiment of the present invention can be provided in a belt-type device 4006. The belt-type device 4006 includes a belt portion 4006a and a wireless power feeding and receiving portion 4006b, and the secondary battery can be provided inside the belt portion 4006a. With the use of the secondary battery of one embodiment of the present invention, space saving required with downsizing of a housing can be achieved.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. With the use of the secondary battery of one embodiment of the present invention, space saving required with downsizing of a housing can be achieved.

The display portion 4005a can display various kinds of information such as time and reception information of an e-mail or an incoming call.

In addition, the watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 36B is a perspective view of the watch-type device 4005 that is detached from an arm.

FIG. 36C is a side view. FIG. 36C illustrates a state where the secondary battery 913 is incorporated in the watch-type device 4005. The secondary battery 913 is the secondary battery described in Embodiment 4. The secondary battery 913, which is small and lightweight, overlaps with the display portion 4005a.

FIG. 36D illustrates an example of wireless earphones. The wireless earphones shown as an example consist of, but not limited to, a pair of earphone bodies 4100a and 4100b.

Each of the earphone bodies 4100a and 4100b includes a driver unit 4101, an antenna 4102, and a secondary battery 4103. Each of the earphone bodies 4100a and 4100b may also include a display portion 4104. Moreover, each of the earphone bodies 4100a and 4100b preferably includes a substrate where a circuit such as a wireless IC is provided, a terminal for charge, and the like. Each of the earphone bodies 4100a and 4100b may also include a microphone.

A case 4110 includes a secondary battery 4111. Moreover, the case 4110 preferably include a substrate where a circuit such as a wireless IC or a charge control IC is provided, and a terminal for charge. The case 4110 may also include a display portion, a button, and the like.

The earphone bodies 4100a and 4100b can communicate wirelessly with another electronic device such as a smartphone. Thus, sound data and the like transmitted from another electronic device can be played through the earphone bodies 4100a and 4100b. When the earphone bodies 4100a and 4100b include a microphone, sound captured by the microphone is transmitted to another electronic device, and sound data obtained by processing with the electronic device can be transmitted to and played through the earphone bodies 4100a and 4100b. Hence, the wireless earphones can be used as a translator, for example.

The secondary battery 4103 included in the earphone body 4100a can be charged by the secondary battery 4111 included in the case 4110. As the secondary battery 4111 and the secondary battery 4103, the coin-type secondary battery or the cylindrical secondary battery of the foregoing embodiment, for example, can be used. A secondary battery whose positive electrode includes the positive electrode active material 100 obtained in Embodiment 1 has a high energy density; thus, with the use of the secondary battery as the secondary battery 4103 and the secondary battery 4111, space saving required with downsizing of the wireless earphones can be achieved.

FIG. 37A illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object that is likely to be caught in the brush 6304 (e.g., a wire) by image analysis, the rotation of the brush 6304 can be stopped. The cleaning robot 6300 further includes a secondary battery 6306 of one embodiment of the present invention and a semiconductor device or an electronic component. The cleaning robot 6300 including the secondary battery 6306 of one embodiment of the present invention can be a highly reliable electronic device that can operate for a long time.

FIG. 37B illustrates an example of a robot. A robot 6400 illustrated in FIG. 37B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with a user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes the secondary battery 6409 of one embodiment of the present invention and a semiconductor device or an electronic component. The robot 6400 including the secondary battery of one embodiment of the present invention can be a highly reliable electronic device that can operate for a long time.

FIG. 37C illustrates an example of a flying object. A flying object 6500 illustrated in FIG. 37C includes propellers 6501, a camera 6502, a secondary battery 6503, and the like and has a function of flying autonomously.

For example, image data taken by the camera 6502 is stored in an electronic component 6504. The electronic component 6504 can analyze the image data to detect whether there is an obstacle in the way of the movement. Moreover, the electronic component 6504 can estimate the remaining battery level from a change in the power storage capacity of the secondary battery 6503. The flying object 6500 further includes the secondary battery 6503 of one embodiment of the present invention. The flying object 6500 including the secondary battery of one embodiment of the present invention can be a highly reliable electronic device that can operate for a long time.

This embodiment can be implemented in appropriate combination with any of the other embodiments.

### Embodiment 7

In this embodiment, examples of vehicles each including the secondary battery of one embodiment of the present invention are described.

The use of secondary batteries in vehicles enables production of next-generation clean energy vehicles such as hybrid vehicles (HEV), electric vehicles (EV), and plug-in hybrid vehicles (PHEV).

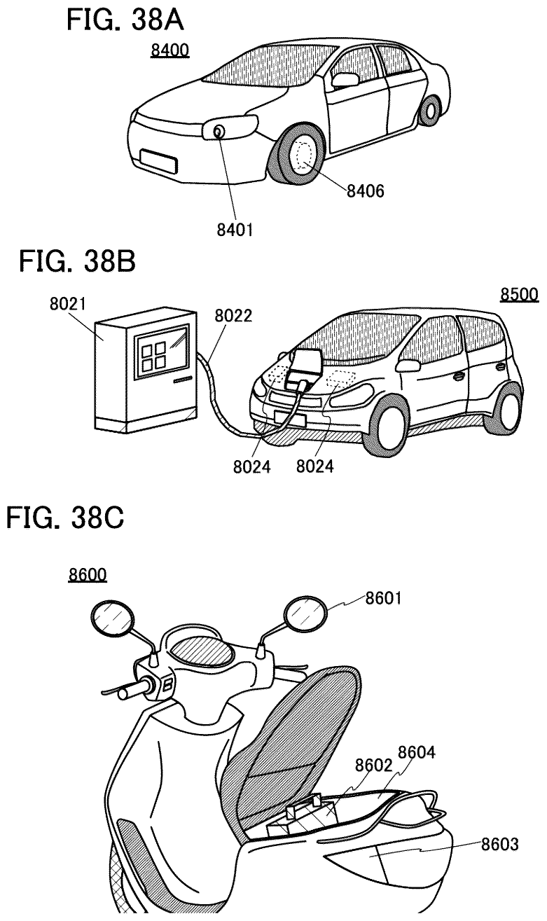

FIGS. 38A to 38C each illustrate an example of a vehicle including the secondary battery of one embodiment of the present invention. An automobile 8400 illustrated in FIG. 38A is an electric vehicle that runs on the power of an electric motor. Alternatively, the automobile 8400 is a hybrid electric vehicle capable of driving using either an electric motor or an engine as appropriate. The use of the secondary battery of one embodiment of the present invention allows fabrication of a high-mileage vehicle. The automobile 8400 includes the secondary battery. As the secondary battery, the modules of the secondary batteries illustrated in FIGS. 23C and 23D can be arranged to be used in a floor portion in the automobile. Alternatively, a battery pack in which a plurality of secondary batteries each of which is illustrated in FIGS. 26A and 26B are combined may be placed in the floor portion in the automobile. The secondary battery is used not only for driving an electric motor 8406, but also for supplying electric power to light-emitting devices such as a headlight 8401 and a room light (not illustrated).

The secondary battery can also supply electric power to a display device included in the automobile 8400, such as a speedometer and a tachometer. Furthermore, the secondary battery can supply electric power to a semiconductor device included in the automobile 8400, such as a navigation system.

FIG. 38B illustrates an automobile 8500 including the secondary battery. The automobile 8500 can be charged when the secondary battery is supplied with electric power from external charging equipment by a plug-in system and/or a contactless power feeding system, for example. In FIG. 38B, a secondary battery 8024 included in the automobile 8500 is charged with the use of a ground-based charging apparatus 8021 through a cable 8022. In charge, a given method such as CHAdeMO (registered trademark) or Combined Charging System can be employed as a charging method, the standard of a connector, or the like as appropriate. The charging apparatus 8021 may be a charging station provided in a commerce facility or a power source in a house. For example, with the use of a plug-in technique, the secondary battery 8024 included in the automobile 8500 can be charged by being supplied with electric power from outside. The charge can be performed by converting AC electric power into DC electric power through a converter such as an AC-DC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road and/or an exterior wall, charge can be performed not only when the vehicle is stopped but also when driven. In addition, the contactless power feeding system may be utilized to perform transmission and reception of electric power between vehicles. Furthermore, a solar cell may be provided in the exterior of the vehicle to charge the secondary battery when the vehicle stops and/or moves. To supply electric power in such a contactless manner, an electromagnetic induction method and/or a magnetic resonance method can be used.

FIG. 38C shows an example of a motorcycle including the secondary battery of one embodiment of the present invention. A motor scooter 8600 illustrated in FIG. 38C includes a secondary battery 8602, side mirrors 8601, and indicators 8603. The secondary battery 8602 can supply electric power to the indicators 8603.

In the motor scooter 8600 illustrated in FIG. 38C, the secondary battery 8602 can be held in an under-seat storage unit 8604. The secondary battery 8602 can be held in the under-seat storage unit 8604 even with a small size. The secondary battery 8602 is detachable; thus, the secondary battery 8602 is carried indoors when charged, and is stored before the motor scooter is driven.

According to one embodiment of the present invention, the secondary battery can have improved cycle performance and an increased discharge capacity. Thus, the secondary battery itself can be made more compact and lightweight. The compact and lightweight secondary battery contributes to a reduction in the weight of a vehicle and hence increases the mileage. Furthermore, the secondary battery included in the vehicle can be used as a power source for supplying electric power to products other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with excellent cycle performance can be used over a long period; thus, the use amount of rare metals such as cobalt can be reduced.

This embodiment can be implemented in appropriate combination with any of the other embodiments.

### Example 1

In this example, the positive electrode active material 100 of one embodiment of the present invention was formed and its characteristics were analyzed.

### <Formation of Positive Electrode Active Material>

Samples formed in this example are described in accordance with the formation methods in FIG. 16 and FIGS. 17A and 17C.

As the LiCoO₂ in Step S14 in FIG. 16, with the use of cobalt as the transition metal M, a commercially available lithium cobalt oxide (Cellseed C-10N produced by NIPPON CHEMICAL INDUSTRIAL CO., LTD.) not containing any additive element was prepared. The initial heating in Step S15 was performed on the lithium cobalt oxide, which was put in a crucible covered with a lid, in a muffle furnace at 850° C. for 2 hours. No flowing was performed after the muffle furnace was filled with an oxygen atmosphere (i.e., O₂ purging was performed). The collected amount after the initial heating showed a slight decrease in weight. The decrease in weight was probably caused by elimination of impurities such as lithium carbonate from the LiCoO₂.

In accordance with Step S21 and Step S41 shown in FIGS. 17A and 17B, Mg, L, Ni, and Al were separately added as the additive elements. In accordance with Step S21 shown in FIG. 17A, LiF and MgF₂ were prepared as the F source and the Mg source, respectively. The LiF and MgF₂ were weighed so that LiF:MgF₂=1:3 (molar ratio). Then, the LiF and MgF₂ were mixed into dehydrated acetone and the mixture was stirred at a rotating speed of 400 rpm for 12 hours, whereby an additive element source (an A1 source) was produced. In the mixing, a ball mill was used and a grinding medium was zirconium oxide balls (1 mm φ). In the mixing ball mill, which had a capacity of 45 mL, the F source and Mg source weighing approximately 9 g in total were put together with 20 mL of dehydrated acetone and 22 g of zirconium oxide balls and mixed. Then, the mixture was made to pass through a sieve with an aperture of 300 μm, whereby the A1 source was obtained.

Next, as Step S31, the A1 source was weighed to be 1 atomic % of the cobalt, and mixed with the LiCoO₂ subjected to the initial heating by a dry method. Stirring was performed at a rotating speed of 150 rpm for 1 hour. These conditions were milder than those of the stirring in the production of the A1 source. Finally, the mixture was made to pass through a sieve with an aperture of 300 μm, whereby a mixture 903 having a uniform particle diameter was obtained (Step S32).

Then, as Step S33, the mixture 903 was heated. The heating was performed at 900° C. for 20 hours. During the heating, the mixture 903 was in a crucible covered with a lid. The crucible was filled with an atmosphere containing oxygen and entry and exit of the oxygen were blocked (purged). By the heating, a composite oxide containing Mg and F was obtained (Step S34a).

Then, as Step S51, the composite oxide and an additive element source (an A2 source) were mixed. In accordance with Step S41 shown in FIG. 17B, nickel hydroxide and aluminum hydroxide were prepared as the Ni source and the A1 source, respectively. The nickel hydroxide and the aluminum hydroxide were each weighed to be 0.5 atomic % of the cobalt, and were mixed with the composite oxide by a dry method. Stirring was performed at a rotating speed of 150 rpm for 1 hour. A grinding medium was zirconium oxide balls. In the mixing ball mill, which had a capacity of 45 mL, the Ni source and A1 source weighing approximately 7.5 g in total were put together with 22 g of zirconium oxide balls (1 mm φ) and mixed. These conditions were milder than those of the stirring in the production of the A1 source. Finally, the mixture was made to pass through a sieve with an aperture of 300 μm, whereby a mixture 904 having a uniform particle diameter was obtained (Step S52).

Then, as Step S53, the mixture 904 was heated. The heating was performed at 850° C. for 10 hours. During the heating, the mixture 904 was in a crucible covered with a lid. The crucible was filled with an atmosphere containing oxygen and entry and exit of the oxygen were blocked (purge). By the heating, lithium cobalt oxide containing Mg, F, Ni, and Al was obtained (Step S54). The positive electrode active material (composite oxide) obtained through the above steps was used as Sample 1-1.

Sample 1-2 was formed in the same manner as Sample 1-1 except that the heating time in Step S15 was 10 hours.

Sample 1-3 was formed in the same manner as Sample 1-1 except that the heating temperature in Step S15 was 750° C.

Sample 1-4 was formed in the same manner as Sample 1-1 except that the heating temperature in Step S15 was 900° C.

Sample 1-5 was formed in the same manner as Sample 1-1 except that the heating temperature in Step S15 was 950° C.

In formation of Sample 2, the heating in Step S15 was not performed and the heating in Step S53 was performed with the oxygen flow rate set to 10 L/min.

As Sample 10, which was a reference, lithium cobalt oxide (Cellseed C-10N produced by NIPPON CHEMICAL INDUSTRIAL CO., LTD.) not subjected to any treatment was used.

As Sample 11, lithium cobalt oxide which was only subjected to the heating in Step S15 was used.

Table 2 lists the formation conditions of Samples 1-1, 1-2, 1-3, 1-4, 1-5, 2, 10, and 11. As shown in Table 2, the commonality of Samples 1-1 to 1-5 is that they were formed in the following manner: the initial heating was performed on LiCoO₂ not containing any additive element, a magnesium source, a fluorine source, a nickel source, and an aluminum source were added, and then, heating was performed; therefore, all of Samples 1-1 to 1-5 may be referred to as Sample 1 to be distinguished from the samples not having the commonality.

TABLE 2
Formation conditions

| | | Step S15 | | Step S33 | | Step S53 |
|---|---|---|---|---|---|---|
| | | Heating temperature | Step S20a | Heating temperature | Step S40 | Heating temperature |
| | Step S14 | (hour) | Al source | (hour) | A2 source | (hour) |
| Sample 1-1 | LiCoO₂ | 850(2) | LiF | 900(20) | Ni(OH)₂ | 850(10) |
| | | | MgF₂ | | Al(OH)₃ | |
| Sample 1-2 | | 850(10) | | | | |
| Sample 1-3 | | 750(2) | | | | |
| Sample 1-4 | | 900(2) | | | | |
| Sample 1-5 | | 950(2) | | | | |
| Sample 2 | | — | LiF | 900(20) | Ni(OH)₂ | 850(10) |
| | | | MgF₂ | | Al(OH)₃ | |
| Sample 10 | | — | — | — | — | — |
| (comparative | | | | | | |
| example) | | | | | | |
| Sample 11 | | 850(2) | — | — | — | — |

### <SEM>

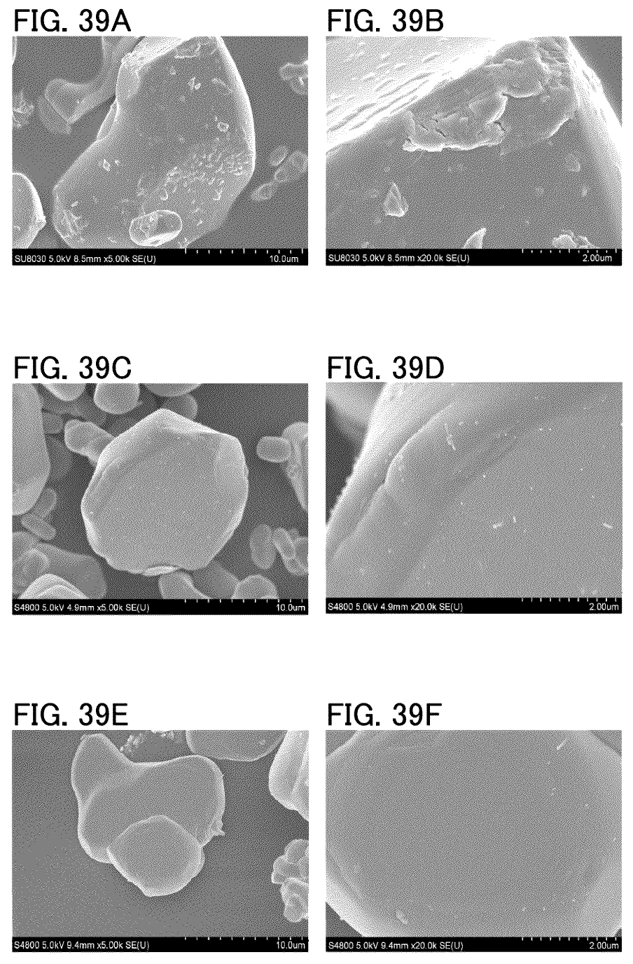

FIGS. 39A to 39F show results of observation using a scanning electron microscope (SEM). The SEM observation in this example was conducted with the use of an SU8030 scanning electron microscope produced by Hitachi High-Tech Corporation under measurement conditions where the acceleration voltage was 5 kV and the magnification was 5000 times or 20000 times.

FIGS. 39A and 39B show SEM images of Sample 10, which was pre-synthesized lithium cobalt oxide (LCO) (Cellseed C-10N produced by NIPPON CHEMICAL INDUSTRIAL CO., LTD.). FIG. 39A shows an overall view of the LCO. FIG. 39B is an enlarged view of the LCO which is shown in FIG. 39A, and shows part of the LCO. Both SEM observation results show a rough surface of the LCO, to which a foreign matter seems to be attached. The pre-synthesized LCO was found to have a surface with much unevenness.

FIGS. 39C and 39D are SEM images of Sample 11 (Cellseed C-10N (LCO) on which the heat treatment was performed). FIG. 39C shows an overall view of the LCO. FIG. 39D is an enlarged view of FIG. 39C and shows part of the LCO. Both SEM observation results showed that the LCO had a smooth surface. The LCO subjected to the initial heating was found to have a surface with reduced unevenness.

FIGS. 39E and 39F show SEM images of Sample 1-1 (Cellseed C-10N (LCO) on which the heat treatment was performed and which contained Mg, F, Ni, and Al as the additive elements). FIG. 39E shows an overall view of the LCO. FIG. 39F is an enlarged view of FIG. 39E and shows part of the LCO. Both SEM observation results showed that the LCO had a smooth surface. The surface of this LCO was smoother than that of the LCO on which the initial heating was only performed. The LCO which was subjected to the initial heating and to which the additive elements were added was found to have a surface with reduced unevenness.

The SEM observation results showed that the initial heating makes a surface of LCO smooth. It can be deemed that the initial heating conditioned the LCO surface and reduced a shift in a crystal and the like, thereby making the surface smooth. It was found that the surface of the LCO maintained the smoothness or had increased smoothness in the case where the additive elements were added after the initial heating.

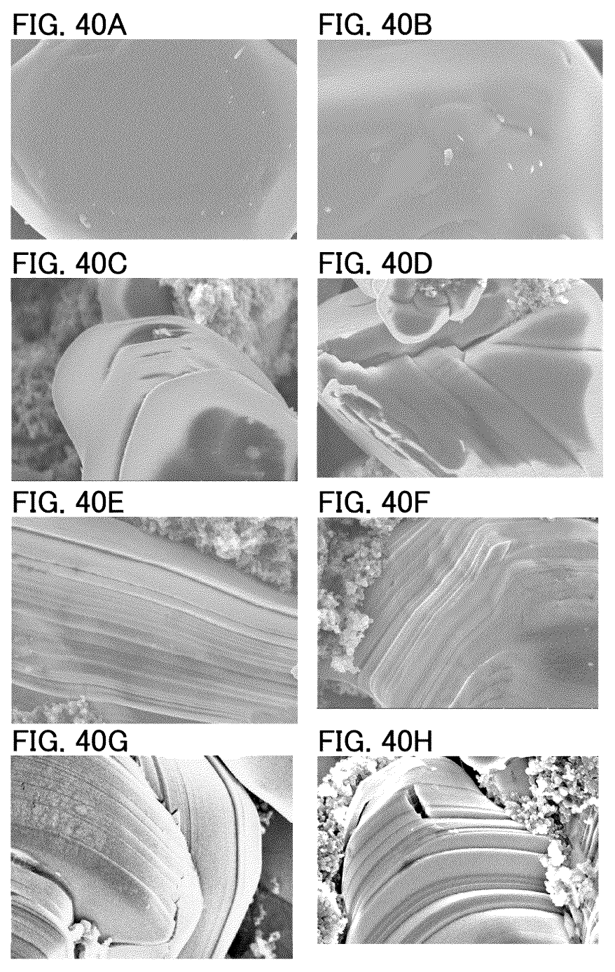

Next, the state of the completed LCO in powder form, that of the LCO before pressing, that of the LCO after pressing, and that of the LCO after a cycle test were observed with a SEM. First, the state of the powder is described. FIG. 40A shows a SEM image of Sample 1-1, on which the initial heating was performed. This image corresponds to FIG. 39F. FIG. 40B shows Sample 10, on which the initial heating was not performed. From FIGS. 40A and 40B, it was found that Sample 1-1, on which the initial heating was performed, had a smooth surface to which few foreign matters were attached.

Next, the state before pressing is described. The LCO before pressing refers to LCO obtained in the following manner: a slurry was formed by mixing an active material, a conductive material, and the like under predetermined conditions, the slurry was applied to a current collector, and a solvent of the slurry was volatilized. The slurry was formed by mixing, at 2000 rpm, LCO in powder form as the active material, acetylene black (AB) as the conductive material, and PVDF as a binder at a ratio LCO:AB:PVDF=95:3:2 (wt %). The solvent of the slurry was NMP, which was volatilized after the slurry was applied to an aluminum current collector. FIG. 40C shows a SEM image of Sample 1-1, on which the initial heating was performed, before pressing. FIG. 40D shows a SEM image of Sample 10, on which the initial heating was not performed, before pressing. FIGS. 40C and 40D showed that a crack was generated at a surface and the like of the LCO by the mixing.

Next, the state after pressing is described. The LCO after pressing refers to a positive electrode layer formed on the current collector which was pressed after the volatilization of the solvent of the slurry. The upper and lower roll temperatures were set to 120° C. using a roll press apparatus, and the pressing consisted of pressure application at 210 kN/m and subsequent pressure application at 1467 kN/m. FIG. 40E shows a SEM image of Sample 1-1, on which the initial heating was performed, after the pressing. FIG. 40F shows a SEM image of Sample 10, on which the initial heating was not performed, after the pressing. FIGS. 40E and 40F showed that slipping was caused at a surface and the like of the LCO by the pressing.

### <Slipping>

Slipping, or a stacking fault, refers to deformation of LCO along the lattice fringe direction (a-b plane direction) by pressing. The deformation includes forward and backward shifts of lattice fringes. When lattice fringes are shifted forward and backward from each other, steps are generated on the particle surface which is in the perpendicular direction with respect to the lattice fringes (the c-axis direction). The steps on the surface can be observed as lines horizontally crossing the image in each of FIGS. 40E and 40F.

Next, the state after a cycle test is described. Half cells including the LCO after the pressing were formed for the cycle test and measurement was performed.

As the electrolyte solution used in the half cells, a mixture of ethylene carbonate (EC) and diethyl carbonate (DEC) at a volume ratio of 3:7 to which vinylene carbonate (VC) was added as an additive at 2 wt % was prepared. As an electrolyte contained in the electrolyte solution, 1 mol/L lithium hexafluorophosphate (LiPF₆) was used.

As a separator used in the half cells, polypropylene was used. As a counter electrode used in the half cells, a lithium metal was prepared. Coin-type half cells were thus fabricated and their cycle performance was measured.

The fabricated half cells each underwent 50 cycles of charge and discharge at a charge and discharge current value of 100 mA/g, a charge and discharge voltage of 4.6 V, and a measurement temperature of 25° C. FIG. 40G shows a SEM image of Sample 1-1, on which the initial heating was performed, after 50 cycles. FIG. 40H shows a SEM image of Sample 10, on which the initial heating was not performed, after 50 cycles. FIGS. 40G and 40H were compared, with a focus on the state of the slipping after the cycle test. It was shown that the slipping in Sample 1-1 (FIG. 40G) did not proceed as much as that in Sample 10 (FIG. 40H) and Sample 1-1 in FIG. 40G was in almost the same state as Sample 1-1 after the pressing. In Sample 10 (FIG. 40H), on which the initial heating was not performed, the slipping proceeded and the steps increased; thus, distinct line patterns appeared.

The SEM observation results showed that in the LCO whose surface has been made smooth by the initial heating, the progress of slipping can be suppressed in the period from the end of the pressing to the end of the cycle test. It is inferred that slipping proceeds after the cycle test and the slipping and other defects lead to deterioration. The initial heating is preferable because it can at least suppress the progress of slipping.

### <STEM and Energy Dispersive X-Ray Spectroscopy (EDX)>

Next, Sample 10, Sample 11, and Sample 1-1 were subjected to surface analysis by STEM-EDX (for example, element mapping) and electron diffraction. Sample 2 was subjected to electron diffraction.

As pretreatment before analysis, the samples were sliced by an FIB method (p-sampling method)

STEM and EDX were performed with the following apparatuses under the following conditions.

### <<STEM Observation>>

Transmission electron microscope: JEM-ARM200F manufactured by JEOL Ltd.
Observation condition, acceleration voltage: 200 kV
Magnification accuracy: ±10%

### <<EDX>>

Analysis method: energy dispersive X-ray spectroscopy (EDX)
Scanning transmission electron microscope: JEM-ARM200F manufactured by JEOL Ltd.
Acceleration voltage: 200 kV
Beam diameter: approximately 0.1 nm φ
Element analysis apparatus: JED-2300T
X-ray detector: Sᵢ drift detector
Energy resolution: approximately 140 eV
X-ray extraction angle: 21.9°
Solid angle: 0.98 sr
Number of captured pixels: 128×128

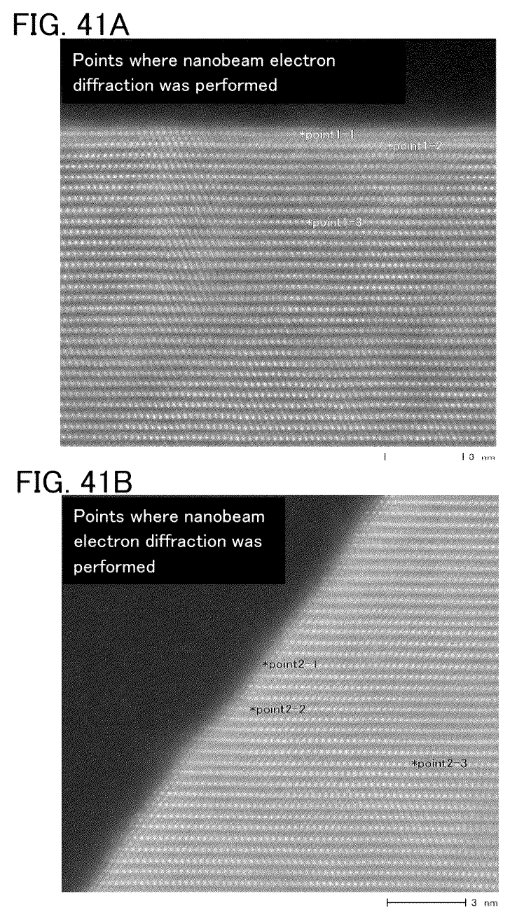

FIGS. 41A and 41B are HAADF-STEM images of Sample 10. FIG. 41A shows a surface having a (001) orientation and a surface portion thereof, and FIG. 41B shows a surface having an orientation other than a (001) orientation and a surface portion thereof. In each image, a layered rock-salt crystal structure was observed. Nanobeam electron diffraction patterns are obtained at Point1-1 to Point1-3 and Point2-1 to Point2-3 in the images. Table 3 lists d values, interplanar angles, and lattice constants that are calculated on the assumption that the space group is R-3m.

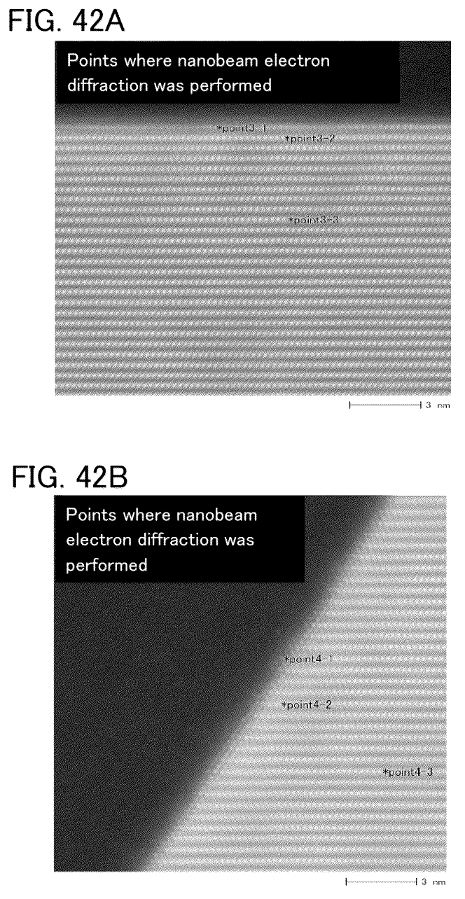

Similarly, FIGS. 42A and 42B are HAADF-STEM images of Sample 11. FIG. 42A shows a surface having a (001) orientation and a surface portion thereof, and FIG. 42B shows a surface having an orientation other than a (001) orientation and a surface portion thereof. In each image, a layered rock-salt crystal structure was observed. Nanobeam electron diffraction patterns are obtained at Point3-1 to Point3-3 and Point4-1 to Point4-3 in the images. Table 3 lists d values, interplanar angles, and lattice constants that are calculated on the assumption that the space group is R-3m.

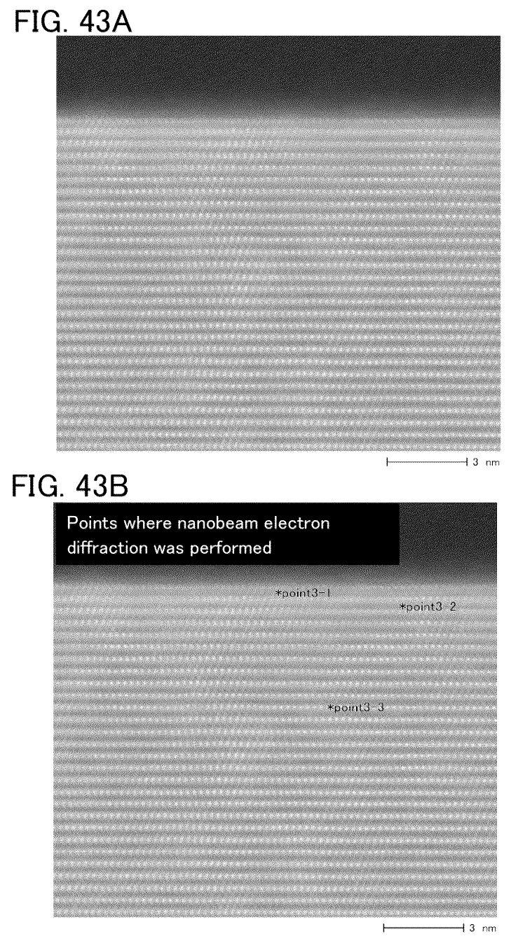

FIG. 43A is a HAADF-STEM image of a surface having a (001) orientation of Sample 1-1 and a surface portion thereof. Points where nanobeam electron diffraction patterns are obtained in FIG. 43A are denoted by Point3-1 to Point3-3 in FIG. 43B

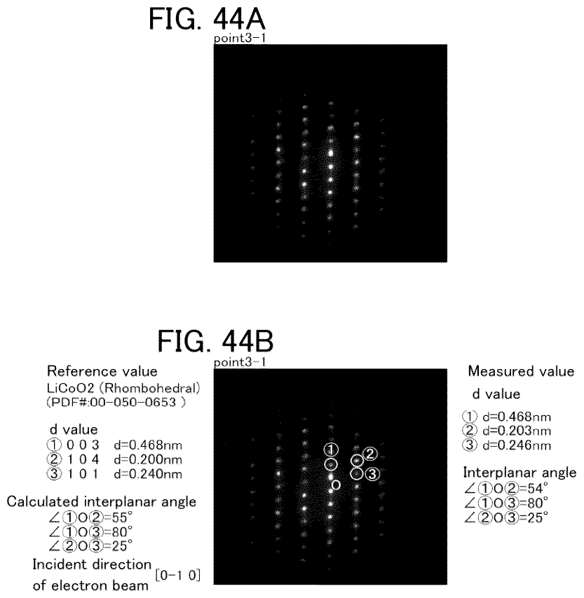

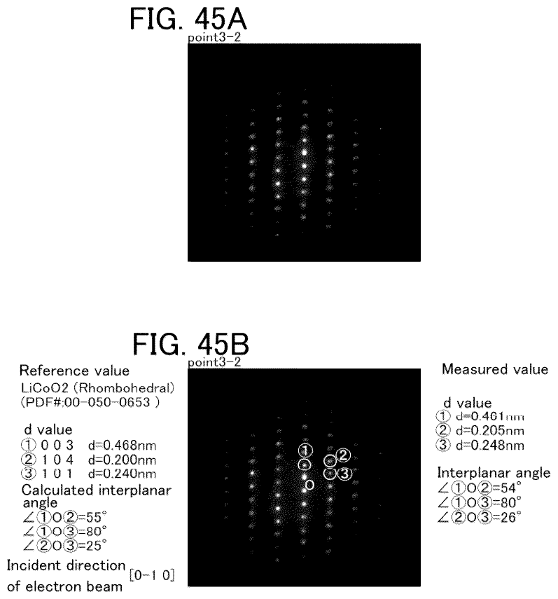

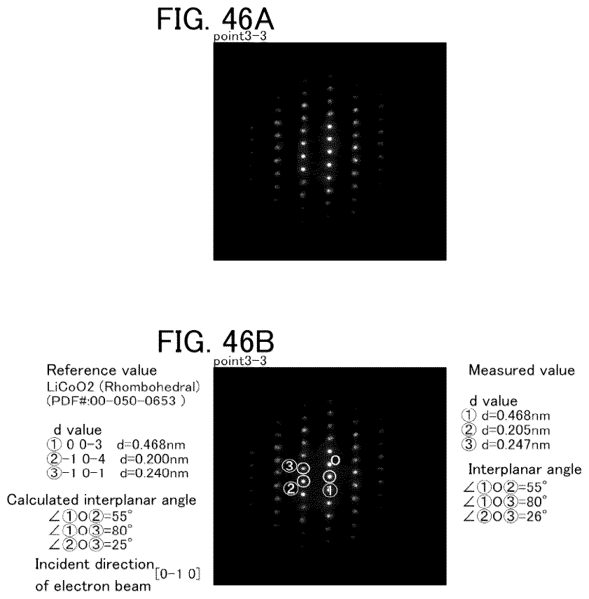

FIG. 44A is the nanobeam electron diffraction pattern of Point3-1 in FIG. 43B, and diffraction spots used for obtaining the d values and the interplanar angles are surrounded by circles in FIG. 44B. The reference value of lithium cobalt oxide is also shown. FIG. 45A is the nanobeam electron diffraction pattern of Point3-2 in FIG. 43B, and diffraction spots used for obtaining the d values and the interplanar angles are surrounded by circles in FIG. 45B. FIG. 46A is the nanobeam electron diffraction pattern of Point3-3 in FIG. 43B, and diffraction spots used for obtaining the d values and the interplanar angles are surrounded by circles in FIG. 46B. Table 3 lists the d values, the interplanar angles, and the lattice constants that are calculated on the assumption that the space group is R-3m.

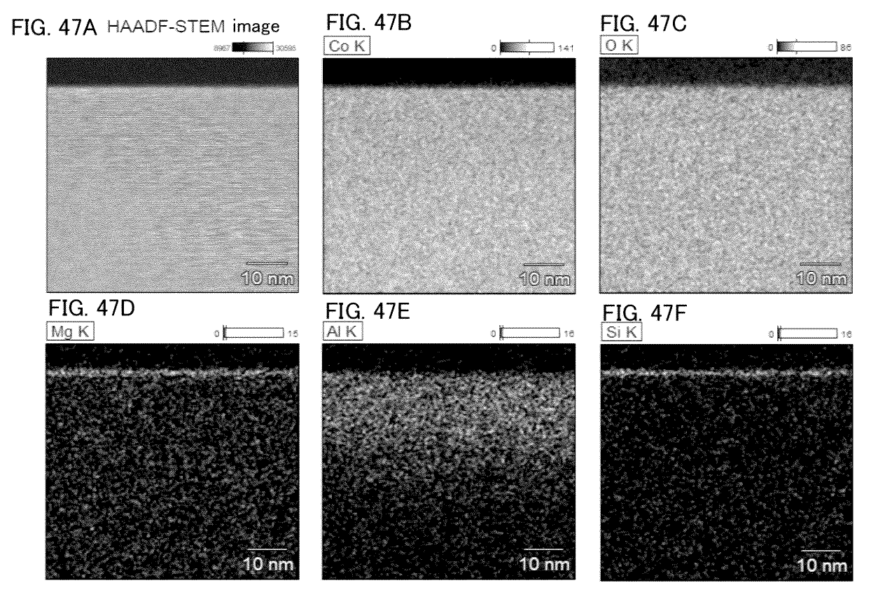

FIG. 47A is a HAADF-STEM image of the surface having a (001) orientation of Sample 1-1 and the surface portion thereof. When EDX surface analysis was performed on this region, C, O, F, Mg, Al, Si, Ca, Co, and Ga were detected. Ga was probably derived from FIB processing. Si and Ca were probably a small amount of Si and a small amount of Ca that were contained in LiCoO₂ used in Step S14 and were unevenly distributed in the surface. FIGS. 47B to 47F are mapping images of cobalt and oxygen, which were main elements, and magnesium, aluminum, and silicon, which were obviously unevenly distributed.

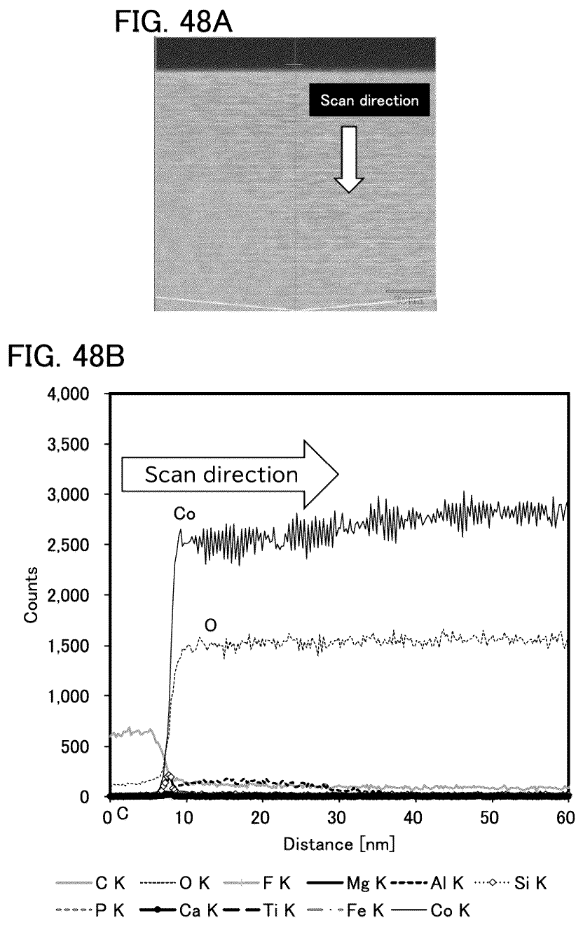

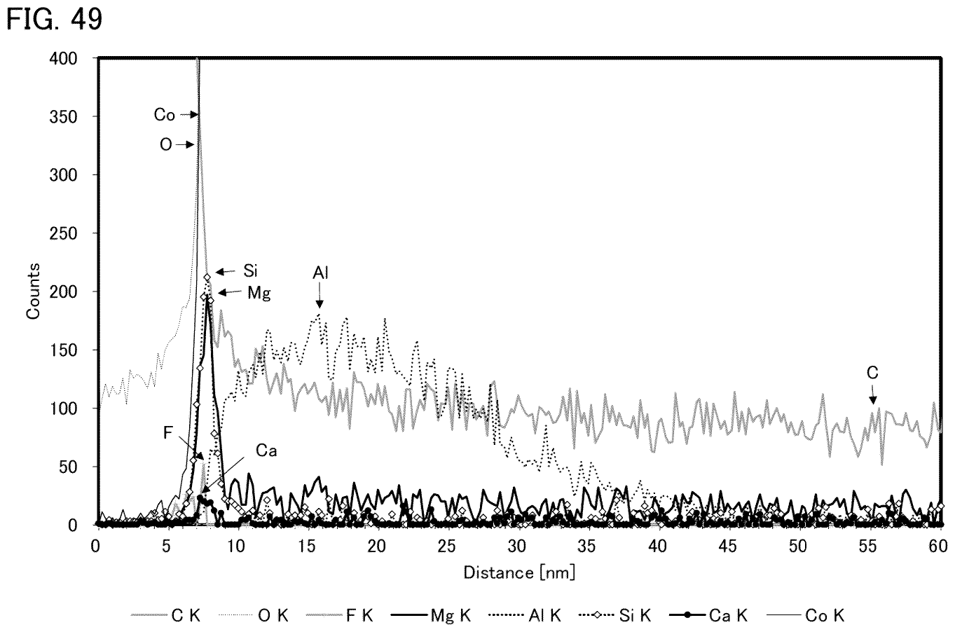

FIG. 48A is a HAADF-STEM image of the surface having a (001) orientation of Sample 1-1 and the surface portion thereof, and in this image, the scanning direction of the STEM-EDX linear analysis is indicated by an arrow. FIG. 48B shows a profile of the STEM-EDX linear analysis of this region. FIG. 49 is an enlarged view of FIG. 48B in the vertical direction.

According to the profiles in FIG. 48B and FIG. 49, the surface was supposed to correspond to a point of 7.95 nm. Specifically, a region other than the vicinity of the point where the amount the detected cobalt begins to increase corresponded to a distance (0.25 nm to 3.49 nm) in FIG. 48B and FIG. 49. A region where the numbers of cobalt and oxygen atoms were saturated and stabilized corresponded to 56.1 nm to 59.3 nm. When Co that is the transition metal Mwas used, a point that represents 50% of the sum of M_{AVE} and M_{BG} was 1408.1 Counts, and the surface estimated using the calculated regression line corresponded to 7.95 nm. Plus or minus 1 nm is regarded as an error.

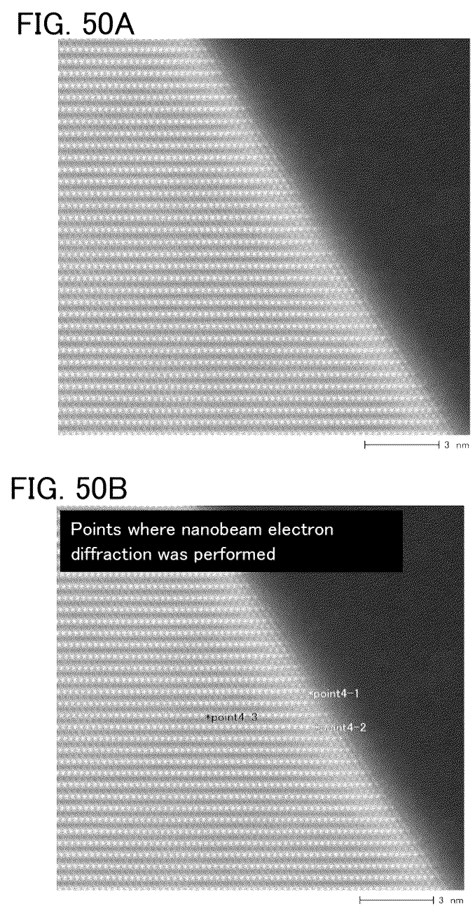

FIG. 50A is a HAADF-STEM image of a surface not having a (001) orientation of Sample 1-1 and a surface portion thereof. Points where nanobeam electron diffraction patterns are obtained in FIG. 50A are denoted by Point4-1 to Point4-3 in FIG. 50B.

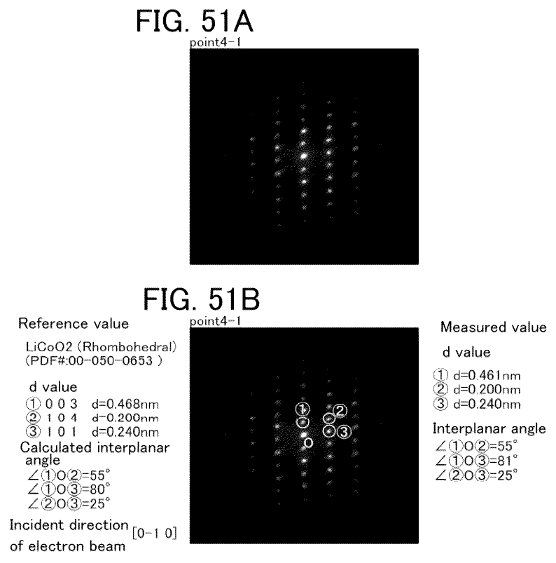

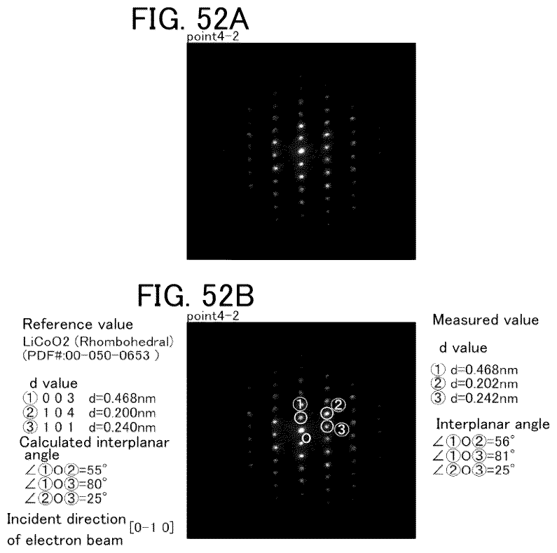

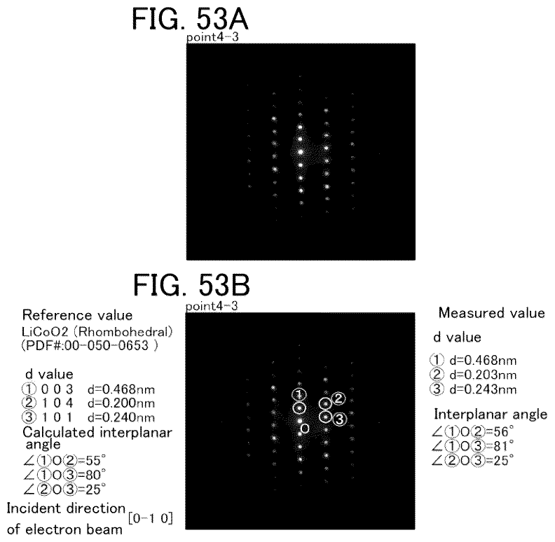

FIG. 51A is the nanobeam electron diffraction pattern of Point4-1 in FIG. 50B, and diffraction spots used for obtaining the d values and the interplanar angles are surrounded by circles in FIG. 51B. The reference value of lithium cobalt oxide is also shown. FIG. 52A is the nanobeam electron diffraction pattern of Point4-2 in FIG. 50B, and diffraction spots used for obtaining the d values and the interplanar angles are surrounded by circles in FIG. 52B. FIG. 53A is the nanobeam electron diffraction pattern of Point4-3 in FIG. 50B, and diffraction spots used for obtaining the d values and the interplanar angles are surrounded by circles in FIG. 53B. Table 3 lists the d values, the interplanar angles, and the lattice constants that are calculated on the assumption that the space group is R-3m.

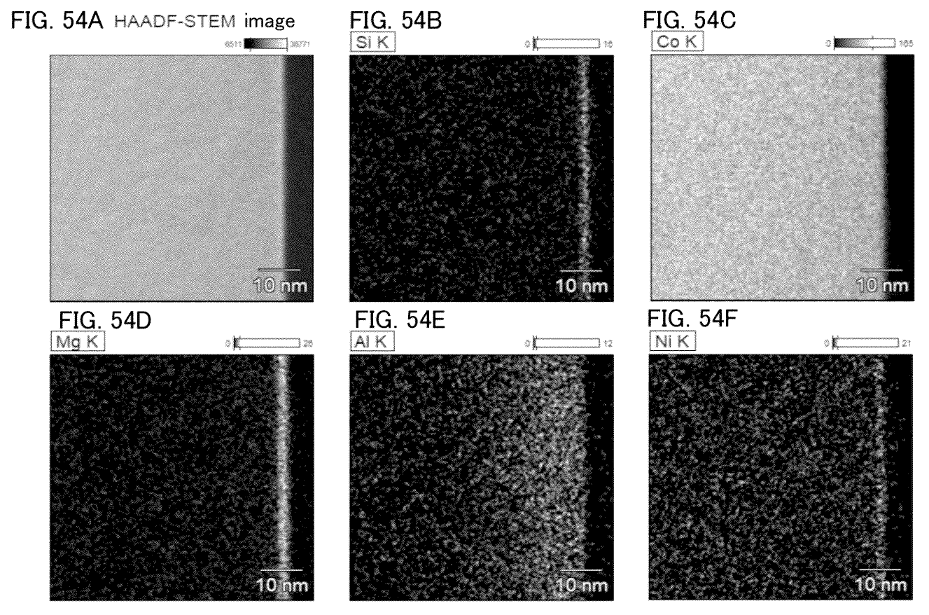

FIG. 54A is a HAADF-STEM image of the surface not having a (001) orientation of Sample 1-1 and the surface portion thereof. When EDX surface analysis was performed on this region, C, O, F, Mg, Al, Si, Co, Ni, and Ga are detected. Ga was probably derived from FIB processing. FIGS. 54B to 54F are mapping images of cobalt and oxygen, which were main elements, and silicon, magnesium, aluminum, and nickel, which were obviously unevenly distributed.

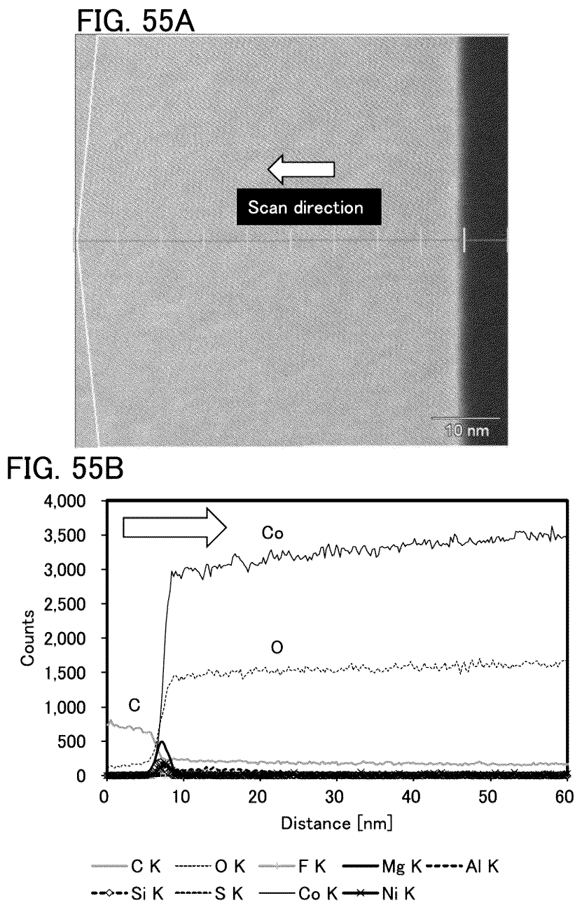

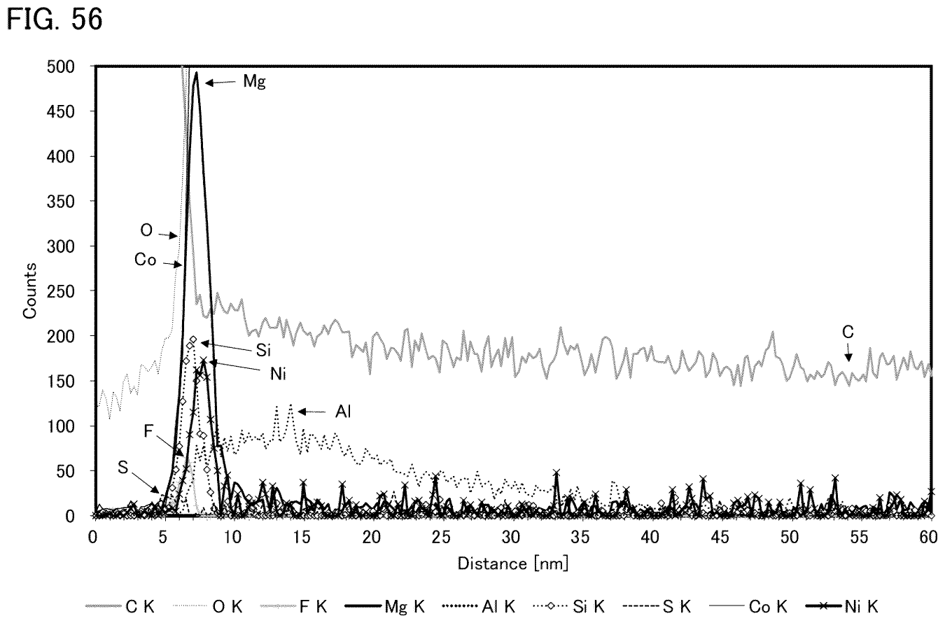

FIG. 55A is a HAADF-STEM image of the surface not having a (001) orientation of Sample 1-1 and the surface portion thereof, and in this image, the scanning direction of the STEM-EDX linear analysis is indicated by an arrow. FIG. 55B shows a profile of the STEM-EDX linear analysis of this region. FIG. 56 is an enlarged view of FIG. 55B in the vertical direction.

According to the profiles in FIG. 55B and FIG. 56, the surface was supposed to correspond to 7.45 nm. Specifically, a region other than the vicinity of the point where the amount the detected cobalt begins to increase corresponded to 0.25 nm to 3.49 nm in FIG. 55B and FIG. 56. A region where the numbers of cobalt and oxygen atoms were saturated and stabilized corresponded to 56.1 nm to 59.3 nm. A point corresponding to 50% of the sum of M_{AVE} and M_{BG} was 1749.0 Counts, and the surface estimated using the calculated regression line corresponded to 7.45 nm. Plus or minus 1 nm is regarded as an error.

Comparison between the surface having a (001) orientation and the surface not having a (001) orientation revealed the following facts.

Nickel was not detected at the surface having a (001) orientation, and was detected at the surface not having a (001) orientation. The ratio of manganese or aluminum to cobalt was different between the surface having a (001) orientation and the surface not having a (001) orientation.

Specifically, the intensity ratio of the additive elements to cobalt was Mg/Co=0.07 and Al/Co=0.06 at the surface having a (001) orientation. The half width of the distribution of magnesium was 1.38 nm.

In contrast, the intensity ratio of the additive elements to cobalt was Mg/Co=0.14, Al/Co=0.04, and Ni/Co=0.05 at the surface not having a (001) orientation. The half width of the distribution of magnesium was 1.90 nm, and the half width of the distribution of nickel was 1.67 nm.

At the surface not having a (001) orientation, nickel was distributed closer to the surface side than aluminum, and magnesium was distributed closer to the surface side than nickel.

Furthermore, the surface having a (001) orientation had a smaller intensity ratio Al/Co than the surface not having a (001) orientation, which indicates that aluminum was diffused into the positive electrode active material at the surface not having a (001) orientation.

At each surface, magnesium was distributed closer to the surface side than aluminum. As indicated by the above-described half width, the shape of the distribution of magnesium was sharper than that of aluminum. Moreover, fluorine was detected at each surface.

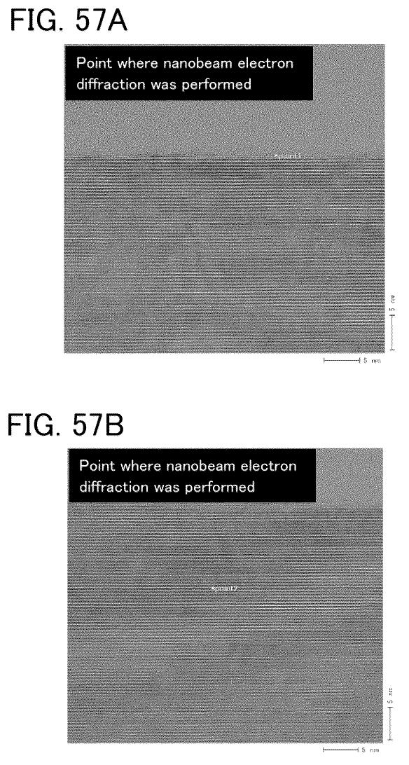

FIGS. 57A and 57B are HAADF-STEM images of a surface having a (001) orientation of Sample 2 and a surface portion thereof. In these drawings, points where nanobeam electron diffraction patterns were obtained are denoted by Point1 and Point2. Although not shown, a nanobeam electron diffraction pattern was also obtained from a region inside Sample 2. Table 3 lists d values, interplanar angles, and lattice constants that are calculated on the assumption that the space group is R-3m.

TABLE 3

| | Unit [nm] | | | | Unit [°] | | | | Lattice coefficient [Å] | | | |
|---|---|---|---|---|---|---|---|---|---|---|---|---|
| | | Point1- | Point1- | Point1- | Interplanar | Point1- | Point1- | Point1- | | Point1- | Point1- | Point1- |
| Sample 10 | d value | 1 | 2 | 3 | angle | 1 | 2 | 3 | | 1 | 2 | 3 |
| FIG. 41A | \textcircled{1} 1 0 1 | 0.240 | 0.239 | 0.241 | ∠\textcircled{1}◯\textcircled{2} | 25 | 25 | 25 | a-axis | 2.81 | 2.79 | 2.82 |
| Incident | \textcircled{2} 1 0 4 | 0.200 | 0.200 | 0.201 | ∠\textcircled{1}◯\textcircled{3} | 80 | 80 | 80 | c-axis | 14.07 | 14.17 | 14.15 |
| direction of | \textcircled{3} 0 0 3 | 0.473 | 0.475 | 0.475 | ∠\textcircled{2}◯\textcircled{3} | 55 | 56 | 55 | | | | |
| electron beam | | | | | | | | | | | | |
| is [0 1 0] | | | | | | | | | | | | |
| | | Point2- | Point2- | Point2- | Interplanar | Point2- | Point2- | Point2- | | Point2- | Point2- | Point2- |
| Sample 10 | d value | 1 | 2 | 3 | angle | 1 | 2 | 3 | | 1 | 2 | 3 |
| FIG. 41B | \textcircled{1} 1 0 1 | 0.243 | 0.243 | 0.240 | ∠\textcircled{1}◯\textcircled{2} | 25 | 25 | 25 | a-axis | 2.85 | 2.85 | 2.81 |
| Incident | \textcircled{2} 1 0 4 | 0.203 | 0.204 | 0.201 | ∠\textcircled{1}◯\textcircled{3} | 81 | 81 | 80 | c-axis | 14.17 | 14.40 | 14.23 |
| direction of | \textcircled{3} 0 0 3 | 0.468 | 0.475 | 0.475 | ∠\textcircled{2}◯\textcircled{3} | 56 | 56 | 55 | | | | |
| electron beam | | | | | | | | | | | | |
| is [0 1 0] | | | | | | | | | | | | |
| | | Point3- | Point3- | Point3- | Interplanar | Point3- | Point3- | Point3- | | Point3- | Point3- | Point3- |
| Sample 11 | d value | 1 | 2 | 3 | angle | 1 | 2 | 3 | | 1 | 2 | 3 |
| FIG. 42A | \textcircled{1} 1 0 1 | 0.238 | 0.242 | 0.239 | ∠\textcircled{1}◯\textcircled{2} | 25 | 25 | 25 | a-axis | 2.79 | 2.83 | 2.79 |
| Incident | \textcircled{2} 1 0 4 | 0.199 | 0.199 | 0.198 | ∠\textcircled{1}◯\textcircled{3} | 80 | 79 | 79 | c-axis | 14.00 | 13.65 | 13.82 |
| direction of | \textcircled{3} 0 0 3 | 0.466 | 0.461 | 0.468 | ∠\textcircled{2}◯\textcircled{3} | 55 | 54 | 54 | | | | |
| electron beam | | | | | | | | | | | | |
| is [0 1 0] | | | | | | | | | | | | |
| | | Point4- | Point4- | Point4- | Interplanar | Point4- | Point4- | Point4- | | Point4- | Point4- | Point4- |
| Sample 11 | d value | 1 | 2 | 3 | angle | 1 | 2 | 3 | | 1 | 2 | 3 |
| FIG. 42B | \textcircled{1} 1 0 1 | 0.249 | 0.245 | 0 242 | ∠\textcircled{1}◯\textcircled{2} | 26 | 25 | 25 | a-axis | 2.93 | 2.87 | 2.84 |
| Incident | \textcircled{2} 1 0 4 | 0.207 | 0.203 | 0 203 | ∠\textcircled{1}◯\textcircled{3} | 81 | 80 | 81 | c-axis | 14.20 | 13.99 | 14.32 |
| direction of | \textcircled{3} 0 0 3 | 0.465 | 0.465 | 0 473 | ∠\textcircled{2}◯\textcircled{3} | 55 | 55 | 56 | | | | |
| electron beam | | | | | | | | | | | | |
| is [0 1 0] | | | | | | | | | | | | |
| | | Point3- | Point3- | Point3- | Interplanar | Point3- | Point3- | Point3- | | Point3- | Point3- | Point3- |
| Sample 1-1 | d value | 1 | 2 | 3 | angle | 1 | 2 | 3 | | 1 | 2 | 3 |
| FIG. 43-46 | \textcircled{1} 1 0 1 | 0.468 | 0.461 | 0 468 | ∠\textcircled{1}◯\textcircled{2} | 54 | 54 | 55 | a-axis | 2.88 | 2.91 | 2.90 |
| Incident | \textcircled{2} 1 0 4 | 0.203 | 0.205 | 0 205 | ∠\textcircled{1}◯\textcircled{3} | 80 | 80 | 80 | c-axis | 13.95 | 13.97 | 14.13 |
| direction of | \textcircled{3} 0 0 3 | 0.246 | 0.248 | 0 247 | ∠\textcircled{2}◯\textcircled{3} | 25 | 26 | 26 | | | | |
| electron beam | | | | | | | | | | | | |
| is [0 −1 0] | | | | | | | | | | | | |
| | | Point4- | Point4- | Point4- | Interplanar | Point4- | Point4- | Point4- | | Point4- | Point4- | Point4- |
| Sample 1-1 | d value | 1 | 2 | 3 | angle | 1 | 2 | 3 | | 1 | 2 | 3 |
| FIG. 50-53 | \textcircled{1} 1 0 1 | 0.461 | 0 468 | 0 468 | ∠\textcircled{1}◯\textcircled{2} | 55 | 56 | 56 | a-axis | 2.81 | 2.84 | 2.85 |
| Incident | \textcircled{2} 1 0 4 | 0.200 | 0202 | 0 203 | ∠\textcircled{1}◯\textcircled{3} | 81 | 81 | 81 | c-axis | 13.92 | 14.12 | 14.17 |
| direction of | \textcircled{3} 0 0 3 | 0.240 | 0242 | 0 243 | ∠\textcircled{2}◯\textcircled{3} | 25 | 25 | 25 | | | | |
| electron beam | | | | | | | | | | | | |
| is [0 −1 0] | | | | | | | | | | | | |
| | | | | | Interplanar | | | | | | | |
| Sample 2 | d value | Point1 | Point2 | Inside | angle | Point1 | Point2 | Inside | | Point1 | Point2 | Inside |
| Surface | \textcircled{1} −2 1 0 | 0.151 | 0.143 | 0.142 | | 31 | 31 | 30 | a-axis | 2.98 | 2.85 | 2.83 |
| having (001) | \textcircled{2} −2 1 −6 | 0.128 | 0.122 | 0.122 | | 90 | 89 | 90 | c-axis | 15.40 | 14.26 | 14.35 |
| orientation and | \textcircled{3} 0 0 −6 | 0.266 | 0.24 | 0.24 | | 59 | 59 | 59 | | | | |
| surfaceportion | | | | | | | | | | | | |
| thereof Incident | | | | | | | | | | | | |
| direction of | | | | | | | | | | | | |
| electron beam | | | | | | | | | | | | |
| is [1 2 0] | | | | | | | | | | | | |

### <<Nanobeam Electron Diffraction Pattern>>

Note that the lattice constants shown in Table 3 were calculated from the nanobeam electron diffraction patterns and cannot be directly compared with lattice constants calculated from XRD patterns. However, the lattice constants calculated from the nanobeam electron diffraction patterns can be compared with each other, and represent the features of the samples.

As shown in Table 3, the lattice constant at Point1, which is closest to the surface in Sample 2, was largest. Thus, a difference between the lattice constant at the measurement point closest to the surface and the lattice constant at the measurement point on the inner side was large. This is probably because the feature of the rock-salt crystal structure such as magnesium oxide strongly appears at the surface portion.

In contrast, in Sample 1-1, the lattice constant did not vary largely between the measurement points, and the feature of the layered rock-salt crystal structure strongly appeared even at the measurement point closest to the surface in the nanobeam electron diffraction pattern. This was probably because the rock-salt structure of cobalt oxide (CoO) or the like was repaired to the layered rock-salt crystal structure by the initial heating.

Specifically, in Sample 2, the lattice constants of Point1 (the measurement point that is 1 nm or less in depth from the surface) was larger than that of Point2 (the measurement point that is 3 nm to 10 nm in depth from the surface) by 0.13 Å (a-axis) and 1.14 Å (c-axis).

In Sample 1-1, a difference between the measurement point that is 1 nm or less in depth from the surface and the measurement point that is 3 nm to 10 nm in depth from the surface was less than or equal to 0.04 Å (a-axis) and 0.3 Å (c-axis).

It was found that even in the nanobeam electron diffraction pattern of the region that is 1 nm or less in depth from the surface as in Sample 1-1, a function of stabilizing the crystal structure of the surface portion is increased by maintaining the lattice constant that is similar to that of the surface portion and the feature of the layered rock-salt crystal structure. It was probably because the additive element such as magnesium was effectively inserted into a lithium site at the surface portion.

### <Particle Size Distribution and Specific Surface Area>

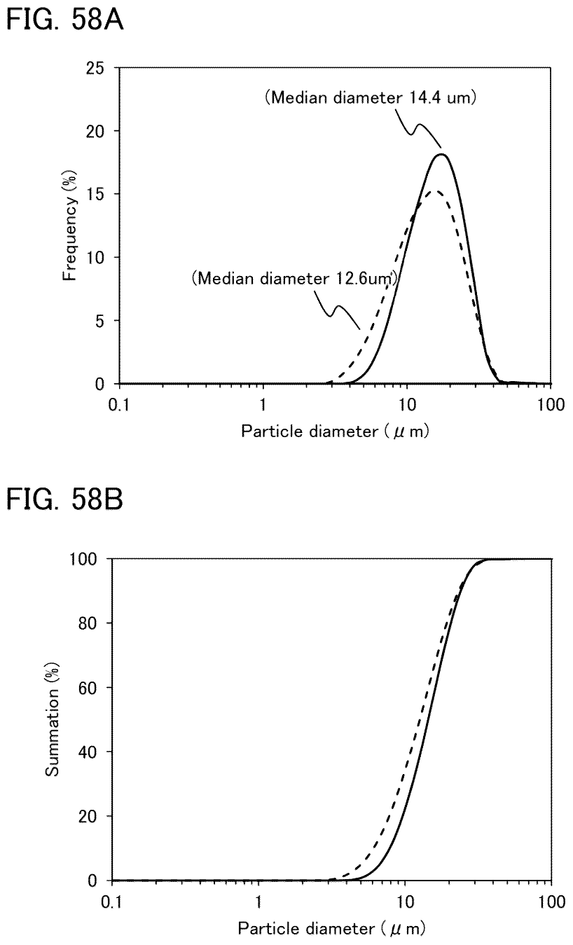

Next, FIGS. 58A and 58B show results of measuring particle size distribution before and after the initial heating. The measurement was performed with a particle size distribution analyzer using a laser diffraction and scattering method. FIG. 58A shows the frequency and FIG. 58B shows the results of a summation. The dotted line denotes the results of Sample 10, which is the pre-synthesized lithium cobalt oxide (LCO) (Cellseed C-10N produced by NIPPON CHEMICAL INDUSTRIAL CO., LTD.), whereas the solid line denotes the results of Sample 11 (Cellseed C-10N (LCO) on which the heat treatment was performed).

Next, Table 4 shows results of measuring the specific surface areas of Sample 10 and Sample 11. The measurement was performed with a specific surface area analyzer using a constant-volume gas adsorption method. A nitrogen gas was used for the measurement.

TABLE 4

| | Specific surface area |
|---|---|
| Sample 10 | 0.314 m²/g |
| Sample 11 | 0.169 m²/g |

The particle size distribution showed that the median diameter increased through the heating. The specific surface area decreased through the heating, meaning that the surface became smooth and unevenness was reduced. These results are consistent with the results of the SEM observation.

### <Unevenness of Active Material Surface>

In this example, unevenness of the surfaces of Sample 1-1, Sample 10, and Sample 11 was measured by the following method to evaluate the smoothness of the surfaces of the active materials.

First, scanning electron microscope (SEM) images of Sample 1-1, Sample 10, and Sample 11 were taken. At this time, Sample 1-1, Sample 10, and Sample 11 were subjected to the SEM measurement under the same conditions. Examples of the measurement conditions include acceleration voltage and a magnification. Conductive coating was performed on the samples as pretreatment for the SEM observation in this example. Specifically, platinum sputtering was performed for 20 seconds. An SU8030 scanning electron microscope produced by Hitachi High-Tech Corporation was used for the observation. The measurement conditions were as follows: the acceleration voltage was 5 kV, the magnification was 5000 times, the working distance was 5.0 mm, the emission current was 9 μA to 10.5 μA, and the extraction voltage was 5.8 kV. All the samples were measured under the same conditions both in an SE(U) mode (upper secondary electron detector) and an auto brightness contrast control (ABC) mode, and observed in an autofocus mode.

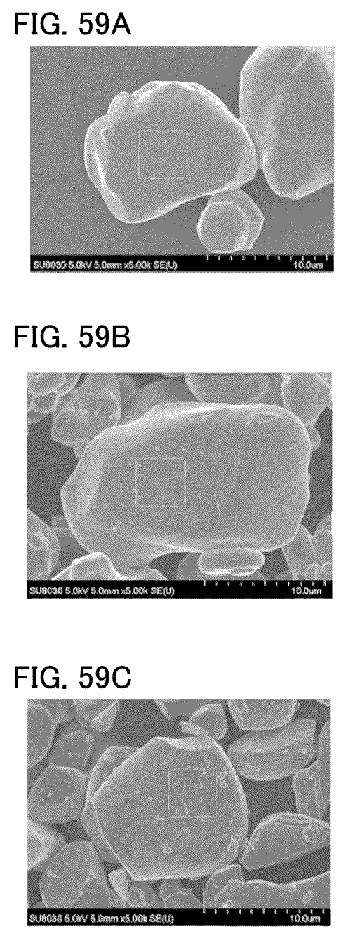

FIGS. 59A, 59B, and 59C show SEM images of Sample 1-1, Sample 11, and Sample 10, respectively. In the SEM images in FIGS. 59A to 59C, a region to be subjected to the subsequent image analysis is framed. The area of the target region was 4 μm×4 μm in all the positive electrode active materials. The target region was set horizontal as an SEM observation surface.

FIGS. 59A and 59B show the positive electrode active materials on which the initial heating was performed. It was found that these positive electrode materials had little surface unevenness as compared to the positive electrode material in FIG. 59C on which the initial heating was not performed. Moreover, it was also found that the number of foreign matters attached to a surface, which might cause unevenness, was small. In addition, Sample 1-1 and Sample 11 in FIGS. 59A and 59B seem to have rounded corners. It can be thus understood that the samples on which the initial heating has been performed have smooth surfaces. Sample 1-1, which was formed by adding the additive element after the initial heating, was found to maintain the surface smoothness achieved by the initial heating.

It can be thus understood that the positive electrode active materials on which the initial heating has been performed have smooth surfaces.

Here, the present inventors noticed that the taken images of the surface states of the positive electrode active materials in FIGS. 59A to 59C showed a variation in luminance. The present inventors considered the feasibility of quantification of information on surface unevenness by image analysis utilizing the variation in luminance.

Thus, in this example, the images shown in FIGS. 59A to 59C were analyzed using image processing software ImageJ to quantify the surface smoothness of the positive electrode active materials. Note that ImageJ is merely an example and the image processing software for this analysis is not limited to ImageJ.

First, the images shown in FIGS. 59A to 59C were converted into 8-bit images (which are referred to as grayscale images) with the use of ImageJ. The grayscale images, in which one pixel is expressed with 8 bits, include luminance (brightness information). For example, in an 8-bit grayscale image, luminance can be represented by 2⁸=256 gradation levels. A dark portion has a low gradation level and a bright portion has a high gradation level. The variation in luminance was quantified in relation to the number of gradation levels. The value obtained by the quantification is referred to as a grayscale value. By obtaining such a grayscale value, the unevenness of the positive electrode active materials can be evaluated quantitatively.

In addition, a variation in luminance in a target region can also be represented with a histogram. A histogram three-dimensionally shows distribution of gradation levels in a target region and is also referred to as a luminance histogram. A luminance histogram enables visually easy-to-understand evaluation of unevenness of the positive electrode active material.

In the above manner, 8-bit grayscale images were obtained from the images of Sample 1-1, Sample 11, and Sample 10, and grayscale values and luminance histograms were also obtained.

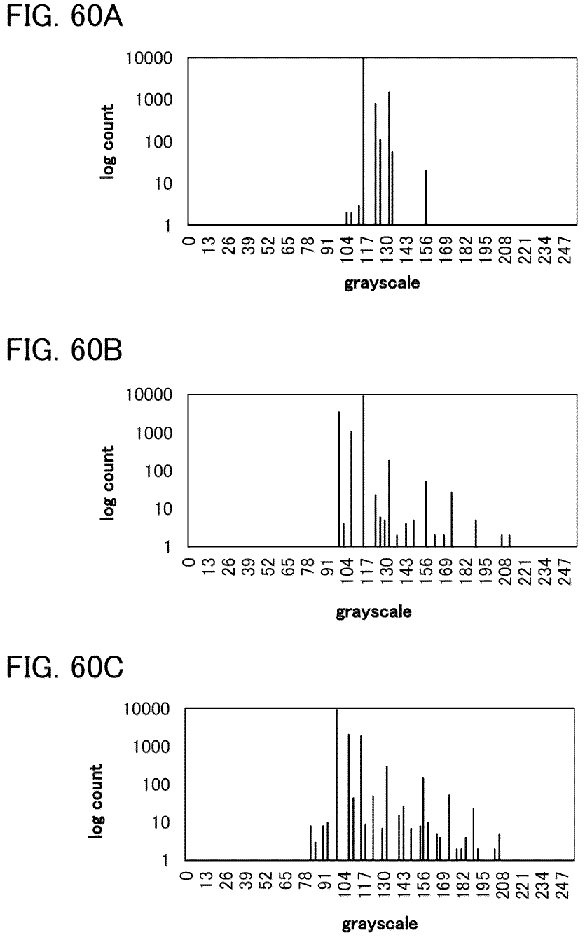

FIGS. 60A to 60C show grayscale values of Sample 1-1, Sample 11, and Sample 10. The x-axis represents the grayscale value, whereas the y-axis represents the count number. The count number is a value corresponding to the proportion of the grayscale value on the x-axis. The count number is on a logarithmic scale.

As described above, the grayscale value relates to surface unevenness. Thus, the grayscale values suggested that the descending order of the surface flatness of the positive electrode active materials was as follows: Sample 1-1, Sample 11, and Sample 10. It was found that Sample 1-1 on which the initial heating was performed had the smoothest surface. It was also found that Sample 11 on which the initial heating was performed had a smoother surface than Sample 10 on which the initial heating was not performed.

The range from the minimum grayscale value to the maximum grayscale value in each sample can be found out. The maximum value and the minimum value of Sample 1-1 are 206 and 96, respectively; the maximum value and the minimum value of Sample 11 are 206 and 82, respectively; and the maximum value and the minimum value of Sample 10 are 211 and 99, respectively.

Sample 1-1 has the smallest difference between the maximum value and the minimum value, which means a small height difference in surface unevenness. Sample 11 was found to have a small height difference in surface unevenness as compared to Sample 10. The height differences in surface unevenness of Samples 1-1 and 11 is small and it can be understood that performing the initial heating makes the surface smooth.

Furthermore, a standard deviation of the grayscale values was evaluated. The standard deviation, which is a measure of a variation in data, is small when a variation in the grayscale values is small. Since the grayscale values presumably correspond to unevenness, a small variation in the grayscale values relates to a small variation in unevenness, or flatness. The standard deviation of Sample 1-1 was 5.816, that of Sample 11 was 7.218, and that of Sample 10 was 11.514. The standard deviations suggested that the ascending order of the variation in surface unevenness of the positive electrode active materials was as follows: Sample 1-1, Sample 11, and Sample 10. Sample 1-1 on which the initial heating was performed was found to have a small variation in surface unevenness and have a smooth surface. It was also shown that Sample 11 on which the initial heating was performed had a smaller variation in surface unevenness and a smoother surface than Sample 10 on which the initial heating was not performed.

Table 5 below lists the minimum value, the maximum value, the difference between the maximum value and the minimum value (the maximum value−the minimum value), and the standard deviation.

TABLE 5

| | | | Maxi- | | |
|---|---|---|---|---|---|
| | | | mum | | |
| | | | value- | | |
| | Mini- | Maxi- | mini- | | Heating |
| | mum | mum | mum | Standard | in Step |
| | value | value | value | deviation | S15 |
| Sample | 99 | 173 | 74 | 5.816 | Performed |
| 1-1 | | | | | |
| Sample | 99 | 211 | 112 | 7.218 | Performed |
| 11 | | | | | |
| Sample | 82 | 206 | 124 | 11.514 | Not |
| 10 | | | | | performed |

The above results show that in Sample 1-1 and Sample 11 having smooth surfaces, the difference between the maximum grayscale value and the minimum grayscale value is less than or equal to 120. This difference is preferably less than or equal to 115, further preferably greater than or equal to 70 and less than or equal to 115. The results also show that the standard deviation of the grayscale values is less than or equal to 11 in of Sample 1-1 and Sample 11 having smooth surfaces. The standard deviation is preferably less than or equal to 8.

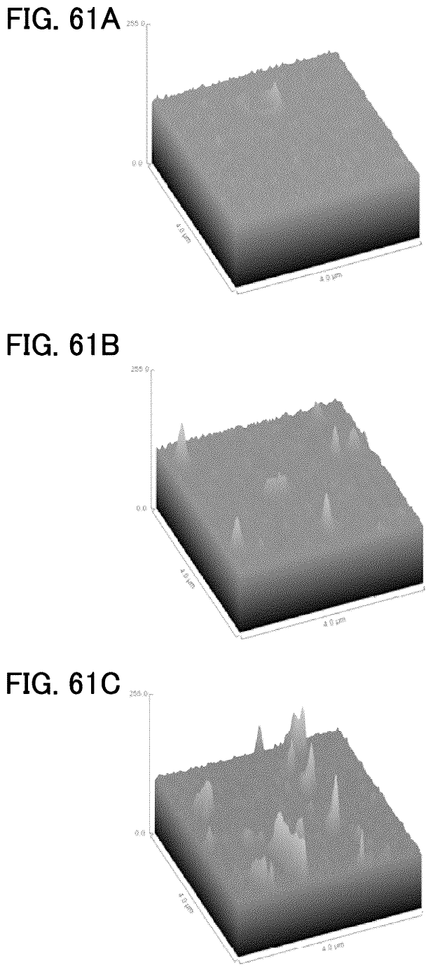

FIGS. 61A to 61C show luminance histograms of Sample 1-1, Sample 11, and Sample 10.

A luminance histogram can three-dimensionally express unevenness based on the grayscale values with a target range represented as a flat plane. Unevenness of a positive electrode active material can be more easily determined with a luminance histogram than by direct observation of the unevenness. The luminance histograms in FIGS. 61A to 61C suggested that the descending order of the surface flatness of the positive electrode active materials was as follows: Sample 1-1, Sample 11, and Sample 10. It was found that Sample 1-1 on which the initial heating was performed had the smoothest surface. It was also found that Sample 11 on which the initial heating was performed had a smoother surface than Sample 10 on which the initial heating was not performed.

Eight samples were formed under the same conditions as each of Sample 1-1, Sample 11, and Sample 10 and were subjected to image analysis in a manner similar to that in this example. The examination of the eight samples showed that these samples had a tendency similar to Sample 1-1, Sample 11, and Sample 10.

Such image analysis enables quantitative determination of smoothness. It was found that the positive electrode active material on which the initial heating has been performed has a smooth surface with little unevenness.

### <Charge and Discharge Cycle Performance of Half Cell>

In this example, half cells were fabricated using the positive electrode active materials of embodiments of the present invention and their cycle performance was evaluated. The performance of the positive electrode alone was clarified by the evaluation of the cycle performance of the half cell.

First, the half cells were fabricated using Sample 1-1 and Sample 1-2 as the positive electrode active materials. The conditions of the half cells are described below.

The positive electrode active material, acetylene black (AB) as a conductive material, and PVDF as a binder were prepared and mixed at a weight ratio of 95:3:2 to form a slurry, and the slurry was applied to an aluminum current collector. As a solvent of the slurry, NMP was used.

After the slurry was applied to the current collector, the upper and lower roll temperatures were set to 120° C. using a roll press apparatus, and the electrode from which the solvent was volatilized was subjected to pressure application at 210 kN/m and subsequent pressure application at 1467 kN/m. Through the above steps, the positive electrodes were obtained. In each positive electrode, the loading level of the active material was approximately 7 mg/cm².

As an electrolyte solution, a mixture of ethylene carbonate (EC) and diethyl carbonate (DEC) at a volume ratio of 3:7 to which vinylene carbonate (VC) was added as an additive at 2 wt % was used. As an electrolyte contained in the electrolyte solution, 1 mol/L lithium hexafluorophosphate (LiPF₆) was used. As a separator, polypropylene was used.

A lithium metal was prepared as a counter electrode. Thus, coin-type half cells including the above positive electrodes and the like were fabricated. Their cycle performance was measured.

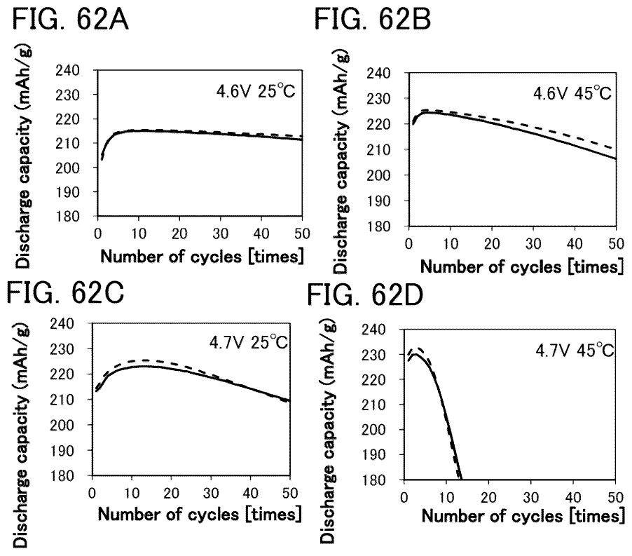

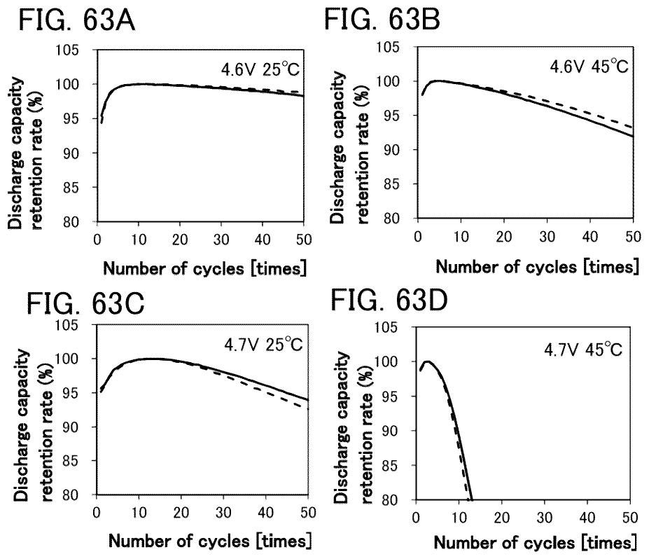

FIGS. 62A to 62D and FIGS. 63A to 63D show the cycle performance.

FIGS. 62A to 62D show the cycle performance in charge and discharge cycles each including CC/CV charge (100 mA/g, 4.6 V or 4.7 V, 10 mA/gcut) and CC discharge (100 mA/g, 2.5 V cut), with a 10-minute break between the cycles. The measurement temperature was 25° C. or 45° C. FIG. 62A shows the results when the charge and discharge voltage was 4.6 V and the measurement temperature was 25° C., FIG. 62B shows the results when the charge and discharge voltage was 4.6 V and the measurement temperature was 45° C., FIG. 62C shows the results when the charge and discharge voltage was 4.7 V and the measurement temperature was 25° C., and FIG. 62D shows the results when the charge and discharge voltage was 4.7 V and the measurement temperature was 45° C. Each graph shows a change in discharge capacity as a function of the number of cycles. The horizontal axis represents the number of cycles and the vertical axis represents discharge capacity (mAh/g) in each graph. The solid line denotes the results of Sample 1-1 and the dashed line denotes the results of Sample 1-2.

FIGS. 63A to 63D show discharge capacity retention rates which correspond to FIGS. 62A to 62D. FIG. 63A shows the results when the charge and discharge voltage was 4.6 V and the measurement temperature was 25° C., FIG. 63B shows the results when the charge and discharge voltage was 4.6 V and the measurement temperature was 45° C., FIG. 63C shows the results when the charge and discharge voltage was 4.7 V and the measurement temperature was 25° C., and FIG. 63D shows the results when the charge and discharge voltage was 4.7 V and the measurement temperature was 45° C. Each graph shows a change in discharge capacity retention rate as a function of the number of cycles. The horizontal axis represents the number of cycles and the vertical axis represents discharge capacity retention rate (%) in each graph. The solid line denotes the results of Sample 1-1 and the dashed line denotes the results of Sample 1-2.

The discharge capacities and discharge capacity retention rates of Sample 1-1 and Sample 1-2 at a charge and discharge voltage of 4.6 V and those at a charge and discharge voltage of 4.7 V were higher at a measurement temperature of 25° C. than at a measurement temperature of 45° C. The cycle performance of the half cells including Sample 1-1 and Sample 1-2 showed that the positive electrode active material of the present invention has excellent cycle performance regardless of the heating time of the initial heating. In other words, the initial heating for longer than or equal to 2 hours and shorter than or equal to 10 hours probably improves the cycle performance, indicating that the effect of the initial heating can be achieved even when the heating time is longer than or equal to 2 hours, which is relatively short.

The maximum discharge capacity of Sample 1-1 was 215.0 mAh/g when the measurement temperature was 25° C. and the charge and discharge voltage was 4.6 V, and the maximum discharge capacity of Sample 1-1 was 222.5 mAh/g when the measurement temperature was 25° C. and the charge and discharge voltage was 4.7 V.

The discharge capacity retention rates of Sample 1-1 and Sample 1-2 at a measurement temperature of 45° C. were higher at a charge and discharge voltage of 4.6 V than at a charge and discharge voltage of 4.7 V. The cycle performance of the half cells including Sample 1-1 and Sample 1-2 showed that the positive electrode active material of the present invention has excellent cycle performance regardless of the heating time of the initial heating. In other words, it was shown that the initial heating for longer than or equal to 2 hours and shorter than or equal to 10 hours improves the cycle performance and the effect of the initial heating can be achieved even when the heating time is short.

The discharge capacity is discussed in detail. For example, the discharge capacity of Sample 1-1 at a charge and discharge voltage of 4.6 V and a measurement temperature of 25° C. was found to be higher than or equal to 200 mAh/g and lower than or equal to 220 mAh/g. In this manner, the values and ranges of the discharge capacity can be read from FIGS. 62A to 62D.

The discharge capacity retention rate is discussed in detail. For example, the discharge capacity retention rate of Sample 1-1 at a charge and discharge voltage of 4.6 V and a measurement temperature of 25° C. was found to be higher than or equal to 94%. In this manner, the values and ranges of the discharge capacity retention rate can be read from FIGS. 63A to 63D.

Samples 1-1 and 1-3 to 1-5 formed as described above were used as positive electrode active materials to fabricate half cells. The conditions of the half cells are as described above. The charge and discharge characteristics of the half cells were measured.

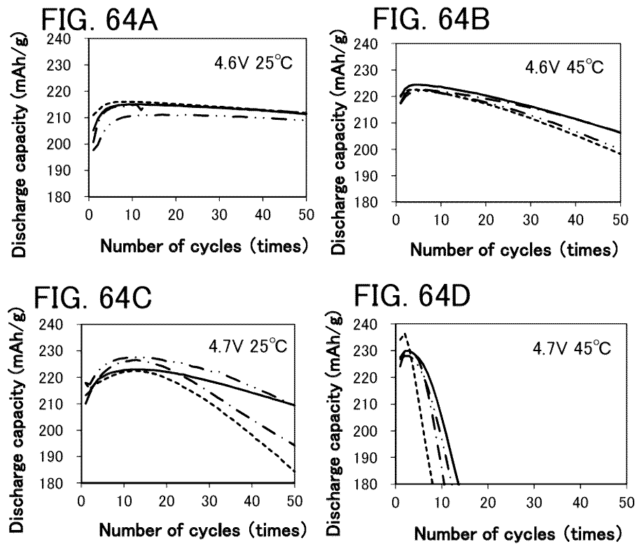

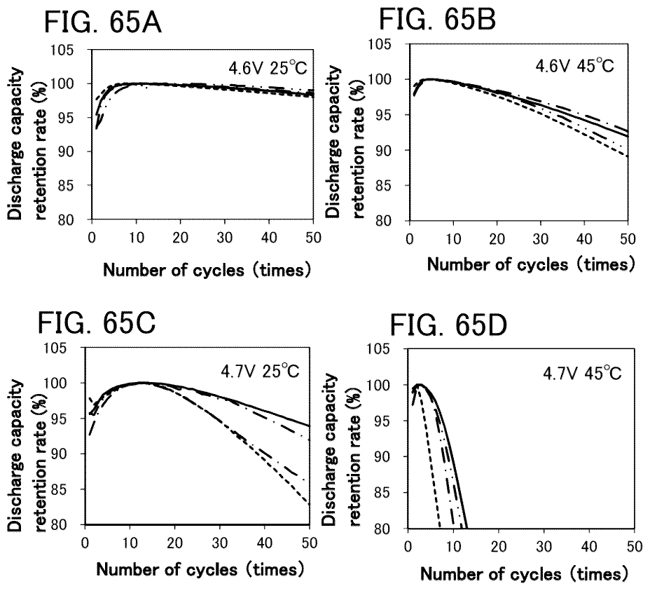

FIGS. 64A to 64D and FIGS. 65A to 65D show the cycle performance.

FIGS. 64A to 64D show the cycle performance when charge and discharge were performed at a current value of 100 mA/g. FIG. 64A shows the results when the charge and discharge voltage was 4.6 V and the measurement temperature was 25° C., FIG. 64B shows the results when the charge and discharge voltage was 4.6 V and the measurement temperature was 45° C., FIG. 64C shows the results when the charge and discharge voltage was 4.7 V and the measurement temperature was 25° C., and FIG. 64D shows the results when the charge and discharge voltage was 4.7 V and the measurement temperature was 45° C. Each graph shows a change in discharge capacity as a function of the number of cycles. The horizontal axis represents the number of cycles and the vertical axis represents discharge capacity (mAh/g) in each graph. The solid line denotes the results of Sample 1-1, the dashed-two dotted line denotes the results of Sample 1-3, the dashed-dotted line denotes the results of Sample 1-4, and the dashed line denotes the results of Sample 1-5.

FIGS. 65A to 65D show discharge capacity retention rates which correspond to FIGS. 64A to 64D. FIG. 65A shows the results when the charge and discharge voltage was 4.6 V and the measurement temperature was 25° C., FIG. 65B shows the results when the charge and discharge voltage was 4.6 V and the measurement temperature was 45° C., FIG. 65C shows the results when the charge and discharge voltage was 4.7 V and the measurement temperature was 25° C., and FIG. 65D shows the results when the charge and discharge voltage was 4.7 V and the measurement temperature was 45° C. Each graph shows a change in discharge capacity retention rate as a function of the number of cycles. The horizontal axis represents the number of cycles and the vertical axis represents discharge capacity retention rate (%) in each graph. The solid line denotes the results of Sample 1-1, the dashed-two dotted line denotes the results of Sample 1-3, the dashed-dotted line denotes the results of Sample 1-4, and the dashed line denotes the results of Sample 1-5.

The discharge capacity retention rates of Samples 1-1 and 1-3 to 1-5 at a charge and discharge voltage of 4.6 V and those at a charge and discharge voltage of 4.7 V were higher at a measurement temperature of 25° C. than at a measurement temperature of 45° C. The cycle performance of the half cells including Samples 1-1 and 1-3 to 1-5 showed that the positive electrode active material of the present invention has excellent cycle performance regardless of the heating temperature of the initial heating. In other words, the initial heating at higher than or equal to 750° C. and lower than or equal to 950° C. probably improves the cycle performance and can be effective. In comparison between the samples in which the effect of the initial heating was achieved, Sample 1-1 had more favorable cycle performance than Samples 1-3 to 1-5.

The discharge capacities and discharge capacity retention rates of Samples 1-1 and 1-3 to 1-5 at a measurement temperature of 45° C. were higher at a charge and discharge voltage of 4.6 V than at a charge and discharge voltage of 4.7 V. The cycle performance of the half cells including Samples 1-1 and 1-3 to 1-5 showed that the positive electrode active material of the present invention has excellent cycle performance regardless of the heating temperature of the initial heating. In other words, the initial heating at higher than or equal to 750° C. and lower than or equal to 950° C. probably improves the cycle performance and can be effective. In comparison between the samples in which the effect of the initial heating was achieved, Sample 1-1 had more favorable cycle performance than Samples 1-3 to 1-5.

Specific values of the discharge capacity are discussed. For example, the discharge capacity of Sample 1-1 at a charge and discharge voltage of 4.6 V and a measurement temperature of 25° C. was found to be higher than or equal to 200 mAh/g and lower than or equal to 220 mAh/g. In this manner, the values and ranges of the discharge capacity can be read from FIGS. 64A to 64D.

Specific values of the discharge capacity retention rate are discussed. For example, the discharge capacity retention rate of Sample 1-1 at a charge and discharge voltage of 4.6 V and a measurement temperature of 25° C. was found to be higher than or equal to 94%. In this manner, the values and ranges of the discharge capacity retention rate can be read from FIGS. 65A to 65D.

### <Charge and Discharge Cycle Performance of Full Cell>

Next, in this example, a full cell was fabricated using the positive electrode active material of one embodiment of the present invention and its cycle performance was evaluated. Through the evaluation of the cycle performance of the full cell, the performance of a secondary battery was clarified.

First, the full cell was fabricated using Sample 1-1 as the positive electrode active material. The conditions of the full cell were similar to the conditions of the half cells described above except that graphite was used for the negative electrode. In the negative electrode, VGCF (registered trademark), carboxymethyl cellulose (CMC), and styrene butadiene rubber (SBR) were added besides graphite. CMC was added to increase viscosity, and SBR was added as a binder. Note that mixing was performed so that graphite: VGCF:CMC:SBR=96:1:1:2 (weight ratio) to form a slurry. The slurry was applied to a copper current collector and then, the solvent was volatilized.

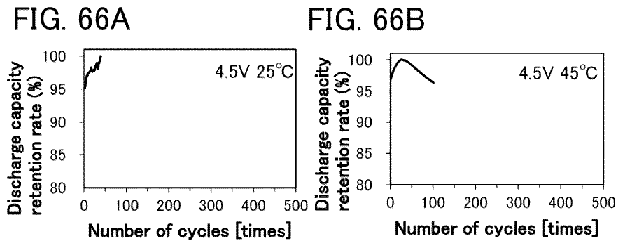

FIGS. 66A and 66B show the cycle performance.

FIG. 66A shows the discharge capacity retention rate when charge and discharge were performed at a current value of 40 mA/g, a charge and discharge voltage of 4.5 V, and a measurement temperature of 25° C. FIG. 66B shows the discharge capacity retention rate when charge and discharge were performed at a current value of 100 mA/g, a charge and discharge voltage of 4.6 V, and a measurement temperature of 45° C. Both of the discharge capacity retention rates were high.

The maximum discharge capacity at a measurement temperature of 25° C. was 192.1 mAh/g, and the maximum discharge capacity at a measurement temperature of 45° C. was 198.5 mAh/g. The initial heating led to the high discharge capacity retention rate and the high discharge capacity.

Since graphite was used as the negative electrode of the full cell, the charge and discharge voltage was lower than that in the case of the half cell including the lithium counter electrode, by approximately 0.1 V. That is, a charge and discharge voltage of 4.5 V in the full cell is equivalent to a charge and discharge voltage of 4.6 V in the half cell.

### <Observation of the Same Portion>

Next, a surface and a surface portion in the same portion of a positive electrode active material were observed before and after the heating following the mixing of the additive element.

Observation of the same portion is difficult when an ordinary formation method is employed; thus, a method was employed in which a pellet is formed, the additive element is mixed, and the heating is performed. Specifically, the following process was conducted.

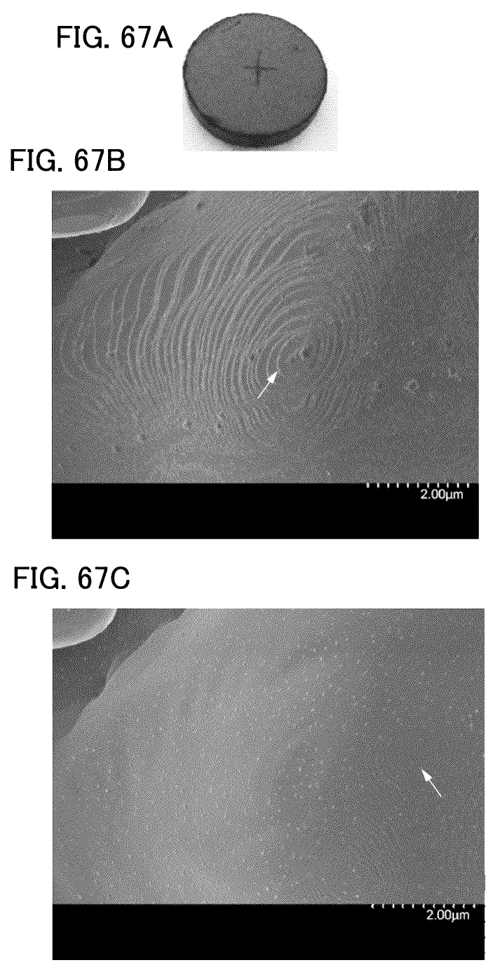

First, commercially available lithium cobalt oxide (Cellseed C-10N produced by NIPPON CHEMICAL INDUSTRIAL CO., LTD.) not containing any additive element was prepared. The lithium cobalt oxide was compacted with a pellet die and molded by heating. The compacting using the pellet die was performed at 20 kN for 5 minutes. The heating was performed at 900° C. for 10 hours at an oxygen flow rate of 5 L/min. This heating doubled as the initial heating. Thus, an LCO-containing pellet (hereinafter referred to as an LCO pellet) with a diameter of 10 mm and a thickness of 2 mm shown in FIG. 67A was obtained. The pellet was marked for easy recognition of the observation portion.

The LCO pellet was observed with a SEM. FIG. 67B shows a SEM image. Although the heating for forming a pellet was performed, minute steps on the surface were observed. The steps look like stripes. The arrow in the image denotes part of the step.

Then, LiF and MgF₂ as additive element sources were mixed into the LCO pellet. Both surfaces of the LCO pellet were covered with a mixture of LiF and MgF₂ at a molar ratio of 1:3. Heating was performed at 900° C. for 20 hours in a muffle furnace. No flowing was performed after the muffle furnace was filled with an oxygen atmosphere (i.e., O₂ purging was performed). In this manner, Sample 3 was formed. The formation conditions of Sample 3 are shown in Table 6.

TABLE 6

| | | Formation conditions | | |
|---|---|---|---|---|
| | | Step S15 | Step | Step S33 |
| | | Heating | S20 | Heating |
| | Step | temperature | A1 | temperature |
| | S14 | (hour) | source | (hour) |
| Sample | LiCoO₂ | 900(10) | LiF | 900(20) |
| 3 | | | MgF₂ | |

FIG. 67C shows a SEM image taken after the mixing of the additive element and the heating. FIG. 67C shows the same portion as FIG. 67B. The stripe-like steps seen in FIG. 67B disappeared and smoothness was seen. On the other hand, a step was newly generated at a different position. This step was smaller than the step seen in FIG. 67B. The arrow in the image denotes part of the newly generated step.

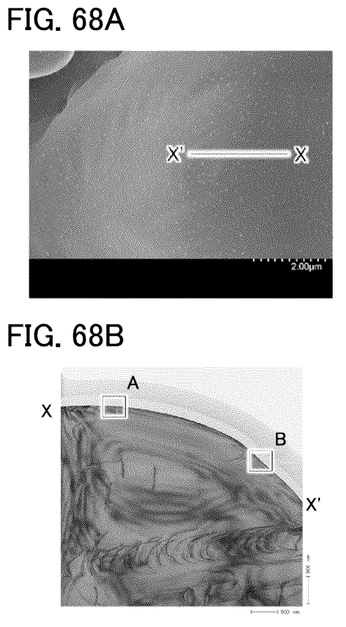

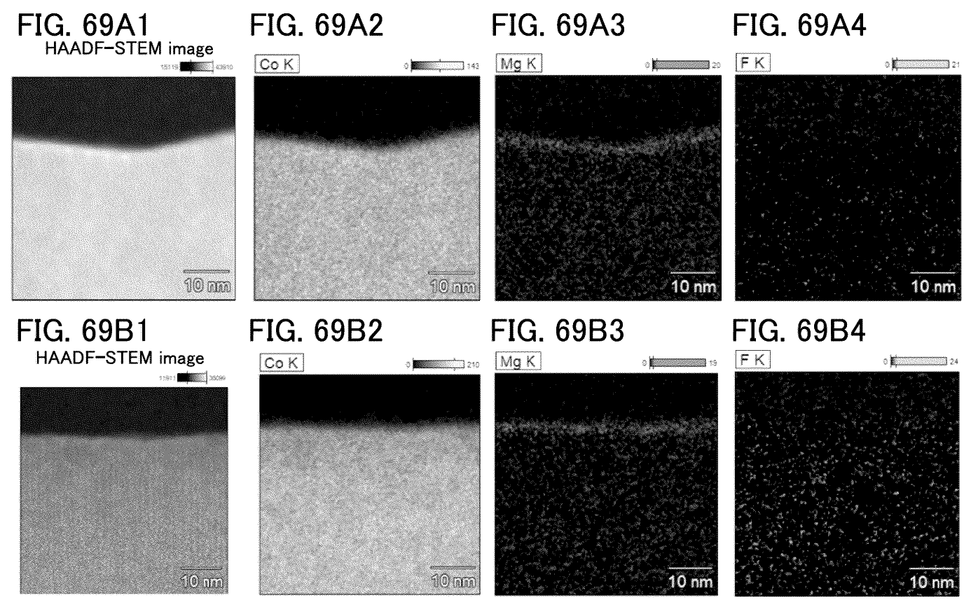

Next, Sample 3 was subjected to cross-sectional STEM-EDX measurement. In FIG. 68A, the line X-X′ denotes a portion subjected to processing for taking out a cross section. In this cross section, there are both the portion which had included the stripe-like step before the heating but became smooth and the portion of the new step.

FIG. 68B shows a cross-sectional STEM image at the line X-X′. The portion denoted by the frame with A in FIG. 68B substantially corresponds to the portion where the new step was generated. In this portion, a depression of the surface can be seen, and this depression was probably observed as the new step. The portion denoted by the frame with B in FIG. 68B substantially corresponds to the portion where the stripe-like step was smoothened. A substantially flat surface can be observed.

FIG. 69A1 shows a higher magnification HAADF-STEM image of the portion in and near the frame with A in FIG. 68B. From FIG. 69A1, it was found that a step, i.e., the difference in height between a depression and a projection in a cross-sectional view, is less than or equal to 10 nm, preferably less than or equal to 3 nm, further preferably less than or equal to 1 nm. FIG. 69B1 shows a higher magnification HAADF-STEM image of the portion in and near the frame with B in FIG. 68B. From FIG. 69B1, it was found that a step, i.e., the difference in height between a depression and a projection in a cross-sectional view, is less than or equal to 1 nm.

FIG. 69A2 shows a mapping image of cobalt in the same region as FIG. 69A1, FIG. 69A3 shows a mapping image of magnesium in the same region as FIG. 69A1, and FIG. 69A4 shows a mapping image of fluorine in the same region as FIG. 69A1. In a similar manner, FIG. 69B2 shows a mapping image of cobalt in the same region as FIG. 69B1, FIG. 69B3 shows a mapping image of magnesium in the same region as FIG. 69B1, and FIG. 69B4 shows a mapping image of fluorine in the same region as FIG. 69B1.

In each region, uneven distribution of magnesium in the surface portion was observed. Magnesium was distributed having a substantially uniform thickness along the surface shape. The concentration of fluorine was below a quantitative lower limit in each region.

Since magnesium was distributed along the surface shape of the LCO in each region, it was suggested that the stripe-like steps which had existed before the heating disappeared as a result of melting of the LCO and moving of Co and the surface of the LCO was thus smoothened.

### Example 2

In this example, the positive electrode active material 100 of one embodiment of the present invention was formed and a dQ/dVvsV curve of its charge curve and the crystal structure after charge were analyzed.

### <Formation of Positive Electrode Active Material and Half Cell>

Positive electrode active materials similar to Sample 1-1 in Example 1 on which the initial heating was performed, Sample 2 on which the initial heating was not performed, and Sample 10 as a reference were formed, and half cells were formed using these materials. At the time of formation of the positive electrodes, pressing was not performed.

<Charging dQ/dVvsV>

The thus formed half cells were each charged to obtain a charge curve, and a dQ/dVvsV curve was calculated from the charge curve. Specifically, voltage (V) and charge capacity (Q), which changed overtime, were obtained from a charge and discharge control device, and a difference in voltage and a difference in charge capacity were calculated. To minimize the adverse effects of minute noise, the moving average for 500 class intervals was calculated for the difference in voltage and the difference in charge capacity. The moving average of the difference in charge capacity was differentiated with the moving average of the difference in voltage (dQ/dV). The results were graphed with the horizontal axis representing the voltage to produce a dQ/dVvsV curve.

The measurement temperature was 25° C. and charge to 4.9 V at 10 mA/g was performed. At the time of the first charge, discharge to 2.5 V at 100 mA/g was performed before measurement of dQ/dV was started. At the time of the first charge and subsequent charges, cycles of charge and discharge were performed, where the charge was CCCV charge (100 mA/g, 4.7 V, 10 mA/gcut) and the discharge was CC discharge (2.5 V, 100 mA/gcut).

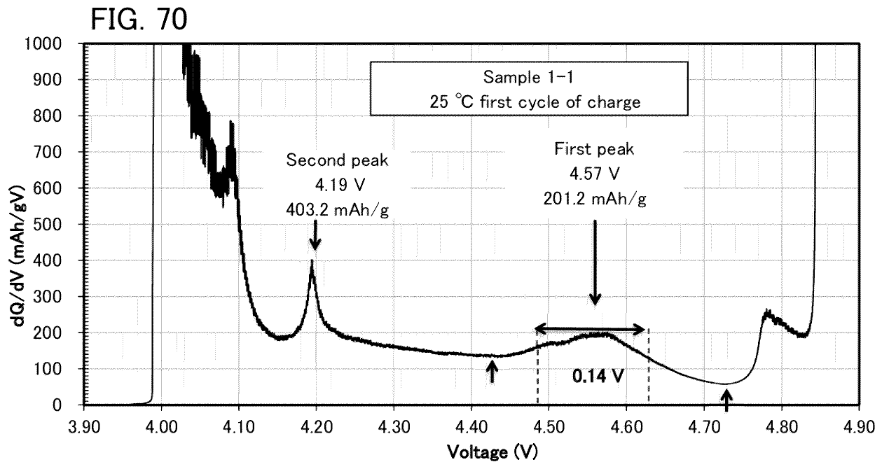

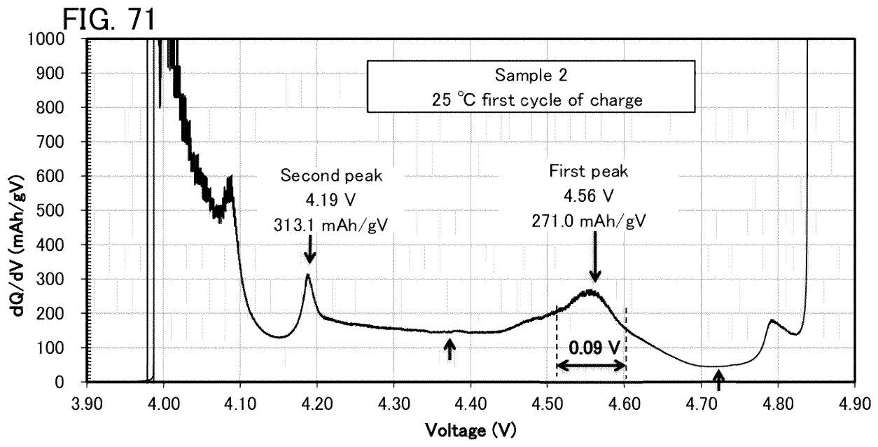

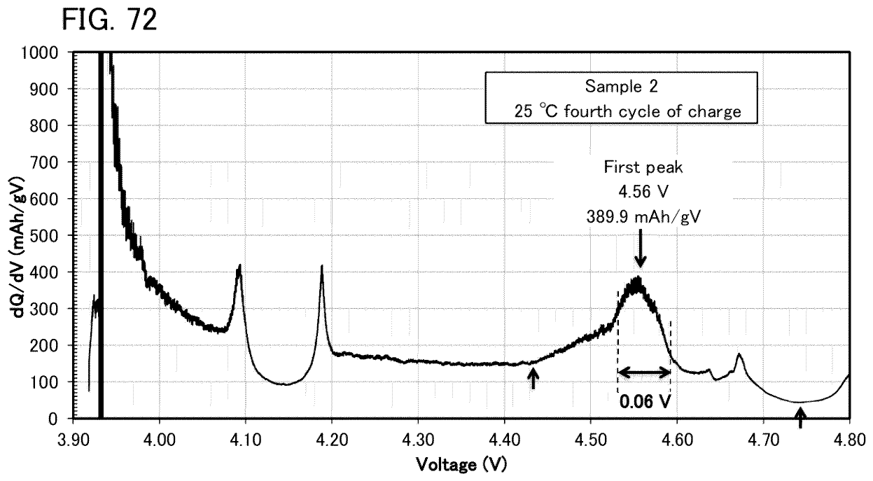

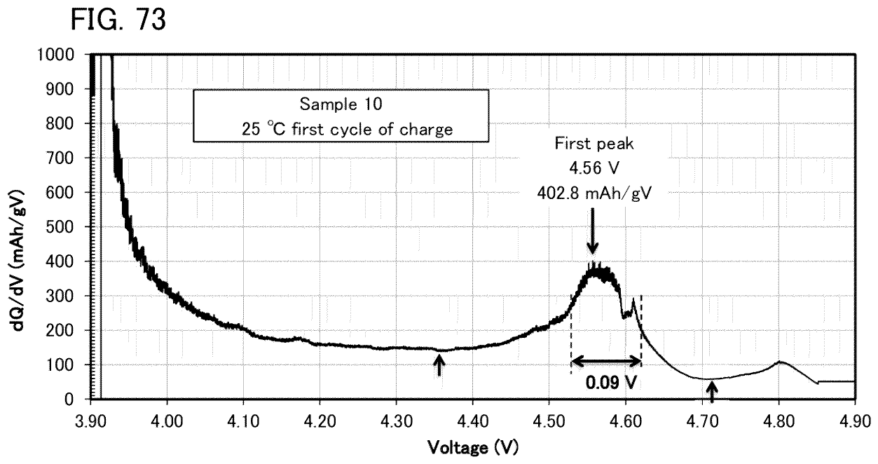

FIG. 70 shows a dQ/dVvsV curve of Sample 1-1 at the first charge, FIG. 71 shows a dQ/dVvsV curve of Sample 2 at the first charge, FIG. 72 shows a dQ/dVvsV curve of Sample 10 at the fourth charge, and FIG. 73 shows a dQ/dVvsV curve of Sample 10 at the first charge.

As shown in FIG. 70, the dQ/dVvsV curve of Sample 1-1 on which the initial heating was performed has a broad peak at around 4.55 V. Specifically, the maximum value in the range of 4.5 V to 4.6 V is 201.2 mAh/gV at 4.57 V. This is regarded as the first peak. The minimum value in the range of 4.3 V to 4.5 V is 130.7 mAh/gV at 4.43 V, which is regarded as the first minimum value. The minimum value in the range of 4.6 V to 4.8 V is 56.6 mAh/gV at 4.73 V, which is regarded as the second minimum value. The first minimum value and the second minimum value are denoted by upward arrows in the graph.

An average value HWHM₁ of the first peak and the first minimum value is 166.7 mAh/gV at 4.49 V. An average value HWHM₂ of the first peak and the second minimum value is 128.3 mAh/gV at 4.63 V. The HWHM₁ and HWHM₂ are denoted by dotted lines in the graph. Accordingly, the difference between the HWHM₁ and HWHM₂, i.e., the full width at half maximum of the first peak in this specification and the like, is 0.14 V, which is greater than 0.10 V.

There is also a sharp peak at around 4.2 V. Specifically, the maximum value in the range of 4.15 V to 4.25 V is 403.2 mAh/gV at 4.19 V. This is regarded as the second peak. The first peak/the second peak is 0.50, which is less than 0.8.

Meanwhile, as shown in FIG. 71, the peak at around 4.55 V in the dQ/dVvsV curve of Sample 2 on which the initial heating was not performed is sharper than that in the dQ/dVvsV curve of Sample 1-1. Specifically, the maximum value in the range of 4.5 V to 4.6 V is 271.0 mAh/gV at 4.56 V. This is regarded as the first peak. The minimum value in the range of 4.3 V to 4.5 V is 141.1 mAh/gV at 4.37 V, which is regarded as the first minimum value. The minimum value in the range of 4.6 V to 4.8 V is 43.5 mAh/gV at 4.72 V, which is regarded as the second minimum value.

The average value HWHM₁ of the first peak and the first minimum value is 206.4 mAh/gV at 4.51 V. The average value HWHM₂ of the first peak and the second minimum value is 157.7 mAh/gV at 4.60 V. The difference between the HWHM₁ and HWHM₂, i.e., the full width at half maximum of the first peak, is 0.09 V, which is less than 0.10 V.

There is also a sharp peak at around 4.2 V. Specifically, the maximum value in the range of 4.15 V to 4.25 V is 313.1 mAh/gV at 4.19 V. This is regarded as the second peak. The first peak/the second peak is 0.87, which is greater than 0.8.

As shown in FIG. 72, the peak at around 4.55 V in the dQ/dVvsV curve of Sample 2 at the fourth charge is also sharper than that at the first charge. Specifically, the maximum value in the range of 4.5 V to 4.6 V is 389.9 mAh/gV at 4.56 V. This is regarded as the first peak. The minimum value in the range of 4.3 V to 4.5 V is 142.5 mAh/gV at 4.43 V, which is regarded as the first minimum value. The minimum value in the range of 4.6 V to 4.8 V is 42.8 mAh/gV at 4.74 V, which is regarded as the second minimum value.

The average value HWHM₁ of the first peak and the first minimum value is 266.2 mAh/gV at 4.53 V. The average value HWHM₂ of the first peak and the second minimum value is 216.3 mAh/gV at 4.59 V. The difference between the HWHM₁ and HWHM₂, i.e., the full width at half maximum of the first peak, is 0.06 V, which is also less than 0.10 V.

As shown in FIG. 73, the peak at around 4.55 V in the dQ/dVvsV curve of Sample 10 not containing any additive element is also sharper than that in the dQ/dVvsV curve of Sample 1-1. Specifically, the maximum value in the range of 4.5 V to 4.6 V is 402.8 mAh/gV at 4.56 V. This is regarded as the first peak. The minimum value in the range of 4.3 V to 4.5 V is 136.2 mAh/gV at 4.36 V, which is regarded as the first minimum value. The minimum value in the range of 4.6 V to 4.8 V is 55.9 mAh/gV at 4.71 V, which is regarded as the second minimum value.

The average value HWHM₁ of the first peak and the first minimum value is 271.0 mAh/gV at 4.53 V. The average value HWHM₂ of the first peak and the second minimum value is 223.2 mAh/gV at 4.62 V. The difference between the HWHM₁ and HWHM₂, i.e., the full width at half maximum of the first peak, is 0.09 V, which is also less than 0.10 V.

As described above, the full width at half maximum of the first peak at around 4.55 V of Sample 1-1 on which the initial heating was performed is greater than 0.10 V, which means that the first peak is sufficiently broad. This indicates that a change in the energy necessary for extraction of lithium at around 4.55 V is small and a change in the crystal structure is small. Accordingly, the positive electrode active material hardly suffers a shift in CoO₂ layers and a volume change and is relatively stable even when x in LiₓCoO₂ is small.

### <XRD>

Next, XRD measurement was performed after charge of half cells including Sample 1-1 and Sample 2, which were fabricated as in Example 1.

In the measurement after the first charge, the charge voltage was 4.5 V, 4.55 V, 4.6 V, 4.7 V, 4.75 V, or 4.8 V. The charge temperature was 25° C. or 45° C. The charge method was CC charge (10 mA/g, each voltage).

In the measurement after the fifth charge, first, four cycles of charge and discharge were performed, where the charge was CCCV charge (100 mA/g, 4.7 V, 10 mA/gcut), the discharge was CC discharge (2.5 V, 100 mA/gcut), and a 10-minute break was taken between the cycles; then, as the fifth charge, CC charge (10 mA/g, each voltage) was performed.

In the measurement after the 15th charge or the 50th charge, similarly, 14 cycles of charge and discharge or 49 cycles of charge and discharge were performed, where the charge was CCCV charge (100 mA/g, 4.7 V, 10 mA/gcut), the discharge was CC discharge (2.5 V, 100 mA/gcut), and a 10-minute break was taken between the cycles; then, CC charge (10 mA/g, each voltage) was performed.

Immediately after completion of the charge, each half cell in a charged state was disassembled in a glove box with an argon atmosphere to take out the positive electrode, and the positive electrode was washed with dimethyl carbonate (DMC) to remove the electrolyte solution. The positive electrode taken out was attached to a flat substrate with a double-sided adhesive tape and sealed in a dedicated cell in an argon atmosphere. The position of the positive electrode active material layer was adjusted to the measurement plane required by the apparatus. The XRD measurement was performed at room temperature irrespective of the charge temperature.

The apparatus and conditions adopted in the XRD measurement were as follows.
XRD apparatus: D8 ADVANCE produced by Bruker AXS
X-ray source: CuKα₁ radiation
Output: 40 kV, 40 mA
Angle of divergence: Div. Slit, 0.5°
Detector: LynxEye
Scanning method: 2θ/θ continuous scanning
Measurement range (2θ): from 15° to 75°
Step width (2θ): 0.01°
Counting time: 1 second/step
Rotation of sample stage: 15 rpm

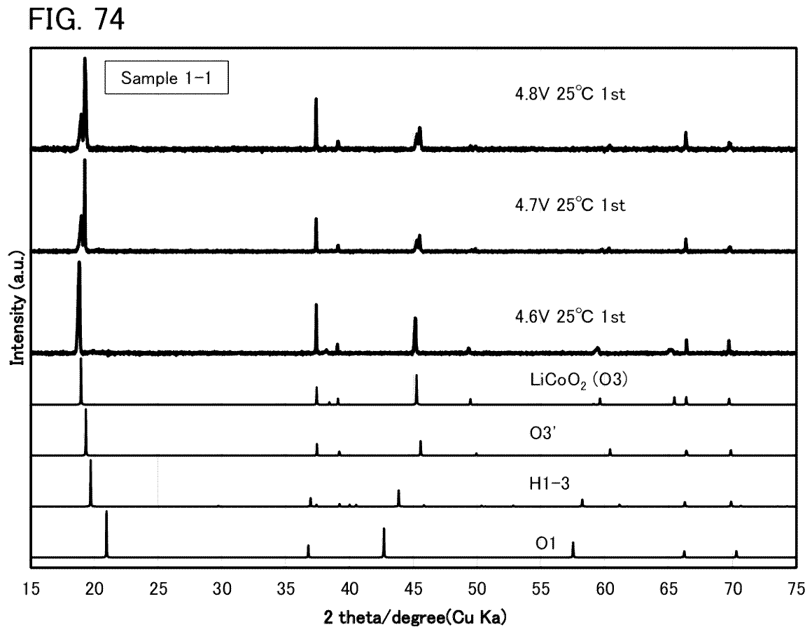

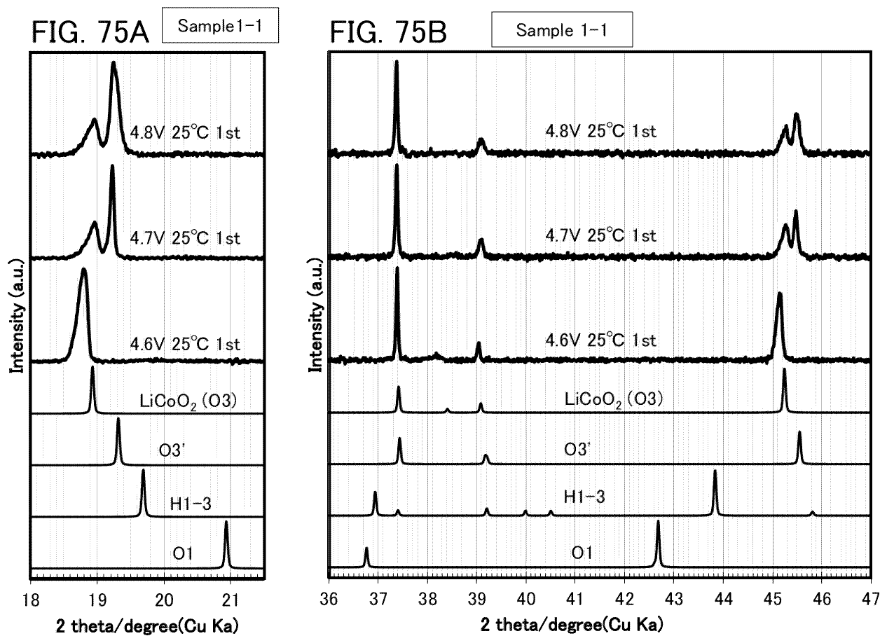

FIG. 74 shows XRD patterns of Sample 1-1 after the first charge at 25° C. and different charge voltages. FIG. 75A shows enlarged patterns in the range of 18°≤2θ≤21.5°, and FIG. 75B shows enlarged patterns in the range of 36°≤2θ≤47°. XRD patterns of O1, H1-3, O3′, and LiCoO₂ (O3) are also shown as references.

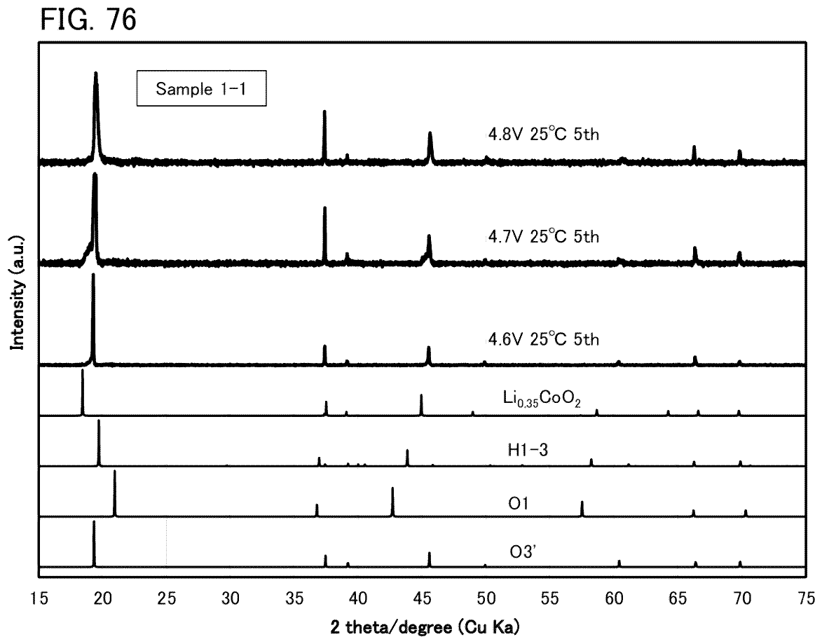

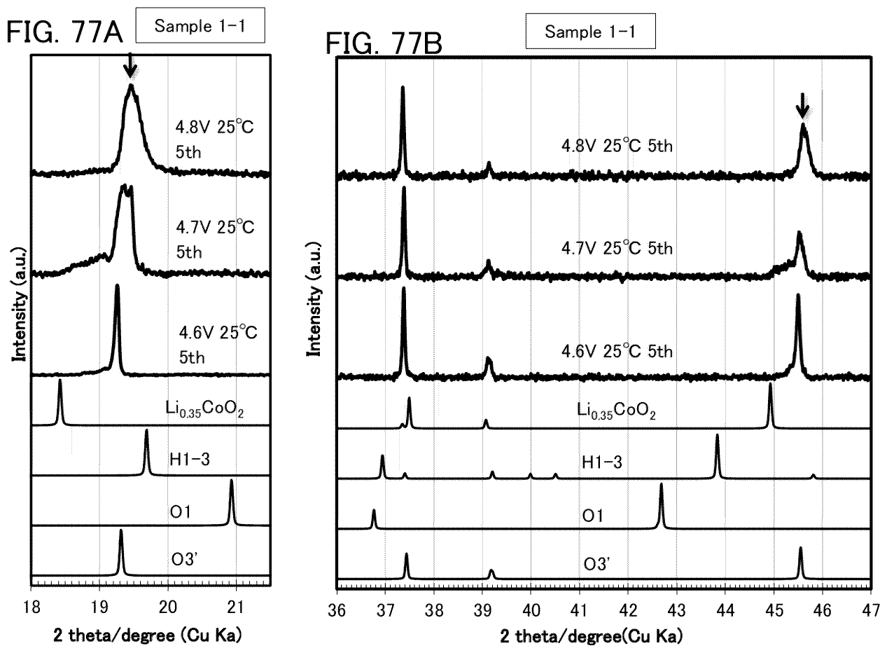

FIG. 76 shows XRD patterns of Sample 1-1 after the fifth charge at 25° C. and different charge voltages. FIG. 77A shows enlarged patterns in the range of 18°≤2θ 21.5°, and FIG. 77B shows enlarged patterns in the range of 36°≤2θ≤47°. XRD patterns of O3′, O1, H1-3, and Li_{0.35}CoO₂ are also shown as references.

It was shown from FIG. 74, FIGS. 75A and 75B, FIG. 76, and FIGS. 77A and 77B that in the case where the charge temperature was 25° C. and the charge voltage was 4.6 V, the sample had the O3′ type structure after the fifth charge. It was suggested that in the case where the charge voltage was 4.7 V, the O3′ type structure appeared after the first charge and the sample had the monoclinic O1(15) type structure exhibiting peaks at 2θ of 19.47±0.100 and 20 of 45.62±0.05° as well as the O3′ type structure after the fifth charge. It was suggested that in the case where the charge voltage was 4.8 V, the O3′ type structure appeared after the first charge and the sample had mainly the monoclinic O1(15) type structure after the fifth charge. In FIGS. 77A and 77B, the peak at 2θ of 19.47±0.10° and the peak at 2θ of 45.62±0.05° are denoted by arrows.

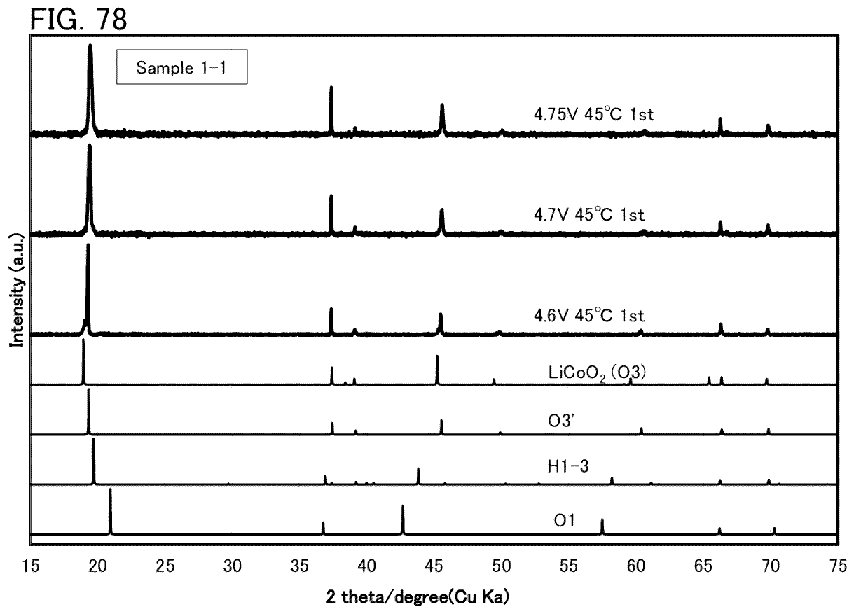

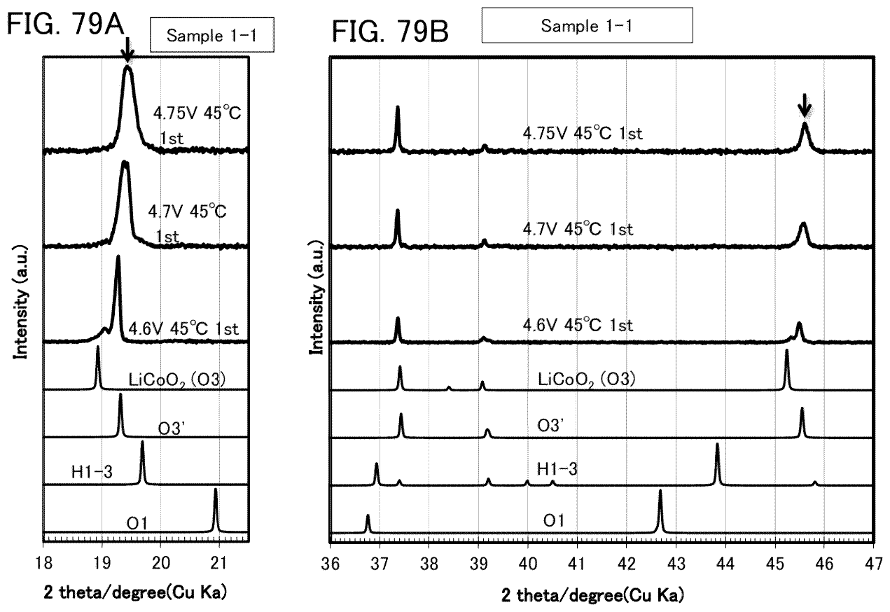

FIG. 78 shows XRD patterns of Sample 1-1 after the first charge at 45° C. and different charge voltages. FIG. 79A shows enlarged patterns in the range of 18°≤2θ≤21.5°, and FIG. 79B shows enlarged patterns in the range of 36°≤2θ≤47°. XRD patterns of O1, H1-3, O3′, and LiCoO₂ (O3) are also shown as references.

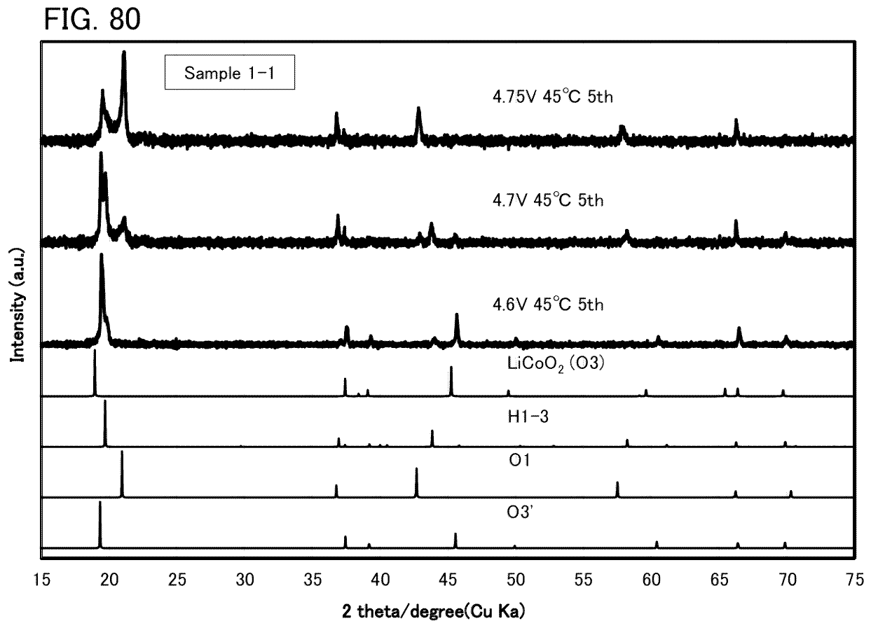

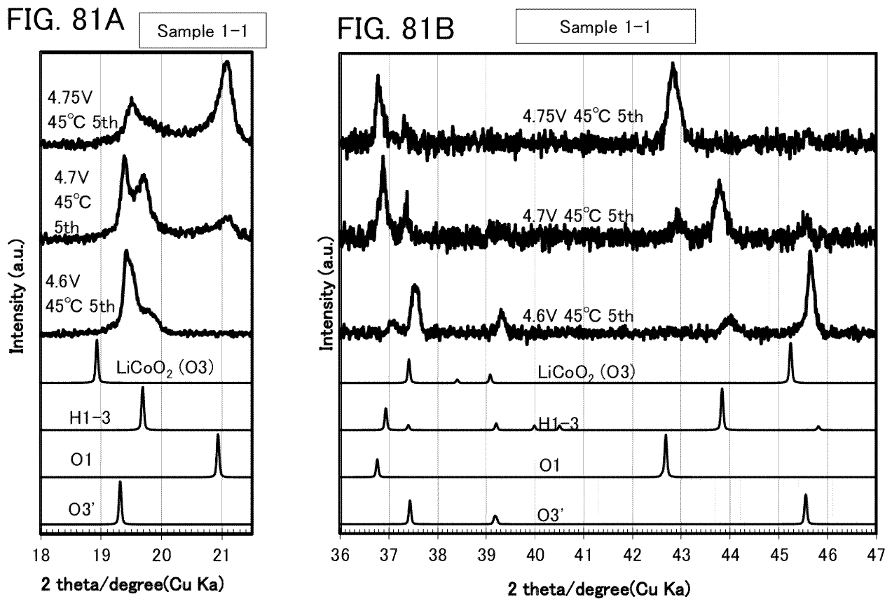

FIG. 80 shows XRD patterns of Sample 1-1 after the fifth charge at 45° C. and different charge voltages. FIG. 81A shows enlarged patterns in the range of 18°≤2θ≤21.5°, and FIG. 81B shows enlarged patterns in the range of 36°≤2θ≤47°. XRD patterns of O3′, O1, H1-3, and LiCoO₂ (O3) are also shown as references.

It was shown from FIG. 78, FIGS. 79A and 79B, FIG. 80, and FIGS. 81A and 81B that in the case where the charge temperature was 45° C. and the charge voltage was 4.6 V, the O3′ type structure appeared after the first charge and the monoclinic O1(15) type structure and the H1-3 type structure appeared after the fifth charge. It was suggested that in the case where the charge voltage was 4.7 V, the proportion of the H1-3 type structure was higher after the fifth charge. It was suggested that in the case where the charge voltage was 4.75 V, the monoclinic O1(15) type structure appeared after the first charge and the sample had the O1 type structure after the fifth charge. In FIGS. 79A and 79B, the peak at 2θ of 19.47±0.100 and the peak at 2θ of 45.62±0.05° are denoted by arrows.

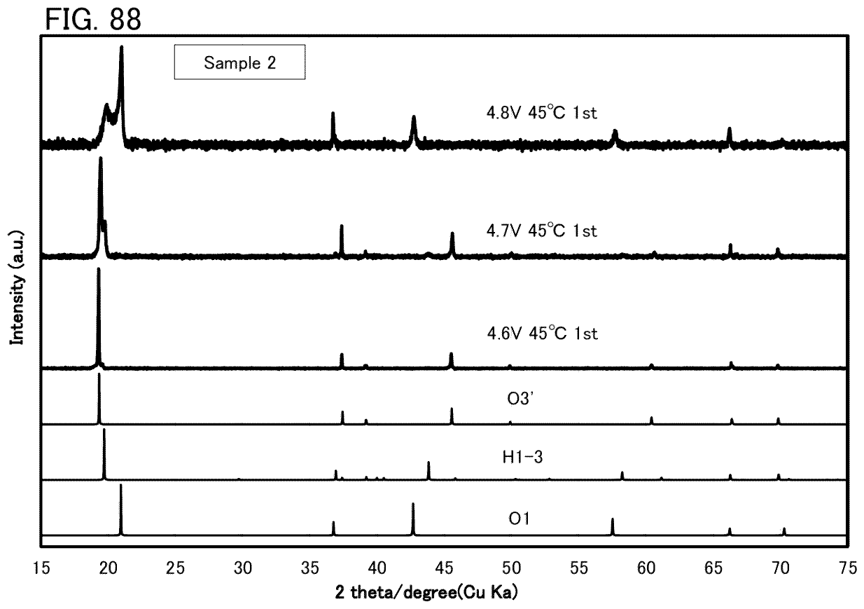

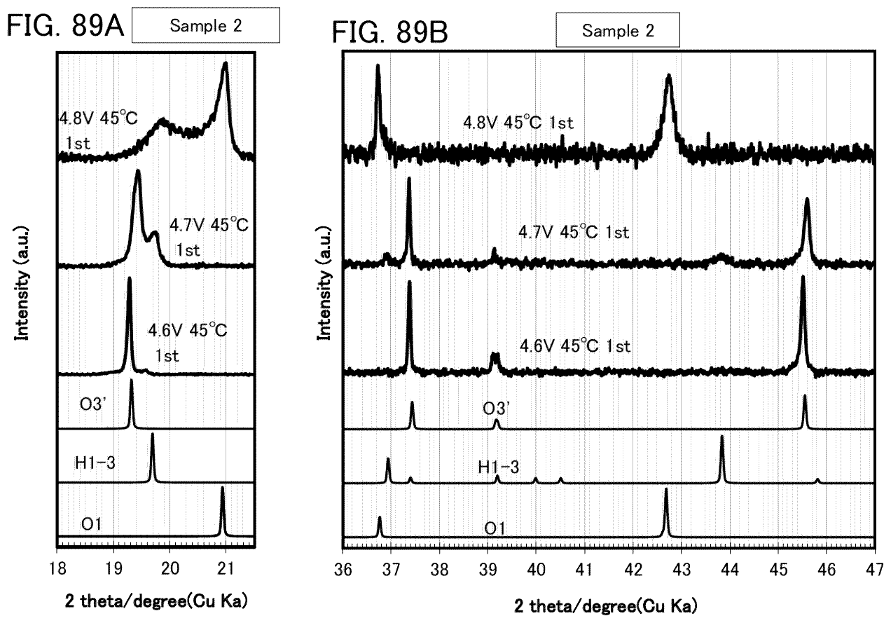

FIG. 88 shows XRD patterns of Sample 1-1 after the first charge, the fifth charge, and the 50th charge at 25° C. and 4.7 V. FIG. 89A shows enlarged patterns in the range of 18°≤2θ≤21.5°, and FIG. 89B shows enlarged patterns in the range of 36°≤2θ≤47°. XRD patterns of O1, H1-3, and O3′ are also shown as references.

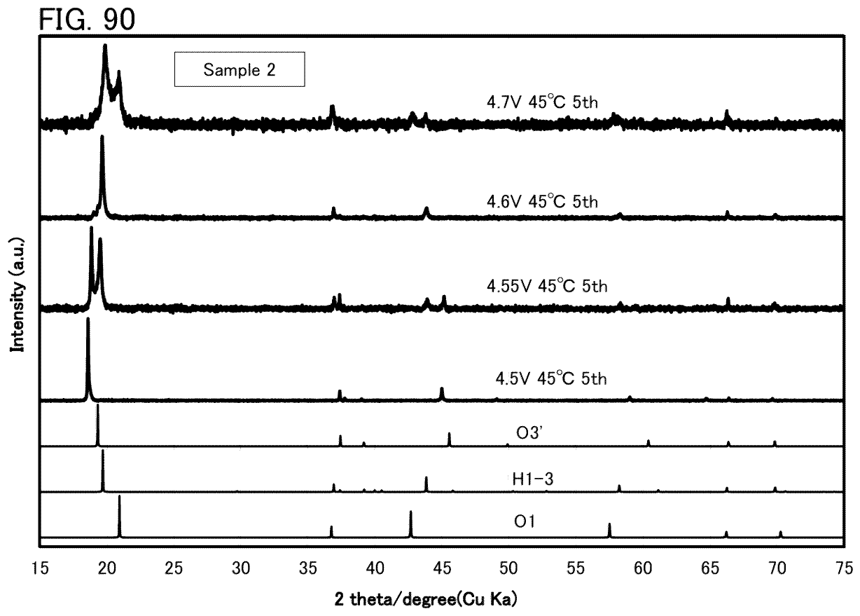

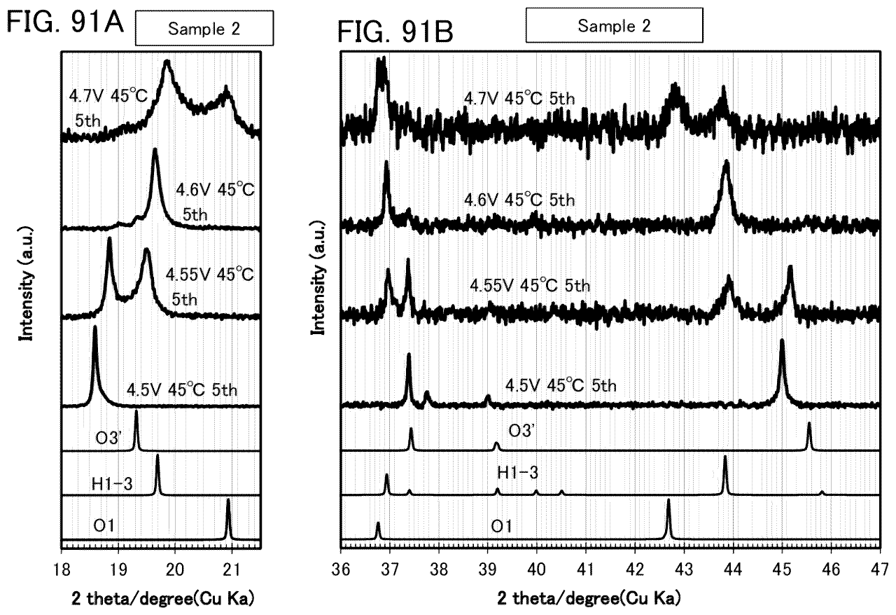

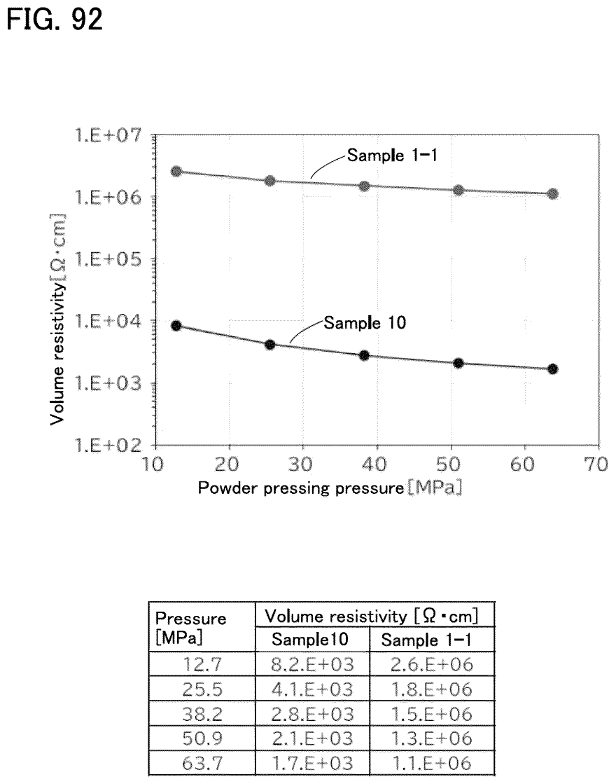

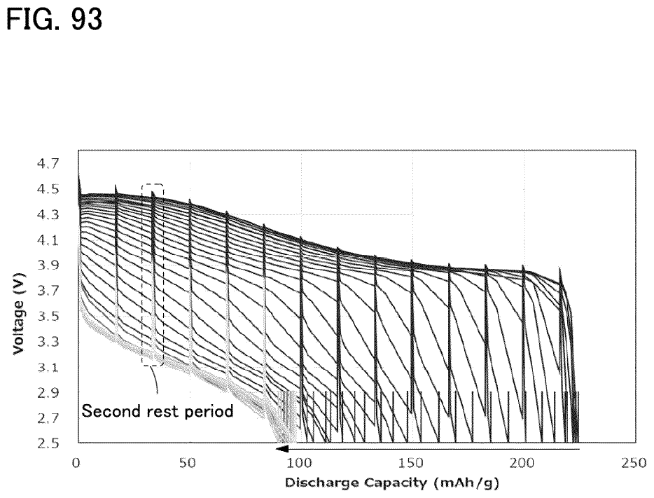

FIG. 90 shows XRD patterns of Sample 1-1 after the first charge, the fifth charge, the 15th charge, and the 50th charge at 45° C. and 4.7 V. FIG. 91A shows enlarged patterns in the range of 18°≤2θ≤21.5°, and FIG. 91B shows enlarged patterns in the range of 36°≤2θ≤47°. XRD patterns of O1, H1-3, and O3′ are also shown as references.

It was suggested that in the case where the charge temperature was 45° C. and the charge voltage was 4.7 V, the sample had mainly the crystal structure of Li_{0.68}CoO₂ after the 50th charge and was not charged efficiently.

Table 7 and Table 8 list typical reciprocal lattice points (hkl), peak positions (20 (degree)) corresponding to the typical reciprocal lattice points, and full widths at half maximum (FWHM) of the peaks for some XRD patterns in FIG. 74, FIGS. 75A and 75B, FIG. 76, FIGS. 77A and 77B, FIG. 78, FIGS. 79A and 79B, and FIG. 80.

TABLE 7

| | Sample and | | | |
|---|---|---|---|---|
| | conditions of | | 2θ | FWHM |
| | charge | hkl | (degree) | (degree) |
| FIG. 60 | Sample 1-1 | 0 0 3 | 19.26 | 0.1282 |
| | 4.8 V 25° C. 1st | 1 0 1 | 37.37 | 0.0554 |
| | | 0 1 2 | 39.09 | 0.1334 |
| | | 0 0 6 | 39.09 | 0.1336 |
| | | 1 0 4 | 45.49 | 0.1090 |
| | Sample 1-1 | 0 0 3 | 19.22 | 0.0603 |
| | 4.7 V 25° C. 1st | 1 0 1 | 37.37 | 0.0548 |
| | | 0 1 2 | 39.08 | 0.1041 |
| | | 0 0 6 | 39.08 | 0.1041 |
| | | 1 0 4 | 45.47 | 0.0746 |
| | Sample 1-1 | 0 0 3 | 18.78 | 0.1673 |
| | 4.6 V 25° C. 1st | 1 0 1 | 37.38 | 0.0471 |
| | | 0 0 6 | 38.16 | 0.2395 |
| | | 0 1 2 | 39.03 | 0.0642 |
| | | 1 0 4 | 45.13 | 0.1346 |
| FIG. 62 | Sample 1-1 | 0 0 3 | 19.47 | 0.2750 |
| | 4.8 V 25° C. 5th | 1 0 1 | 37.36 | 0.0614 |
| | | 0 1 2 | 39.13 | 0.0668 |
| | | 0 0 6 | 39.13 | 0.0672 |
| | | 1 0 4 | 45.62 | 0.2058 |
| | Sample 1-1 | 0 0 3 | 19.37 | 0.1013 |
| | 4.7 V 25° C. 5th | 1 0 1 | 37.37 | 0.0565 |
| | | 0 1 2 | 39.12 | 0.0584 |
| | | 0 0 6 | 39.12 | 0.0584 |
| | | 1 0 4 | 45.57 | 0.0993 |
| | Sample 1-1 | 0 0 3 | 19.25 | 0.0761 |
| | 4.6 V 25° C. 5th | 1 0 1 | 37.40 | 0.0552 |
| | | 0 1 2 | 38.99 | 0.0552 |
| | | 0 0 6 | 38.99 | 0.0548 |
| | | 1 0 4 | 46.18 | 0.9819 |

TABLE 8

| | Sample and | | | |
|---|---|---|---|---|
| | conditions of | | 2θ | FWHM |
| | charge | hkl | (degree) | (degree) |
| FIG. 64 | Sample 1-1 | 0 0 3 | 19.44 | 0.2441 |
| | 4.75 V 45° C. 1st | 1 0 1 | 37.36 | 0.0558 |
| | | 0 1 2 | 39.12 | 0.0742 |
| | | 0 0 6 | 39.12 | 0.0745 |
| | | 1 0 4 | 45.61 | 0.1655 |
| | Sample 1-1 | 0 0 3 | 19.38 | 0.2060 |
| | 4.7 V 45° C. 1st | 1 0 1 | 37.36 | 0.0553 |
| | | 0 1 2 | 39.12 | 0.0667 |
| | | 0 0 6 | 39.12 | 0.0669 |
| | | 1 0 4 | 45.57 | 0.1735 |
| | Sample 1-1 | 0 0 3 | 19.26 | 0.0932 |
| | 4.6 V 45° C. 1st | 1 0 1 | 37.36 | 0.0577 |
| | | 0 1 2 | 39.11 | 0.1273 |
| | | 0 0 6 | 39.11 | 0.1266 |
| | | 1 0 4 | 45.49 | 0.0997 |
| FIG. 66 | Sample 1-1 | 0 0 3 | 19.51 | 0.1996 |
| | 4.75 V 45° C. 5th | 1 0 1 | 37.33 | 0.0780 |
| | | 0 1 2 | 37.92 | 1.8963 |
| | | 0 0 6 | 38.21 | 1.5897 |
| | | 1 0 4 | 45.59 | 0.1321 |
| | Sample 1-1 | 0 0 3 | 19.39 | 0.1127 |
| | 4.7 V 45° C. 5th | 1 0 1 | 37.35 | 0.0797 |
| | | 0 1 2 | 39.22 | 0.3804 |
| | | 0 0 6 | 39.25 | 0.5196 |
| | | 1 0 4 | 45.54 | 0.2581 |

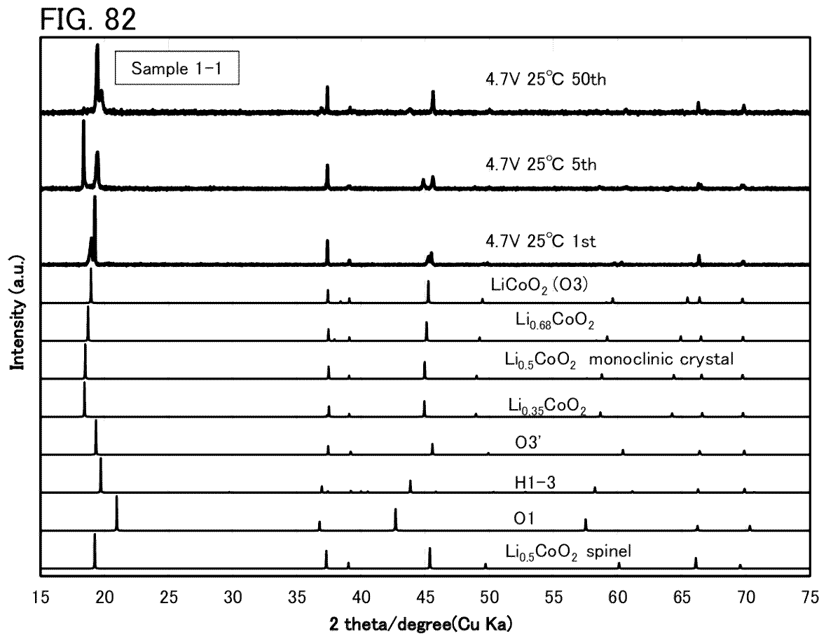

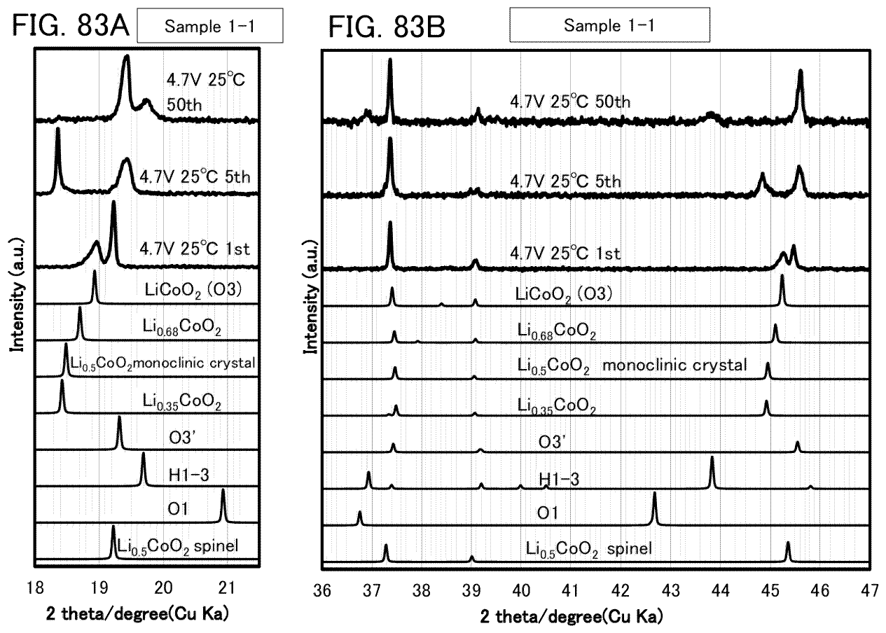

FIG. 82 shows XRD patterns of Sample 1-1 after the first charge at 25° C. FIG. 83A shows enlarged patterns in the range of 18°≤2θ≤21.5°, and FIG. 83B shows enlarged patterns in the range of 36°≤2θ≤47°. XRD patterns of LiCoO₂ (O3), Li_{0.68}CoO₂, Li_{0.5}CoO₂ monoclinic crystal, Li_{0.35}CoO₂, O3′, H1-3, O1, and Li_{0.5}CoO₂ spinel are also shown as references.

It was shown from FIG. 82 and FIGS. 83A and 83B that in the case where the charge temperature was 25° C. and the charge voltage was 4.7 V, the O3′ type structure appeared after the first charge.

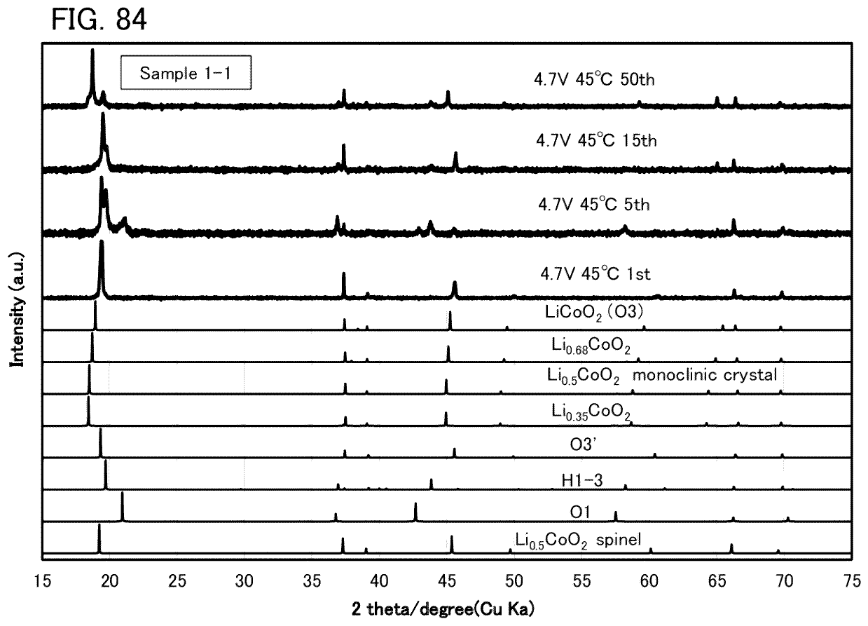

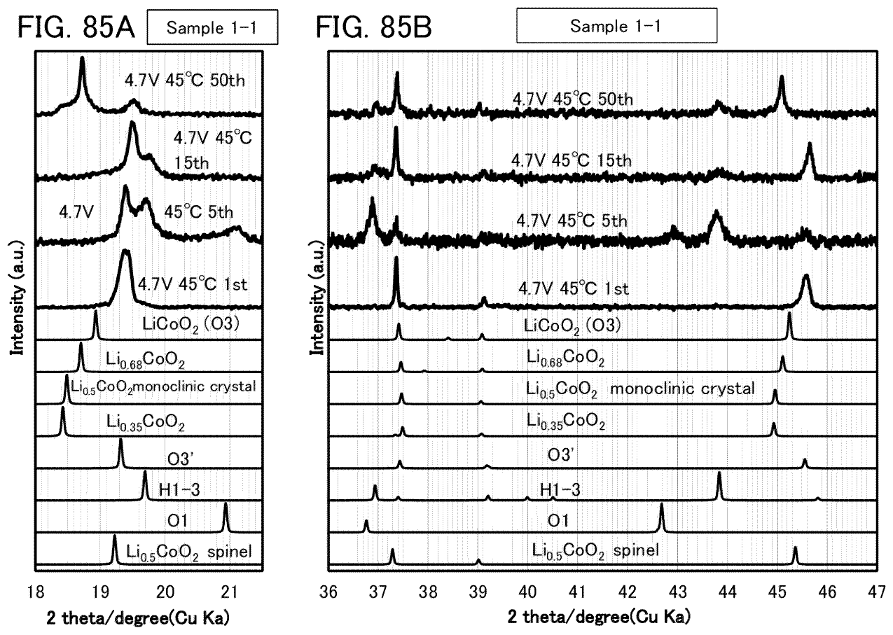

FIG. 84 shows XRD patterns of Sample 1-1 after the first charge at 45° C. and different charge voltages. FIG. 85A shows enlarged patterns in the range of 18°≤2θ21.5°, and FIG. 85B shows enlarged patterns in the range of 36°≤2θ≤47°. XRD patterns of LiCoO₂ (O3), Li_{0.65}CoO₂, Li_{0.5}CoO₂ monoclinic crystal, Li_{0.35}CoO₂, O3′, H1-3, O1, and Li_{0.5}CoO₂ spinel are also shown as references.

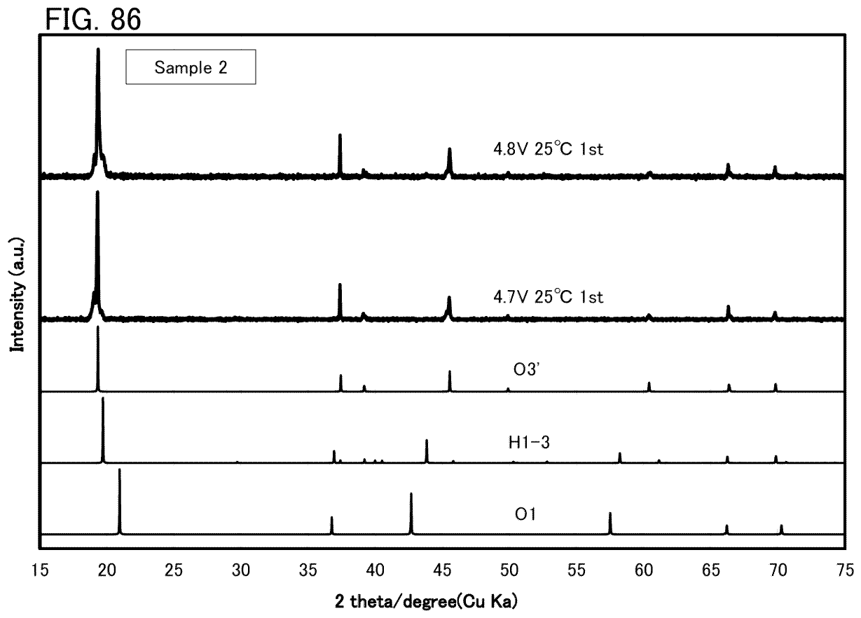

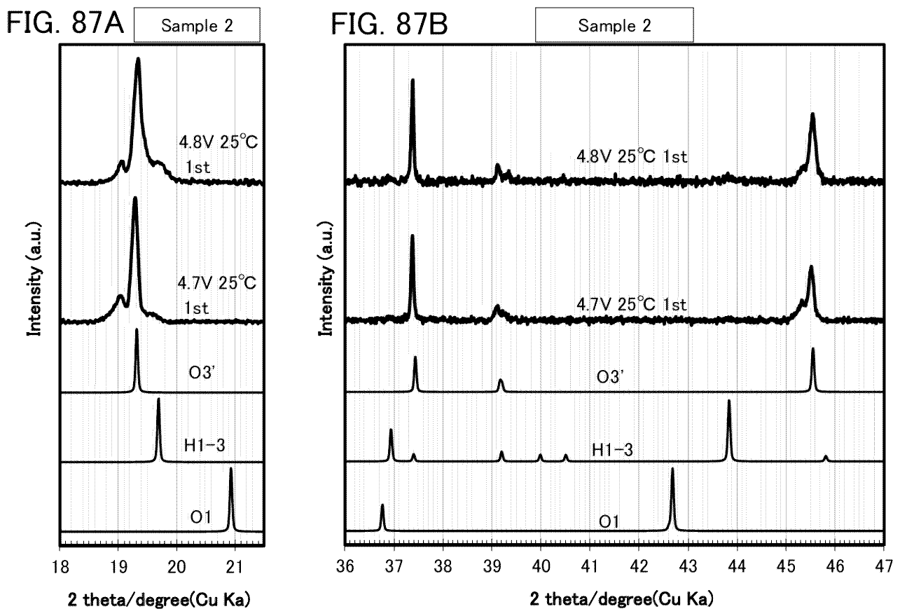

FIG. 86 shows XRD patterns of Sample 2 after the fifth charge at 45° C. FIG. 87A shows enlarged patterns in the range of 18°≤2θ≤21.5°, and FIG. 87B shows enlarged patterns in the range of 36°≤2θ≤47°. XRD patterns of O1, H1-3, and O3′ are also shown as references.

It was shown from FIG. 84 and FIGS. 85A and 85B that in the case where the charge temperature was 45° C. and the charge voltage was 4.7 V, in Sample 1-1, the O3′ type structure appeared after the first charge and the H1-3 type structure appeared after the fifth charge. It was shown from FIG. 88 and FIGS. 89A and 89B that in the case where the charge voltage was 4.7 V, in Sample 2, the H1-3 type structure already appeared after the first charge and the O3′ type structure and the monoclinic O1(15) type structure hardly appeared after the fifth charge. It was shown from FIG. 88 and FIGS. 89A and 89B that in the case where the charge voltage was 4.8 V, in Sample 2, the O1 type structure already appeared after the first charge.

It was thus shown that as compared to the positive electrode active material of Sample 2 on which the initial heating was not performed, the positive electrode active material of Sample 1-1 on which the initial heating was performed in its formation was unlikely to be changed into the H1-3 type structure and likely to maintain its crystal structure even when charge and discharge at a high voltage and/or a high temperature, i.e., charge and discharge that make x in LiₓCoO₂ be 0.24 or less are performed.

It was also suggested that Sample 1-1 has mainly the monoclinic O1(15) type structure after charge under certain charge conditions, e.g., after the fifth charge at 25° C. and 4.8 V and after the first charge at 45° C. and 4.75 V.

### <Rietveld Analysis>

Next, Rietveld analysis was conducted with the use of the XRD patterns of Sample 1-1 described above.

For the Rietveld analysis, an analysis program RIETAN-FP (see Non-Patent Document 5: F. Izumi and K. Momma, Solid State Phenom., 130, 2007, pp. 15-20) was used.

In the Rietveld analysis, multiphase analysis was conducted to determine the abundance of the O3 type structure, the O3′ type structure, the H1-3 type structure, and the O1 type structure in each sample. Here, the abundance of an amorphous portion in Sample 1-1 not undergoing a charge and discharge cycle was assumed to be zero. The abundance of an amorphous portion in a positive electrode after charge was the remainder of subtraction of the total abundance of the O3 type structure, the O3′ type structure, the H1-3 type structure, and the O1 type structure in the positive electrode after charge from the total abundance of the O3 type structure, the O3′ type structure, the H1-3 type structure, and the O1 type structure in Sample 1-1. Here, the abundance of an amorphous portion in the positive electrode after charge can be regarded as the abundance of an amorphous portion generated or increased by a charge and discharge cycle.

In the Rietveld analysis, the scale factor was a value output by RIETAN-FP. The abundance ratio of each of the O3 type structure, the O3′ type structure, the H1-3 type structure, and the O1 type structure was calculated in molar fraction from the number of the multiplicity factors of the crystal structure and the number of the chemical formula units in a unit cell for the crystal structure. In the Rietveld analysis in this example, each sample was standardized with white noise in the range including no significant signals in the XRD measurement in this example (2θ=greater than or equal to 23° and less than or equal to 27°), and each abundance is not an absolute value but a relative value.

Table 9 lists the abundance ratios (by percentages) of the O3 type structure, the O3′ type structure, the H1-3 type structure, the O1 type structure, and an amorphous portion in Sample 1-1 not undergoing a charge and discharge cycle and those in a positive electrode of a half cell including Sample 1-1 after the first charge or the fifth charge. The temperature at the time of the charge and discharge was 25° C. or 45° C.

TABLE 9

| | XRD analysis | |
|---|---|---|
| | Crystal | Ratio |
| Conditions of charge | structure | (%) |
| Sample 1-1 (without charge | O3 | 100 |
| and discharge) | | |
| Sample 1-1 | O3 | 44 |
| 25° C., 4.7 V | O3’ | 34 |
| 1st | Amorphous | 22 |
| Sample 1-1 | O3 | 32 |
| 25° C., 4.7 V | O3′ | 51 |
| 5th | Amorphous | 17 |
| Sample 1-1 | O3 | 56 |
| 45° C., 4.7 V | O3′ | 32 |
| 1st | Amorphous | 12 |
| Sample 1-1 | O3 | 11 |
| 45° C., 4.7 V | O3′ | 15 |
| 5th | H1-3 | 23 |
| | O1 | 12 |
| | Amorphous | 39 |

It was shown from Table 9 that in the case where charge was performed five or more times at 45° C., the XRD pattern became broad and the proportion of the amorphous region increased.

### Example 3

In this example, resistance components of Sample 1-1 on which the initial heating was performed and Sample 10 (reference) in Example 1 were analyzed.

### <Measurement of Powder Resistivity>

The powder resistivity of Sample 1-1 on which the initial heating was performed and Sample 10 (reference) in Example 1 was measured. As a measurement system, MCP-PD51 (produced by Mitsubishi Chemical Analytech Co., Ltd.) was used; for a device with a four probe method, Loresta-GP and Hiresta-GP were used properly. FIG. 92 shows the results of the powder resistivity measurement.

As shown in FIG. 92, Sample 1-1 had higher powder resistivity than Sample 10. Since one difference between Sample 1-1 and Sample 10 is the presence or absence of the additive element in the surface portion of the active material particle, it can be thus inferred that the presence of the additive element in the surface portion leads to a higher powder resistivity.

### <Current-Rest-Method>

Half cells were fabricated using Sample 1-1 on which the initial heating was performed and Sample 10 (reference) in Example 1 and were subjected to measurement by a current-rest-method. The positive electrodes and half cells were fabricated in manners similar to those of the half cells in Example 1. Note that the pressing in the formation of the positive electrode was performed at 210 kN/m at a roll temperature of 120° C.

The conditions of the measurement by a current-rest-method are as follows. An HJ1010 SD8 battery charge/discharge system produced by HOKUTO DENKO CORPORATION was used as a measurement system. The charge was constant current constant voltage (CCCV) charge in which constant current charge to 4.70 V was performed at a current of 100 mA/g and constant voltage charge at 4.70 V was performed until the charge current fell below 10 mA/g. The discharge was performed by repeating constant current discharge at 100 mA/g for 10 minutes and a 2-minute break (without charge or discharge) until the discharge voltage reached 2.50 V. Note that 38 cycles of the above charge and discharge were performed. FIG. 93 shows a graph in which discharge curves of Sample 1-1 in 25 cycles are overlapped.

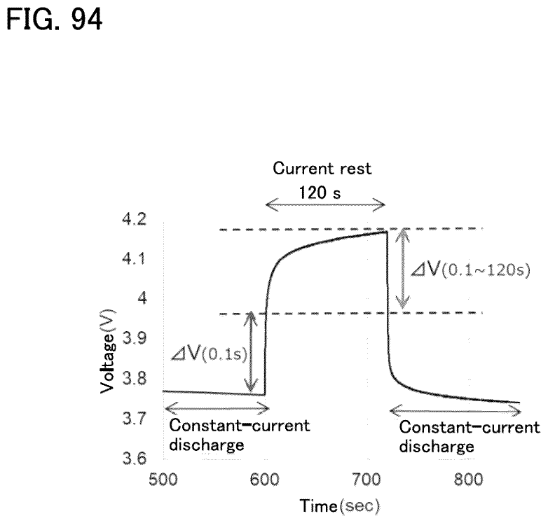

FIG. 94 illustrates an analysis method of internal resistance. The difference between the battery voltage just before a rest period and the battery voltage after 0.1 seconds after the rest period starts is ΔV(0.1 s). The difference between the battery voltage after 0.1 seconds after the rest period starts and the battery voltage after 120 seconds after the rest period starts (the battery voltage when the rest period ends) is ΔV(0.1 to 120 s). ΔV(0.1 s) divided by the current value of the constant current discharge is a resistance component R(0.1 s) with a high response speed, and ΔV(0.1 to 120 s) divided by the current value of the constant current discharge is a resistance component R(0.1 to 120 s) with a low response speed. The resistance component R(0.1 s) with a high response speed can be attributed mainly to electrical resistance (electronic conduction resistance) and movement of lithium ions in the electrolyte solution, whereas the resistance component R(0.1 to 120 s) with a low response speed can be attributed mainly to lithium diffusion resistance in the active material particles.

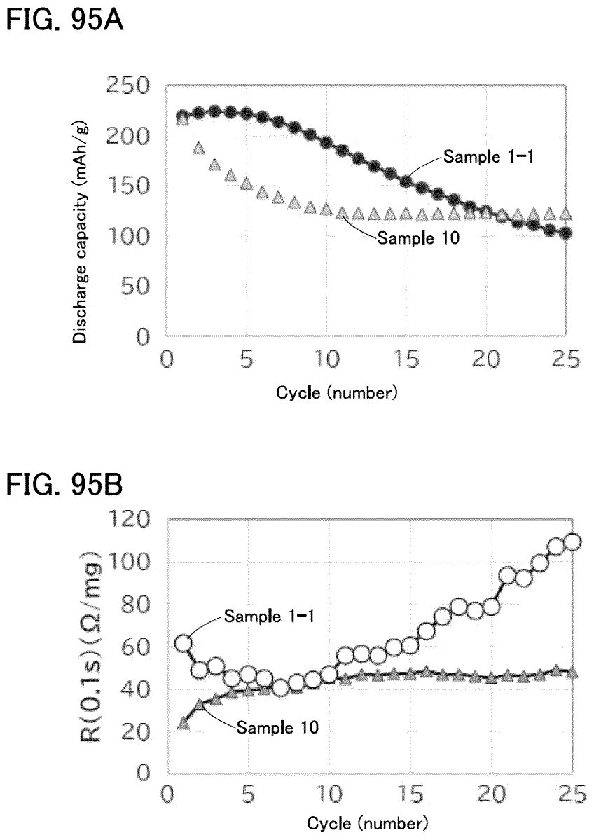

Next, results of the analysis by a current-rest-method are described below. For the second rest period, which is denoted by the arrow in FIG. 93, the resistance component R(0.1 s) with a high response speed and the resistance component R(0.1 to 120 s) with a low response speed were analyzed using the analysis method illustrated in FIG. 94. As the analysis results of Sample 1-1 and Sample 10, FIG. 95A shows a change in discharge capacity up to the 25th cycle, and FIG. 95B shows a change in the resistance component R(0.1 s) with a high response speed up to the 25th cycle. In each graph, circles denote the results of the half cell including Sample 1-1 and triangles denote the results of the half cell including Sample 10.

As shown in FIG. 95A, as the charge and discharge cycles proceeded, the discharge capacity of Sample 1-1 tended to decrease after increasing. As shown in FIG. 95B, the resistance component R(0.1 s) with a high response speed in Sample 1-1 tended to increase after decreasing; thus, in Sample 1-1, the tendency of a change in discharge capacity probably related to the tendency of a change in the resistance component R(0.1 s) with a high response speed. In other words, in Sample 1-1, the discharge capacity probably increased as the resistance component R(0.1 s) with a high response speed decreased. Note that in Sample 10, the discharge capacity only decreased and the resistance component R(0.1 s) with a high response speed only increased. One difference between Sample 1-1 and Sample 10 is the presence or absence of the additive element in the surface portion of the active material particle, and it is probable that the decrease in the resistance component R(0.1 s) with a high response speed shown in FIG. 95B reflects a change in the surface portion containing the additive element. The resistance component R(0.1 s) with a high response speed in Sample 1-1 tended to decrease until the seventh charge and discharge in FIG. 95B.

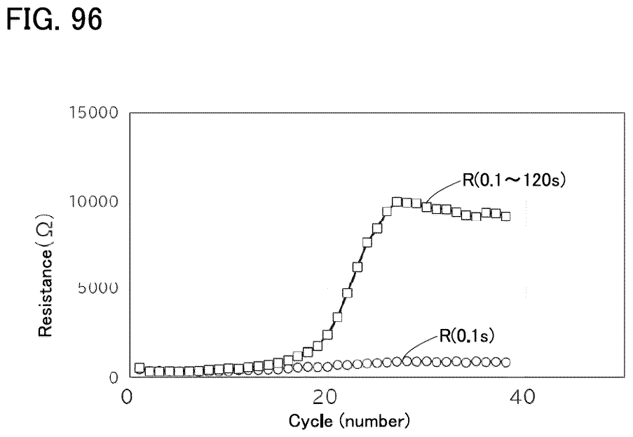

Next, FIG. 96 shows a change in the resistance component R(0.1 s) with a high response speed and the resistance component R(0.1 to 120 s) with a low response speed in Sample 1-1 up to the 38th cycle. Squares denote the change in the resistance component R(0.1 to 120 s) with a low response speed, whereas circles denote the change in the resistance component R(0.1 s) with a high response speed.

As shown in FIG. 96, the resistance component R(0.1 s to 120 s) with a low response speed changed more than the resistance component R(0.1 s) with a high response speed. The resistance component R(0.1 s to 120 s) with a low response speed abruptly increased around the 20th cycle and was substantially constant from the 27th cycle. It is thus presumable that when Sample 1-1 significantly degrades under charge and discharge cycle conditions at 4.70 V and 45° C., the lithium diffusion resistance, which is a main factor of the resistance component R(0.1 to 120 s) with a low response speed, is extremely high.

### Example 4

In this example, the positive electrode active material 100 of one embodiment of the present invention was fabricated and its characteristics were analyzed. The characteristics during the fabrication process and after the positive electrode active material 100 was used for a secondary battery were also analyzed.

TABLE 10

| | Fabrication condition |
|---|---|
| Sample 10 | Similar to Table 2 |
| (comparative example) | |
| Sample 11 | |
| Sample 1-1 | |
| Sample 1-10 | Sample 1-1 subjected to aging |

### <<Raman Spectroscopy>>

As shown in Table 10, analysis was performed by Raman spectroscopy on a comparative example Sample 10; Sample 11, which is a composite oxide during fabrication; Sample 1-1, which is a positive electrode active material of one embodiment of the present invention; and Sample 1-10, which is a secondary battery that uses the positive electrode active material of one embodiment of the present invention and has undergone aging.

The aging was performed under the following conditions. First, as in Example 1, a half cell including Sample 1-1 was fabricated. Then, charge and discharge cycles including CC/CV charge (20 mA/g, 4.3 V, 2 mA/g cut) and CC discharge (20 mA/g, 2.5 V cut) were performed twice, with a 10-minute break between the cycles. The measurement temperature was 25° C.
Measurement apparatus: Raman microscopy apparatus (SENTERRA II, produced by Bruker Japan K.K.)
Measurement and analysis software: OPUS Version 8.7
Objective mirror: 50×Raman
Laser wavelength: 532 nm
Laser output: 2.5 mW
Aperture: 50 μm
Wavenumber resolution: 4 cm⁻¹
Binning: 1
Frequency of accumulating: 50
Exposure time: 5000 ms

Measurement was performed on powder of the positive electrode active material on a glass plate having a depression while an electrode is attached to the glass plate. Before the measurement, the powder was focused on using an optical microscope.

Spectrum analysis was performed as follows. First, baseline correction was performed in a wavenumber range from 50 cm⁻¹ to 4250 cm⁻¹ under the conditions described below.
Method: Concave rubberband correction
Baseline point: 64
Interactive mode
Iteration: 3

Peak separation was performed in a wavenumber range from 300 cm⁻¹ to 800 cm⁻¹ of the spectrum that was subjected to the baseline correction.

Distributions of a single peak were set as initial values for a range from 470 cm⁻¹ to 490 cm⁻¹, a range from 580 cm⁻¹ to 600 cm⁻¹, and a range from 665 cm⁻¹ to 685 cm⁻¹. The shape of each distribution was Lorentz+Gauss mixture distribution, and the mixture ratio was set so as to be optimized by fitting. The Levenberg-Marquardt method was employed for the fitting.

When the wavenumber position of the peak set for the range from 665 cm⁻¹ to 685 cm⁻¹ was out of the range by the fitting, fitting was performed again using two curves while this peak is excluded.

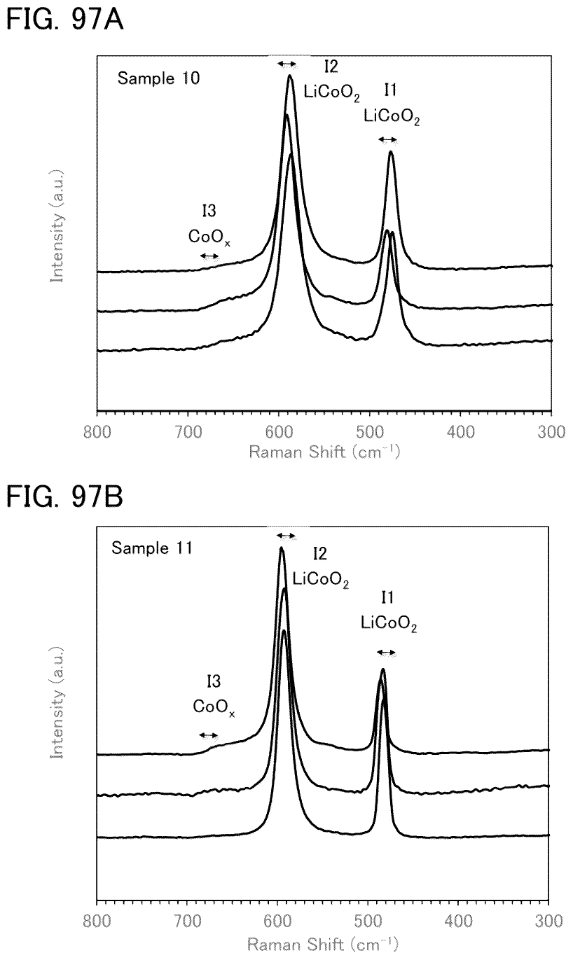

FIGS. 97A and 97B show the measurement results of Sample 10 and Sample 11.

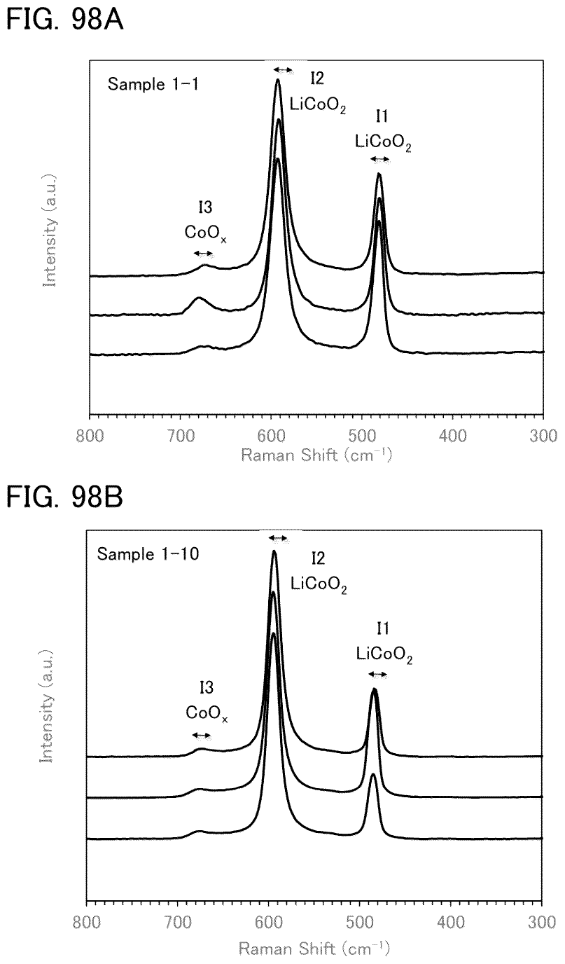

FIG. 98A shows the results of measuring three randomly selected powders of Sample 1-1. In the case where the integrated intensities of the peak in the range from 470 cm⁻¹ to 490 cm⁻¹, the peak in the range from 580 cm⁻¹ to 600 cm⁻¹, and the peak in the range from 665 cm⁻¹ to 685 cm⁻¹ are represented by I1, I2, and I3, respectively, I3/I2 was 3.1%, 4.1%, and 8.1%

Six randomly selected powders of Sample 1-10 were subjected to measurement, and FIG. 98B shows the measurement results of three of them. Similarly, I3/I2 was 3.6%, 4.40%, 4.70%, 7.20%, 7.2%, and 8.8%.

The above results show that I3/I2 of the positive electrode active material of one embodiment of the present invention is greater than or equal to 1% and less than or equal to 10%, specifically greater than or equal to 3% and less than or equal to 9%.

### Example 5

In this example, Sample 1-1 and Sample 2 were fabricated under the different conditions of a crucible used for heating, and analysis was performed using XPS. A region that is approximately 2 nm to 8 nm (normally, less than or equal to 5 nm) in depth from a surface can be analyzed by XPS; thus, the concentrations of elements in the surface and the surface portion can be quantitatively analyzed.

For Samples 1-1a and 1-1c, a used crucible made of aluminum oxide was used in heating. For Sample 1-1b, a new crucible made of aluminum oxide was used in heating. For Sample 2, a used crucible made of aluminum oxide was used. The fabrication conditions other than a crucible were the same as those in Example 1.

### <<XPS>>

The positive electrode active materials fabricated under the above conditions were subjected to quantitative analysis using XPS. The results are shown in Table 11. The main element ratios calculated from Table 11 are shown in Table 12. Table 12 also lists the maximum discharge capacities and the discharge capacity retention rates after 50 cycles of half cells fabricated using the positive electrode active materials in a manner similar to that in Example 1.

TABLE 11

| | | atomic % | | | | | | | | | | | | |
|---|---|---|---|---|---|---|---|---|---|---|---|---|---|---|
| | Cruicible | Li | Co | O | Mg | F | Ni | Al | C | Ca | Na | S | Si | Total |
| Sample 1-1a | used | 7.5 | 11.1 | 46.2 | 8.4 | 5.9 | 0.5 | 0 | 17.3 | 1.2 | 0.7 | 1.2 | | 100.0 |
| Sample 1-1b | new | 10.2 | 13.5 | 50.2 | 8.2 | 5.8 | 0.9 | 0.5 | 4.7 | 1.9 | 2.1 | 2 | 0 | 100.0 |
| Sample 1-1c | used | 10.1 | 11.4 | 48.9 | 10.8 | 7 | 1.2 | 0.6 | 3.6 | 1.5 | 1.9 | 2.1 | 1 | 100.1 |
| Sample 2 | used | 8.3 | 13.7 | 51.5 | 8.4 | 5.3 | 1.1 | 1.2 | 3.9 | 2.3 | 2.3 | 1.9 | 0 | 99.9 |

TABLE 12

| | | | | | | | | | Maximum | Discharge capacity |
|---|---|---|---|---|---|---|---|---|---|---|
| | | | | | | | | | discharge capacity | retention rate after 50 |
| | Cruicible | Mg/Co | Ni/Co | Al/Co | Mg/Li | Al/Li | F/Co | F/Li | [mAh/g] | cycles [%] |
| Sample 1-1a | used | 0.76 | 0.05 | 0.00 | 1.12 | 0.00 | 0.53 | 0.79 | 223.0 | 93.9 |
| Sample 1-1b | new | 0.61 | 0.07 | 0.04 | 0.80 | 0.05 | 0.43 | 0.57 | 221.3 | 79.3 |
| Sample 1-1c | used | 0.95 | 0.11 | 0.05 | 1.07 | 0.06 | 0.61 | 0.69 | 216.4 | 95.3 |
| Sample 2 | used | 0.61 | 0.08 | 0.09 | 1.01 | 0.14 | 0.39 | 0.64 | 217.6 | 87.5 |

It was found from Table 11 and Table 12 that which of the new crucible or the used crucible was used made a difference between the discharge capacity retention rates after 50 cycles of the half cells.

It was also found that as the proportion of magnesium was high, the cycle performance was improved. This indicates that magnesium stabilized the surface portion. For example, Mg/Li is preferably greater than or equal to 1.07 and less than or equal to 1.12. Mg/Co is preferably greater than or equal to 0.76 and less than or equal to 0.95.

It was also found that as the proportion of aluminum was low, the cycle performance was improved. Although aluminum was contained, the proportion of aluminum that was detected in XPS was low, which indicates that aluminum was diffused from the surface into the positive electrode active material deeply and formed a solid solution. For example, Al/Li is preferably less than or equal to 0.6. Al/Co is preferably less than or equal to 0.5.

It was also found that as the proportion of fluorine was high, the cycle performance was improved. Fluorine was efficiently detected, which indicates that a fluoride effectively functioned as a fusing agent and wettably spread over the surface of lithium cobalt oxide. For example, F/Li is preferably greater than or equal to 0.69 and less than or equal to 0.79. F/Co is preferably greater than or equal to 0.53 and less than or equal to 0.61.

Furthermore, the sample in which nickel was detected tended to have better cycle performance. It can be considered that when nickel existed at a concentration that can be detected, a function of stabilizing the crystal structure of the surface portion increased.

It was found that when some of the above-described features are achieved, a positive electrode active material with favorable cycle performance can be fabricated.

This application is based on Japanese Patent Application Serial No. 2021-079264 filed with Japan Patent Office on May 7, 2021, the entire contents of which are hereby incorporated by reference.

What is claimed is:

1. A method for manufacturing a positive electrode active material, comprising:
heating a first composite oxide comprising lithium and cobalt;
forming a first mixture by mixing a heated first composite oxide and a first additive element source comprising magnesium and fluorine;
heating the first mixture to form a second composite oxide comprising lithium, cobalt, magnesium, and fluorine;
forming a second mixture by mixing the second composite oxide, a second additive element source comprising nickel and aluminum; and
heating the second mixture,
wherein the heating of the first composite oxide is performed at a temperature of higher than or equal to 700° C. and lower than or equal to 1000° C.,
wherein the heating of the first mixture is performed at a temperature of higher than or equal to 800° C. and lower than or equal to 1100° C.,
wherein the heating of the second mixture is performed at a temperature of higher than or equal to 800° C. and lower than or equal to 1100° C., and
wherein the heating of the second mixture is performed at a lower temperature than the heating of the first mixture.
